(19) United States
(12) Patent Application Publication
(10) Pub. No.: US 2004/0054572 A1
(43) Pub. Date: Mar. 18, 2004

(54) Collaborative filtering

(76) Inventors: Alison Oldale, London (GB); John Oldale, London (GB); John Van Reenen, London (GB); Michael Campbell, London (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/333,953

(22) PCT Filed: Jul. 27, 2001
(86) PCT No.: PCT/GB01/03383

(30) Foreign Application Priority Data
Jul. 27, 2000 (GB) 0018463.0
Jan. 2, 2001 (GB) 0100035.5
Jun. 1, 2001 (GB) 0113334.7
Jun. 1, 2001 (GB) 0113335.4

(51) Int. Cl. G06F 17/60

(52) U.S. Cl. 705/10

(57) ABSTRACT

A method of filtering data to predict an observation about an item for a particular case is provided in which: a set of data representing actual observations about a plurality of items for a plurality of different cases is modelled as a function of a plurality of case and item profiles, each profile being a set of parameters comprising at least one hidden metrical variable, the parameters defining characteristics of the respective case or item; a best fit of the function to the data is found in order to find the values of the item profiles; and the profiles found are used together with the function to predict an observation for a particular case about one or more items for which data is not available for that case.

The present invention relates to a method of filtering data in which a dataset of observations about a set of different items for a set of different cases is analysed to determine various characteristics of the dataset. Thus for example, the observations could reflect the suitability of the different items for a plurality of users (each user representing a different case) and the characteristics determined when the data is analysed could be used to predict the suitability of one or more items for a user.

The method of the invention has particular application in e-commerce such as for example, Internet web-sites for selling products such as books, music and holidays, but also in call centres and telesales and in traditional (BAM) retailing.

Various collaborative filtering systems which use a database containing data representing user preferences to predict a topic or product which a user might like are known in the art. Typically, a user logs onto a website such as for example, the Amazon.com website which deals chiefly in book sales. The user is given a user ID when first using the site so that any data obtained from previous site visits will be retrieved and used when the user logs on in the future.

One known filtering method, memory based reasoning (MBR), correlates the preferences of users in the data set for various items with preferences provided by the user for some of the items in the data set. The system then recommends to the user other items that similar users in the data set liked. However, this method can be slow if all other users in the data set are used to make a recommendation, involves losing information if only a subset is used, and is subject to known sources of inaccuracy such as how to weight the preferences of each of a set of very similar users since the informational content of each is low. Consequently, the method is disadvantageous (and may not be practical) in situations where there is a large data set, i.e. a large number of users recommending a large number of items. The method is also disadvantageous in that an operator cannot see how the recommendations made correspond to the dataset. This is a particular problem in certain marketing situations where transparency of the recommendations made is required.

One solution which has been proposed to this problem is the use of clustering techniques. Thus, users having similar preferences are grouped into clusters and the probability of a user belonging to any one cluster is calculated so that a weighting can be assigned to each item to be recommended to the user. However, when clustering users into groups, it is assumed that all users in a cluster or group have the same rating for all items. Further, the rating of an item for a user will be based only on the history of users in one cluster such that a large amount of available data will be disregarded. Moreover, the number of clusters is intrinsically limited by the requirement that each cluster must contain a sufficiency of members to allow statistically meaningful results. Thus, clustering techniques are thought to be inaccurate or imprecise.

One clustering approach to collaborative filtering is the Bayesian clustering approach. This is based on a predictive model. The model supposes that a user can be described by a single variable that assigns the user to one of a finite set of classes.

The predictive model is a set of likelihood functions, one for each item, that specify the probability of the item being suitable for a user, depending on their class.

An example for one of the likelihood functions might be:

Probability the user has seen the movie ‘Titanic’ is

$$\{ \begin{matrix}0.2 if the user is in class A \\ 0.3 if the user is in class B\end{matrix}$$

This method is described in greater detail in Breese, Heckerman and Kadie “Empirical Analysis of Predictive Algorithms for Collaborative Filtering”, Proceedings of the fourteenth conference on uncertainty in artificial intelligence, Maddison, Wis. 1998.

The method has advantages over MBR. In particular it is fast, since recommendations are based on a model, and in principle the model can be investigated to assess whether its behaviour accords with an administrator's preferences. On the other hand the method is not as accurate, since users are assumed to belong to one of a limited number of classes, and all predictions are the same across members of the same class. The number of classes cannot grow too large because there needs to be enough members in each class to generate statistically meaningful estimates. Moreover investigating the model simply leads to a list of probabilities for the items, one list for each class. This does not generate intuitive understanding about its behaviour, so that the ability of administrators to assess and control it is limited.

It is an object of the present invention to provide a filtering method which is capable of overcoming the problems associated with the prior art.

From a first aspect, the present invention provides a method of filtering data to predict an observation about an item for a particular case, in which: a set of data representing actual observations about a plurality of items for a plurality of different cases is modelled as a function of a plurality of case and item profiles, each profile being a set of parameters comprising at least one hidden metrical variable, the parameters defining characteristics of the respective case or item; a best fit of the function to the data is approximated in order to find the values of the item profiles; and the profiles found are used together with the function to predict an observation for a particular case about one or more items for which data is not available for that case.

It will be understood that using the method described above, all of the data obtained may be used in predicting the observation about the item(s). Thus, no data need be ignored or wasted.

The method of the invention differs from the prior art naive Bayes approach described above in that in the method of the invention the case profiles are not labels which identify the class to which the case belongs. Instead they include metrical variables—numbers that enter into the predictive models as meaningful parameters. The use of the method of the invention provides a filtering method which is fast, accurate and generates relevant marketing knowledge about the data. In addition, it is easy for a user such as for example a marketing executive to understand the pattern of predictions which can be obtained using the method of the invention. Further, the pattern of predictions may be easily controlled as will be discussed further below

From a further aspect, the present invention provides a method of filtering data to predict an observation about an item for a particular case in which: a set of data representing actual observations about a plurality of items for a plurality of different cases is modelled as a function of a plurality of case and item profiles; a best fit of the function and the profiles found are used together with the function to predict an observation for a particular case about one or more items for which data is not available for that case.

Preferably, the function which models the data set is made up of a plurality of models, each model representing the observations about one item for the cases in the data set. Each model is preferably derived by identifying a model type which most closely fits the data available for the item in question. For example, the model might be based on a logistic curve or on a neural network. The exact model which best fits the available data is identified by a set of the unknown parameters which is referred to as the item profile and preferably comprises a vector of metrical components. The model further includes another set of unknown parameters known as the case profile. This is a vector including metrical components identifying various unknown characteristics of the case which for example could be a user in which case the characteristics would be assumed to cause them to like or dislike various items.

In the function which models the data set, the observations about items for cases are preferably independent, conditional on the case profiles. This allows the function to be used in a tractable, sensible way.

Preferably, the models which make up the function are learnt from past observations, i.e. the models are chosen to give a good fit between modelled observation predictions and actual instances of past observations.

The models used may be stochastic with specified distribution on the error terms so that a likelihood for past observations given the model can be specified and the item profiles can then be estimated using the techniques that fall under the heading of maximum likelihood estimation in statistics to maximise the likelihood of past observations. Alternatively for example, models could be fitted to the data by using estimation procedures that seek to minimise some function of the errors, such as least squares and its variants. Alternatively a stochastic model could be estimated using Bayesian methods.

In an alternative however, a set of models may be built by an expert to behave in ways which they think appropriate.

In one preferred form of the method of the invention, point estimates of the parameters of the case and item profiles are found for the dataset and these are used to predict an observation. The method of decomposing the dataset into a plurality of case and item profiles in this way is considered to be novel and inventive in its own right and so, from a second aspect, the invention provides a method of filtering data to predict an observation about an item for a particular case, in which a set of data is obtained representing actual observations for a plurality of cases, including the particular case, of a plurality of items, a function which models the data set is solved so that the data is decomposed into a plurality of case profiles and item profiles, and an observation for the particular case about an item is predicted using the case profiles and item profiles obtained.

Thus again using the method of the invention described above, all of the data obtained may be used in predicting an observation about an object for a particular case. Thus, no data need be ignored or wasted and, as data relating specifically to the case in question is used to obtain the case profiles, the predictions obtained with the method will generally be more accurate than those obtained with clustering methods particularly in situations where there is only a relatively small amount of data available.

Preferably, the function is maximised so as to determine the case and item profiles.

Still more preferably, the data set is modelled as a function of the likelihood of the data in the data set being present and the function is solved by choosing item profiles and case profiles which maximise the likelihood of the data in the data set being present.

Still more preferably, the function is maximised iteratively such that one of the case and item profiles is held constant during each iteration.

One advantage of this method is that all the information in the data is used and yet the number of parameters that are used to make recommendations scales linearly with the number of items (objects). In a Bayesian network or decision tree approach as used in many prior art methods, by contrast, either information is discarded or the number of parameters potentially scales as the square of the number of items (objects).

In an alternative preferred filtering method according to the invention, point estimates of the case and item profiles are not derived but rather a prior distribution is assumed over possible case profiles and point estimates of the item profiles are then obtained. This method is believed to be novel and inventive in its own right.

From a further aspect therefore, the invention provides a method of filtering data to predict an observation about an item for a particular case, in which a set of data is obtained representing actual observations for a plurality of cases about a plurality of items, a function which models the data set as a function of a plurality of item profiles and a prior distribution over a plurality of possible case profiles is set up to provide point estimates of the item profiles that fit the function to the data, and an observation about an item for a particular case is predicted using the item profile point estimates obtained together with a set of data representing observations about a plurality of items for the said particular case.

In this method, as the data is modelled in such a way that only point estimates of the item profiles are found (i.e. point estimates of the case profiles are not obtained) the dimensionality of the process of solving the function is much lower than it would be if no prior distribution over case profiles were assumed. Thus, this feature reduces the sampling variance of the estimated item profiles, improving the prediction performance. Consequently, the method allows a good, relatively accurate solution to the data set to be found by relatively simple computation.

An observation about an item for a particular case can be predicted using various alternative methods. In two particularly preferred forms of the invention, the observation can be predicted either by using the item profile point estimates together with the function which models the data set to obtain a prediction of the observation directly or by updating a prior distribution over possible case profiles using Bayesian inference, the data relating to the particular case, and the function.

Most preferably, the prediction of an observation about an item for a case is estimated by Bayesian inference about the case profile. Thus, the observation can be predicted by updating a prior distribution over possible case profiles using Bayesian inference, the data relating to the particular case and the function.

It will be understood that this recommendation method could be implemented by a single function such that the prior distribution is not explicitly updated but is only done so implicity. As the item profiles are estimated based on an assumed prior distribution of the case profiles, the method of obtaining the item profiles is more closely linked to the prediction method using Bayesian inference which also uses an assumed prior distribution of the case profiles than it would be if point estimates of both the item and case profiles were obtained. This also leads to potentially more satisfactory results being obtained from the prediction method of the invention. Further, this method is equally applicable to the case in which point estimates of item profiles and case profiles are obtained.

From a further aspect therefore, the invention provides a method of filtering data to predict an observation about an item for a particular case, in which a set of data representing actual observations for a plurality of cases about a plurality of items is modelled by a function, and the function is solved so as to decompose the data into a plurality of case profiles and a plurality of item profiles, and an observation for the particular case about an item is predicted by Bayesian inference using the case profiles and item profiles obtained together with a set of data representing observations about a plurality of items for the said particular case.

Preferably the case profiles obtained are used to obtain a prior probability distribution over possible case profiles for the said particular case and the prior probability distribution is then used in the Bayesian inference.

Preferably the prior probability distribution is generated by taking an average of the case profiles in the data set.

Preferably a posterior probability distribution over possible case profiles for the said particular case is generated from the prior probability distribution by Bayesian inference using the set of data relating to the said case and a function modelling the likelihood of the data set being present.

Preferably the posterior probability distribution is used to generate a probability distribution over possible observations about items for the particular case.

Preferably, only the data relating to those items for which observations have been obtained for the case is used in updating the prior distribution over possible case profiles. This improves the results obtained as it avoids the bias effect from assuming for example that for a particular case, there is a reason why no observation has been recorded for an item.

Preferably, each case is a different user of a prediction system such that observations by that user about various items are included in the dataset.

Preferably the function is made up of a plurality of 0models, each model representing the suitability of an item for a user. Still more preferably, each model of the suitability of an item for a user depends directly only on the user (or case) profile and the profile for that item, and not directly on any of the data relating to the suitability for the user of any other item.

Preferably the item profiles are estimated as those parameters which maximise the fit between the function which models the data set and the data.

Preferably the number of components of each item profile is set by the profile engine to maximise the effectiveness of the function in making predictions. Still more preferably, this is done using standard model selection techniques such as the Akaike information criterion.

Still more preferably, the data set is modelled as a function of the expected likelihood of the data in the data set being present and the item profiles are chosen as the parameter values which maximise the likelihood of the data in the data set being present given the function and the assumed prior distribution of the case profiles.

Still more preferably, the function is maximised iteratively and in the preferred embodiment, an EM algorithm is used to do this.

Preferably the prior distribution over each component of the plurality of possible case profiles is assumed to be a standard normal distribution and the components are assumed to be independent. Still more preferably, this distribution is also used in the Bayesian inference to estimate the observation about an item for the particular case.

Preferably a posterior probability distribution over possible case profiles for the said particular case is generated from the prior probability distribution by Bayesian inference using the set of data relating to the said particular case and a function modelling the likelihood of the data set being present.

Preferably the posterior probability distribution is used to generate a probability distribution over possible observations about items for the particular case.

In one embodiment the data set includes ratings given by users for various items and the posterior probability distribution is used to generate a probability distribution over possible ratings for items by the user.

Preferably the probability distribution over possible preferences or ratings for items by the user is used to estimate the preference or rating of the user for each of a set of items.

From a still further aspect, the present invention provides a method of filtering data to predict an observation about an item for a particular case, in which a set of data is obtained representing actual observations for a plurality of cases about a plurality of items, a function which models the data set as a function of a set of case profiles and a set of items profiles comprising sets of parameters is set up, wherein the case and item profiles each comprise at least one hidden metrical variable, the parameters defining the characteristics of each said respective case and item, the method comprising the steps of:

a) estimating the values of the case profile parameters by solving a hidden variable model of the dataset;

b) using the estimated values of the case profile metrical variables in the function to estimate the values of the item profile metrical variables; and

c) predicting an observation about an item for a particular case using the item profile values obtained together with a set of data representing observations about a plurality of items for the said particular case.

This method is relatively fast and simple to implement as it can be implemented using widely available and familiar algorithms. The method has the advantage that once the case profiles have been estimated such that they can be treated as known variables, a wide range of familiar curve fitting and statistical techniques can be used to estimate the item profiles. This allows a modeller to use widely available statistical packages to estimate item profiles for a variety of possible item functions.

Further, by estimating values of the case profiles and using those estimated values to estimate the item profile values, the dimensionality of the dataset of observations about cases is reduced before estimating the item profiles. Thus, the dataset containing observations about a possibly large number of items for each case is reduced to a dataset containing a small number of profile components for each case.

Preferably, the case profile values are estimated by solving a hidden variable model of the dataset to find approximate values of the item profile variables and the approximate item profile values are then used to estimate the case profile values.

Still more preferably, the hidden variable model used is a linear model such as for example a standard linear factor model or principal component analysis.

Once the case profile values have been estimated, they are preferably substituted into the function modelling the dataset which is then solved using maximum likelihood techniques to find the item profile values.

In one preferred embodiment of the invention, items in the dataset can be considered as belonging to a plurality of different groups, each group having a different set of case profiles associated with it so that the case profile values for each group are estimated separately. This could be advantageous in situations where the different groups largely act as indicators of different components of the cases' profiles as it reduces the number of free parameters that need to be estimated for a given number of overall components in a case profile and so could result in more accurate predictions being made.

Alternatively or in addition, some items in the dataset could be treated directly as observed components of the case profile, i.e. as values of one or more of the metrical variables. This could be advantageous in situations where one or more items caused other aspects of the observations rather than themselves being caused by other things.

Once the case and item profile values have been estimated, they can be used to estimate an observation about an item for a case. Preferably, the prediction of an observation about an item for the case is made by updating a prior distribution over possible profiles for the case by Bayesian inference and then using the updated case profile obtained together with the function modelling the dataset and the estimated item profile values to make predictions. It will be understood that this prediction method could be implemented by a single function such that the prior distribution is not explicitly updated but is only done so implicitly.

This method has the advantage that any point estimate of a case profile based on the updated case profile obtained will not be very sensitive to small changes in the dataset. This reduces the potential for imprecision in the estimates of the case profile to act as a source of prediction error.

In an alternative embodiment, an observation about an item for the case is estimated by maximising the likelihood of the data relating to the case in question given the function modelling the dataset and the estimated item profile values to find the values of the case profile, and then using the case profile obtained together with a likelihood function and the estimated item profiles to predict observations about items for that case.

The entire filtering process could be carried out in real time each time that a prediction was requested. However, it will be appreciated that this would require a very heavy calculation load to be carried such that a prediction would take a relatively long time to generate. Preferably, therefore, the item profiles and the prior distribution over possible case profiles or the actual case profiles are calculated in an off-line non real-time filtering engine and are supplied to an on-line real-time engine for use in the calculation of predicted observations for a case when a set of data relating to the said case is supplied to the real-time engine. In this way, updated predictions may be supplied in real-time without the need to recalculate item and/or case profiles for each case and item in the data set.

The various filtering methods of the invention as described above can be used in various marketing contexts including analytics, marketing automation and personalisation.

The data representing the suitability of a plurality of objects for a plurality of users could be obtained in many different ways. For example, users could merely select some objects from a group of objects and an assumption could be made that the selected objects were suitable for the user. Alternatively, the level of suitability of an object could be linked to the rating given to that object by a user.

Preferably, the data set is modelled as a function of a plurality of unknown case and item profiles. It will of course be understood however that the item and case profiles may include information on observable characteristics such as the age of a user so that one or more of the case and/or item profiles in the model may be known.

In one embodiment of the invention, the item profiles obtained by the method of the invention could be stored such that subsequently a particular item could be specified and items which were similar to that particular item would then be recommended. The specified item could be compared to other items for which item profiles were available using for example a similarity metric based on the item profiles. A recommendation of other items which were similar to the specified item could then be made to the user.

The method of recommending similar items to a user as described above is thought to be novel and inventive in its own right and so, from a further aspect, the present invention provides a method of filtering data to find items which are similar to an item specified by a user, in which a set of data representing observations about a plurality of items for a plurality of cases is obtained, a function which models the data set is used to estimate a plurality of item profiles each containing a set of parameters representing characteristics of the item and at least one hidden metrical variable, and wherein items which are similar to a specified item are found by comparing the item profile of the specified item to other item profiles.

In a further alternative embodiment, the item and case profiles obtained from the filtering methods of the invention may be used to sort items and/or cases into groups or clusters by comparing the case and/or item profiles and placing all those cases or items having similar profiles into one group or cluster. Such groups or clusters might provide useful information to marketing organisations for example.

This method is also considered to be novel and inventive in its own right and so, from a further aspect, the present invention provides a method of filtering data, in which a set of data representing observations about a plurality of items for a plurality of cases is obtained, a function which models the data set is solved so that the data is used to estimate a plurality of item profiles each containing a set of parameters representing characteristics of the item, and at least one hidden metrical variable, and wherein cases and/or items are sorted into groups or clusters such that each group contains cases or items having similar case or item profiles.

In some instances, the data obtained may be biased. This may be due to the fact that users have only sampled some of the objects about which they are asked and/or that users have not entered data for all of the objects which they have sampled. In order to avoid the prediction provided by the method of the invention being influenced by this selection bias, the method preferably further includes the use of statistical techniques to correct for bias in the case data prior to predicting an observation about an item for a case.

In some instances, the data available may not be sufficient for accurate predictions to be made. In this case, a user could be asked to assess some further items (referred to herein as exogenous standards) which are not directly linked to the class of items for which predictions of observations are being made.

Preferably therefore, the method of the invention further comprises the step of obtaining data relating to the assessment by a plurality of users of one or more exogenous standards so as to increase the amount and range of data available.

In this way, means are provided for comparing the preferences of each of the users contributing to the data set. This may improve the overlap between the data sets obtained for each user.

Examples of exogenous standards which might be used are a photograph of scenery for holiday preference selection or descriptions of TV programmes for book preference selection. A user's assessment of the exogenous standard would take place either on the basis of the information presented alone (e.g. a photograph of scenery or a text summary of an unread book or magazine) or on the basis of perceptions associated with the description (e.g. users' perceptions of, say, “Friends” TV programme or a book or a magazine that they have previously read). The use of such exogenous standards may improve the assessment overlap between users. This may help to address problems with data sparseness by artificially increasing the pool of experiences common to multiple users and therefore making the data set of items to be assessed “better populated” than would otherwise be the case. The satisfactory application of exogenous standards requires users' preferences regarding the exogenous standards to be at least reasonably associative with their preferences concerning the class of objects to be assessed. Thus, suitable exogenous standards would be found by testing them in advance on a test population using appropriate surveying and analysis methods.

The use of exogenous standards to improve the population and range of a data set to be used in the prediction of user preferences for a particular object is thought to be novel and inventive in its own right. Thus, from a further aspect, the invention provides a method of obtaining a data set from which the suitability of a specific object for a user can be estimated, in which data relating to the suitability for a plurality of users of a plurality of related objects is obtained together with data relating to the preferences of those users for at least one exogenous standard which is not directly related to the plurality of related objects.

It will be appreciated that the exogenous standards used can be in multi-media and include any form of graphic image, photograph, sound or music as well as a conventional passage of text, a name or other written description.

One of the most profitable applications of personalization technologies such as collaborative filtering is to match advertising with users on a one to one basis so that each user sees those advertisements that are most likely to elicit a positive response from her. This application can either be run on a standalone basis (e.g. by using passive observation of each user's browsing behaviour and a record of click through rates and other indicators on the part of previous users in respect of particular advertisements to build up the necessary user and item databases to allow collaborative filtering) or on the back of an express personalised recommender service, i.e. a service for predicting the suitability of an item for a user in which data representing the suitability of a plurality of items for a plurality of users is obtained and analysed using for example a filtering method according to the invention. In the latter case difficulties may arise where preferences concerning the object being advertised are not strongly associative with the class of objects about which data is held by the personalised recommender service. In such cases the introduction of appropriately selected exogenous standards may “bridge the gap” allowing better prediction of preferences concerning advertised goods (as well as helping with data thinness as described above). The appropriate exogenous standards must be selected through preparatory research to be at least reasonably associative with both the objects for which data is obtained and the advertisements being placed.

In the data filtering method of the invention, the data relating to the suitability of the items for the users can be obtained by asking each user to rate their opinion of each or some of the items (for example on a scale of 1 to 5). However, users may well have other information about the items or information on related items and this information could usefully be collated.

Preferably therefore, users are given the opportunity of giving additional details about their preferences over and above rating the items about which they are asked. Thus, the users can provide more information about their preferences than is currently usable in the prediction of the suitability of an item for a user or can be displayed as output in the system at the time at which they input the data. Thus, for example, a user might be asked whether or not she had been to each of four locations and she would answer yes or no for each of these. If the user wished to do so however, she could add additional information either in the form of, say, other locations which she had visited (resulting in a horizontal broadening of the data set) or she could, for example, specify the attractions which she had visited at each of the four locations (resulting in a vertical deepening of the data set). Thus, in vertical deepening of the data set, the user will provide data relating to one or more attributes (e.g. the attractions at a particular location) of one or more of the items for which data is obtained.

This broadening or deepening of the data set could either be done by adding to closed menu options presented to users at the data acquisition stage or by inviting free text inputs from the user. An advantage of the latter route is that it provides a means to determine what sorts of additional information would be most commonly encountered and hence useful to predict.

This determination could be automated so that the database could be broadened or deepened efficiently without overburdening users with an excessive number of options.

Once a sufficient number of users had provided additional information about an item or an attribute of an item which was not originally included in the data set, the data relating to that item or attribute would be added to the data set and used in the prediction of the suitability of items for subsequent users.

The idea of allowing users to provide information of greater detail than is at the time directly capable of application in the calculation of suitability predictions so that this additional data is used to expand the data set is believed to be novel and inventive in its own right.

Thus, from a further aspect, the invention provides a method of obtaining a data set from which an observation for a case about a specific object can be predicted, in which data relating to the observations for a plurality of cases about a plurality of predefined items is obtained and in which further data relating to one or more attributes of one or more of the predefined objects may also be provided for one or more of the cases.

Preferably, a statistical model is used to determine when an item or item attribute has been specified by a sufficient number of users to allow it to be added into the observation prediction data set.

Whilst collaborative filtering (and the filtering method of the invention in particular) excel at subjective recommendation other methods will often be preferable for recommendation in respect of objective criteria. As many real life applications require recommendations/advice based upon a mix of subjective and objective criteria the combination of multiple techniques may give better results in such situations.

Consequently, a pre-filtering processing step may be provided to carry out preliminary screening using objective criteria to reduce the number of items that must be assessed in the filtering step.

As, typically, it is computationally easier to screen an item using an objective process than a filtering one, generally pre-screening will make the overall prediction process more efficient in the use of computer resources. In practice, it may sometimes be most efficient to run the pre-filtering processing stage and filtering together such that each individual item is pre-screened and then (if necessary) subjected to filtering. Weighting and other adjustments can then be applied before the process moves on to the next step.

Still more preferably, weighting factors may be applied to the data relating to the observations about items for the cases prior to the filtering step.

In one preferred embodiment, the weighting factors applied to the data reflect the time that has elapsed since the time at which the observation about the item was formed such that the weight of each piece of data for predictive purposes declines with time. In this way, the profiles obtained using the filtering method of the invention may be made to automatically reflect the changes in an item which occur over time.

Such a use of weighting factors is considered to be novel and inventive in its own right and so, from a further aspect, the present invention provides a method of weighting data relating to observations about an item in which the weight of the data decreases with an increase in the time elapsed since the observation was made.

Particularly where observations are weighted according to recency, it may be useful to record the value of each item profile on a periodic basis (e.g. daily, weekly, monthly etc.) in order to track any changes in profile values over time. These changes can then conveniently be displayed using a graphical interface such as an item position map of the type described below. In such a map the changes in position can be marked as trajectories across profile space and the time each profile was calculated can be represented either by suitable labelling or by colour coding or some other suitable means.

Changes in customer (or personal) profiles can likewise be tracked over time by periodically calculating and recording profile values in respect of relevant sets of items. These can then be displayed graphically either individually (in the same way as for item profiles) or net changes in the aggregate density of profiles across can be displayed by some suitable means such as colour coding or 3D simulation according to time. To aid understanding these changes may be animated.

Preferably, a post filtering processing step is provided in addition to or instead of the pre-filtering processing step.

Post filtering processing will typically have primarily commercial value, allowing a provider of the filtering method of the invention to adjust the output before it is used or displayed to an end-user (i.e. the user viewing the results of the filtering method). This addresses commercial concerns sometimes expressed concerning filtering to the effect that the process deprives the provider of a degree of marketing/sales discretion.

In one preferred embodiment, the post-filtering processing step is a rules based processing step which excludes any items which do not fall within a defined set of criteria from the predictions output from the filtering step.

One problem that arises in filtering systems such as that of the invention is that there is not enough data available to provide accurate predictions until a minimum number of users have provided their preferences for a range of objects or until a minimum amount of information has been gathered for a case. However users are unlikely to be motivated to provide this information unless they will obtain a prediction after doing so.

Thus, in a preferred embodiment of the invention, a different type of output giving an estimated prediction such as for example the generic mean of the output can be substituted for filtering predictions where, for whatever reason, there is insufficient information concerning either one or more items within the item database or concerning one or more cases.

In this way, users will see that an output is provided and so will be encouraged to provide their details and preferences so that the database can be built up until it contains sufficient information to implement the filtering process of the invention.

Preferably, the estimated predictions are replaced gradually by predictions obtained from the filtering method of the invention as more data becomes available.

This can be achieved using various means including Bayesian updating or, more simply, a weighted average of the estimated and filtered predictions with the weighting set according to the statistical uncertainty of the filtering prediction (where the statistical uncertainty is dependent on the amount of data available).

In an alternative preferred embodiment, the manager of the database could generate a fixed number of phantom cases. The profile of an item for which insufficient data was available would be specified by the manager to be a weighted average of some other items and the phantom cases would be specified to rate that item with ratings which depending on the manually determined profile. Whenever a new actual case was added to the database, a phantom case could be removed. Thus, over time, the updated case profile would increasingly reflect the observations for actual cases.

The output from the filtering method of the invention could be used in a number of ways. Thus, the end-user of the filtering method may be notified of some or all of the results (possibly via a third party such as the provider site operator or a call centre staff member) or alternatively some or all of the output may be made available solely to one or more third parties (such as a provider) and not to the end-user. This might be useful for commercial purposes such as for example content management or advertising personalisation.

Thus, in one preferred embodiment the invention provides a data filtering service in which a database of observations about a plurality of items for a plurality of cases is obtained and analysed on an exclusive basis for a single client. The database could be used as a recommender service and/or for the client's content management and/or for advertising selection.

Typically, this client would be a website service provider selling a specific range of products. Advantages of this arrangement include ease of implementation, ability for the client to dictate the parameters of the service fully allowing to total customisation, exclusivity regarding the data collected (possibly shared with the PCF service provider), and exclusivity regarding the service provided (which may have the commercial benefit of acting as a marketing tool to attract new users and/or as a means for increasing customer loyalty).

There are, however, significant disadvantages of this arrangement. In particular, the amount of data that can be collected is likely to be much less than for a pooled service (unless the client is strongly pre-eminent in its field). This will have an adverse effect on the range, depth and precision of the predictions that may be generated. Additionally, the service may prove less convenient for users as it is well-known that Internet users are deterred by an overabundance of registrations, passwords, information requests and so forth. The adoption of a pooled service with common registration (in whatever form) and data acquisition is therefore more attractive to Internet users who recognise that they will receive a greater range of services (i.e. from multiple sites) for their registration and data inputting and are therefore even more likely to regard the registration and data provision processes as worthwhile. Thus, unless the client website operator is pre-eminent in its field or intends to rely entirely on passively collected data, the user uptake of the service may be reduced vis a vis a comparable pooled service.

Consequently, in an alternative preferred arrangement the invention provides a data filtering service in which a database of observations about a plurality of items for a plurality of cases is obtained and analysed to provide a database which may be pooled with other databases, the filtering service operating from the pooled databases via linkage preferably through a dedicated extranet. Under this arrangement a single history database (i.e. a data set representing the suitability of a plurality of objects for a plurality of users) may be established, developed and maintained for the class of clients being served as a whole.

The most significant advantage of this pooled arrangement is that it allows significantly more widely ranging, detailed and precise predictions for each client than might ordinarily otherwise be the case. Further advantages include improved user convenience, (due to the reduction in individual registrations and data inputs required for access to the service via multiple websites—as discussed above) and potentially reduced development and maintenance costs for each client due to scaling economies and costs sharing.

In one preferred arrangement, the pooled database is configured such that, although the history database is held in common as described above, contributing websites retain either partial or complete exclusivity in relation to the inputs and outputs from the database in respect of those particular users that register through their sites.

Thus, for example, other websites might be able to make use of information concerning such individual users for the purposes of obtaining predictions regarding optimisation of site advertising or content for that individual but would not be able to make use of the information for the purpose of offering express advice or recommendations to the individual user. An advantage of this arrangement for the website acquiring the information concerning the individual user is that it can retain a degree of exclusivity in respect of prediction/recommendation services to that user whilst taking advantage of the data concerning assessment of objects to provide wider, deeper and more precise advice and recommendations to the user than might otherwise be the case.

In a further preferred arrangement, database information concerning individual users is held in a common pooled database but either partial or complete exclusivity may be maintained by individual clients in relation to inputs and outputs in relation to specific classes of item.

Such an arrangement might for example suit groups of non-competing clients looking to co-market and/or increase user convenience/minimise development/maintenance costs. Dependant on the degree of inter-relationship between the specific classes of objects to be assessed such an arrangement may also allow more precise predictions to be made, based upon additional information concerning individual users or items acquired by other participating websites. Thus, for example, separate clients operating travel agency, restaurant guide and wine selling sites might take advantage of pooling of user information concerning travel, dining and wine preferences to provide a more precise and convenient service to users than would be possible individually whilst at the same time limiting user access to advice/recommendations relating to their sales field to themselves as a marketing/customer loyalty tool. Such a partial pooling configuration would have particular value in optimising advertising content as it would potentially allow advertising in fields other than the client's primary field of activity to be optimised with much greater precision. In all cases, use could be made subject to applicable data protection principles being observed.

The above has been described principally in terms of a service by which an individual user interacts directly with a service in real-time (either passively or expressly or both). However, the service may equally well be provided to users indirectly via the medium of a third party such as, for example, a salesperson or call centre operative.

In such instances, the third party would interact directly with the service via any of the appropriate means described above and interact with the ultimate user by any reasonable method (typically either by telephone or face to face communication, but potentially also for example by e-mail, letter, video link or other means).

A filtering service carried out on this basis may provide the ultimate user with express predictions giving rise to advice or recommendations, or it may not be made known to the ultimate user but instead be used to provide recommendations or advice based on predictions to the third party (for example regarding up-selling or cross-selling opportunities or simply concerning suggestions concerning appropriate recommendations/advice that the third party might choose to make), or it may be used for a number of different purposes some of which are made known to the ultimate user and some are not.

The service might operate in real-time or not. In other regards the process would operate in the same manner as described above except where the practical context provides otherwise. (Thus, for example, it would not normally be possible to use images to acquire exogenous standards information from ultimate users by telephone although it might be in a face to face context where a display screen was available (e.g. in a shop or travel agency)).

Using such a service provides the ultimate user with many of the benefits of the on-line service and provides the third party with very useful customer service and sales tools, and/or a means of supplementing the skills base of its operatives as well as the other advantages discussed more generally above.

It will be noted that prediction/recommendation services may also be provided to clients through multiple channels such that the service can be delivered to users via one of several touch points across the client—user interaction interface. Thus, for example, a travel agency might provide its customers with the same filtering based advice drawing upon the same databases via inter alia the Internet, WAP, digital interactive TV, its call centres and retail shops according to the requirements of its customer. This flexibility provides significant customer service benefits to both client and customer.

The primary use of a filtering service according to the invention to provide predictions concerning the preferences, likely courses of action, decisions and responses of individuals has already been discussed. In addition, the information contained within the history databases may preferably be marketed to various third parties particularly as a source of market information whether in regard of the characteristics of the individual constituent users (e.g. for the compilation or acquisition of mailing/prospect lists or for the purpose of datamining of whatever applicable form) or in regard of aggregate information concerning either users or objects assessed or both (e.g. for the purpose of datamining of whatever applicable form or for benchmarking, profiling, obtaining trend/time series data or any other recognised management, marketing or market research purpose).

As an adjunct to this it is considered preferable that an archive of history data be maintained and a means employed to facilitate the searching for, collation and analysis of data from this archive according to various criteria including by date. This will greatly enhance the usefulness of such data for the purpose of off-line sales most particularly in the provision of all forms of time dependent analysis and information.

In one preferred embodiment of the invention, an indication of the level of personalisation of the predictions provided is given at the user interface. This will inform the user of how targeted the recommendations provided are to his or her particular tastes. This has the advantage that the user will be encouraged to input more information into the database as they will see a direct result in an increase in the level of personalisation of recommendations. It will also provide a useful indication to the user of when there is no point answering any further questions as the level of personalisation will stop increasing.

The provision of an indication of the level of personalisation of recommendations generated by a collaborative filtering engine is believed to be novel and inventive in its own right and so, from a further aspect the present invention provides a method of providing an indication of the level of personalisation of recommendations generated by a collaborative filtering engine to a user at the user interface.

The indication of the level of personalisation could for example be provided by a sliding scale representing a personalisation score.

In one preferred embodiment, the recommendations are generated by a filtering method according to the invention and the personalisation score is obtained by determining the average variance of the probability distribution over each characteristic for the case in question.

Preferably, the recommendations provided to the user at the user interface are updated each time that the user enters a further piece of information into the database. This will further encourage the user to input information as they will obtain a direct result by so doing.

Still more preferably, the user interface is a web site and the inputting of information is carried out on the same page on which the personalisation level indicator and the recommendations are displayed.

In one preferred embodiment of the filtering method of the invention, each item in the data set is plotted against a first component of the item profile and a second component of the item profile on the x and y axes respectively. Thus, the relative characteristics of the items in the data set can be compared to one another by a user such as a marketing executive viewing the graphical representation thereof.

If the user considers that the position of an item is incorrect, he can move that item thus imposing a different profile on it. This could for example be useful if the user considered the item profile component on the x axis to represent some characteristic of users (for example yuppiness) to which items appealed and wished to market an item to more young people even though the profile calculated by the profile engine showed the item to be popular exclusively amongst older people.

This method of imposing a profile on an item is considered to be novel and inventive in its own right and so from a further aspect, the present invention provides a method of filtering data in which a function is set up which models a set of data representing observations about a plurality of items for a plurality of cases, as a function of a plurality of item profiles and case profiles each containing a set of unknown parameters defining characteristics of the case or item, and a best fit of the function to the data is found in order to find the values of the unknown parameters, the unknown parameters for each item are compared to one another and, if desired, an operator alters one or more of the unknown parameters for one or more of the items before using the sets of unknown parameters to analyse the underlying trends in the data.

Preferably, the parameters found together with the altered parameters are used together with the function to predict an observation about one or more items for a particular case for which data is not available.

From a further aspect, the invention extends to a method of controlling a recommendation engine. Further, the method extends to a method of using information about items by restricting the item profiles. It will be appreciated that the filtering methods according to the invention would usually be implemented through the appropriate computer software. Thus, from further aspects, the invention provides computer software for carrying out the methods described above. This extends to software in any form, whether on media such as disks or tapes or supplied from a remote location by e.g. the Internet. The software may be in compressed or encoded form, or as an installation set. The invention also extends to data processing apparatus programmed to carry out the methods. The methods may be carried out on one or more sets of apparatus, and may be distributed geographically. The steps of the method may be divided up, and the invention extends to performing some steps only and supplying data to another party who may carry out the remaining steps.

Preferred embodiments of the invention will now be described by way of example only, and with reference to the accompanying drawings in which:

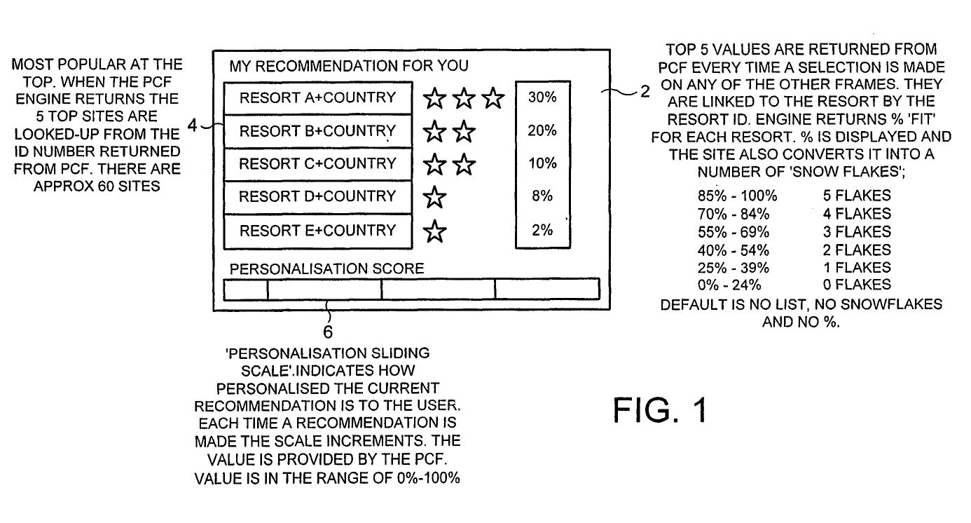

FIG. 1 schematically shows the arrangement of a filtering system according to the invention;

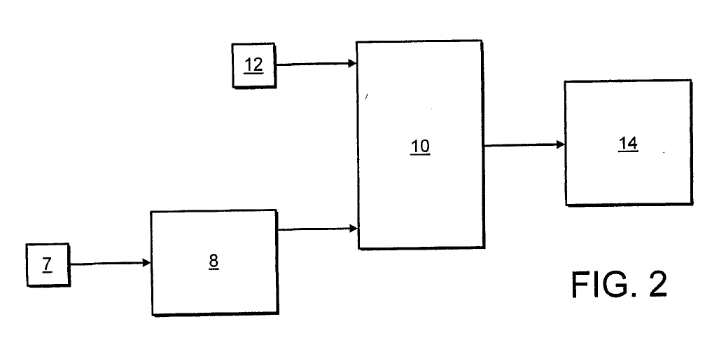

FIG. 2 schematically shows a page of a website using a filtering method according to the invention.

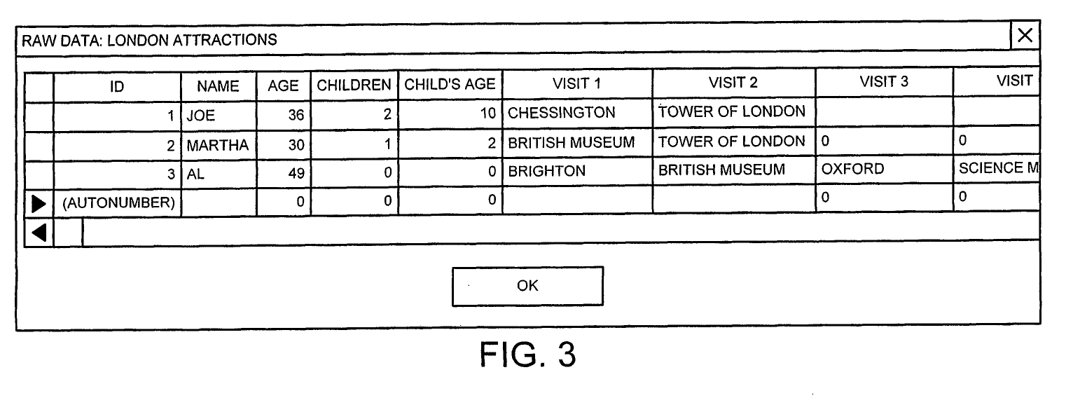

FIG. 3 shows a set of raw data about a plurality of users' preferences as displayed to a user in software embodying the invention;

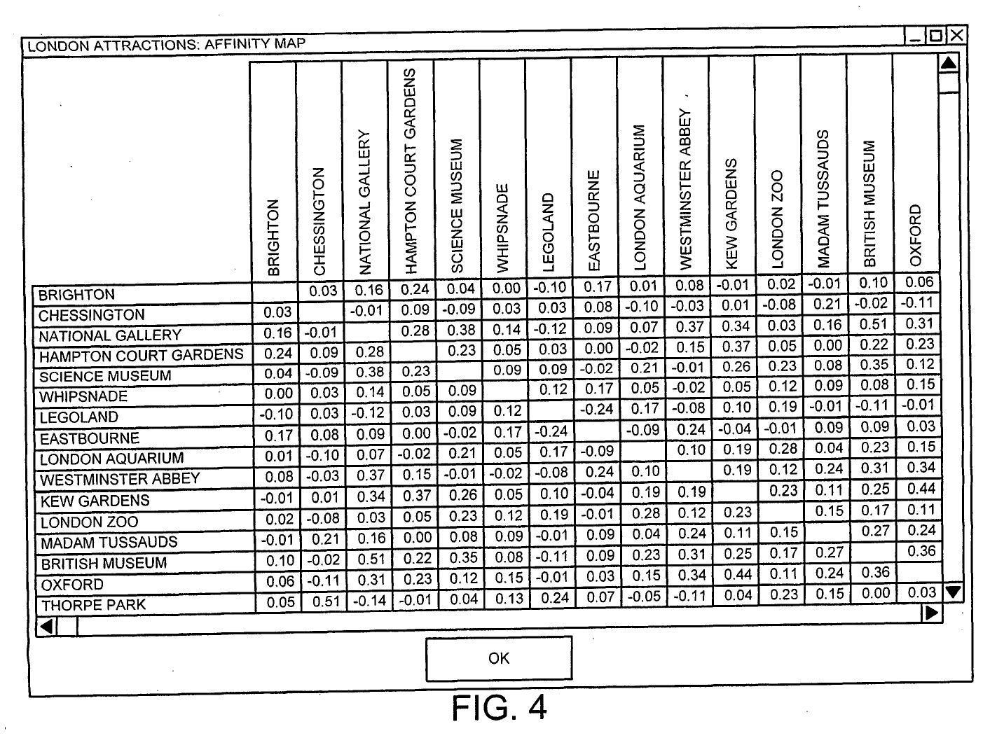

FIG. 4 shows a pair-wise correlation of the data of FIG. 3;

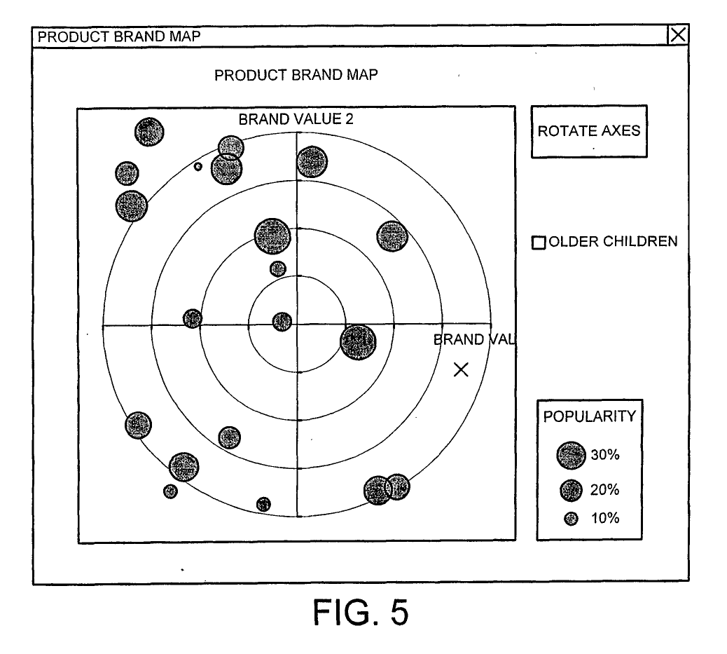

FIG. 5 shows a plot of first and second item profile components for each item in the data set of FIG. 3 as provided by software embodying the invention; and

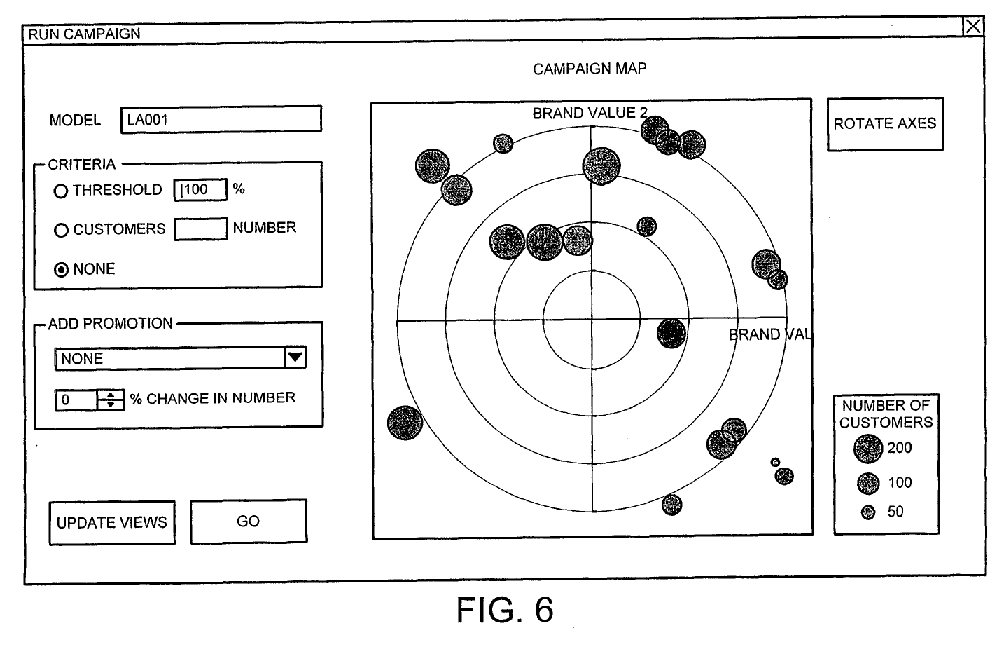

FIG. 6 shows a plot of groups of users having similar profiles against the first and second item profile components as provided by software embodying the invention.

The filtering method of the invention is a predictive technique that builds, estimates and uses a predictive model of the observations about items for different cases in terms of case profiles for each case which include hidden metrical variables. The predictive model can for example be used to predict which of a number of items is most likely to arise next, or to predict the values of a number of missing observations. The method is applicable to all circumstances where conventional collaborative filtering would find application but is not limited to these uses.

The method is embodied by a computer program or software for carrying out the method and the program is adapted to provide recommendations of items to an individual user who accesses the information via an Internet website. The recommendations are provided to the website by a filtering engine described below.

The filtering engine includes an off-line profile engine 8 and a real-time recommendation engine 10 as shown in FIG. 1. The off-line profile engine contains a database of data relating to the preferences of various users for various items stored in storage means 7. This data could have been obtained by asking users to rate each of a list of items and/or by monitoring users' click histories while on-line.

When a user logs on to a web-site using the filtering engine they are asked to rate various items so that the engine can store a history for the user. The filtering engine builds up and stores a database that records observations about a number of users.

Recommendations made by the method of the invention are based on learning about a user's profile from observations about her. Data about the user (and the data about previous users which makes up the database) can be gathered from a number of sources including:

from a website

by questionnaire or survey

by phone

from bank records or other sources of transaction history

customer service records

Observations about users which can be included in the database can include:

Click-stream history for single visits to a web-site. If a user visited the same web-site on a number of occasions, the click-stream history for each history would form a separate record in the database.

Combined click-stream history for all of a user's visits to a web-site by the user. In this case the user would need to identify herself to the web-site so that details of different visits can be stored and matched up.

Ratings of objects. For example the user may be asked to rate various products that she has experienced.

Answers to questions, either just from this visit to the website, or combined for all visits.

Responses to “exogenous standards”. Examples of these are a photograph of scenery for holiday preference selection or descriptions of TV programmes for book preference selection. The exogenous standards used can be in multi-media and include any form of graphic image, photograph, sound or music as well as a conventional passage of text, a name or other written description.

Demographic and other information about the user.

The user's purchase history, either just for this visit to the website, or combined for all visits.

The observations about a user from different touchpoints can be aggregated into a single set. To do this the client implementing the filtering system will need to ensure that identification procedures recognise the user no matter what touchpoint she uses.

In one preferred embodiment of the filtering engine of the invention, the off-line profile engine estimates item profiles which can be used to generate recommendations by the following method.

Firstly, the profile engine specifies a model for the stored dataset. To do this, the following steps are carried out:

1. Each user i in the dataset (i=1, 2, . . . , I) is associated with a user profile aᵢ, where the set of all user profiles is A.

Each user profile contains Q components, where each component is an unobservable metrical variable. The number of components can be selected using model selection techniques as is described further below. Alternatively, Q can be set at a value that gives a reasonable compromise between speed of execution, accuracy and intelligability of results (Q=2 or 3 would normally be suitable values for such a compromise).

2. Each item j in the dataset (j=1, 2, . . . , J) is associated with an item profile be, where the set of all item profiles is B. Each item profile contains Q+1 components.

3. A model ĥ (aᵢ, b^{j}) is specified that generates a predicted observation, ĥᵢ^{j}, for each user i and each item j.

ĥᵢ^{j}=ĥ(aᵢ, b^{j}), j=1, 2, . . . , J, i=1, 2, . . . , I

where the set of all predicted observations is Ĥ.

As an example, suppose that each observation records whether or not a user has chosen the object, there are no missing observations, and so all values are either 0 or 1. A common way to model this kind of observation is to suppose that the probability that a customer chooses an item depends on a constant term that reflects the general attractiveness of the item to all customers. It also depends on the interaction between the user's profile and that of the object. A common specification for binary observations of this kind uses the logit distribution.

$$\begin{matrix}\hat{h} ( {a}_{i} , {b}^{j} ) = \{ \begin{matrix}1 & if {logit}^{- 1} ( {b}_{0} + {\sum }_{q = 1}^{Q} {a}_{i q} {b}_{q}^{j} ) > 0.5 \\ 0 & otherwise\end{matrix} \\ where {logit}^{- 1} ( x ) = \frac{1}{1 + {ⅇ}^{- x}}\end{matrix}$$

Once the model has been specified, the item profiles (i.e. the model parameter) are estimated so that the set of predicted observations, Ĥ, approximates the actual set of observations, H. To fit the data, the system chooses those parameter values that maximise the likelihood of the observed data.

To do this, the likelihood of the data is first specified by carrying out the following steps:

1. Specify the model in terms of a likelihood function, f(h|aᵢ, b^{j}). This gives the probability of an observation given the relevant user and object profiles.

$$\begin{matrix} \hat{h} ( {a}_{i} , {b}^{j} ) = arg max f ( h \vert {a}_{j} , {b}^{j} ) \\ where f ( h \vert {a}_{j} , {b}^{j} ) = Pr ( {h}_{i}^{j} = h \vert {a}_{j} , {b}^{j} ) \end{matrix}$$

Thus, in the example

$$f ( h \vert a , b ) = \{ \begin{matrix}{logit}^{-} 1 ( {b}_{0} + {\sum }_{q = 1}^{Q} {a}_{q} {b}_{q} ) & if & h = 1 \\ 1 - {logit}^{- 1} ( {b}_{0} + {\sum }_{q = 1}^{Q} {a}_{q} {b}_{q} ) & if & h = 0\end{matrix}$$

2. Aggregate across users, and items, and take the natural log, to give the loglikelihood of the data, LL (H|A, B). The independence assumption allows this to be expressed as:

$$LL ( H \vert A , B ) = ln {\prod }_{i j}^{} f ( h \vert {a}_{j} . {b}^{j} )$$

Once the likelihood of the data has been specified, the item profiles are estimated by choosing the set of item profiles B that maximise the likelihood of the observed data H, conditional on user profiles. This gives the equation

$$B = arg {max LL}_{X} ( H \vert A , X )$$

The problem with solving this equation is that the user profiles A are unobserved. To deal with this, a set of estimates for the user profiles are derived via a set of pseudo-item profiles. To do this the following steps are carried out:

Use a simple linear model to derive pseudo-item profiles. Appropriate examples include the normal linear factor model and Principal Component Analysis. Thus, one simple linear model that could be used in the example is the normal linear factor model. This models the data by assuming that, conditional on the user profile, observations are random variables with a normal distribution. The model also assumes that user profiles are independent random variables which are also normally distributed:

$${h}^{j} \vert a ∼ N ( {c}_{0}^{j} + {\sum }_{q = 1}^{Q} {c}_{q}^{j} {a}_{q} , {σ}^{j} )$$

$$and a ∼ {N}_{Q} ( 0 , 1 )$$

The pseudo-item profiles are then found as those parameters, C=(c¹, . . . , c^{J}), and σ^{j}, j=1, . . . , J, that maximise the likelihood of the data. A number of software packages, such as S-PLUS, have pre-programmed routines to estimate this model. Often these routines will generate C as standardised factor loadings. This means that factor loadings are relevant to a model where the observations about an item are first normalised to have unit variance. There is no fixed component, c₀^{j}, in this case. Standardised factor loadings can be used to generate estimated user profiles without modification.

A suitable estimate of each user's profile is to use what is often referred to in factor analysis as the score:

$${\hat{a}}_{i q} = {\sum }_{j = 1}^{J} {h}_{ i}^{ j} {c}_{ q}^{ j} , q = 1 , … , Q$$

Once the estimates of the user profiles have been obtained, these can be entered into the likelihood equation for the data. This leaves only the item profiles as free parameters, and they can be estimated using well known maximum likelihood or least squares techniques.

B=arg max LL(H|A, X)

In the example this step leads to a standard logit regression model, which is available pre-programmed in most statistical packages.

$$B = arg {max LL}_{X} ( H \vert \hat{A} , X )$$

$$where f ( h \vert a , b ) = \{ \begin{matrix}{logit}^{-} 1 ( {b}_{0} + {\sum }_{q = 1}^{Q} {a}_{q} {b}_{q} ) & if & h = 1 \\ 1 - {logit}^{- 1} ( {b}_{0} + {\sum }_{q = 1}^{Q} {a}_{q} {b}_{q} ) & if & h = 0\end{matrix}$$

To choose the number of components Q, estimate the item profile for Q=1, 2 and 3. For each model estimate the Akaike Information Criterion, which is given by

AIC=−2LL(H|Â, B)+2p

where p is the number of free parameters being estimated and is given by:

p=(Q+1)J

and where the loglikelihood for the data is found by entering the item profiles and the estimated user profiles into the predictive model. Choose the value of Q, that gives the lowest value of the AIC.

Putting this value of Q back into the equation for the item profiles together with the estimated user profiles allows values to be obtained for the item profiles using the maximum likelihood techniques described above. The item profiles are then used to make recommendations in the real-time recommendation engine as will be described later.

Once the item profiles have been estimated, they are used to recommend items to a user. Recommendations to a user involve 2 steps. However, although not discussed here, the two steps could be implemented together by a single function or piece of code.

1. Learn about the user's profile from existing observations about her.

2. Use this knowledge about the user profile to make predictions about future observations, and base recommendations on these predictions.

Each step is discussed in turn, and for each step there are two methods which can be used. These are known as Approach 1 and Approach 2 respectively.

Step 1: Learn About the User's Profile

Approach 1 (Bayesian)

The preferred method is to represent knowledge about the user's profile as a probability distribution over possible profiles, and to use Bayesian inference, combined with the predictive model, to generate a posterior distribution α(a|h) by updating a prior distribution α(a). Standard results give:

$$α ( a \vert h ) = \frac{α ( a ) L ( h \vert a , B )}{{\sum }_{a} α ( a ) L ( h \vert a , B )}$$

$$where L ( h \vert a , B ) = {\prod }_{j}^{} f ( {h}^{j} \vert a , {b}^{j} )$$

Approach 2

The classical statistical approach which is also effective would be to maximise the likelihood of the user's observations, given the predictive model and the estimated item profiles.

$$a = a r g {max L L}_{X} ( h \vert X , B )$$

$$where L L ( h \vert X , B ) = ln {\prod }_{j}^{} f ( {h}^{j} \vert a , {b}^{j} )$$

Step 2: Make Recommendations

To make recommendations to a user the knowledge of the user's profile is combined with the predictive model, taking the item profiles as known. This generates predictions for the user's choices of objects and/or ratings of objects. The method depends on what approach is being used.

Approach 1 (Bayesian)

In this case knowledge about the user profile is represented as a distribution over possible profiles, α(a|h) and the predictive model generates, for each object, a probability distribution over possible observations. One method is to use a summary statistic for this distribution, the expected prediction ρⁱ(h) for object j. When the observation records whether the user has chosen the object or not the summary statistic is the probability that it has been chosen:

$${ρ}^{j} ( h ) = {\sum }_{a} f ( 1 \vert a , {b}^{j} ) α ( a \vert h )$$

When the observation records the user's rating for an object a possible summary statistic is the expected rating:

$${ρ}^{j} ( h ) = {\sum }_{a} {\sum }_{X} {X}^{f} ( X \vert a , {b}^{j} ) α ( a \vert h )$$

where the dummy variable χ is a typical observation about item j.

The actual recommendations will depend on the context and various commercial considerations, as well as on predicted observations. The basic assumption here is that it is good to recommend items that it is predicted the user would rate highly, or that the user is likely to choose. One simple recommendation rule would then be to recommend the object, which has not yet been chosen, with the highest expected prediction, or to recommend the object, which has not yet been rated, with the highest expected prediction.

Approach 2

In this case knowledge about the user is represented as a point estimate for the user profile, a and the predictive model generates, for each object, a probability distribution over possible observations. Using analogous summary statistics to those for Approach 1 topping gives, for observations recording choices:

ρ^{j}(h)=f(1|â, b^{j})

and for observations recording ratings:

$${ρ}^{j} ( h ) = {\sum }_{h} h f ( h \vert \hat{a} , {b}^{j} )$$

The same simple recommendation rule suggested for Approach 1 is appropriate for Approach 2.

An example of one implementation of the above described method is given in Appendix A.

The method of estimating the item profiles as described above can be extended to deal with situations in which it is appropriate to consider items in separate groups with separate sets of user profile components associated with each group when deriving the pseudo-item profiles and the estimates of the user profiles. This might for example be because the dataset contained some items relating to preferences over objects and some indicators of socioeconomic group. By treating these groups separately. The number of free parameters that need to be estimated for a given number of overall components in a user profile is reduced. If the two groups do largely act as indicators of different components of the user's profile then this approach can lead to better estimates of the parameters that remain and to more accurate predictions.

An example of the method of deriving item profiles, showing how to implement the method when the data is divided into two classes is given in Appendix B. The example does not show recommendations, since the process would be exactly the same as for the example above. Neither is it shown how to derive the number of components using the AIC as the method would be the same as in the previous example. Here it is assumed there will be two components associated with each group of items.

In another alternative embodiment of the method, some items can be treated directly as observed components of the user profile. This might be appropriate for items such as user age which are exogenous, in other words they are causes of other aspects of the user's observations rather than being the result of other hidden variables.

The example in Appendix C is an example showing how to implement the method when using exogenous data. The example does not show recommendations, since the process would be exactly the same as for the example of the basic method. Neither is it shown how to derive the number of components using the AIC as the method would be the same as in the previous example. Here it is assumed there will be two components.

In an alternative embodiment of the method of the invention, point estimates of the parameters making up the case and item profiles are obtained. To do this a database is obtained which consists of user histories h for a set of users indexed 1, 2, . . . , I; a set of user profiles, a, one for each user, a=(a₁, a₂, . . . , a_{I}) ; a set of object profiles, b, one for each object, b=(b₁, b₂, . . . , b_{J}) ; an estimation function H(aᵢ, bⱼ), and a recommendation function R(aᵢ, bⱼ) with the properties that:

The user history for user i, hᵢ=(hᵢ¹, hᵢ², . . . hᵢ^{j}) records the available information about that user's scores for the objects, so that hᵢ^{j} is user i's score for object j. For each user the dataset may contain information on only some objects. Scores can be discrete, categorical or ordinal, and in particular may be binary, or continuous. What the scores represent depends on the context, but examples include the user's enjoyment of the object, or a binary variable indicating whether the user has sampled that particular object or not.

Function R(aᵢ,bⱼ), uses user i's profile aᵢ, and object j's profile bⱼ, to rate object j for user i, if the database does not record i's score of j. Recommendations about whether user I should sample object j can be based either on the outcome of R( .,. ) alone, or on a comparison for R(.,.) for a set of different objects.

User i's profile and object j's profile are chosen so that H(Aᵢ,,Bⱼ.) is a good estimate of user i's score for object j, if that score is already in the database, for all users i and objects j taken together.

H(.,.) and R(.,.) can estimate histories and provide recommendations for hypothetical user profiles and for hypothetical object profiles.

In the operation of the offline profile generator the followings steps are undertaken:

a) the current database of user histories, h, the existing matrix of user profiles a (if recorded) and a matrix of object profiles b, and the recommendation function H(.,.) are inputted;

b) the matrix is updated, choosing (a,b) so that the history model H(.,.) estimates the user history. The existing matrix may act as the initial point of a numerical algorithm.

c) the updated matrix of object profiles, b, and, if recorded, the user profiles, a is outputted.

The real time recommendation engine is then operated as follows:

a) the user id is inputted, the user history from the database h is looked up and, if user profiles are recorded, the current user profile from the database a is looked up. The subset of objects that are to be rated; the object profile database b; the rating function R(.,.); the estimation function H(.,.); and an indication of whether the user profile needs to be recalculated are inputted.

b) If the user history has changed since last visit, or if user profiles are not recorded, then the user profile aᵢ is updated. aᵢ is chosen so that H(aᵢ,b) estimates the user history hᵢ. If appropriate, the old user profile is used as a starting point for the algorithm that updates aᵢ. Thus, the system determines whether or not the user history has changed since last accessing the filtering system. If yes, the user profile aᵢ is calculated and recorded. If not then the user profile aᵢ is simply looked up.

c) For each object in the subset the rating is then calculated according to R(.,.), using the user's profile and the object profile as parameters.

d) The list of ratings is then outputted. These will form the basis of the recommendations to the user.

e) If user profiles are recorded in the system, the updated user profile aᵢ is saved.

In one preferred embodiment of the invention an Unobserved Attribute Model (UAM) is used for the estimation function H(.,.).

A UAM starts from the assumption that users and objects can be described by vectors that list their level of each of a number of (unobservable) characteristics, where the number of characteristics is less than some fixed limit. For example aᵢ^{x} would give user i's level of characteristic x., and bᵢ^{y} would give object j's level of characteristic y.

These characteristics together determine the observations in the user-history data-base. An example would be where data base holds information on whether a user has been to a London visitor attraction or not. Assume that the probability that user i has visited attraction j is

$$φ ( {a}_{i}^{1} + {b}_{j}^{1} + {\sum }_{x = 2}^{X} \vert {a}_{i}^{x} - {b}_{j}^{x} \vert ) ,$$

for some probability distribution φ. Here the user would be more likely to visit the attraction if the characteristics for which she has a high score are the same as the characteristics for which the attraction has a high score. There is also an allowance for the possibility that the user is more likely than most to visit any attraction, and that this is a particularly popular attraction. This kind of model assumes that users ‘care’ about some factors more than others, and make their decisions based on whether or not the factor they care about is present.

Another example of a plausible model would be if the probability that user i has visited attraction j is given by

$$φ ( {a}_{i}^{1} + {b}_{j}^{1} + {\sum }_{x = 2}^{X} \vert {a}_{i}^{x} - {b}_{j}^{x} \vert ) . ,$$

for some probability distribution φ. Here users want to go to the place that most closely matches their own preferences. So if a user's rating for characteristic 3 was low, she would prefer to visit attractions which also had a low rating for characteristic 3, other things being equal.

One general approach to deriving a UAM is to set up a likelihood function that outputs the likelihood of the observed history, given the current estimate of the user profiles and object profiles, and then to choose those user and object profiles that maximise the likelihood of the observed history.

The likelihood functions would be maximised according to the methods known in the art. Sources which describe these known maximisation methods include “Maximum Likelihood Estimation with STATA” by W. Gould & W. Sribney. Pub. Stata Press, College Station, Tex. 1999.

An alternative approach might be to use genetic algorithms.

The preferred embodiment, however, exploits the particular structure of the data base, which can be seen either as a set of user histories, recording how each user scored the objects, or as a set of object histories, recording how each object was scored by users.

This structure suggests that an iterative procedure can be used to derive the user and object profiles that maximise the likelihood of the observed data. Each iteration comes in two parts. In the first the current object profile estimates are held constant, while the user profiles are updated to record those that maximise the likelihood of the data, given the object profiles. In the second part the user profiles are held constant while the object profiles are updated to record those profiles that maximise the likelihood of the data, given the user profiles.

Any convergence point of this iterative algorithm will maximise the likelihood of the observed data. This method to derive a UAM is described below.

To initialise the algorithm:

a) Firstly, a likelihood function P(h|a,b) is set up that gives the likelihood of observing history h, given user profiles a and object profiles b. The likelihood of an element of the database is assumed to be an independent random variable, given the profiles of the object and user. The likelihood of the data as a whole can therefore be written as

$$P ( h \vert a , b ) = {\sum }_{i = 1}^{I} {\prod }_{j = 1}^{J} f ( {h}_{i j} \vert {a}_{i} , {b}_{j} )$$

The function should be chosen bearing in mind that the estimate of the history, H(a,b), takes the same arguments as the likelihood function.

From the likelihood function, two sets of loglikelihood functions are defined, one for the user profiles as a function of known item profiles, which is:

$$\begin{matrix}L ( {a}_{i} \vert B ) = ln {\prod }_{j = 1}^{J} f ( {h}_{i j} \vert {a}_{i} , {b}_{j} ) \\ = {\sum }_{j = 1}^{J} ln f ( {h}_{i j} \vert {a}_{i} , {b}_{j} )\end{matrix}$$

and one for the item profiles as a function of known user profiles, which is:

$$L ( {b}_{j} \vert A ) = {\sum }_{i = 1}^{I} ln f ( {h}_{i j} \vert {a}_{i} , {b}_{j} )$$

Then, for each item j, an initial value for the item profile, b^{o}ⱼ is defined. As an example the initial values could be random variables.

Alternatively the current object profiles, from the previous estimation of the UAM, could be used as the starting point.

For each user i an initial value for the user profile, a^{o}ᵢ is defined. As an example these could be the current user profiles.

Once the algorithm has been initialised, it must be converged by an iterative process comprising the following steps:

a) User profiles A^{t+1}=(a₁^{t+1}, . . . , a_{I}^{t+1}) are then chosen to maximise the loglikelihood of the user profiles as a function of known item profiles B^{t}

$${a}_{i}^{ t + 1} = arg {max}_{{a}_{i}} L ( {a}_{i} \vert {B}^{t} )$$

b) Object profiles B^{t+1} are chosen to maximise the loglikelihood of the item profiles as a function of known user profiles A^{t+1}.

$${b}_{j}^{t + 1} = arg { max }_{{}_{{b}_{j}}} L ( {b}_{j} \vert {A}^{ t + 1} )$$

The steps a and b are then repeated until there is convergance in the values found, at which point the values of the user and item profiles found are taken as the solution to the function.

One way of determining whether or not the item and user profiles have converged sufficiently is to calculate the loglikelihood of the data (i.e. the value of L(bⱼ|A) and to consider there to have been sufficient convergance if the percentage fall in the loglikelihood is less than some pre-set value, such as 0.1.

It would be apparent to someone skilled in the art that the number of parameters in an item or user profile can be varied by changing the specification of H and L, and that the optimal number can be chosen to balance requirements that the algorithm not use too much processing power or storage, and that it gives accurate recommendations. A further important factor is to avoid overfitting of the data.

In a further preferred embodiment of a filtering engine according to the invention, bias in the user history data is corrected for. The information held in the user history database can take a number of different forms. It could hold whether or not the user has sampled an item, or how the user rated an item if sampled. The information may also be incomplete in the sense that the user may have sampled an object, but not entered its score into the database.

This means there are at least two potential sources of selection bias. The first is that users will only have sampled some of the objects. The second is that users may not have entered into the database all the objects they have sampled. In many cases users will be more likely to sample objects that they are likely to rate highly. They may also be more likely to enter information about objects they liked. The effect is that estimates of ratings based on standard statistical analysis of the database of user histories will estimate the ratings conditional on whether an object has been sampled and recorded. The estimated conditional ratings may be biased (inaccurate) estimates of the underlying unconditional ratings.

In a still further embodiment of a filtering system according to the invention, a maximum likelihood method is used. The data records whether an item has been sampled or not and, if sampled, what the rating was.

$$L ( h \vert a , b ) = {\prod }_{j}^{} L ( {h}_{i}^{j} \vert {a}_{i} , {b}_{j} )$$

is the likelihood of observing h. Choose a and b to maximise this.

The following is a simple numerical example showing how a method according to the invention might operate in practice. As will be apparent, in the method described below, the function modelling the data is solved using an unobserved attribute model (UAM).

In this example, the history data set records whether or not users have visited each of four attractions in the South East of England. In the example there are four users, and their histories are given in the following table.

TABLE 1
History h

| | | | Natural | |
|---|---|---|---|---|
| | | National | History | |
| | Brighton | Gallery | Museum | Legoland |
| Alice | 1 | 0 | 1 | 0 |
| Ben | 0 | 1 | 1 | 0 |
| Carl | 1 | 1 | 1 | 0 |
| Dan | 1 | 0 | 0 | 1 |

The likelihood function for the observed history assumes that whether or not a user has visited an attraction is an independent random variable, conditional on the user's profile. The likelihood function for whether user i has visited attraction j is:

$$\begin{matrix}L ( {h}_{i j} ) = max \{ 0 , min \{ 1 , {a}_{1}^{i} {b}_{1}^{j} + {a}_{2}^{i} {b}_{2}^{j} \} \} & if & {h}_{i j} = 1 \\ 1 - max \{ 0 , min \{ 1 , {a}_{1}^{i} {b}_{1}^{j} + {a}_{2}^{i} {b}_{2}^{j} \} \} & if & {h}_{i j} = 0\end{matrix}$$

and the overall likelihood of h is:

$${\prod }_{i j}^{} L ( {h}_{i j} )$$

For simplicity user and object profiles are restricted to belong to a set of discrete values, and the largest value for each parameter in the object profile is restricted to be equal to 1.

$$\begin{matrix}{a}^{i} \{ 0 , 0.25 , 0.5 , 0.75 , 1 \} i = 1 , 2 \\ {b}^{j} \{ 0 , 0.25 , 0.5 , 0.75 , 1 \} j = 1 , 2 \\ {max}_{x} {b}_{x}^{j} = 1 x = 1 , 2 \\ \\ {a}^{i} \{ 0 , 0.25 , 0.5 , 0.75 , 1 \} i = 1 , 2 \\ {b}^{j} \{ 0 , 0.25 , 0.5 , 0.75 , 1 \} j = 1 , 2 \\ {max}_{x} {b}_{x}^{j} = 1 x = 1 , 2\end{matrix}$$

Choosing object and user profiles to maximise the likelihood yields, as one solution:

TABLE 2
User profiles

| | a1 | a2 |
|---|---|---|
| Alice | 0.5 | 0.5 |
| Ben | 1 | 0 |
| Carl | 1 | 0.5 |
| Dan | 0 | 1 |

TABLE 3
Object Profiles

| | b1 | b2 |
|---|---|---|
| Brighton | 0.5 | 1 |
| National | 1 | 0 |
| Gallery | | |
| Natural | 1 | 0.25 |
| History | | |
| Museum | | |
| Legoland | 0 | 0.75 |

The example was implemented using an excell worksheet. Initial values of all parameters were set to 0.5. Each parameter was in its own cell. The likehihood of the data was entered as a formula into a separate cell, taking the parameter as arguments. The likelihood function was then maximised by iterating manually through the following steps.

1. Holding all other parameters constant, try all possible combinations of the two parameters relating to Alice. Retain that combination that maximises the likelihood.

2. Do likewise for Ben, Carl and Dan in turn.

3. Holding all other parameters constant, try all possible combinations of the two parameters relating to Brighton. Retain that combination that maximises the likelihood.

4. Do likewise for the National Gallery, Natural History Museum and Legoland in turn.

5. Have any parameters changed? If yes then go back to step 1. If no then stop.

Once a solution has been obtained, the user and object profiles for user i and object j can then be substituted back into the function L(hᵢⱼ) to predict the likelihood of user i wanting to visit object or attraction j if they have not already done so.

In one example, the function R could be determined as follows. If it is assumed that people are more likely to visit attractions they will enjoy then an example for the recommendation function R would be to base R on the likelihood function L. Let R(aᵢ,bⱼ)=L(hᵢ^{j}|aᵢ,bⱼ) for those attractions that user I has not visited (hᵢ^{j}=0) and set R(aᵢ,bⱼ)=0 for those it has visited. If it is proposed to recommend one attraction to user i then it should be to visit the attraction for which R(aᵢ, .) is largest.

In this example the data only indicates whether a user has visited an attraction or not. In an alternative embodiment the data holds ratings which indicate, for those attractions which the user has visited and entered information for, how much they enjoyed them. The ratings held in the database are conditional on the user having visited the attraction and having entered information into the database. In these cases the likelihood function and the history function that estimated the condition ratings could be based on a combination of two other functions—one that estimated whether any rating on an attraction was held, and one that estimated the unconditional rating. The recommendation function would then be based on the estimated unconditional rating function. The simplest case is to assume that whether a rating is held is random when compared to the rating itself, so that the unconditional rating is the same as the conditional rating. In this case the recommendation function will be directly related to the estimation function and there is no need to correct for selection bias.

The function H could be determined in many ways. The function models the data as a function of user and object profiles. H is an explicit model of how the data is generated in terms of the way that users make choices.

To take some particular cases, in one embodiment the data might record 1 if the user has both sampled the object and recorded a vote, and 0 otherwise. Given the type of objects in the database a good model of the data might assume that users are more likely to sample and record votes for objects that are suitable, and that an object is more likely to be suitable if its profile is similar to the user's profile. So H will be a model of the probability of sampling and recording as a function of a distance between the user and object profiles, for some distance metric. Then the profiles are chosen to maximise the fit between what H predicts and the actual data. In this case R would be the same as H because there is no other information available about suitability other than the assumption that users are more likely to select more suitable objects.

In another embodiment, the data records a user's rating from 1 to 10 of an object if it has both sampled the object and recorded information on it. Given the type of object a good model of the data might assume that users are more likely to sample and record votes for objects that are suitable, but that sampling and recording depend on other things as well, and that suitability depends on the extent to which the user and the object both have high levels of the same characteristics. In this case one approach would be for H to be a combination of:

1. a model of those votes where information on suitability was recorded as a model of suitability conditional on sampling and recording, and

2. a model whether a vote was recorded or not as a separate model of sampling and recording.

Both could take the inner product of the user and object profiles as parameters.

It might be better however if H was based on a model of the suitability unconditional on sampling and recording. One way to do this would be to use an estimation procedure that corrected for selection bias. An alternative might be to estimate in one go a single function that was the product of a selection equation and a suitability equation. If however there was no correlation between selection and suitability then there would be no need to correct for selection bias. The best model will depend on the data.

This method can be implemented using known techniques for correcting for selection bias in the F module (where case profiles are treated as known and the goal is to estimate the item profiles) such as Heckman regression. An example (i) the unconditional rating is modelled as being linearly related to the case profile, where the coefficients are components of the item profile (ii) selection (or sampling) is modelled using a logit model where the parameter that enters the inverse logit function is linearly related to the case profile, and where the coefficients are components of the item profile (iii) all components in the case profiles enter into the model of selection and at least one component of a case profile does not enter into the model of ratings and (iv) the components of the item profile that enter into the selection model are different from those that enter into the model of unconditional observations. The Heckman regression is well known and is available preprogrammed for a number of specific functional forms, including the ones mentioned above, in the STATA statistical package.

Recommendations would be based on the unconditional suitability, and so, depending on the modelling choices made, could differ from estimates of H.

FIG. 2 shows a frame within a page of the website according to the invention. This website could use any of the various filtering methods according to the invention as described herein. The web page contains a frame into which the user inputs data relating to their preferences as well as the frame shown in FIG. 2.

This frame 2 includes a list 4 of the top five objects which the user is most likely to prefer. Also included in the frame is a personalisation sliding scale 6 which indicates to the user the degree of personalisation of the recommendations which they are provided with. As shown, the scale indicates the degree of personalisation as a score in the range of 0 to 100%. Each time that the user inputs a new piece of data, the recommendation provided will be updated and the personalisation score will also be updated. Although not shown in FIG. 2, the recommendations provided to the user are displayed on the same web page as the personalisation slilding scale thus providing the user with a motivation for inputting more data about themselves.

In a further alternative embodiment of the invention, the off-line profile engine operates as follows:

1. Receive the set of user histories

H={h^{ij}}ᵢⱼ (A)

2. Receive a likelihood function for the user histories:

L(H|A,B)=ΠᵢL(hⁱ|aⁱ,B)=ΠᵢΠ_{jL}^{h}(hᵢⱼ|aⁱ,b^{j}) (B)

The arguments of the likelihood function are:

A set of user profiles A={aⁱ}ᵢ

A set of user profiles B={b^{j}}ⱼ

The way in which the likelihood function is derived for a particular set of user histories is described in the examples which follow.

3. Maximise the likelihood function by an iterative process in order to solve it to obtain the object and user profiles

$${A}^{\cdot } , {B}^{\cdot } \cdot arg {max}_{A , B} ( {H}_{1} A , B ) \qquad ( C )$$

4. Use the set of point estimates of the user profiles (one for each user in the history database) to generate a prior distribution α^{o} over possible user profiles, A

α^{o}(a)=f(a,A); aεA (D)

where the user profiles for each user in the history database {aⁱ}ᵢ are represented by A.

The real-time Bayesian recommendation engine is then operated as follows:

1. Information about a particular user's history is received into the recommendation engine

h^{i={h}^{ij}}ⱼ (E)

2. A prior probability distribution over possible profiles for the user α^{o},

a point estimate of profiles for each item

B={b^{j}}ⱼ, and

a likelihood function for histories

L(h|a, B)=ΠⱼL^{h}(h^{j}|a,b^{j})

are received from the off-line profile engine

3. A posterior probability distribution over possible profiles is generated for the user by updating the prior probability distribution in the light of data using Bayesian inference and the likelihood function.

$${α}^{i} ( a ) = \frac{{α}^{0} ( a ) ( {h}^{i} \vert a , B )}{{\sum }_{a} {α}^{0} ( a ) ( {h}^{i} \vert a , B )}$$

4. A point estimate of profiles for each item

B={b^{j}}ⱼ, and

a likelihood function for ratings.

L^{r}(r|a,b^{j})

are received from the off-line profile generator.

5. A probability distribution over possible ratings for items (for which there are no votes) is generated using the likelihood function and integrating over possible profiles.

$${l}^{ i j} ( r \vert {α}^{i} , {b}^{j} ) = \frac{{\sum }_{a} {α}^{i} ( a ) {L}^{r} ( r \vert a , {b}^{j} )}{{\sum }_{r} {L}^{r} ( r \vert a , {b}^{j} )}$$

6. A point estimate of the likely rating for each item is generated using the probability distribution over possible ratings for each item obtained at 5.

7. The point estimate of the likely rating is used to output information to the user in the required form.

The functioning of the off-line profile engine and the on-line Bayesian recommendation engine have been described above in terms of the space of allowable user profiles being discrete. However, as would be apparent to the skilled person, the modules could be modified to allow for a continuous space of allowable profiles.

In an alternative mode of filtering data to provide recommendations to a user, the user and object profiles obtained are used together with the user profile for the user requiring a recommendation to estimate the preferences of that use for a plurality of objects. An example of such a filtering method is given below. It will be appreciated that the iterative method by which the likelihood function modelling the data set was solved in this example is equally applicable to the solution of the likelihood function in the off-line profile engine of the present invention.

This example was implemented using the S-PLUS statistical software package.

In the examples there are 20 users and 5 objects. The data is binary and complete, so that every hᵢⱼ is either 1 or 0. hᵢⱼ is equal to 1 if and only if user i has sampled object j. The aim of the filter in this case is to model the process that has generated user sampling choices so far.

Recommendations are based on identifying those items that the user is most likely to sample next. The recommendation function in this case is the estimated probability that the particular user has sampled the particular item. It is assumed that the task is to recommend to a new user which single item she should sample next. The recommendation is to sample that, as yet unsampled, item to which the model assigns the highest probability.

The likelihood function L is defined via a scoring function s(.,.) that models the probability that a particular item has been sampled by a particular user.

The full definitions are:

$$L ( h \vert a , b ) = \{ \begin{matrix}s ( a , b ) & if & h = 1 \\ 1 - s ( a , b ) & if & h = 0\end{matrix} \\ where \\ s : {R}^{2} \times {R}^{2} \to R , ( a , b ) \to ∅ ( < a , b > ) \\ ∅ : R \to R , x \to \frac{1}{1 + exp ( - 4 ( x - 0.5 ) )}$$

and <a,b > is the inner product of the vectors a and b.

The history function H(a,b) is taken as the most likely outcome given the estimated parameters, so that:

$$H : {R}^{2} \times {R}^{2} \to 0 , 1 , ( a , b ) \to {max L ( h}_{h e \{ 0 , 1 \}} \vert a , b )$$

The dataset is complete and the recommendation function is just the scoring function:

R(.,)=s(.,.).

It is assumed that each user and object is associated with a vector of two parameters. We have sought to find parameters for the users and objects that maximise the overall likelihood of the data using an iterative procedure as described herein. Parameters were restricted to lie between 0 and 1. Initial values for all parameters were chosen at random. At each iteration the current value was replaced with a linear combination of the current value and whatever value maximised the likelihood (in practice we used the natural log of the likelihood as likelihood itself was too small) holding parameters for all other places or users constant.

Iterations continued until the improvement in the log-likelihood between successive iterations was less than a specified tolerance. In the examples the tolerance was set at 0.01, i.e. a one percent improvement.

We followed the iterative procedure three different times using a different set of initial conditions each time. Of these runs two appear to converge on a similar maximum, giving similar values for the likelihood and similar values for the parameters. The likelihood for these two was slightly higher than for the other run. All three appear to be good approximations to parameters that maximise the likelihood.

Once each run had converged we calculated the history function and gave a recommendation for a new user. All three sets of profiles gave the same recommendation.

In this example we used the iterative procedure to arrive at three sets of profiles, each of which appear to be good approximations to parameters that maximise the likelihood. Someone skilled in the art would be able to arrive at a single preferred approximation using a number of methods, for example running the iterative procedure a fixed number of times and choosing those profiles that gave the highest likelihood.

There are three appendices accompanying this example. The first (Appendix D) defines the functions. The second (Appendix E) gives a complete session log for the first of the three runs. The third (Appendix F) summarises the results for each of the three runs.

The structure of the user history data set obtained in the filtering method of the invention may take various forms. Two alternative embodiments of the invention using different forms of data are set out below.

In the first embodiment, the data records whether or not a user has sampled an item, or whether or not the user has recorded sampling an item. The data is complete.

In this case there is no distinction between ratings and histories.

$${h}^{ij} = {r}^{ij} = \{ \begin{matrix}1 & if the user has sampled item j \\ 0 & otherwise \end{matrix}$$

$$Alternatively \text{:} , \\ {h}^{ij} = {r}^{ij} = \{ \begin{matrix}1 & if the user has recorded that she has sampled item j \\ 0 & otherwise \end{matrix}$$

Because histories and ratings are the same, the likelihood functions for the two are the same.

L^{h}(h^{j}|a,b^{j})=L^{r}|a,b^{j})

In the second embodiment, the data records user preferences over items. The data is incomplete, in that each user has recorded preferences for only a subset of the available item.

Each element of data is the product of two variables. The sample variable s^{ij} records whether a particular user has recorded a rating for item j.

$${s}^{ij} = \{ \begin{matrix}1 & if the user has visited attraction j \\ 0 & otherwise \end{matrix}$$

The rating variable r^{ij} records the user's rating for attraction j.

The user's history for attraction j is the product of these two variables.

h^{ij}=s^{ij}r^{ij}

In general there will be selection bias—users will be more likely to give ratings for items they rate highly. If so then a user's selections are informative about how they would rate currently unrated items.

To capture this information the likelihood that a user selects a particular item is modelled as a function of the user and object profiles and it is assumed that, conditional on profiles, selection and rating are independent. This independence assumption means the likelihood of the history can be decomposed as follows.

$${L}^{h} ( {h}^{j} \vert a , {b}^{j} ) = \{ \begin{matrix}{L}^{s} ( 0 \vert a , {b}^{j} ) & if {s}^{j} = 0 \\ {L}^{s} ( 1 \vert a , {b}^{j} ) {L}^{r} ( {r}^{j} \vert 1 , {b}^{j} ) & if {s}^{j} = 1\end{matrix}$$

The following is a specific example of an application of is the filtering method of the invention.

Data records user preferences over some London area attractions from a set of available alternatives. Each element of data is the product of two variables. The sample variable s^{j} records whether a particular user has been to attraction j.

$${s}^{ij} = \{ \begin{matrix}1 & if the user has visited attraction j \\ 0 & otherwise \end{matrix}$$

The rating variable r^{ij} records whether the user likes attraction j or not.

$${r}^{ij} = \{ \begin{matrix}2 & if the user likes the attraction \\ 1 & if the user does not like it \end{matrix}$$

The user's history for attraction j is the product of these two variables.

h^{ij}=s^{ij}r^{ij}

The information on ratings will be incomplete as users will only record ratings for attractions they have visited. The definitions are nevertheless complete since h^{ij}=0 for unvisited attractions, whatever value r^{ij} takes.

Each user and object profile is made up of three attributes. The first user attribute determines the distribution of s^{ij}. The first item attribute has no effect and is set to 0. The second and third attributes from the profiles together determine the distribution for r^{ij}.

a=(a₁,a₂,a₃)

b^{j}=(0, b₂^{j},b₃^{j})

Prior beliefs about a user's profile are generated by taking an average over the profiles of all other users.

$${α}^{0} ( a ) = f ( a , A ) = \frac{{\sum }_{i} I ( {a}^{i} = a )}{N}$$

$$where N is the number of users and$$

$$I ( {a}^{i} = a ) = \{ \begin{matrix}1 & if {a}^{i} = a \\ 0 & otherwise \end{matrix}$$

The likelihood functions for histories and ratings are related. Conditional on the user and item profiles, the probability that a user has sampled item j and the user's rating for that item are independent.

$${L}^{h} ( {h}^{j} \vert a , {b}^{j} ) = \{ \begin{matrix}{L}^{s} ( 0 \vert a , {b}^{j} ) & if {s}^{j} = 0 \\ {L}^{s} ( 1 \vert a , {b}^{j} ) {L}^{r} ( {r}^{j} \vert 1 , {b}^{j} ) & if {s}^{j} = 1\end{matrix}$$

The probability of sampling each item is independent of the object profiles and is constant across objects. The probability for each item differs across users and is given by the first attribute of the user profile.

$${L}^{s} ( {s}^{j} \vert a , {b}^{j} ) = \{ \begin{matrix}{a}^{1 } & if {s}^{j} = 1 \\ 1 - {a}^{1} & if {s}^{j} = 0\end{matrix}$$

The probability that the user likes an item is an increasing function of the inner product of the user's profile and the profile of the item, ignoring the first attributes.

$${L}^{r} ( {r}^{j} \vert a , {b}^{j} ) = \{ \begin{matrix}g ( a , {b}^{j} ) & if {r}^{j} = 2 \\ 1 - g ( a , {b}^{j} ) & if {r}^{j} = 1 \end{matrix} \\ where g ( a , {b}^{j} ) = \frac{1}{1 + exp ( - 4 ( {a}_{2} {b}_{2}^{j} + {a}_{3} {b}_{3}^{j} - 0.5 ) )}$$

In this example there is no overlap between the attributes that affect selection and those that affect rating. The consequence of this is that selection and rating are independent, even without conditioning on profiles. This feature allows a simplification.

When estimating the profile of the user requesting a recommendation we can, in effect, treat profiles as containing just the last two attributes, and use the likelihood function for ratings in place of the more complex likelihood function for histories.

The likelihood function used would be:

$${L}^{h} ( {h}^{j} \vert a , {b}^{j} ) = \{ \begin{matrix}1 & if {s}^{j} = 0 \\ {L}^{r} ( {r}^{j} \vert a , {b}^{j} ) & if {s}^{j} = 1\end{matrix}$$

The recommendation task is to identify the three attractions which the user has not yet visited and which she is most likely to like. To derive a point estimate of the likely rating for each item assume that the numerical ratings themselves are meaningful so that we can use the expectation of the ratings for an item as our estimate.

$${r}^{ej} = E [ {r}^{j} ] = {\sum }_{r} r {l}^{j} ( r )$$

Identify those three items with the highest estimated ratings, and which the user has not yet sampled, and output an identifier for them.

The profile engine treats the item profiles as unknown parameters and estimates them to fit the user histories in the database.

A standard statistical procedure for estimating unknown parameters is to choose those parameters that maximise the likelihood of the data being present. However, in the embodiment of the method described below, the profile engine models the likelihood of the data being present as a function depending on some hidden variables (the user profiles). Thus, to solve the function, the hidden variables are represented by a distribution over possible values and the likelihood of the data is then maximised when the expectation is taken over the distribution. It will be appreciated that this is the approach to estimation used in latent variable analysis which is a known statistical technique.

The following defines the notation used in the description of the profile engine.

As discussed above, a database of user histories is input to the profile engine. Each user history comprises a set of observations that record what is known about the user's actions and preferences.

The set of users in the database is denoted by:

I={1, 2. . . I}.

The set of items in the database is denoted by:

J={1, 2. . . , J}.

An observation about item j and user i is denoted as hᵢ^{j}.

The set of all user histories in the database is denoted by H={h₁, h₂. . . , h_{I}} where a user history is the set of all observations for a particular user (user i) and is denoted by: hᵢ={hᵢ¹, hᵢ², . . . , hᵢ^{J}}.

If data for a user were showing whether or not they had been to Greece then allowable values for Greece (the item) would be true, false or missing. Alternatively, if data were collated showing the age of a user, then the item could have any integer value or could be missing.

In addition to the database of user histories, a function which models the loglikelihood of the user histories in the database LL(H|B) is also input to the profile engine. This function returns the likelihood of a set of user histories as a function of given item profiles and a probability distribution over possible user profiles. Thus, user profiles are not observed by this function, and knowledge about them is represented as a probability distribution over possible profiles.

The loglikelihood function is a function of a set of user histories H and a set of item profiles B. The user profiles are assumed to be drawn from asset of possible profiles. Each user profile is a vector of components.

In the user profile notation Q^{a} is the number of components in a user profile, A is the set of possible user profiles, and a={a₁, a₂, . . . , a_{Qa}} is a typical element of A.

As discussed above, the loglikelihood function uses an assumed prior distribution over user profiles in the data set. The prior probability that a user's profile is a is denoted as α(a).

The prior probability in latent variable analysis would normally derive from the assumption that each component in the user profile is distributed as standard normal and the components are independent. However, it has been shown by past research that the actual prior distribution assumed in latent. trait analysis has little effect on the results obtained. Changes in the mean and variance of the assumed distribution would lead to a translation of the estimated item profiles that however would not affect the fit of the data model or of a prediction obtained using them. Empirical tests have shown that the form of the distribution has only a small effect on the results of latent variable models.

The profile engine of the present invention is described here in discrete form and so the prior distribution used for each component, α_{q}(a) is a discrete approximation to a standard normal distribution.

To simplify the exposition, the loglikelihood function is expressed in terms of a likelihood of a user history, L(h|B,a), and that in turn is expressed in terms of the likelihood of an observation, f(h^{j}|a,b).

The function f(h^{j}|a,b) gives the likelihood of observation h^{j} about a particular item and user, given that the item profile is given by b and the user's profile is given by a.

In a preferred embodiment of the profile engine for binary data, all items are binary variables which take either value 0 or 1 or missing, or equivalently are either true or false or missing. An example is where each item is a possible action, such as “watch Titanic” and the user history records whether the user has taken each action, or whether no information is available on the action. The likelihood that a variable is TRUE is given by the logit function, where the argument depends on the item and user profile as:

$$f ( {h}^{j} \vert a , b ) = \{ \begin{matrix}{logit}^{- 1} ( {b}_{o} + {\sum }_{q = 1}^{Q} {a}_{q} {b}_{q} ) if {h}^{j} = 1 \\ 1 - {logit}^{- 1} ( {b}_{o} + {\sum }_{q = 1}^{Q} {a}_{q} {b}_{q} ) if {h}^{j} = 0 \\ 1 if {h}^{j} = •\end{matrix}$$

where logit⁻¹ (x)=1/(1+exp(−x)) and h^{j}=* means that the observation is missing.

The logit function is commonly used in regression models where the goal is to model the variants of a binary variable.

Once f(h^{j}|a,b) has been defined, this can be used in the likelihood of a user history given a set of item profiles and a user profile. The likelihood of user history h given that the item profiles are given by B and the user's profile is a is: L(h|a, B). To derive the expected likelihood of the set of user histories, it is assumed that the user and item profiles contain all the information which is needed to predict the observation so that the likelihood of each observation is conditionally independent, given the item and user profiles. As a result, the likelihood of a user's history is the product of the likelihood of each observation, i.e.

$$L ( h \vert a , B ) = {Π}_{j ∈ J} f ( {h}^{j} \vert a , {b}^{j} )$$

From the likelihood of a user history, the expected loglikelihood of the set of user histories can be found. The loglikelihood, LL(H|B)=lnL(H|B), where L(H|B) is the expected likelihood of the set of user histories given the item profiles. To derive the expected likelihood of a set of user histories it is assumed that the user and item profiles contain everything needed to predict the observation, so that the likelihood of each observation is conditionally independent, given the item and user profiles. As a result, the likelihood of a user's history is the product of the likelihood of each observation, and the likelihood of all histories is the product of the likelihood of each user's history. Thus:

$$L ( h \vert B ) = {Π}_{i ∈ l} {\sum }_{a ∈ A} L ( {h}_{i} \vert a , B ) α ( a )$$

giving a loglikelihood of:

$$LL ( H \vert B ) = {\sum }_{i ∈ l} ln {\sum }_{a ∈ A} L ( {h}_{i} \vert a , B ) α ( a )$$

It will be appreciated that in the profile engine method described it is assumed that one observation is made per item. It would of course be possible however to modify the profile engine for situations in which more than one observation were made and it would be apparent to a man skilled in the art how to do this.

In addition, the profile engine described is set up to handle attendance data in which each observation has a value of either 0 or 1. Such a data structure would arise when items were movies or places for example and the data recorded whether or not a user had visited an item.

The profile engine could however be modified to deal with other types of data and again, it would be apparent to one skilled in the art how to do this.

The database of user histories and the loglikelihood function defined above are input to the profile engine in use and the loglikelihood function is solved to find the item profiles which maximise the function for the data set. Each item profile found is a vector of components defining characteristics of an item. The profile engine specifies the number of vector components to be included in each item profile.

When choosing the number of components in a user profile, there are two effects which need to be balanced. Increasing the number of vector components will increase the number of parameters that are estimated by the item profile engine. On the one hand this will give the model greater scope to fit complex relationships between the variables and improve its ability to predict behaviour out of sample. On the other hand it will also increase the scope of the model to fit idiosyncratic features of the data which are not seen in out-of-sample cases. This will harm the model's ability to make good predictions.

One method which can be used to balance these two effects in order to select the model that gives the best predictions is the Akaike Information Criterion (the AIC). The method looks for the model that maximises a measure of the likelihood of the data, but subject to a penalty term that increases as the number of parameters increases. More precisely, if B is the set of item profiles that maximises the expected likelihood, and p is the number of parameters, then the AIC is:

−2LL(H|B)+2p

The selection rule is to choose the model that minimises the AIC.

In the present method, the parameters in the model are the item profiles. Each item profile is a list of Q+1 numbers, where Q is the number of components in a user profile. Selecting on the basis of the AIC leads to

$$Q = {arg min}_{X} - 2 LL ( H \vert B ) + 2 ( X + 1 ) J$$

where B is the set of item profiles that maximise the expected loglikelihood of the data.

In practice, other considerations militate against having a large number of components. A large number of components means that the complexity of the user profile is greater, and this can slow down the process of making recommendations. In some contexts, an administrator may wish to attach meanings to the components and this will be harder if there are many components. The following procedure is therefore carried out in practice:

1. Estimate the model with Q=1, 2 and 3.

2. Estimate the AIC for each number of components.

3. Select the model with the lowest AIC.

In an alternative embodiment, no balancing method is carried out and the number of components is set at 2. Experiments suggest that in many cases the predictive performance of a model with 2 components is good although not perfect. The main advantage of using such a small number of components is that it is easy to display the resulting item profiles graphically, which is beneficial in cases where the administrator of the system wants to have an intuitive indication of the basis of the engine's recommendations.

The item profile for item j is denoted by b^{j}=(bₒ^{j}, b₁^{j}, . . . b_{Q}^{j}) where Q⁺¹ is the number of components in the item profile and b_{Q}^{j} is the value of component Q of the profile for item j. The set of item profiles, B is denoted by B={b¹, b², . . . , b^{J}}.

In a preferred embodiment, the functions in the item profile engine are set up such that Q^{a}=Q which means that the number of components in a user profile is one less than the number of components in an item profile.

The item profiles are estimated as those parameters that maximise the history loglikelihood function.

i.e. B=argmaxₓLL(H|X)

A discussion of appropriate methods of solving equations of this type which arise in latent variable analysis is to be found in “Latent Variable Models and Factor Analysis”, by David Bartholomew and Martin Knott, Publ. Arnold 1999. Particular methods of solving a functional form of the equation for B which arises when attendance data is analysed are described by Bartholomew and Knot at sections 4.5-4.13 of their book. In the preferred method of solving for B, a program known as TWOMIS and referred to in the book which uses the EM algorithm described in section 4.5 of the book is used. This algorithm estimates the equation by an iterative process in which the gradient of the function is written in two parts and one part of the gradient is held constant for each iteration of the algorithm.

The user histories in the database could include only information relating to the choices made by users for certain items (i.e. their preferences). The filtering method of the invention assumes that the user's choices are a stochastic function of the user and item profiles. In observing a user's choices, beliefs about the user's profile can be updated and in this way, more is learnt about the user's likely future choices. In many cases however, the method is not restricted to considering a user's past choices. It is also possible to learn about a user's likely future choices from other information about the user, such as demographic information.

Further, in the method described below, the user and item profiles are interpreted as causing user choices. Alternatively however, the user choices could be interpreted as being correlated random variables and so the profiles are treated as a way to facilitate a parsimonious representation of the correlation structure between them. It is because these random variables are correlated that knowing the realisation of one helps predict realisations of the others, and the predictive content of a user's choices is summarised by his or her posterior profile. Thus, in this interpretation, the profiles do not cause user choices but rather they track what previous choices indicate about possible future choices. Under this alternative interpretation, information about a user can be interpreted in the same way as observations about his or her choices. Thus, the correlation between random variables can be modelled using user profiles in the same way as with information about choices.

Thus, information about users can be introduced into the framework by using the following steps for each new kind of information:

1. Create a new item with index k∉{1, . . . , J}

2. Define the values that observations relating to the information, h^{k}, can take.

3. Define the likelihood of an observation as the stochastic relationship between a user's profile, aᵢ, the profile of the new item, b^{k}, and the possible values of the observation: f(h^{k}|aᵢ,b^{k}).

4. Estimate all the item profiles together, treating this new item in just the same way as observations about user's choices.

In the following example, the database of user histories records whether or not a user has visited various attractions (i.e. the observations about user choices are binary). Graphical analysis of the contents of the database suggests that the average age of a user's children is informative about which attractions the user has visited. Thus, information about the average age of a user's children is added into the model of the dataset.

A simple way to introduce information about average child age is to create another item which records the information as an additional observation about a user. Instead of the observation relating to a choice the user has made, it relates to non-choice information about a particular subject. It is necessary to define the allowable values for this item. In this case average child age is treated as a binary variable which records whether or not the user has older children. This approach is particularly simple to describe and to interpret as it means that all the items are of the same type. Moreover graphical analysis suggests that this approximation may be reasonable given that the true relationship between average child age and visiting behaviour is not always monotonic. It will be clear, however, that a number of ways are possible. For example average child age could be approximated as a continuous variable. The method is not restricted to cases where all variables have the same type.

The cut-off between older and not-older children has been chosen to be 10 years old. This value is chosen as being reasonable in light of simple graphical analysis of the average child age for users visiting the various attractions. It will be clear, however, that alternative methods of arriving at the cut-off could have been used. For example various values could have been tried and the fit and performance of the model compared, or an automatic routine to choose that cut-off that maximises the likelihood of the data could have been created.

To introduce information about average child age the following steps were carried out:

1. Create an item that records whether or not the user has children with an average age of 10 or above. The item index is denoted OLD

$${h}^{OLD} = \{ \begin{matrix}1 if the user ' s children have average age of 10 or less \\ 0 otherwise\end{matrix}$$

2. Assume that the relationship between a user's profile and whether or not they have children with an average age of 10 or above can be approximated as a logistic curve:

$$f ( {h}^{OLD} \vert a , b ) = \{ \begin{matrix}{logit}^{- 1} ( {b}_{o} + {\sum }_{q = 1}^{Q} {a}_{q} {b}_{q} ) if {h}^{OLD} = 1 \\ 1 - {logit}^{- 1} ( {b}_{o} + {\sum }_{q = 1}^{Q} {a}_{q} {b}_{q} ) otherwise\end{matrix}$$

3. Treat this new item identically to the items that record whether or not the user has visited each of the attractions.

A numerical example of a data filtering method which includes an item representing average child age is given in Appendix G.

The real-time Bayesian recommendation engine could take various forms depending on the context in which it is used. The engine described below will specify which of a number of items a user should visit next. The recommendation engine takes a user history and returns an item with the highest expected score, and the expected score for that item.

The on-line Bayesian recommendation engine receives a set of item profiles B found from a previous iteration of the item profile engine. It also receives the history h for a user for whom a recommendation is required. The index i which matched the user i to history h is not used in the recommendation engine notation as only one user is dealt with at a time.

In some instances the history h for a user for whom a recommendation is required is advantageously modified before being used in the on-line recommendation engine. This is the case when the user history records, amongst other things, which actions the user has already taken and when the recommendations are based on predicting which action will be taken next. In this situation, it is preferable to modify the user history so that it records only information that is known currently and that will remain true whatever action the user takes next.

Thus, in the embodiment of the profile engine described above, the user history records whether or not a user has taken a plurality of actions, such as for example whether or not they have watched a movie. Some observations about the user will not change, whatever action the user takes next. For example, if a user has already watched “Titanic” then she will still have watched it whatever she does next. However, other observations may change. Thus, for example, a user may not have watched “Toy Story” but if his next action is to go and watch it then the observation relating to “Toy Story” will change. It is undesirable for the user history to record information that might change depending on the user's next action and so, the modified user history should not record any information about whether or not the user has watched “Toy Story” in order to overcome the problem.

Thus in general, the prior distribution over possible user profiles is updated in the recommendation engine using only information relating to those items for which a positive observation has been recorded. This is implemented using a modified user history θ which follows:

$${θ}^{j} = \{ \begin{matrix}1 if {h}^{j} = 1 , \\ j = 1 , … , J \cdot \\ if {h}^{j} = 0 \end{matrix}$$

Empirical tests have shown that the use of a modified user history θ in the recommendation engine generates better predictions.

The recommendation engine uses a prior distribution over possible user profiles to generate an updated or posterior distribution by Bayesian inference. Ideally, the possible user profiles and the prior distribution are the same as those used by the off-line profile engine. In practice however, the two distributions may differ in detail without affecting performance.

Nevertheless there is no distinction between them in the notation used here.

Thus, as for the off-line profile engine, the prior distribution over possible user profiles is denoted by α(a) and α_{q}(a_{q}) is the marginal distribution with respect to characteristic q.

Tests on the performance of the recommendation engine have indicated that it is sufficient for practical purposes that the prior distributions used are (possibly different) discrete approximations to the standard normal, and that there are sufficient points in the domain of the prior distribution used by the recommendation engine. (Five or more points per characteristic will normally be sufficient). Thus, in the preferred embodiment of the recommendation engine a binomial approximation to the standard normal is used. Here, the binomial distribution with a sample size of 4 is used and the number of successes is transformed so that they are distributed evenly about 0 giving:

$${a}_{q} ∈ \{ - 2 , - 1 , 0 , 1 , 2 \}$$

$${α}_{q} ( {a}_{q} ) = \frac{1}{{2}^{4}} \frac{( 4 ) !}{( {a}_{q} + 2 ) ! ( 2 - {a}_{q} ) !}$$

$$α ( a ) = {{Π}_{q = 1}}^{{Q}_{a}} {α}_{q} ( {a}_{q} )$$

The recommendation engine uses Bayesian inference to find the posterior distribution over possible user profiles, α(a|h). Standard Bayesian inference leads to

$$α ( a \vert h ) = \frac{α ( a ) L ( h \vert a , B )}{{\sum }_{a ∈ A} α ( a ) L ( h \vert a , B )}$$

where L(h|a, B) is the function defining the likelihood of a user history as defined above in the discussion of the off-line item profile engine.

After deriving a posterior distribution over user profiles, the recommendation engine uses this to calculate an expected score by the user for each item. This expected score indicates the expected preference for an item by the user. The underlying assumption of this method of profile sequencing is that a user's past choices depend on their preferences. This dependence is given by the likelihood function for an observation, and so the expression for the score is based on this function.

In the preferred embodiment of the recommendation engine when analysing attendance data, the score for an item is taken to be the probability that the user has visited it, given their profile.

Thus ρ(j|a,B)=f(h^{j}=1|a, B), where ρ(j|a,B) is the rating for item j by a person with profile a.

Taking the expected ratings over possible user profiles then gives:

$$ρ ( j \vert B ) = {\sum }_{a ∈ A} α ( a \vert h ) ρ ( j \vert a , B )$$

Thus in use, the recommendation engine outputs a set of preferences of a user for various items. The output is in pairs of numbers, the first number identifying the recommended item and the second number giving a score that indicates how strongly the user is expected to prefer it.

In the following, J′ denotes the set of items in the data set for which the observation for the user in question is 0.

The engine finds the item for which the user's expected rating is highest out of the set of items J′. The item with the highest expected rating out of set J′ is denoted by r₁ and r₂ is the expected score for item r₁.

Thus, the system recommends an item to the user which satisfies the following function:

r₁=arg max_{jεJ′} ρ(j|B)

where

J′={j|h^{j}}0

and

r₂=ρ(r₁|B)

A numerical example of the off-line profile engine and on-line recommendation engine as described above when functioning is given in Appendix H.

In an alternative embodiment of the off-line item profile engine to that described above, an alternative model is used to estimate the item profiles.

The alternative model supposes that underlying each binary observation is a continuous variable, where the observation is positive if the continuous variable is above a threshold. Next suppose that the underlying continuous variables are generated by a standard normal factor model. A common approach to estimating the item profiles in standard normal factor models uses the correlations between the continuous variables. These cannot be calculated directly, since the continuous variables are not observed. The correlations can be estimated, however, using the tetrachoric correlations of the observations.

The reason that this alternative approach is useful is that there is an equivalence between the logit model described above and the underlying variable model, in the sense that they cannot be distinguished empirically. The parameter estimates in the two models are related by a simple formula. This means that estimates of the item profiles from one model can be used as the basis for item profiles in the other. The equivalence between the two models is described in detail in chapter 4 of Bartholomew and Knott (99), “Latent Variable Models and Factor Analysis”, second edition, publ. Arnold, London.

The method for estimating item profiles by first solving the alternative model is not as efficient as the full information maximum likelihood estimation method described previously. It does, however, have the advantage that the techniques for solving linear factor models using correlation matrices are widely available in statistical packages.

The method involves the following steps:

1. Calculate the tetrachoric correlation matrix for the observations. This can be done using LISREL.

2. Estimate the standardised factor loadings for a standard linear factor model using known techniques based on correlation matrices, treating the tetrachoric correlations as though they were product-moment correlations. (Standardised factor loadings are those that obtain when the underlying variables are first normalised so that each has unit variance.) This can be done using LISREL.

3. The factor loadings from step 2 are the item profiles λ^{j}, j=1, . . . J for the linear factor model. Each profile contains a weight for each component, λ^{j}, q =1, . . . , Q. Derive the item profiles for the binary observation model, b^{j}, j=1, . . . , J, from those for the linear factor model using the following:

$${b}_{q}^{j} = \frac{Π}{\sqrt{3}} \frac{{λ}_{q}^{j}}{\sqrt{1 - {\sum }_{q = 1}^{Q} {( {λ}_{q}^{j} )}^{2}}} , q = 1 , … , Q , J = 1 , … , J \\ {b}_{o}^{j} = {logit}^{- 1} ( {b}_{o}^{j} ) = {Π}^{j} , j = 1 , … , J \qquad ( 1 )$$

where n^{j}=the proportion of observations of item j equal to 1.

4. There is an exception to the equation (1) above. In some cases the item profiles from the linear factor model are such that

$${\sum }_{q = 1}^{Q} {( {λ}_{q}^{j} )}^{2} \geq 1 ,$$

in which case the equation in (1) does not give sensible results. These cases are known as Heyward cases. In these cases (in practice whenever

$${\sum }_{q = 1}^{Q} {( {λ}_{q}^{j} )}^{2} \geq 0.99 )$$

the relevant part of (1) is replaced with (2) below.

$${b}_{q}^{j} = \frac{Π}{\sqrt{3}} \frac{{λ}_{q}^{j}}{\sqrt{2 - {\sum }_{q = 1}^{Q} {( {λ}_{q}^{j} )}^{2}}} , q = 1 , … , Q , J = 1 , … , J \qquad ( 2 )$$

This follows the suggestion of Bartholomew and Knott in section 3.18 of their book.

Appendix I gives a numerical example of the use of this alternative method of the invention.

A practical implementation of the filtering methods of the invention for the analysis of data is shown in FIGS. 3 to 6. A raw set of data showing which of a range of attractions has been visited by each user as well as the user's age, how many children they have and the age of their children is shown in FIG. 3. This data can be entered into a computer program which is adapted to analyse the data using a filtering method according to the invention to find item profiles for each of the attractions and then to generate recommendations.

In the past, if a marketing executive wished to analyse a set of data such as that of FIG. 3, he would have carried out a pair-wise correlation and picked out items with a high correlation as being similar to one another. A pair-wise correlation. for the data of FIG. 3 is shown in FIG. 4. For example, he would have considered Chessington and Thorpe Park having a correlation of 0.51 (the highest in the data shown) as being very similar to one another. It will be appreciated however that this method is relatively complex and time consuming and that only two items can be compared at any one time.

With the filtering method of the invention, a first component of the item profiles for each item can be plotted as the X axis against a second component of the item profiles for each item on the y axis. Such a plot as produced by software implementing the method of the invention is shown in FIG. 5. Of course it will be understood that information about users which can be treated as one or more items can be included in these plots. If the user disagrees with the place on the plot for a particular item then he can forcibly move it along in the x and/or y directions. For example, if a major refurbishment of an attraction had been carried out, it could be moved on the plot to take account of this.

As shown in FIG. 5, the % popularity of each item is shown by the size of dots representing respective items. Using the plot of FIG. 5, marketing executives can compare all items profile components if they wish. The software used can also plot each user in the database against the item profile components (not shown).

In addition, an item not included in the database could be added to the graphical representation and then used in generating recommendations. To do this an operator would specify an item profile for that item.

Further, the graphical representations generated by the software can be very useful to a marketing executive's understanding of data in a dataset. For example, it could allow them to determine that one item profile component related to a characteristic of users such as for example, old fogyness.

As shown in FIG. 6, the item profiles calculated from the raw data can be used to predict which attractions a user will like by the filtering method of the invention. The software uses this information to plot a campaign map as shown in FIG. 6 which shows where groups of users having similar profiles are situated relative to first and second brand values or item profiles plotted on the x and y axes respectively. When planning an advertising campaign for example, the campaign map of FIG. 6 could be used to determine which groups of users should be targeted. As shown, the size of dots plotted on the campaign map could show the number of users falling into each group or cluster.

The filtering method of the invention provides a predictive technique that builds, estimates and uses a predictive model of the observations relating to a case in terms of a profile for that case that includes hidden metrical variables. The method can be used for: predicting which of a number of items is most likely to arise next; or predicting the values of a number of missing observations.

The method can be applied to tasks that fall within the heading of analytics, marketing automation and personalisation.

The method can be used as a method of filtering data to predict the suitability of an object, or the relative suitability of an object, compared to other objects, for a customer.

Predictions about the suitability of an object for a customer (or prospect) can be used for personalisation and, in particular, as the basis of making recommendations to her or concerning her likely preferences or interests.

Recommendations can be part of an explicit process in which the customer elects to enter into a process of providing information in order to receive recommendations.

Alternatively recommendations can be part of an implicit process in which information about the customer's activities are used to generate the recommendations and suggestions are made unprompted. An example would be cross-sell suggestions made by a call centre operative. Or personalising web pages, or e-mail or direct mail suggestions.

One application is where an administrator wants to suggest content or products to a customer based in part on what content or products she has already rated or sampled. In this case the items will be the set of possible things that may be rated or sampled. The method would be based on the concept of suggesting that thing which is likely to be most suitable.

To make recommendations the following steps are implemented.

Generate a Predictive Model of the Suitability of Items

1. Specify the Data

Identify the items that recommendations might be about. Examples of items that might be recommended are:

products and services

content (eg web pages)

holiday destinations, movies, books, etc

courses of action

Identify a data set of observations that can be used to predict the suitability of the items. Data can be gathered from a number of sources including:

from a website

by questionnaire or survey

by phone

from bank records, store card records or other sources of transaction history

customer service records

loyalty card records

obtained from third party sources

The data must include direct information about the suitability of various items for customers. Examples of the observations about the suitability of items are:

Visits to web pages. Assume that customers only visit web-pages that are suitable. One possible implementation is that different sessions are considered as being different records. Another is that all sessions for a, user are aggregated into the same record;

Explicit ratings of the suitability of items by customers. This is used for example on the MovieCritic website;

Customer purchase history. Assume that customers only buy items that are suitable; or

What items have customers selected in the past (e.g. what movies have they seen, where have they been on holiday). Assume that customers only select items that are suitable.

The data may also include covariates, i.e. observations that might be informative about a customer's preferences, but which are not directly about the suitability of items. Examples of observations which are covariates are:

answers to questions, either just from this visit to the website, or combined for all visits;

responses to “exogenous standards”. Examples of these are a photograph of scenery for holiday preference selection or descriptions of TV programmes for book preference selection. The exogenous standards used can be in multi-media and include any form of graphic image, photograph, sound or music as well as a conventional passage of text, a name or other written description;

customer contact data logged by sales and/or customer service staff in respect of customer interactions (e.g. telesales, emails, face to face). Including both objective data (e.g. call duration and time) and subjective assessments (e.g. categorising call purpose, customer satisfaction etc.); and

demographic, geographic, behavioural and other information about the customer.

2. Model the data

3. Estimate the parameters of the item models

Make Recommendations to Customers

Depending on the context: this may be a batch if the context is a mail shot or similar; alternatively it may be one customer if the context is a web-site or call centre etc.

For each the following steps are carried out.

1. Learn About the Customer from Observations About Her

Observations about the customer may include observations about the suitability of some items and about covariates. Use these observations, together with the item models estimated at the previous step, to learn about the customer's profile.

2. Make Predictions About the Suitability of Items

Use knowledge of the customer's profile, together with the item models, to predict the suitability of items for that customer. Predictions can be made in respect of:

all items which have not be previously selected by the customer; those unselected items which are not excluded by business rules.

3. Make a Recommendation

Recommendations are made based on the predicted suitability of items. Examples include:

recommend the item most likely to be suitable; or adjust the suitabilities in the light of business rules. Contexts in which recommendations can be made to customers include any touchpoint between the customer and supplier, including:

online, as part of an e-commerce site or an Internet site holding information; by sales operatives in call centres/contact centres; by sales staff in shops and other face to face arenas; by e-mail and post; digital interactive TV; and personalised newsletters, mailshot or brochures.

The personalisation will be related to particular items in the document and may be implemented using a print technology that can create customised documents. A specific implementation is in the management of selective binding programs.

The recommendations could be notified to the end-customer (possibly via a third party such as the provider site operator or a call centre staff member)

Alternatively some or all of the output may be made available solely to one or more third parties (such as a provider) and not to the end-customer. This might be useful for commercial purposes such as for example content management or advertising personalisation.

The observations about a customer from different channels can be aggregated into a single set. To do this the client implementing the Profile Sequencing system will need to ensure that identification procedures recognise the customer no matter what channel she uses.

The method of the invention enables some additional features to supplement the basic personalisation task. These have additional benefits.

Generating and Viewing Item Profiles

The filtering method generates a profile for each item. Item profiles may automatically be updated periodically by recalculation to incorporate any new data that has been acquired since the last calculation. Recalculation can be done arbitrarily frequently, including in real time, as new data is acquired.

In many cases the item profiles can be used to generate knowledge of the relationship between the items, or of the items themselves. It will frequently be the case that the components of the profile are interpretable by marketing executives in terms of meaningful variables.

One implementation could be as a software component that allowed the system administrator to view a graphical representation of the item profile map showing the item profiles as points in a profile space, with one axis for each component. Where preference data is gathered, this profile space can be considered as effectively equivalent to a machine generated product position map or, as the case may be, brand position map, otherwise known as a perceptual map. (However, it will be noted that the map will have been generated using the objective and quantified analysis of observed consumer preferences, rather than through the use of subjective consumer surveying). The interface could allow the administrator to use their skill and judgement to interpret the components, and to attach their own labels, identifying the brand or product values (which may correspond to product or brand attributes) to the components, which can then be used to refer to the relevant components.

Additional features include: data points on a plot of item profiles could indicate the item popularity, for example using size or colour; filters could be used to show graphically how popularity differs, for example between those customers who have young children and those who do not, between those customers who have seen “Titanic” and those that have not; and profiles using different sets of historical data could be shown on the same plot to indicate changes over time in positioning of items.

These profiles may also be used to sort items into groups or clusters by comparing the item profiles and placing all those items having similar profiles into one group or cluster.

Analysing the item profiles in any of these ways may be useful because:

by illuminating the basis on which recommendations will be made the analysis may generate understanding and trust that the recommendations will be sensible, and so encourage use of the system; the analysis of the item profiles can be used as the basis for modifying the behaviour of the system; and knowledge of the relationship between items may itself form the basis of other marketing initiatives that do not depend on personalising marketing messages to customers.

Generating Customer Profiles

Profile Sequencing provides a method for ascribing a profile to a customer, based on her behaviour. Customer profiles may automatically be updated periodically by recalculation to incorporate any new data that has been acquired since the last calculation. Recalculation can be done arbitrarily frequently, including in real time, as new data is acquired. This allows recommendations to be updated, using the updated profiles (together with updated item profiles if relevant), arbitrarily often, including in real time if desired. One convenient way of displaying customer profiles is by a graphical representation of the customer profile map in which the customer profiles relating to any given set of items are plotted as points in a profile space with one axis for each component (the components corresponding to those determined for the relevant set of items) Where there are a large number of customer profiles to be mapped, these may alternatively be depicted by some of density mapping (e.g. contour chart, colour coded profile density map or simulated 3D representation (with the third dimension representing the density value)). Where customer profiles are mapped against item attributes, relevant items (and, if appropriate other objects eg. messages, demographic categories etc.) may be superimposed on the plot as a convenient means of understanding the inter-relationship between the items and customer preferences. These profiles may be used to sort customers into groups or clusters by comparing the customer profiles and placing all those customers having similar profiles into one group or cluster. These groups can be used as the basis for targeting marketing campaigns.

Customer profiles may be calculated at large across the whole population about which there is relevant data. Alternatively, the profiles might be restricted to some subset by first filtering by one or more criteria (e.g. demographic, geographic or behaviouristic criteria). These filtered profiles may then be displayed in exactly the same as described above for the population as a whole.

Combining Filtering with Rules

In some cases the administrator may want to restrict the set of objects that might be recommended to a customer, or might want to otherwise modify the pattern of recommendations or other forms of personalisation (e.g. messaging, content). The following are illustrative examples of such situations.

Restrictions may be based on rules operating on some of the observations about that customer. For example “do not recommend products that do not satisfy objective requirements specified by the customer”.

Restrictions may be based on commercial considerations such as “do not recommend products that are out of stock”.

Modifications to the pattern of recommendations may be based on commercial considerations under which objects that carry a higher commercial benefit, or which form part of a special promotion, are more likely to be recommended.

To accommodate these situations the Recommendation Engine can include additional steps that may include the following.

A list of restricted objects is passed to the Recommendation Engine and the predicted suitability is calculated only for objects that are not restricted.

A list of weights is passed to the Recommendation Engine that is used to weight the calculated predicted suitabilities of the objects, and the object with the highest weighted suitability is recommended.

If object profiles include a term that reflects the general popularity of the object, then the Recommendation Engine can accommodate these situations by using modified object profiles in which the components representing popularity for the different objects are adjusted until the pattern of recommendations is as desired.

Communicate with Only a Subset of Customers

In some cases the administrator may wish to use profile sequencing to target a number of prospects from a longer list for direct marketing purposes (e.g. mailshot, personalised email or outbound telesales). This can be accommodated by assessing the probability of interest using profile sequencing for each prospect in turn and then:

If all those above a certain threshold of interest are to be targeted, rejecting all prospects that fall below the assigned probability of interest whilst passing forwards the remainder for further processing (if further criteria for targeting are to be applied) or for despatch of the marketing material to them; or

If only a pre-set number of prospects are to be targeted, ranking all prospects in order of probability of interest and then discarding all those that fall below the pre-set number ranking.

Similarly, the administrator may wish to make a certain promotion or display particular content on a website (including mobile enabled website) or interactive TV channel only if the level of interest predicted for the recipient is over a certain threshold. In this case also profile sequencing can be used in real time for each user/viewer to assess if the assigned probability of interest is reached, rejecting all viewers/users with lower probability forecast interest.

Another manifestation of the use of rules to modify profile sequencing output is to pre-filter the sample set by administrator specified demographic, geographic or behaviouristic criteria so that recommendations are only generated for prospects that are pre-qualified by one or more of the criteria. This pre-qualification would be particularly useful in managing personalised advertising or direct marketing campaigns.

A further form of restriction that the administer may wish to apply to modify profile sequencing output is, prior to using profile sequencing, to rank or group customers (or prospects) according to their economic attractiveness as customers and to restrict or modify marketing effort to each customer according to their economic ranking or grouping. Economic ranking or grouping can be carried out using customer scoring or any other appropriate standard technique. After ranking or grouping, personalised marketing using profile sequencing can, for example, be restricted to the nth most profitable customers or to customers exceeding some arbitrary profitability. Alternatively, extra inducements (eg. special promotions) may be restricted to more profitable customers using profile sequencing to determine for example which, out of those customers, the promotions should be aimed at or which promotion should be targeted at which customer.

Changing Item Profiles

One way for system administrators to affect the pattern of recommendations is to override some or all of the machine-generated item profiles. This may be useful if, for example:

the administrator feels that the machine-generated item profiles are misleading; one of the items has been rebranded so that its profile is not well modelled using past data; the system administrator may want to modify the proportion of recommendations to the different items, to reflect commercial considerations; or the actual recommendation made by the system will depend on the pattern of profiles. The system administrator may want to affect the pattern of “competition” between items so as to favour some items at the expense of others.

This control can be effected by allowing the administrator to override the components of an item profile. One implementation could be via a graphical interface. A convenient implementation is one that allows the administrator to “drag and drop” the item from one place in profile space to another. In this implementation, the item profile corresponding to the selected position on the graphical interface would be automatically calculated and that profile substituted for the original one. Depending on whether the administrator wanted to make a permanent change or alter the profile for one particular purpose only (e.g. model a scenario or run a particular campaign), the changed profile could be treated as either a local value only or as a global change.

Adding New Items

When adding new items the administrator may impose an initial item profile, or may rely on a default initial profile (for example that each component in the item profile has a neutral value such that the predicted suitability for a customer is the same regardless of the customer's particular profile). Over time the system will collect observations about the new item. Components in the initial profile may be replaced by free parameter's, when there is sufficient data, that give a better fit to the data. Statistical methods of model selection can be used to determine when there is sufficient data.

The Interface for End-Customers

Features of the customer interface at which the customer enters observations, such as a website, may include the following:

the interface is arranged such that the customer may choose which items to rate or otherwise provide information on (eg. by responding to multiple choice questions) and in what order to rate or provide information on them;

updated recommendations are presented to the customer each time she provides a further observation. This will further encourage the customer to input information as they will obtain a direct result by so doing;

each time the customer provides a further observation she is presented with one or both of:

updated recommendations;

an indication of the level of personalisation of the recommendations. The indication of the level of personalisation could for example be provided by graphical means, for example a sliding scale, representing a personalisation score. One way to derive a personalisation score would be by determining the average variance of the probability distribution over each component of the profile for the customer in question.

This feedback will encourage the customer to enter more observations; and if the interface is a website then the inputting of information is carried out on the same page on which the personalisation level indicator and the recommendations are displayed.

The filtering method of the invention can, without limitation, be conveniently used to automate the planning and execution of marketing campaigns. Predictions about the suitability of an item can be used to identify to which customers a particular recommendation should be made. This may, for example, be used when promoting a particular item.

Predictions can also be used to identify the customers for which one of the available suggestions are most suitable. This may be used when choosing to which customers recommendations should be made.

The administrator may want to communicate messages (ie. information in whatever format relating to items to be marketed that is designed to inform, interest, excite and/or stimulate or support a desire to acquire in the recipient. Examples include advertisements, editorial material, newsletter content, images, sounds, music, video content, presentations etc. It also includes information or recommendations regarding new products/services) not currently included as items in the database, and may either want to select who out of a set of customers to communicate a given message to, or may want to communicate different messages to different customers within a given set. Examples tasks where this would be useful include:

promoting an item using a range of marketing messages or images designed to appeal to different kinds of customer for example through a direct marketing campaign;

promoting an object or objects not in the database

personalising web-site, PDA, brochure, newsletter, mailing etc. content (ie. content management); and

personalising the selection and/or content of relevant advertising (through whatever media capable of supporting personalisation).

Messages may be communicated over any touchpoint between the customer and the supplier.

Existing methods for communicating messages not in the database are limited. The administrator can:

use a machine learning based clustering routine to identify clusters of customers, look at the pattern of their behaviour in order to assess their “brand values”, and then choose the appropriate message to send to each cluster. In many cases, however, there are few or no meaningful clusters in the data;

specify rules to determine which message to send to each customer. This can be hard when the range of possible customer histories is large, as there may be no intuitive way to distinguish groups on the basis just of rules applied to their histories; or

manually identify market segments, devise rules to assign customers to segments, and choose an appropriate message for each segment. This has the same problems as above, when the range of possible customer histories is large there may be no intuitive way to distinguish market segments.

Profile Sequencing enables an alternative approach. Profile Sequencing could be implemented in a software package that allowed the following process:

Another application is where an administrator wants to identify suitable customers to target with a particular message (or which customers should be targeted with what message) and where the message is not currently something on which the administrator has data. A method would be:

Identify a set of covariates on which there is data.

Treat at least some as items.

Use a filtering method of the invention to work out item profiles for these using the data.

Estimate a case profile using observations of the covariates using a method of the invention.

Predict suitability for each of the messages using a method of the invention.

Implement some rule, for example “send the message most likely to be preferred” or “send the message if the likely preference is >0.5”.

In more detail, preferably the last three steps listed above comprise:

Specify models of the items. Suitable functions would be monotonically increasing functions of a linear function of the case profile, where the coefficients on the case profile components are the item profile components, and where the fixed term is also an item profile component. Examples of these are described on page [ ]

Estimate the item profiles useing the filtering method of the invention

Create a binary variable, one for each message, and set up item models for them using the same function family as for the other items.

Allow the administrator to specify the item profiles for the messages possibly after analysing the item profiles for the other items, possibly using a graphical interface.

To determine whether and how to target a case: learn about (estimate whether point of density) the case profile from observations of the covariates treated as items; predict the suitability of each message using the method of the invention and the item profiles specified above; implement some rule, for example “send the message most likely to be preferred” or “send the message if the likely preference is >0.5”.

An example of this process is:

Send out messages to customers in the database using the Profile Sequencing recommendation engine to identify which message is most likely to appeal to each customer, given the customer's profile, which is learnt from their observations, and the item profile of the message, which has been specified by the system administrator.

Another application for Profile Sequencing is in media buying and selling and in the development of media plans. Personalisation applications rely on a database of customer records, where each record lists observations about the customer. In a media buying and selling application the database would be of advertising campaign records, where each record lists the media on which the advertising campaign (or individual advertisements) was carried, together optionally with. further information such as, for example, the individual advertisement used, the date, time, position, length and prominence etc.) Possible media would include but not be limited to: different newspapers and magazines; advertising slots on different television and radio programmes; cinema/video; internet sites; WAP and other mobile channels; billboards; sports stadia; point of sale; bus/taxi; and commercial sponsorship.

The application uses the database to generate item profiles for the different media. It could then:

generate knowledge about the product/brand values (which may be regarded as attributes)of different media. The interface could plot the item profiles as points in a profile space, with one axis for each component. This profile space can be considered as a machine generated media position map. The interface could allow the administrator to use their skill and judgement to interpret the components, and to attach their own labels, identifying the value or attribute, to the components, which can then be used to refer to the relevant components. Such maps might, as convenient, be each confined to one media class (eg. TV programmes, newspapers etc.) or incorporate multiple types of media in a single map; and/or

suggest combinations of media (or, as the case may be, individual publications, programmes, types of event etc.) to use for new advertising campaigns, optimising the media mix. The user would specify the item profile of the campaign (or separately each element of the campaign), possibly by “dragging and dropping” the campaign (or campaign element) onto the position map(s). The application would then list those media (or individual publication etc.) most likely to have carried a campaign (or campaign element) with that profile.

This functionality could be used , for example, by sellers of advertising space, media buyers, advertising agencies, marketing departments and consultancies and business analysts.

It could also track and display changes in the media profiles over time (as described for item profiles more generally below. This could be useful to determine and forecast trends in the positioning of individual media publications etc., and in the media more generally.

A further application of the filtering method of the invention is as a tool to facilitate product or brand management. The database in this case could be the same one as is used in a marketing automation function. Alternatively it could be collected separately. Unlike for marketing automation applications, there is no need to be able to identify customers since there will not be any future communication with them. This can simplify the data acquisition process.

But it is an advantage of the method that exactly the same model is used for brand management as for personalisation and targeting, so that a single view of brands and so on can be used across many disparate tasks.

The data will contain customer records. Records may contain information about a number of things including:

what products they have bought; preference information about products; answers to questions; demographic information; geographic information; and behavioural information (including what products are bought).

A product or brand management application could:

derive item profiles for the data. These will include in particular item profiles for the different products and/or brands;

the interface could plot the item profiles as points in a profile space, with one axis for each component. This profile space can be considered as a machine generated position map. The interface could allow the administrator to use their skill and judgement to interpret the components, and to attach their own labels, identifying the values (which may be regarded as attributes), to the components. These labels can then be conveniently used to refer to the relevant components. This can generate marketing relevant information such as identifying if products have values or attributes in common;

the interface could allow the administrator to run “what if” scenarios, for example to examine what the effects on sales is likely to be if one product is rebranded, where the rebranding is specified in terms of a changed item profile, one or other market expansion strategy were to be followed, it is proposed to establish or reposition a brand, in which case the optimum positioning can be explored, there is a demographic shift, or a new product or brand enters the market with particular attributes, where the product/brand attributes are quantified (either using market research or by some other means eg. the administrator's own skill and judgement) and entered as an item profile. This could form the basis of a tool to identify “gaps or market opportunities that could be exploited by new products/brands.

Other useful product/brand management applications include the follow tasks:

forecasting the parasitic effects on other products of advertising or otherwise promoting one of a number of products (whether these be competitors' products or the producers' own);

psychographic (or behaviouristic or demographic or a combination of these) segmentation on the basis of the customer profile position map;

predicting cannibalisation effects on the introduction of new product(s) according to product positioning;

forecasting effects of planned product obsolescence or product elimination (including as part of a product line pruning or retrenchment exercise) on sales of related existing and new products;

promotional impact on product sales of advertising campaigns according to positioning of advertising message(s);

planning product/brand development strategies on the basis of product/brand positioning information;

developing product differentiation strategies using information on relative product positions in position map;

forecasting demand in respect of introduction of new products (including product extensions and product line stretching) and optimising new product positioning;

optimising new brand development (using information regarding brand attributes of existing competitor brands and customer profile positioning in that space to select appropriate attribute mix for proposed new brand);

optimising the positioning of flanking products or brands;

modelling the effects of proposed repositioning of products (or, as the case may be, product lines or brands), for example due to product or brand modernisation or product modifications;

assessing product mix consistency through observation of the relative positions of products on the position map and, if appropriate, modelling the effects of potential changes (eg. repositioning of existing products, elimination of products or introduction of new products) to optimise forecast demand). Where the product mix shares a common branding this modelling will also form an important part of brand management and development;

planning product modification through forecasting the predicted effects on demand through the associated expected repositioning of the product;

planning brand repositioning/revitalisation/revival through reassessing the predicted effects on demand from the from the proposed new position(s) on the brand position map;

assessing the suitability of prospective brand extensions or brand leverage by comparing the brand's positioning with the positioning of the product to be brought within the brand (or, if a new product, the positioning of representatives of that product category);

quantifying product/brand image and, through the use of trend analysis, carrying out attitude tracking over time on that product/brand, particularly for use for management control and predictive purposes; or

as a tool for planning, controlling and assessing marketing tests or campaigns (eg. for assessing whether marketing objectives associated with product or brand positioning have been met).

Analytical tasks, such as those highlighted above in the context of product and brand management, can be run arbitrarily often (including in real time if desired) to reflect changes with time (or as additional information is gathered) in the subject matter being analysed. This can be done automatically by recalculating the profiles underlying the analysis arbitrarily often including any new information that has been gathered

The filtering method of the invention can be used in support of automated product configurators. It can be used (possibly in conjunction with other fact-based expert systems) to predict which amongst numerous product configurations or variants would appeal most to a prospective customer. The most appealing product configuration can then be presented to the prospective user automatically at an early stage as a pre-configured product option customised to that customer's needs.

The method of the invention can also be used as a method of analysing data to: predict whether an observation about one particular item is likely for a case; and possibly also to investigate whether there are different reason associated with the observation being likely; and possibly to also target cases for which the observation is likely, possibly depending on the different reasons.

One example is where companies want to manage customer attrition, or churn. Another is whether the customer is likely to generate a lot of revenue for a supplier and so be a particularly valued customer. Although the description. that follows is in the context of attrition management it will be understood that the description could equally apply to other examples.

The aim of attrition management is to:

Identify which customers are likely to close an account.

Target customers according to any differences in the underlying reasons why they are likely to close an account.

Data that might be useful in predicting behaviour can include but is not limited to:

demographic information; purchase patterns; information from customer service records; and information provided explicitly by the customer.

The method for predicting whether a customer is likely to churn involves the following steps.

1. treat all the pieces of information, including the event that the customer churns, as items

2. use the filtering method of the invention to work out item profiles for these using the data.

3. make predictions about whether or not a customer is likely to churn using the method of the invention. The difference is that instead of working out the likelihood that the customer will choose each of a range of unchosen objects, instead only the likelihood that the user will choose the item “churn” is worked out.

One method for investigating the different reasons for attrition is to:

Specify a binary variable stating whether a customer closed an account as an item.

Identify a set of covariates which might be informative about a customer's attrition behaviour and treat at least some as items.

Specify models of the items. Suitable functions would be monotonically increasing functions of a linear function of the case profile, where the coefficients on the case profile components are the item profile components, and where the fixed term is also an item profile component. Examples of these are described on page [ ]

Estimate the item profiles using the filtering method of the invention

Identify those items which are signals of attrition—these will be those for which case profiles that give a high likelihood of the item being selected or having a high value will also have a high likelihood of attrition.

Investigate, possibly visually, whether these signals of attrition all have similar profiles, or whether their profiles differ indicating different reasons associated with attrition.

If desired, target messages to customers with a high propensity to attrite, possibly according to the different reasons associated with attrition, by specifying profiles for the messages that are similar to those of the signals of interest.

One method is to:

Specify a binary variable stating whether a customer closed an account as an item. identify a set of covariates which might be informative about a customer's attrition behaviour and treat at least some as items. Do steps M through B.

From the item profile for attrition, identify which components in a case profile are indicative of a high propensity to attrite. Where models depend on

$$[ {b}_{jo} + {\sum }_{n = 1}^{Q} {a}_{iq} {b}_{jq} ]$$

then these components will be those >0 with a high b_{jq}.

Analyse the other item profiles, possibly visually, and apply skill and judgement to decide what message is appropriate to customers likely to attrite depending on which components of their profile indicate propensity to attrite. For example if high component 2 is indicative of attrition, can we learn from looking at other items where component 2 scores highly what “reason” this component indicates.

Implement targeting of the customers by the method described above.

The method can be used assess the likelihood of churn in the manner described above for each customer at arbitrary periodic intervals (including in real time) and, where, a churn likelihood over a given threshold probability is detected, either alert the administrator to this or automatically select the marketing response predicted most likely to avert churn (treating the responses in the same way as messages as described above) and trigger suitable pre-emptive action. This process may be used in conjunction with rules to restrict which marketing responses will be considered by profile sequencing dependant on the economic value of the customer.

It is assumed that there are considered to be different reasons for churn that cannot be observed directly. Profile Sequencing can be used to distinguish these reasons. This can be useful because the marketing response to a customer who is disgruntled and is considering moving to a competitor is very different to one who is liquidating assets to invest.

Another method is to use a priori knowledge about the reasons for attrition. For example modify the previous method as follows;

1. decide what the reasons for churning might be,

2. decide which items are indicative of which reasons

3. associate each reason with a component in the item profile

4. require that the case profiles are estimated so that they have as many components as reasons, and that items have non-zero values for a component in their profile only where the item is indicative of the reason associated with that component.

The filtering method of the invention can be used to alert operators of potentially fraudulent transactions. The basic idea is to build a model that relates various indicators of the pattern of a customer's transactions to their profile. A customer's profile is learnt from their past transactions, and when a new transaction occurs the system looks to see whether it is unusual given the customer's profile.

The advantages of using the filtering method for this task are that:

a very large number of similar variables can be used as part of the same predictive model. Traditional predictive models include variables directly in the predictive equations. If there are very many of these then traditional models cannot identify the separate effects of each, and will not be able to estimate the equation parameters. With the method of the invention on the other hand only the customer's profile and possibly some covariates enter into the item models. Because each equation has only a small number of arguments, there is no need to ignore any variables.

The system can be used by, for example: financial services companies (eg. banks, credit card companies etc); or telecommunications companies.

It can be used in a retail context to detect fraud by individuals, in a commercial context to detect fraud by companies, public authorities or other commercial entities, or by commercial entities (eg. banks, shops, other companies, public authorities etc.) to alert against employee fraudulent transactions made by the employee on the entities behalf.

In using the method of the invention to detect potentially fraudulent transactions, the process requires data on transactions so that unusual ones can be spotted.

In the context of detecting credit card theft a system might consider: strange withdrawals; strange payees; strange time of day.

In the context of mobile phone theft a system might consider: frequency of phone use; unusual numbers of a phone.

Using the knowledge of the customer's profile, it is predicted how likely the observed transaction would be.

If the probability is sufficiently low, then someone is alerted to take a closer look.

In one embodiment, a computer software product for carrying out the filtering method of the invention could be supplied to customers to be used with data that they themselves obtain.

An alternative is to use the method to supply analysis and marketing automation tasks as a service, possibly over an extranet. Clients may send their data to the service provider, and would receive from them analytics results or inputs for marketing automation.

One example may be where the service provider receives from the client a set of observations about a customer, and returns predictions about the suitability of objects. Depending on the commercial arrangements the customer database used by the filtering engines could contain: observations about customers that are pooled from different clients, or only observations about customers that are supplied by the client in question.

If observations are pooled from different clients, then there is the possibility that predicted suitabilities for a customer can be based on observations about her gathered from all those client sites that pool their data. To implement this the clients would need to implement identification policies that allowed customers to be identified no matter what participating site they were on.

In other cases observations can be pooled from different clients, and yet predicted suitabilities for a customer can be based only on observations made by the client making the request. In this case customers would have different identities for each participating client, and will have one record in the customer database for each different identity.

Intermediate cases are possible, in which for example some clients provide their data to the pool and get predicted suitabilites that benefit from all the data in the pool, while others benefit from the pool but do not supply their own data into it, or in which arrangements differ for different classes of item.

The above has been described principally in terms of a service by which an individual customer interacts directly with a service in real-time (either passively or expressly or both). However, the service may equally well be provided to customers indirectly via the medium of a third party such as, for example, a salesperson or call centre operative.

Knowledge and analysis about customer and item profiles that the filtering method of the invention can generate can be sold directly to companies interested in market research in the appropriate markets.

Where information in the customer database is dated, knowledge discovery could be focussed also on whether there are marketing relevant trends in customer behaviour. Services could reflect the types of analytics described in the rest of the document except that they are carried out on behalf of the client on a consultancy basis rather than by the client themselves.

The following describes the commonality between the various methods described above.

1 The Set Up

We have a data set D about a set of cases. For each case i=1, . . . , I the data contains a set yᵢ of observations Yᵢⱼ about items j=1, . . . , J. We want to build a predictive model for these items. Two paradigm cases arise which are dealt with in essentially the same way.

1. Data is binary and there are no missing values. Examples include where observations about items record

—whether a user has or has not visited a web page

—whether the customer has or has not bought an item and where the prediction task is to predict how likely one of the items is to have been selected from amongst those items that have not in fact yet been selected.

2. Data contains missing observations examples include (see section on missings) and where the prediction task is to predict what an observation for an item would be if it was not missing.

Throughout •P(ξ|θ) denotes the probability of random variable ξ given the particular value at variable θ••L(θ) denotes the likelihood of observations given the particular value of θ•L(0)=LnP(ξ|θ).

1.1 The Central Concepts

Item Model f(y|aᵢ, bⱼ,.), ŷ (aᵢ, bⱼ,.)

The item model links an observation about an item to a case profile aᵢ. There is one function per item and they are the keys to the method. Once specified they allow us to go back and forth between observations, case profiles, and predictions about observations. One form of item model is in terms of a modelled observation and an error.

yᵢⱼ=ŷ(aᵢ, bⱼ,.)+εᵢⱼ

where εᵢⱼ is an error term equal to the difference between the modelled and the actual observation. Another form is in terms of a probability distribution over possible observations f(y|aᵢ,bⱼᵢ)=P(y_{ij=y}|aᵢⱼbⱼᵢ). These are closely related. If a probability distribution for the error term is specified then they are equivalent as

$$f ( y \vert {a}_{i} , {b}_{j} , . ) = P ( {y}_{ij} = y \vert {a}_{i} , {b}_{j} , . ) \\ = P ( {∈}_{ij} = y - \hat{y} ( {a}_{i} , {b}_{j} , . ) )$$

To keep descriptions clear we will often use just the version in terms of probability functions. It will be obvious how to proceed in the alternative case. The functions are written to indicate that, in general, they may take arguments in addition to the item and case profiles. For convenience we may sometimes omit this additional dependence in the notation.

Item Profile bⱼ

This specifies the parameters of the model for the item. It may include terms that identify which from a set of possible functional forms is being used. The set of all item profiles is B.

Case Profile aᵢ

This specifies the case in terms that include metrical latent components. It does not include observations about other items. The set of all case profiles is A.

1.2 The Key Steps

The method involves a number of steps, each of which estimates some of the parameters in the item models. The estimation procedure may lead to point estimates of the parameters, or to density estimates that specify a probability distribution over some range of possible values. Estimated variables are shown with a hat in what follows.

D Step: Specify the data (Y,.) which includes the observations Y about items.

M Step: Specify a model of the data M (Y, A, B,.) that includes as sub-models the item models f. The specification includes the range of allowable free parameters.

B Step: Estimate the item profiles. Take the observations and, using the model, derive estimates of the item profiles by trying to get a good fit to the data. Schematically we can write:

M(Y,.,.)→\hat{B}

A Step: Estimate a case profile. Take the models, estimated item profiles and observations for one case, and get the case profile. Schematically the step involves:

yᵢ, \hat{B}→âᵢ

Y Step: Make predictions about observations regarding items for a case. Take the model and estimates of the case profile and item profile to give predicted observations. Schematically:

âᵢ, \hat{b}ⱼ→ŷᵢⱼ

We have described the A and Y steps as separate. In practice many related steps may be carried out together and it may be more efficient to code them together. Nevertheless conceptually the method can be expressed in these two different steps.

2. M Step

The item model for item j has as parameters the item profile bⱼ and takes as an argument a case profile. In all the embodiments we discuss it does not depend directly on observations about other items. In particular this means that:

Where the model is given as a probability distribution over observations then this distribution does not depend on observations about other items.

Where the model is given in terms of a modelled observation this modelled observation does not depend on observations about other items and the errors are treated as independent random variables.

Examples of functional forms include ones where:

the case profile has Q components

the item profile has Q+1 components

the distribution of an observation depends on bⱼ₀+Σ_{q=1}^{Q}a_{iq}b_{jq}

The way in which observations depend on the profiles depends on the kind of observation.

Continuous variables—examples include

ratings (even if ratings are picked from a finite set, it might be convenient to model them as continuous),

length of time viewing a web-page,

covariates such as age.

A possible model of continuous variables is:

$$\hat{y} ( {a}_{ i} , {b}_{j} ) = {b}_{j 0} + {\sum }_{q = 1}^{Q} {a}_{i q} {b}_{j q}$$

Binary variables—examples include

whether or not a customer has visited a web-page this session

whether or not a customer has a pension

A possible model of binary data is

$$P ( 1 \vert {a}_{ i} , {b}_{j} ) = l o g i {t}^{- 1} ( {b}_{j 0} + {\sum }_{q = 1}^{Q} {a}_{i q} {b}_{j q} )$$

where logit⁻¹ (x)=1/(i+^{-x}). This is a common specification for binary data but many others are possible as well.

A simple alternative is to use the model specified above for continuous data. Examples of ways to model ordinal and categorical variables are known. See for example Bartholomew and Knott (99).

2.3 Indeterminacy

A feature of many of the models we describe is that, without additional assumptions, many different sets of item profiles give a good fit to the data. One option is to accept any set as estimates of the item profiles. Another is to make additional assumptions. These additional assumptions can improve the intelligability of the result by making it easier to compare results from different runs and using different data.

If the model depends on case and item profiles via the function

$${b}_{j 0} + {\sum }_{q = 1}^{Q} {a}_{i q} {b}_{j q}$$

then an assumption that removes one source of indeterminacy is to require that each component of the case profile has unit variance and zero mean.

Those familiar with latent variable models will also be familiar with the indeterminacy known as rotation issues. In what follows we have used the default i.e. unrotated output from packages but it will be clear how to use rotated if available.

3. B Step

In Step B the item profiles are estimated as those that mean the item models fit the data well.

1. If the item models are expressed in terms of a modelled observation, then choose item profiles that approximate those that minimise a function of the errors, e.g. the sum of errors squared.

2. If the item model is expressed in terms of a probability distribution over observations then choose item profiles that approximate those that maximise the likelihood of the data. In practice we generally seek to maximise the log of the likelihood as this is more treatable. Item profiles that maximise one will maximise the other also.

It is well known that these two general approaches are closely related, and indeed that in many cases there are distributional assumptions and functions of the errors that make them formally identical. To keep the description concise we will typically express the methods in terms of maximising the likelihood of the data, but it will be clear how to describe them in terms of minimising a function of the errors.

Fitting the model to the data would be a straightforward task if the case profiles were known. However the case profiles are not, at this stage, known. We give some examples of ways to estimate the item profiles in these circumstances.

3.1 One Preferred Method (Approach 2)

This method treats the case profiles as parameters to be estimated along with the item profiles. The method is to estimate the item and case profiles jointly so that the item models fit the data.

The loglikelihood of the observations about items, as a function of both case and item profiles is

$$\begin{matrix}L ( A , B ) = ln P ( H \vert A , B ) \\ = {\sum }_{i = 1}^{I} {\sum }_{j = 1}^{J} ln f ( {h}_{i j} \vert {a}_{i} , {b}_{j} )\end{matrix}$$

The method is to choose item and case profiles that approximately maximise the loglikelihood (Â,\hat{B})=argmax L(A,B).

(A,B)

The following method will give estimates that locally maximise the likelihood of the data. Experiment suggests that local maxima have similar likelihoods, so that in many cases it may be sufficient to accept the parameter estimates from a single run through these steps. Alternatively choose n (n=3 for example) different starting values, and choose the resulting parameter estimates associated with the highest likelihood.

The steps in the method are:

1. Define two sets of log likelihood functions, one for the case profiles aᵢ, i=1, . . . , I as a function of known item profiles,

$$\begin{matrix}L ( {a}_{i} \vert B ) = {\prod }_{j = 1}^{J} f ( {h}_{i j} \vert {a}_{i} , {b}_{j} ) \\ = {\sum }_{j = 1}^{J} ln f ( {h}_{i j} \vert {a}_{i} , {b}_{j} )\end{matrix}$$

and one for the item profiles bⱼ=1, . . . , J as a function of known case profiles.

$$L ( {b}_{j} \vert A ) = {\sum }_{i = 1}^{I} ln f ( {h}_{i j} \vert {a}_{i} , {b}_{j} )$$

2. Choose starting values B⁰=(b₁⁰, . . . , b_{J}⁰)) for the item profiles. These can be random variables. Alternatives include item profiles from previous versions runs of the model. It will be apparent that an alternative method is to start with values for A⁰, with obvious consequential changes.

3. Then iterate the following two steps until there is convergence.

(a) Choose A^{t+1}=(a₁^{t+1}, . . . , a_{I}^{t+1}) to maximise the log likelihood, given item profiles B^{t}

$${a}_{i}^{t + 1} = arg {max}_{{a}_{i}} L ( {a}_{i} \vert {B}^{t} )$$

(b) Choose B^{t+1} to maximise the log likelihood, given case profiles A^{t+1}

$${b}_{j}^{t + 1} = arg {max}_{{b}_{j}} L ( {b}_{j} \vert {A}^{t + 1} )$$

4. Set \hat{B} equal to the converged value of B^{t}, and Â to the converged A^{t}.

It will be apparent that some method for deciding whether the iterative procedure has converged or not will be needed. There are many ways to do this. An obvious method is to calculate the log likelihood of the data at the end of step b and to consider the procedure to have converged if the percentage fall in the log likelihood is less than some pre-set value, such as 0.1. The advantage of this iterative method is that, at each stage (a) or (b) the method involves estimating the parameters of a straightforward prediction function for a single dependent variable in terms of a number of known explanatory variables. This is the standard situation in statistical and econometric modelling, so that a wide variety of techniques, approaches, and fully worked examples for particular functional forms are known and can be used. Known examples include the functional forms for binary and continous data suggested earlier.

3.2 Latent Variable Method

The latent variable method treats the case profiles as unobserved random variables. It fits the data by finding point estimates of the item profiles that maximise the likelihood of the data, given a prior distribution for the unobserved case profiles. An alternative, approximate, method find point estimates of the item profiles that give a good fit of the model correlation matrix to the correlation matrix for the data.

One way to estimate the item profiles is to treat each case profile as an unobserved random variable. This is the approach to estimating latent variable models (including factor analysis, latent trait analysis and similar models) and many examples and methods are known. Many are described in Bartholomew and Knott (99). In this literature the item profiles are often referred to as factor loadings.

3.3 Latent Variable Method I—Full Information Maxiumun Likelihood

This note describes a method for estimating latent variable models based on maximising the likelihood function.

1. Make a distributional assumption about the case profiles. The usual assumption is that they are standard normal. a_{iq}≈(N (0,1) and are statistically independent of the errors. In addition it is usually assumed that the case profile components are statistically independent of each other.

2. Write down the expected log likelihood of the data. The probability of any particular case is:

$$P ( {y}_{i} \vert a , B ) = {\prod }_{j = 1}^{J} P ( {y}_{i j} \vert a , B )$$

a is an unobserved random variable and the expected probability (or equivalently the expected likelihood or marginal distribution) of yᵢ is:

$$P ( {y}_{i} \vert B ) = {\sum }_{a} P ( a ) {\prod }_{j = 1}^{J} P ( {y}_{i j} \vert a , B )$$

Looking at all observations in the dataset together gives the overall expected probability (or equivalently the expected likelihood or marginal distribution):

$$P ( Y \vert B ) = {\prod }_{i = 1}^{I} {\sum }_{a} P ( a ) {\prod }_{j = 1}^{J} P ( {y}_{i j} \vert a , B )$$

The log likelihood of item profiles B is the log of this

$$\begin{matrix}L ( B ) = ln P ( Y \vert B ) \\ = {\sum }_{i = 1}^{I} ln {\sum }_{a} P ( a ) {\prod }_{j = 1}^{J} P ( {y}_{i j} \vert a , B )\end{matrix}$$

3. Estimate item profiles to maximise the log likelihood.

$$\hat{B} = arg {max}_{B} L ( B )$$

3.3.1 EM Algorithm

Step 3, the estimation of the parameters, can be difficult. One method is to use a well known iterative scheme known as the EM algorithm. The EM algorithm iteratively estimates parameters that maximise the expected value of the log likelihood of the observations and case profiles, where the expectation is with respect to the density estimates of the case profiles. Thus the EM algorithm jointly estimates case and item profiles. The application of this algorithm to latent variable models is described in Bartholomew and Knott (99) where they give examples for different kinds of variable.

Methods implementing full information maximum likelihood have been implemented in a number of software programmes, for example TWOMISS estimates models for binary data for Q=I or 2. The software is available on a website of the publishers of Bartholomew and Knott (99), arnoldpublishers.com/support/lvmfa2.htm.

The program is described in the document latv.pdf available on the site. This document also contains a detailed description of the model and the EM method of estimation. References to other packages for binary and other models can be found in Bartholomew and Knott (99).

3.4 Latent Variable Method II—Fitting the Correlation Matrix

An alternative method that can be used whenever observations are ordered variables is based on 2 steps:

1. recast the model so that it reflects an underlying linear model

2. estimate the parameters of the underlying linear model by fitting the covariance or correlation matrix.

This method is generally fast because only summary statistics are needed.

3.4.1 The Underlying Linear Model

The linear model assumes that observations are random variables with distribution:

$${y}_{i j} = {β}_{j 0} + {\sum }_{q = 1}^{Q} {a}_{i q} {β}_{j q} + {i j}_{}$$

where the error term εᵢⱼ is a random variable with zero mean and variance ψⱼ, which is independent of the observations, of the case profile, and of other error terms, and the q'th component a_{iq} of the case profile is a random variable with mean zero and unit variance. This model implies a covariance matrix of

irini

3.4.2 Estimating the Parameters of the Linear Model

One method for estimating the profiles of the linear model is to fit the covariance matrix for the model to that of the data. The programme LISREL does this. The correlation matrix can be used in place of the covariance matrix. The steps of the method are:

1. Calculate the correlation matrix for the observations. This can be done using standard statistical packages such as S-PLUS or PRELIS (distributed with LISREL).

2. Assume that the components of the case profile are independent and use standard factor analysis, for example using S-PLUS, of the correlation matrix to estimate the β parameters.

3.4.3 Recasting the Original Model in Terms of an Underlying Linear Model

The method can be used for different types of observation. Examples are described in Bartholomew and Knott (99).

Continuous Variables.

The β variables can be identified directly with item profiles.

Binary Variables.

In this case the method is

1. assume that underlying each item j is an underlying continuous variable εⱼ and a threshold tⱼ. Together these determine the observations for that item—an observation is 1 if z is above the threshold, and 0 otherwise.

$${y}_{i j} = \{ \begin{matrix}1 & if {i j}_{} \geq {t}_{j} \\ 0 & otherwise\end{matrix}$$

2. Under this assumption calculate a tetrachoric correlation matrix from the observations. This is a known technique that estimates the correlation matrix of the inferred underlying variables. The estimation can be done using PRELUS.

3. Estimate the linear model for these underlying variables, generating estimates for the β parameters.

To recover the item profiles for a model of binary data from these parameter estimates:

1. Use the logit model for binary data

2. Derive the item profiles b_{jq} for the binary observation model from these factor loadings according to:

$${b}_{j q} = \frac{π}{\sqrt{3}} \frac{{β}_{j q}}{\sqrt{1 - {\sum }_{q = 1}^{Q} {( {β}_{j q} )}^{2}}}$$

for j≠0, and logit⁻¹ (bⱼ₀)=n^{j} where n^{j}=the proportion of observations of item j equal to 1

3. There is an exception to the equation (1) above. In some cases the item profiles from the linear factor model are such

$${\sum }_{q = 1}^{Q} {( {β}_{j q} )}^{2} \geq 1$$

in which case the equation in (1) does not give sensible results. These cases are known as Heywood cases. For Hewood cases (in practice whenever

$${\sum }_{q = 1}^{Q} {( {β}_{j q} )}^{2} \geq 0.9 )$$

we replace the relevant part of (1) with (2) below.

$${b}_{j q} = \frac{π}{\sqrt{3}} \frac{{β}_{j q}}{\sqrt{2 - {\sum }_{q = 1}^{Q} {( {β}_{j q} )}^{2}}} \qquad ( 2 )$$

In doing so we follow one of the suggestions of Bartholomew and Knott in section 3.18 of their book. We could alternatively have used other known methods for dealing with Heywood cases.

Ordinal Data

Bartholomew and Knott (99) describe a way to recast ordinal variable problems in terms of an underlying continuous model.

3.5 2 Stage Method

The 2 stage method is another method that fits the data by finding point estimates of both item and case profiles. It first estimates case profiles using a simple linear model. Then, treating these as observed variables, it estimates item profiles.

The method is in two stages.

1. Generate estimated user profile

2. Estimate the item profiles treating user profiles as known.

3.5 B Step

1. Derive Pseudo-Item Profiles

Use a simple linear model to derive pseudo-item profiles. Appropriate examples include the normal linear factor model and Principal Component Analysis.

2. Generate Estimated User Profiles

Derive point estimates of each case profile âᵢ, using the pseudo-item profiles. One method is to use the A Step of the PCA method.

3. Estimate the Item Profiles Treating User Profiles as Known

Now that we have estimates of the user profiles, these can be treated as known in the item models, leaving only the item profiles as free parameters. The item profile for item j can now be estimated by:

(a) write down a set of the loglikelihood functions, one for each item, as a function of known case profiles

$$L ( {b}_{j} \vert \hat{A} ) = {\sum }_{i = 1}^{I} ln f ( {h}_{i j} \vert {\hat{a}}_{i j} , {b}_{j} )$$

(b) choose an item profile for j that maximises the loglikelihood.

$${\hat{b}}_{j} = {arg max }_{{b}_{j}} L ( {b}_{j} \vert \hat{A} )$$

There are a wide range of estimation procedures for this kind of problem.

3.5.2 Applying the Method to Different Types of Item

We described the method as though all items were considered together when deriving the pseudo-item profiles and the estimates of the user profiles. In some cases it might be appropriate to consider items in separate groups, with separate sets of user profile components associated with each group. For example, the dataset of observations about a user may contain some items relating to preferences over objects, and some indicators of socioeconomic group. Treating these two groups separately reduces the number of free parameters that need to be estimated for a given number of overall components in a user profile. If the two groups do largely act as indicators of different components of the user's profile then this approach can lead to better estimates of the parameters that remain and to more accurate predictions. The method is:

1. Estimate pseudo item profiles and case profiles for each group of items separately. The number of components in group g is Q^{g}.

2. Combine the case profiles from the different groups, so that each case profile contains Σ_{g}Q^{g} components.

3. Continue as before.

3.6 Principal Components Analysis

Principal components analysis generates a mathematical transformation of the observations that gives both item profiles and case profiles.

This section describes a method for using Principal Components Analysis (PCA) to find the item profiles. As a technique PCA has the advantage that it is quick, and routines to implement it are well known and widely available in statistical packages.

3.6.1 The Theory

PCA is a well known procedure that is used to reduce the dimensionality of a dataset while minimising the loss of information. The method is to transform the original variables for a case, yᵢⱼ, j=1, . . . , J, to a new set of uncorrelated variables, a_{iq}, q=1, . . . , Q, called principal components, which contain most of the information about the variance in the original data. These new variables are linear combinations of the original variables so that:

a_{iq}=b_{iq}(yᵢ₁−b₁₀+ . . . +b_{Jq}(y_{iQ}=b_{Jq}), q=1, . . . . , Q

or more compactly A=β^{T}(Y−B₀). Here bⱼ₀ is the average value for observations yᵢⱼ about item j. B^{T} denotes the transpose if the item profile matrix, omitting the constant terms B₀. We impose the normalisation that

$${\sum }_{q = 1}^{Q} {( {b}_{j q} )}^{2} = 1$$

The first principal component, aᵢ₁, is found by choosing bⱼ₁, j=1, . . . , J, so that aᵢ₁ has the largest possible variance. The second principal component is found by choosing bⱼ₂ so that aᵢ₂ has the largest possible variance subject to it being uncorrelated with the first principal component and so on.

This approach models the data in the following sense.

If the number of principal components is equal to the number of original variables (Q=J) then it is a result of linear algebra that we can invert the equations to write Y=B₀+BA. If we ignore some of the later transformed variables (Q<J) that account for only a small part of the variance, then we can get a model of the data Ŷ=B₀+BA which will have the property that errors between ŷ and yᵢⱼ.will be small.

3.6.2 B Step in Practice

1. Calculate the covariance matrix for the data. This can be done using a standard stats package.

2. Find the Q principal components of the data by analysis of the covariance matrix. This can be done using standard statistical packages such as S-PLUS. (In practice packages can also take the raw data as an input and calculate the matrix as part of the estimation procedure).

3. For each item j set bⱼ₀ equal the average observation for that item.

4. For each item j and component q≠0 set b_{jq} equal to the weighting associated with item j on the q^{th} principal component

4. Making Predictions

We give a number of examples.

4.1 Example One (Approach 2)

A step—derive a point estimate aᵢ of the case profile

Y step—enter that point estimate into the relevant item model or models to derive a point prediction of the observation for that item.

4.1.1 A Step

Within the literature on hidden variable models various statistical methods have been described to derive a point estimate of the true value of the case profile. Examples are described in Bartholomew and Knott (99), the LISREL 8 handbook [LISREL 8: User's Reference Guide, (1996) Joreskog and Sorbom, publ. Scientific Software International] and in references therein. The method we describe here is to maximise the likelihood of the data.

1. Take all the observations about a case as the sample. The same case profile will enter into the model for each of these observations, but the item profiles will be different for each.

2. Treat the observations as the dependent variables, the item profiles as the explanatory variables, and the case profile as the parameters to be estimated.

3. Define a likelihood of for the data for a case profile as

$$L ( {a}_{i} \vert \hat{B} ) = {\sum }_{j = 1}^{J} ln f ( {y}_{i j} \vert {a}_{i} , {\hat{b}}_{j} ) .$$

4. Estimate the case profile to maximise the likelihood of the data: â=arg minᵢ L(aᵢ|\hat{B}).

This last step involves the same calculations as step 3(a) in the iterative process to derive item profiles in the Appraoch 2 method for item profiles.

4.1.2 Y Step

Using the estimated case and item profiles, predict observations ŷᵢⱼ about items using the item model.

It will be clear that in many cases a suitable point prediction is the expected observation

$${\hat{y}}_{ i j} = {\sum }_{i j} y f ( y \vert {\hat{a}}_{i} , {\hat{b}}_{j} )$$

With binary data this reduces to Ŷᵢⱼ=f(l|âᵢ, \hat{b}ⱼ). Equally it will be clear that we could use information about the predicted distribution.

4.2 Bayesian

A better method is to use Bayesian updating. This is a statistical method that treats the customer profile as a random variable with a specified distribution. Alternatively we can say that it treats the customer profiles as parameters, but that knowledge of the parameters is probabilistic and prior knowledge is given by a distribution.

This method has advantages.

It is consistent with the latent variable method for estimating item profiles in the following sense. In the latent variable approach all that is known about a user's profile, given their observations, is contained in the Bayesian posterior distribution over possible profiles.

It is conservative, in the sense that any point estimate of a user's profile based on the Bayesian posterior will not be very sensitive to small changes in the observations. This reduces the potential for overfitting and improves the accuracy of out of sample predictions.

Unlike Approach 2 A step, it can be used even if item models have different forms

4.2.1 A Step

1. Specify a prior distribution over case profiles. Experiment suggests that the exact form of the prior has little effect on the results.

(a) To be consistent with the assumptions made when estimating the item profiles using the latent trait method, we assume that each component of the case profile has a standard normal distribution. a_{iq}~N(0,1). In practice we will need to approximate this using a discrete distribution. In the examples we used a binomial distribution with a sample size of 4, where the number of successes is transformed so that they are evenly distributed about 0. Thus a_{iq}ε{−2, −1,0,1,2} and:

$$P ( {a}_{i q} ) = \frac{1}{{2}^{4}} \frac{4 !}{( 2 + {a}_{i q} ) ! ( 2 - {a}_{i q} ) !}$$

(b) An alternative method when using the 2 stage, Approach 2 or PCA methods for estimating item profiles is to generate a prior distribution during the B step. The method is to use the actual distribution of case profiles as the prior distribution. To be practical the actual distribution needs to be approximated by a discrete distribution with a small number of points. Various methods are obvious. For example, for the 2 stage process a simple example could be to (i) set out the discrete values that each profile component can take when making recommendations, say a_{iq}ε{−2,−1,0,1,2} (ii) set P(a_{iq}) equal to the proportion of cases for which the estimated profile component â_{iq} is closest to a_{iq}. For example P (aᵢ₂=−1) will be the proportion of cases for which âᵢ₂ lies between −1.5 and −0.5.

Another example suitable for any of these methods is:

(i) for each component q calculate the standard deviation σ_{q}

(ii) define the discrete values that each profile component can take when making recommendations as a_{iq}ε{−2σ_{q}−σ_{q},0, σ_{q}2σ_{q}}

(iii) Set P(a_{iq}) equal to the proportion of cases for which the estimated profile component â_{iq} is closest to a_{iq}.

2. Update the distribution over possible case profiles in the light of observations about the case to give a posterior distribution P (aᵢ|yᵢ) using Bayesian inference. Standard calculations give:

$$P ( {a}_{i} \vert {y}_{i} ) = \frac{P ( {a}_{i} ) P ( {y}_{i} \vert {a}_{i} , \hat{B} )}{{\sum }_{a} P ( a ) P ( {y}_{1} \vert a , \hat{B} )}$$

where P(aᵢ)=Π^{Q}_{q=1}P(aᵢⱼ) and P(yᵢ|aᵢ, \hat{B})=Π^{J}ⱼ₌₁ f(yᵢⱼ|aᵢ, \hat{b}ⱼ).

4.2.2 Y Step

The probabilistic knowledge of the case profile can be combined with the item models in a number of ways to predict observations. A simple approach is to take the expected observation as the prediction.

$${\hat{y}}_{i j} = {\sum }_{y} y {\sum }_{a i} P ( {a}_{i} \vert {y}_{i} ) f ( y \vert {a}_{i} , {\hat{b}}_{j} )$$

In the example of binary data where observations are either 0 or 1, this simplifies to:

$${\hat{y}}_{i j} = {\sum }_{a i} P ( {a}_{i} \vert {y}_{i} ) f ( 1 \vert {a}_{i} , {b}_{j} )$$

Equally clearly, if further steps depend in the whole distribution g(ŷᵢⱼ) over observations then a suitable form would be

$$g ( {\hat{y}}_{i j} ) = {\sum }_{a i} P ( {a}_{i} \vert {y}_{i} ) f ( {\hat{y}}_{i} , \vert {a}_{i} , {b}_{j} )$$

4.3 PCA

The best method would be to use a Bayesian method with PCA.

A fast and simple alternative is to use the PCA equations to define a PCA method.

A Step:

â_{iq}=b_{1q}(yᵢ₁−b₁₀)+ . . . +b_{Jq}(Y_{iQ}−b_{Jq}), q=1, . . . Q

Y Step: The prediction step also uses the PCA model directly to give:

$$\hat{y} ( {\hat{a}}_{i} , {\hat{b}}_{j} ) = {b}_{j 0} + {\sum }_{q = 1}^{Q} {a}_{i q} {b}_{j q}$$

4.4 Using a Reduced Set of Case Observations Iᵢ^{j}

In some circumstances we may want to make to make predictions about an observation for an item in the light of what is known about observations only in respect of other items. The most important example is where data records which items a customer has selected previously, and the task is to predict whether a particular item is likely to be selected. Ideally the observation that the item has not yet been selected is ignored. In other words predictions about item j are made in the light of a reduced set of case observations Iᵢ^{j} which omits observation Yᵢⱼ:

I^{j}ᵢ={yᵢₖ}_{k≠j}

Where predictions need to be made about a number of items, the ideal process would be, for each item j for which a prediction is needed:

A Step—generate knowledge about the case profile using the reduced set of case observations that omits the observation about item j

Y Step—use the knowledge so generated to make a prediction about item j.

This ideal approach does involve some sacrifice of speed and a faster though less accurate, alternative is to:

A Step—generate knowledge about the case profile using either the full set of observations about the case (suitable when making predictions only about a small number of items), or using a reduced set of observations that omits the observations about all the items for which predictions are needed (suitable when making predictions about many items).

Y Step—use the knowledge so generated to make predictions about all the relevant items.

5. Using Covariates

Covariates are variables with observations Zᵢₖ, k=J+1, . . . , K, that are informative about a case, but which are not items about which predictions are wanted.

5.1 Treating Covariates as Items

One straightforward way to incorporate some covariates is to treat them as though they were items. For each covariate to be treated this way:

D Step 1. Create a new item with index k with observations Zᵢₖ, i=1, . . . I

M Step 2. Specify an item profile and model f(yᵢₖ|aᵢ, bₖ), depending on the type of variable.

B Step 3. Estimate the profile for the covariates at the same time and in the same way as for the other items.

A Step 4. Update these case profiles in the light of observations about these covariates in exactly the same way as observations about other items.

Y Step Do not make predictions about these covariates.

This approach will ensure that information about covariates will influence predictions—observations about covariates will be used to update a case profile, and this will then affect predictions. The approach has a number of advantages.

It can cope easily with missing observations.

The methods for all the steps D-A go through unchanged.

It is particularly easy to interpret the results and to use covariates to help target messages—the covariate profiles can be shown in visual representations in exactly the same way as item profiles.

5.2 Covariates as Observed Components of a Case Profile

Another way to treat covariates is as observed components of a case profile.

5.2.1 M Step

One way to specify the model is to choose item models that are functions of

$${b}_{j0} + {\sum }_{q = 1}^{Q} {a}_{iq} {b}_{jq} + {\sum }_{k = Q + 1}^{K} {z}_{ik} {b}_{jk} .$$

The item profile now has K rather than Q components.

5.2.2 B Step

2 Stage Method

This method provides a straightforward way to include some covariates as directly observed components of the user profile. The method is:

1. Ignore these covariates when estimating the pseudo-item profiles and case profiles.

2. Include the covariates as observed variables in the item models.

3. Estimate the item profiles as before, treating both the case profile and the covariates as observed variables.

Latent Variable Method.

Examples of estimating item profiles in latent variable models with covariates are known. For example see Moustaki (2001), “A general class of latent variable models for ordinal manifest variables with covariate effects on the manifest and latent variables”, London School of Economics Statistics Research Report January 2001, LSERR58, and references therein.

5.2.3 A Step

Bayesian Method

The method is unchanged, though the functional forms of the equations will need to be able to accommodate the covariates.

6. Using Prior Information about Items

In many cases system administrators will have prior knowledge about items. Examples include:

What are the latent variables that determine observations, and what items do they most affect.

The time of year when it is best to visit particular holiday destinations

Cost

The genre of movies.

Using this knowledge can be beneficial.

It may improve accuracy, as it adds information into the system, or reduces the number of free parameters needed to fit the data well

Aids knowledge discovery and control by ensuring the relationships in the model reflect the administrators prior knowledge.

One way to use any of these forms of prior knowledge about items is to impose prior restrictions on the item profiles.

6.1 Prior Knowledge About the Latent Variables

One form of prior knowledge is about what the latent variables that determine observations are, and which observations are most strongly related to each of these factors. One way to incorporate this knowledge is to modify the model specification step as follows. The other steps are unaffected.

6.1.1 M Step

1. Identify the underlying latent variables and list which items are strongly related to which latent variables.

2. Specify item models that are functions of

$${b}_{j0} + {\sum }_{q = 1}^{Q} {a}_{iq} {b}_{jq}$$

3. Fix b_{jq} to be 0 if item j is not strongly related to latent variable q.

4. Set the correlations between components in the case profile to be free parameters.

B Step

A convenient method to estimate item profiles is to use the LISREL package. The LISREL 8 manual describes how to estimate models when some item profile components are set to zero and where the correlation between components are to be estimated.

7. Missing Values

This section describes how to deal with cases where some observations are missing (denoted ⊥)

observations record a customers own assessment of the suitability of some of the items, for example of movies or books. The recommendation task is to predict the suitability of those items the customer has not rated.

observations record whether or not a customer responded favourably to a cross-sell suggestion made by a call center operative. The observation is 0 if the customer didn't take up the offer, 1 if she did and missing if no offer for that item has been made.

One method is to assume that observations are missing at random, by which we mean that we assume that whether or not is missing is independent of the case profile.

7.1.1 Example One (Approach 2)

When defining the likelihood function, omit observations that are missing, or define their probability as equal to something independent of the case profile (for example equal to 1 or to the proportion of observations about that item that are missing).

7.1.2 Latent Trait—Maximum Likelihood Methods

When defining the likelihood function, omit observations that are missing, or define their probability as equal to something independent of the case profile. The programme TWOMISS does this for binary data when some observations are missing at random.

7.1.3 Latent Trait—Assuming an Underlying Linear Factor Model

Modify the procedure for calculating the estimated correlation matrix for the inferred underlying continous variables. When estimating the correlation between the inferred variables underlying observations for items j1 and j2, omit any cases for which either observation is missing. PRELIS will do this automatically if the option for pairwise deletion is specified when estimating the correlation matrix.

7.1.4 PCA

Calculate the covariance matrix using pairwise deletion, as for latent trait above.

7.2 A Step

7.2.1 Bayesian

Ignore missing observations when updating beliefs about a case profile.

7.2.2 Example One (Approach 2)

Omit missing observations from the sample used to fit the case profile to the observations about that case.

7.2.3 PCA

Replace missing observations about item j with the expected value bⱼ₀.

8. Choosing the Set of Free Parameters

So far we have assumed the set of free parameters is fixed at the M Step. A better procedure is to choose the set of free parameters in the light of the data. This is an example of a model selection problem. In choosing the set we need to balance two effects. Increasing the number of parameters will, on the one hand, give the model greater scope to fit complex relationships between the variables and improve its ability to predict behaviour out-of-sample. On the other hand it will also increase the scope for the model to fit idiosyncratic features of the training data which are not seen in out-of-sample cases. This will harm the models ability to make good predictions.

There are many known methods for selecting between models in the light of the data. We describe one example.

8.1 The Akaike Information Criterion

The Akaike Information Criterion (the AIC) is one method for balancing these two effects. The method scores a model according to the likelihood of the data and a penalty term that increases as the number of parameters increases. More precisely, if \hat{θ} is the set of estimated parameters for a model, and p is the number of free parameters, then the AIC is:

2L(\hat{θ})+2p

Models with low values of the AIC are preferred.

8.2 Choosing Q

One example of choosing the set of free parameters is to use the AIC to choose the number of components Q. When designing a rule to choose the number of components we need to trade off accuracy of predictions against speed and intelligability of the resulting model. A simple rule that did this could be:

1. Estimate the model with Q=1, 2, and 3

2. Estimate the AIC for each number of components

3. Select the model with the lowest AIC

Latent Trait Method.

In the latent trait method the free parameters in the B Step are the item profiles. These maximise the likelihood at \hat{B}. Each item profile is a list of Q+1 numbers so that the AIC for Q is:

AIC(Q)=−2L(\hat{B})+2(Q+1)J

The above explains how to find item profiles for given Q using PCA. We also need to choose Q. PCA is a mathematical procedure rather than a statistical model so there is no statistical test that we can use to decide when adding more components will make matters worse rather than better.

One approach is to choose Q as the cutoff between eigenvectors with eigenvalues greater than 1 and those with eigenvalues less than 1. Examples suggest that this can lead to a large number of components being retained. Instead in our example we choose 3 components, as being a good compromise between lots of components, which would lead to more accurate predictions, and fewer components, which are easier for system administrators to visualise.

8.3 Fixing Item Profile Components

One way to reduce the number of free parameters is to fix some of the item profile components, for example to be 0. A process of model selection that allowed item profile components to be fixed would look for item profiles for which:

a large number of individual item profile components are 0

the AIC is low (or out of sample predictions are accurate).

The advantages of this approach are:

it is easier to interpret the item profiles when more item profile components are 0

for the same number of components the AIC will be lower, potentially giving more accurate predictions

it is possible to increase the number of components whilst continuing to reduce the AIC, potentially giving more accurate predictions

The LISREL 8 handbook describes in detail how to estimate models with fixed parameters. It will be clear how to modify the steps to accommodate this.

8.3.1 Initial Values

Schemes for selecting a model will typically require an initial set of parameter restrictions. One method for generating this is to:

1. estimate parameters for the case where no item profile components are restricted.

2. choose a rotation of the item profiles, from amongst those that leave the likelihood unchanged, which gives simple structure

3. fix those item profile components which are small in the resulting model to be zero.

7.3. Selection Bias

In some examples data about some items will record the suitability of the item rather than simply whether the item has been sampled or not. In these cases the suitability is only recorded for those items that have been sampled. If there is a correlation between the suitability of an item, and whether or not it is sampled, then models that fit the observed data may be subject to selection bias. The models will fit suitability conditional on selection, whereas we may want to base predictions on the unconditional suitability.

A known method of dealing with selection bias is described in Moustake (2000). The data in this example is binary, with some missing values, and where values are not missing at random.

An alternative way to think about this is to note that in some cases it is sensible to think that whether or not an observation is missing does depend on the case profile.

One way to deal with selection bias is to specify the estimation function as being a combination of two other functions. The first models whether or not the item has been selected and an observation is present. The second models the observation, unconditional on its being present. Predictions about missing observations (the recommendation function) will be based on this model of unconditional observations.

This method can be implemented using known techniques for correcting for selection bias in the F module (where case profiles are treated as known and the goal is to estimate the item profiles) such as Heckman regression. Preferably all components in the case profiles enter into the model of selection and at least one component of a case profile does not enter into the model of ratings. And the components of the item profile that enter into the selection model are different from those that enter into the model of unconditional observations.

O'Muircheartaigh and Moustaki (99), “Symmetric pattern models: a latent variable approach to item non-response in attitude scales” Journal of the Royal Statistical Society (1999) 162 part 2, pp 177-194, give an example of a method for dealing with this. They suppose that each observation is the result of two random variables, a rating variable using the observation unconditioned on it being present, and a selection variable y^{s} which models whether the observation is present or missing. Both depend on the case profile and are independent conditional on this profile. The distributions are g(y^{r}|aᵢ bⱼ)and h(y^{s}|aᵢ, bⱼ). The authors estimate an example model and predict values for the missing variables—i.e. they show steps M through Y.

A step—use the models for both y^{r} and y^{s} to estimate a user profile

Y step—when making recommendations, we fit the model for y^{r}.

### 10. EXAMPLES

In all of these examples the data is binary, and in most the item model takes the form:

$$\begin{matrix}f ( {y}_{ij} \vert {a}_{i} , {b}_{j} ) = \{ \begin{matrix}{logit}^{- 1} ( {b}_{j0} + {\sum }_{q = 1}^{Q} {a}_{iq} {b}_{jq} ) if {y}_{ij} = 1 \\ 1 - {logit}^{- 1} ( {b}_{j0} + {\sum }_{q = 1}^{Q} {a}_{iq} {b}_{jq} ) otherwise\end{matrix} \\ where \\ {logit}^{- 1} ( x ) = \frac{1}{1 + {ⅇ}^{- x}}\end{matrix}$$

### 10.1 Example 1

This example uses the approach 2 method. For each item the model is

$$f ( {y}_{ij} \vert {a}_{i} , {b}_{j} ) = \{ \begin{matrix}s ( {a}_{i1} {b}_{j1} + {a}_{i2} {b}_{j2} ) if {y}_{ij} = 1 \\ 1 - s ( {a}_{i1} {b}_{j1} + {a}_{i2} {b}_{j2} ) otherwise\end{matrix}$$

where s(x)=max {0, min {1, x}}

We require that the user and object profiles belong to a set of discrete values. This keeps the example simple.

a_{iq}ε{0,0.25,0.50,0.75,1}, i=1, . . . ,4, q=1,2

b_{jq}ε{0,0.25,0.50,0.75,1}, j=1, . . . ,4, q=1,2

### 10.2 Example 2

This example uses binary data, with item models based on the logit function described above. Estimates of the item profiles are made using the latent trait method with full information maximum likelihood estimation. The number of components is fixed to be 2.

Recommendations are made using the Bayesian method. The case history is modified by setting all observations of a 0 to be missing. We used the software package TWOMISS to implement step B. The software is available on a website of the publishers of Bartholomew and Knott (99), arnoldpublishers.com/support/lvmfa2.htm. The program is described in the document latv.pd1 available on the site. This document also contains a detailed description of the model and the EM method of estimation.

### 10.3 Example 3

This example is similar to example 2 but estimates the item profiles by fitting the correlation matrix, and chooses the number of components using the AIC.

### 10.4 Example 4

This is similar to 3 but includes a covariate treated as an item.

### 10.5 Example 5

This example is similar to the above two, but uses the 2 stage method to estimate the item profiles.

### 10.6 Example 6

This example includes a covariate which is treated as an item. This uses the London Attractions dataset, including an additional binary variable which is 1 if the average child age in the family is above 10 and 0 otherwise.

### 10.7 Example 7

This example uses PCA to estimate item profiles and make recommendations.

### 10.8 Example 8

This example illustrates the A step for the Bayesian method if a reduced set of case observations is used.

### 10.9 Example 9

This example imposes restrictions on the item profiles to reflect prior knowledge of the latent variables. This is an extension of the latent variable method II to allow for different parameter restrictions. The example shows how to estimate the β variables from the underlying linear model. The transformation of these to the item profiles of the original binary model is as before.

It will be appreciated that the embodiments of the invention described above are illustrative examples only thereof and that the scope of the invention is limited only by the appended claims.

Appendix A

1.1 The Set of Items

The data in the database example describe visits to a number of London Attractions. There are 20 attractions. These attractions are labelled in various ways in what follows. The labels, and the attraction identities, are:

| | | |
|---|---|---|
| BRIGHTON | Brighton | 1 |
| CHESS | Chessington | 2 |
| NATGAL | National Gallery | 3 |
| HAMPTON | Hampton Court Gardens | 4 |
| SCIENCE | Science Museum | 5 |
| WHIPSNDE | Whipsnade | 6 |
| LEGO | Legoland | 7 |
| EASTBORN | Eastbourne | 8 |
| LONAQUA | London Aquarium | 9 |
| WESTABBY | Westminster Abbey | 10 |
| KEW | Kew Gardens | 11 |
| LONZOO | London Zoo | 12 |
| MADTUS | Madam Tussauds | 13 |
| BRITMUS | British Museum | 14 |
| OXFORD | Oxford | 15 |
| THORPE | Thorpe Park | 16 |
| NATHIST | Natural History Museum | 17 |
| TOWER | Tower of London | 18 |
| WINDSOR | Windsor Castle | 19 |
| WOBORN | Woburn Wildlife Park | 20 |

1.2 The Data Set The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in Appendix A). As an example, this data records that the first user has visited Brighton and the National Gallery, but not Chessington.

Extract begins

| | | | | | | | | | | | | | | | | | | | |
|---|---|---|---|---|---|---|---|---|---|---|---|---|---|---|---|---|---|---|---|
| 1 | 0 | 1 | 1 | 1 | 0 | 0 | 0 | 1 | 1 | 1 | 1 | 1 | 1 | 1 | 0 | 1 | 1 | 1 | 0 |
| 1 | 1 | 1 | 1 | 1 | 0 | 1 | 1 | 1 | 1 | 1 | 1 | 1 | 1 | 0 | 1 | 1 | 1 | 1 | 0 |
| 0 | 1 | 1 | 1 | 1 | 0 | 1 | 0 | 0 | 1 | 1 | 1 | 1 | 1 | 1 | 1 | 1 | 1 | 1 | 0 |
| 0 | 0 | 1 | 1 | 1 | 0 | 1 | 0 | 1 | 1 | 1 | 1 | 1 | 1 | 1 | 0 | 1 | 1 | 1 | 0 |
| 0 | 0 | 1 | 0 | 1 | 0 | 0 | 0 | 1 | 1 | 1 | 0 | 0 | 1 | 0 | 0 | 1 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 |
| 0 | 1 | 1 | 1 | 1 | 1 | 0 | 1 | 1 | 1 | 0 | 1 | 0 | 1 | 0 | 0 | 1 | 1 | 1 | 0 |
| 1 | 1 | 0 | 1 | 1 | 1 | 1 | 0 | 0 | 1 | 1 | 1 | 0 | 1 | 0 | 1 | 1 | 0 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 |
| 0 | 1 | 1 | 1 | 1 | 0 | 0 | 0 | 0 | 0 | 1 | 0 | 0 | 1 | 0 | 0 | 1 | 1 | 1 | 0 |

Extract ends

2.1 Derive Pseudo-Item Profiles

To derive the item profiles from the data the program S-PLUS was used. Three versions of their factor analysis function were run, specifying 1, 2 and 3 factors respectively. The following gives the S-PLUS call and the output for the 2 factor version. These factors are standardised.

Extract starts

> round(unclass(factanal(Dom.x[1:500,], factors = 2)$load), 3)

| | Factor1 | Factor2 |
|---|---|---|
| bright | 0.079 | 0.043 |
| chess | −0.061 | 0.354 |
| natgal | 0.385 | −0.087 |
| hampt | 0.241 | 0.006 |
| science | 0.332 | 0.064 |
| whip | 0.229 | 0.091 |
| lego | 0.065 | 0.165 |
| east | 0.121 | 0.025 |
| lonaqu | 0.216 | −0.001 |
| westab | 0.259 | −0.051 |
| kew | 0.377 | 0.055 |
| lonzoo | 0.237 | 0.140 |
| madamt | 0.256 | 0.090 |
| britm | 0.476 | 0.017 |
| oxford | 0.369 | 0.066 |
| thorpe | −0.008 | 0.997 |
| nathist | 0.345 | 0.043 |
| tower | 0.425 | 0.003 |
| wind | 0.338 | 0.048 |
| woburn | 0.191 | 0.129 |

Extract ends

These factor loadings are taken as the item profiles. Because the loadings are standardised, there is no b₀. For example the item profile for Woburn is (b₁, b₂)=(0.191, 0.129).

2.2 Generate Estimates of the User Profiles

For each user we used these factor loadings to generate an estimated user profile. Component q in the profile is equal to the sum of each observation multiplied by component q in the relevant item profile: i.e.

$${α}_{iq} = {\sum }_{j}^{} {h}_{i}^{j} {b}_{q}^{j} .$$

These are available automatically from S-PLUS using the score parameter. The following shows S-PLUS call and the resulting scores for the first 5 users in the database.

Extract begins

> factanal(Dom.x[1:500,], scores = 'reg', factors = 2)$scores[1:5,]

| | Factor1 | Factor2 |
|---|---|---|
| 1 | −0.1661745 | −0.6675610 |
| 2 | −0.6143931 | −0.6655715 |
| 3 | −0.7493019 | −0.6639595 |
| 4 | −0.5263396 | −0.6660611 |
| 5 | −0.3366707 | −0.6651219 |

Extract ends

2.3 Generate Item Profiles

These estimated user profiles the item profiles were generated. A logit regression function in S-PLUS, grim, was called specifying the user profiles as the independent variables. An example for Brighton is shown.

Extract begins

Call: glm(formula = bright ˜ f1 + f2, family = binomial ( ),
data = big.dog2)

| Coefficients: | | | |
|---|---|---|---|
| (Intercept) | f1 | f2 | |
| −0.66083 | 0.24780 | 0.09124 | |
| Degrees of Freedom: 499 Total (i.e. Null); 497 Residual | | | |
| Null Deviance: | 642.4 | | |
| Residual Deviance: | 636.8 | AIC: | 642.8 |

Extract ends

The results gives the item profile for Brighton as (b₀, b₁, b₂)=(−0.661, 0.248, 0.091). The full set of results are shown below. In this table the components are listed in the order (1,2,0).

Extract begins

| | | | |
|---|---|---|---|
| | [,1] | [,2] | [,3] |
| [1,] | 0.24779997 | 0.091235765 | −0.66082865 |
| [2,] | −0.21544381 | 0.754903543 | −0.18170548 |
| [3,] | 1.53636908 | −0.424177397 | −1.75295313 |
| [4,] | 0.80029653 | −0.001894496 | −1.05189359 |
| [5,] | 1.50012265 | 0.194537695 | 0.06676404 |
| [6,] | 0.77903453 | 0.221078866 | −1.65736390 |
| [7,] | 0.20997573 | 0.338806740 | −0.08729226 |
| [8,] | 0.51292535 | 0.066094474 | −2.41805007 |
| [9,] | 0.70743844 | −0.012873143 | −0.91289761 |
| [10,] | 1.06350153 | −0.321008989 | −2.69301485 |
| [11,] | 1.40188843 | 0.111778939 | −1.61679712 |
| [12,] | 0.89624918 | 0.328477350 | −0.05714305 |
| [13,] | 0.86897447 | 0.217827415 | −1.59056044 |
| [14,] | 2.09201506 | −0.098552427 | −2.34406098 |
| [15,] | 1.42967216 | 0.145618309 | −2.61659654 |
| [16,] | −0.09497242 | 10.697211868 | −4.48776360 |
| [17,] | 1.44575482 | 0.123545459 | −0.25139096 |
| [18,] | 1.73629559 | −0.067640956 | −1.44709209 |
| [19,] | 1.23460197 | 0.088305200 | −2.07386916 |
| [20,] | 0.75330360 | 0.410859138 | −2.63379257 |

Extract ends

2.4 Choose the Number of Components.

The steps above were performed for 1, 2 and 3 components respectively, and the AIC was compared in each case. The AIC was calculated as the sum of the AIC for the logit regressions. The results were:

| | |
|---|---|
| 1 | 10348.77 |
| 2 | 10276.46 |
| 3 | 10370.49 |

The lowest value of the AIC is for 2 components (where the constant term b₀ is not included as a component), and this model is used to make recommendations.

Once the item profiles have been generated they are used to make recommendations in the on-line recommendation engine. The following gives an example for a single user. The routines to implement the steps were written in S-Plus, a widely available statistical package.

3.1 User History

The information set on which recommendations are based gives the visiting history of the user. This is:

| bright | chess | natgal | hampt | science | whip | lego | east | lonaqu | westab | kew |
|---|---|---|---|---|---|---|---|---|---|---|
| 0 | 0 | 1 | 1 | 1 | 0 | 0 | 0 | 0 | 0 | 0 |
| lonzoo | madamt | britm | oxford | thorpe | nathist | tower | wind | woburn | | |
| 0 | 0 | 0 | 0 | 0 | 0 | 0 | 0 | 0 | | |

3.2 Prior Distribution Over Possible User Profiles

This history is used to update a prior distribution over possible user profiles. The first task is to specify the possible profiles. Each possible profile requires two numbers. In this example the possible profiles are:

| | [,1] | [,2] |
|---|---|---|
| [1,] | −2 | −2 |
| [2,] | −2 | −1 |
| [3,] | −2 | 0 |
| [4,] | −2 | 1 |
| [5,] | −2 | 2 |
| [6,] | −1 | −2 |
| [7,] | −1 | −1 |
| [8,] | −1 | 0 |
| [9,] | −1 | 1 |
| [10,] | −1 | 2 |
| [11,] | 0 | −2 |
| [12,] | 0 | −1 |
| [13,] | 0 | 0 |
| [14,] | 0 | 1 |
| [15,] | 0 | 2 |
| [16,] | 1 | −2 |
| [17,] | 1 | −1 |
| [18,] | 1 | 0 |
| [19,] | 1 | 1 |
| [20,] | 1 | 2 |
| [21,] | 2 | −2 |
| [22,] | 2 | −1 |
| [23,] | 2 | 0 |
| [24,] | 2 | 1 |
| [25,] | 2 | 2 |

The probability of each possible profile that is assumed in the prior distribution is then specified. Here a binomial approximation is used having a sample size of 4. (The following should be read as: the probability of the first profile is 0.0039, the probability of the second is 0.0156, the probability of the third is 0.234 and so on).

| | | | | | |
|---|---|---|---|---|---|
| [1] | 0.00390625 | 0.01562500 | 0.02343750 | 0.01562500 | 0.00390625 |
| [6] | 0.01562500 | 0.06250000 | 0.09375000 | 0.06250000 | 0.01562500 |
| [11] | 0.02343750 | 0.09375000 | 0.14062500 | 0.09375000 | 0.02343750 |
| [16] | 0.01562500 | 0.06250000 | 0.09375000 | 0.06250000 | 0.01562500 |
| [21] | 0.00390625 | 0.01562500 | 0.02343750 | 0.01562500 | 0.00390625 |

3.3 Posterior Distribution Over Possible User Profiles

Having specified the prior distribution, the likelihood of each profile is updated using Bayesian updating in the light of the user's visiting history. In doing so non-visits are treated as missing data.

| | | | | | |
|---|---|---|---|---|---|
| [1] | 3.922150e−04 | 8.512675e−04 | 5.726658e−04 | 2.415706e−07 | 4.340733e−13 |
| [6] | 3.134620e−02 | 6.494663e−02 | 4.081062e−02 | 1.708743e−05 | 2.670556e−11 |
| [11] | 2.021309e−01 | 3.856605e−01 | 2.137281e−01 | 8.269622e−05 | 1.037207e−10 |
| [16] | 1.588965e−02 | 2.881321e−02 | 1.474086e−02 | 5.554259e−06 | 5.891024e−12 |
| [21] | 3.318585e−06 | 5.536305e−06 | 2.669398e−06 | 1.052816e−09 | 1.057896e−15 |

3.4 Probability of a Visit

This posterior distribution over possible user profiles is then used to work out the likelihood of a visit to each attraction. The probability of a visit to Brighton, say, is calculated by working out, for each possible profile, what the probability of visiting Brighton is, and then weighting each of these using the probability that the user's profile is the relevant one. The result is:

| | | | | | | |
|---|---|---|---|---|---|---|
| [1] | 0.4120460 | 0.3744845 | 0.5589836 | 0.4939777 | 0.8384324 | 0.3434113 |
| [7] | 0.5307790 | 0.1500989 | 0.4989128 | 0.2402854 | 0.5357991 | 0.7198547 |
| [13] | 0.3845266 | 0.5670006 | 0.3378800 | 0.2552298 | 0.7929130 | 0.6537655 |
| [19] | 0.3924300 | 0.1675236 | | | | |

3.5 Make a Recommendation

The recommended attraction is that one with the highest probability of a visit, but which has not yet been visited. The attraction with the highest probability of a visit is number 5, the science museum. The user has already visited this, however and it is not recommended. The recommendation is item 17, the Natural History museum. The expected probability is 0.793

Appendix B

1.1 The Set of Items

The data in the example describe visits to a number of London Attractions. There are 20 attractions.

1.2 Create Different Sets of Item

The attractions were divided into two classes, one for outdoor attractions and one for indoor attractions since it might be thought that people look for different things when visiting attractions in the different classes. Outdoor ones are labelled “o” and indoor ones labelled “i”. The labels, and the attraction identities, are:

| | | | |
|---|---|---|---|
| BRIGHTON | Brighton | 1 | o |
| CHESS | Chessington | 2 | o |
| NATGAL | National Gallery | 3 | i |
| HAMPTON | Hampton Court Gardens | 4 | o |
| SCIENCE | Science Museum | 5 | i |
| WHIPSNDE | Whipsnade | 6 | o |
| LEGO | Legoland | 7 | o |
| EASTBORN | Eastbourne | 8 | o |
| LONAQUA | London Aquarium | 9 | i |
| WESTABBY | Westminster Abbey | 10 | i |
| KEW | Kew Gardens | 11 | o |
| LONZOO | London Zoo | 12 | o |
| MADTUS | Madam Tussauds | 13 | i |
| BRITMUS | British Museum | 14 | i |
| OXFORD | Oxford | 15 | o |
| THORPE | Thorpe Park | 16 | o |
| NATHIST | Natural History Museum | 17 | i |
| TOWER | Tower of London | 18 | i |
| WINDSOR | Windsor Castle | 19 | o |
| WOBORN | Woburn Wildlife Park | 20 | o |

1.3 The Data Set

The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in an appendix). As an example, this data records that the first user has visited Brighton and the National Gallery, but not Chessington.

Extract begins

| | | | | | | | | | | | | | | | | | | | |
|---|---|---|---|---|---|---|---|---|---|---|---|---|---|---|---|---|---|---|---|
| 1 | 0 | 1 | 1 | 1 | 0 | 0 | 0 | 1 | 1 | 1 | 1 | 1 | 1 | 1 | 0 | 1 | 1 | 1 | 0 |
| 1 | 1 | 1 | 1 | 1 | 0 | 1 | 1 | 1 | 1 | 1 | 1 | 1 | 1 | 0 | 1 | 1 | 1 | 1 | 0 |
| 0 | 1 | 1 | 1 | 1 | 0 | 1 | 0 | 0 | 1 | 1 | 1 | 1 | 1 | 1 | 1 | 1 | 1 | 1 | 0 |
| 0 | 0 | 1 | 1 | 1 | 0 | 1 | 0 | 1 | 1 | 1 | 1 | 1 | 1 | 1 | 0 | 1 | 1 | 1 | 0 |
| 0 | 0 | 1 | 0 | 1 | 0 | 0 | 0 | 1 | 1 | 1 | 0 | 0 | 1 | 0 | 0 | 1 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 |
| 0 | 1 | 1 | 1 | 1 | 1 | 0 | 1 | 1 | 1 | 0 | 1 | 0 | 1 | 0 | 0 | 1 | 1 | 1 | 0 |
| 1 | 1 | 0 | 1 | 1 | 1 | 1 | 0 | 0 | 1 | 1 | 1 | 0 | 1 | 0 | 1 | 1 | 0 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 |
| 0 | 1 | 1 | 1 | 1 | 0 | 0 | 0 | 0 | 0 | 1 | 0 | 0 | 1 | 0 | 0 | 1 | 1 | 1 | 0 |

Extract ends

2.1 Derive Pseudo-Item Profiles for Each Class Separately

For each class the pseudo-item profiles were derived using a factor analysis call in S-PLUS specifying 2 factors. The following gives the results for the outdoor attractions. In this view only factor loadings that are above a minimum threshold have been shown.

Extract starts

| | Factor1 | Factor2 |
|---|---|---|
| bright | | |
| chess | 0.335 | |
| hampt | | 0.342 |
| whip | | 0.180 |
| lego | 0.136 | 0.177 |
| east | | |
| kew | | 0.449 |
| lonzoo | 0.127 | 0.205 |
| oxford | | 0.421 |
| thorpe | 0.995 | |
| wind | | 0.423 |
| woburn | | 0.118 |

Extract ends

These factor loadings are taken as the item profiles. Because the loadings are standardised, there is no b₀. For example the item profile for Woburn is (b₁, b₂)=(0,0.118).

Pseudo-item profiles for the indoor attractions were derived in a similar way to give:

Extract begins

| | Factor1 | Factor2 |
|---|---|---|
| natgal | 0.286 | 0.314 |
| science | 0.632 | |
| lonaqu | 0.218 | |
| westab | | 0.427 |
| madamt | | 0.295 |
| britm | 0.321 | 0.439 |
| nathist | 0.500 | 0.131 |
| tower | 0.132 | 0.436 |

Extract ends

2.2 Generate Estimates of the User Profiles

For each user these factor loadings were used to generate an estimated user profile for each group separately. Component q in the profile is equal to the sum of each observation multiplied by component q in the relevant item profile: i.e.

$${α}_{iq} = {\sum }_{j}^{} {h}_{i}^{j} {b}_{q}^{j} .$$

These are available automatically from S-PLUS using the score parameter. The following shows S-PLUS call and the resulting scores for the first 5 users in the database for the outdoor attractions.

Extract begins

| > factanal(Dom.x[1:500, air = = ‘o’], scores = ‘reg’, | | |
|---|---|---|
| factors=2)$scores | | |
| | Factor1 | Factor2 |
| 1 | −0.62325S2 | −0.36748994 |
| 2 | −0.6089289 | −0.44638126 |
| 3 | −0.6333564 | −0.23152621 |
| 4 | −0.6208385 | −0.36168293 |
| 5 | −0.6822305 | 0.10715258 |

Extract ends

User profiles in respect of the indoor attractions were calculated in a similar manner. The total user profile combines the two. It has four components, two from the indoor attractions and two from the outdoor ones.

2.1 Generate Item Profiles

Using these estimated user profiles the item profiles were generated. A logit regression function in S-PLUS, grim, was called specifying the user profiles as the independent variables. The full set of results are shown below. In this table the components are listed in the order (1,2,3,4,0).

Extract begins

> matrix(unlist(lapply(dimnames(Dom.x)[[2]], do.in.out)),
ncol = 5)

| | [,1] | [,2] | [,3] | [,4] | [,5] |
|---|---|---|---|---|---|
| [1,] | −0.66497682 | 0.06631292 | −0.94866420 | −1.6587867149 | −0.443933558 |
| [2,] | −0.14224857 | 8.61834093 | 0.84786846 | 0.1258775729 | 3.421769372 |
| [3,] | 0.16070782 | −1.44241195 | −0.04910719 | 1.3299388583 | 0.264559297 |
| [4,] | 0.05639791 | 0.11898905 | −0.08425662 | 0.2725675719 | 0.004498342 |
| [5,] | 0.33026646 | 0.20881792 | 0.26471087 | −0.0338485436 | −0.236691297 |
| [6,] | −0.18430768 | −1.72651454 | −6.92681004 | −3.2661175617 | −1.591378576 |
| [7,] | −0.12763604 | 0.20989516 | −3.23738624 | 2.0482587025 | 0.073698981 |
| [8,] | 0.16046396 | −0.22394473 | 6.31290092 | 3.5461147033 | 2.690590592 |
| [9,] | 0.80989483 | 0.06323751 | −0.37184738 | 0.0014233164 | −0.002682853 |
| [10,] | −0.25525493 | 1.17491048 | 0.62420648 | −0.6601784440 | 0.371846177 |
| [11,] | −1.83613752 | −0.08602790 | −2.00233330 | −3.3374396600 | −2.655359233 |
| [12,] | 1.21738255 | 0.03825106 | 0.07490919 | −0.6161212026 | −0.819341155 |
| [13,] | 1.21257946 | −0.49036764 | −0.34287230 | 0.0660361639 | 0.285405279 |
| [14,] | −0.46608714 | 0.23134578 | −0.28247497 | −0.1965370782 | −0.224963948 |
| [15,] | 0.05155804 | 0.95326279 | 2.89985604 | 2.9202511713 | 2.699170241 |
| [16,] | −1.14495536 | −2.42700804 | −0.06364561 | −4.4877205744 | −2.755308580 |
| [17,] | 0.10751957 | −0.14824210 | 0.44152766 | −0.0002659749 | 0.018338347 |
| [18,] | −0.29253927 | 0.30650048 | −0.05671760 | 0.0001933553 | −0.209695788 |
| [19,] | −0.22787088 | 0.01015998 | 0.18361485 | 10.6113818822 | 0.262801694 |
| [20,] | 1.55867871 | 0.50430103 | 0.93072996 | 1.3554356391 | 1.267106002 |

Extract ends

Appendix C

1.1 The Set of Items

The data in the example describe visits to a number of London Attractions. There are 20 attractions. The data also includes an additional binary variable which records whether or not the user's children have an average age of 10 and above, or not (all users are assumed to have school age children). These attractions and the child-age variable are labelled in various ways in what follows. The labels, and the attraction identities, are:

| | | |
|---|---|---|
| BRIGHTON | Brighton | 1 |
| CHESS | Chessington | 2 |
| NATGAL | National Gallery | 3 |
| HAMPTON | Hampton Court Gardens | 4 |
| SCIENCE | Science Museum | 5 |
| WHIPSNDE | Whipsnade | 6 |
| LEGO | Legoland | 7 |
| EASTBORN | Eastbourne | 8 |
| LONAQUA | London Aquarium | 9 |
| WESTABBY | Westminster Abbey | 10 |
| KEW | Kew Gardens | 11 |
| LONZOO | London Zoo | 12 |
| MADTUS | Madam Tussauds | 13 |
| BRITMUS | British Museum | 14 |
| OXFORD | Oxford | 15 |
| THORPE | Thorpe Park | 16 |
| NATHIST | Natural History Museum | 17 |
| TOWER | Tower of London | 18 |
| WINDSOR | Windsor Castle | 19 |
| WOBORN | Woburn Wildlife Park | 20 |
| CH.10 | Average age of child- | 21 |
| | ren is 10 or more | |

1.2 The Data Set

The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in Appendix B). As an example, this data records that the first user has visited Brighton and the National Gallery, but not Chessington.

Extract begins

| | | | | | | | | | | | | | | | | | | | | |
|---|---|---|---|---|---|---|---|---|---|---|---|---|---|---|---|---|---|---|---|---|
| 0 | 0 | 1 | 1 | 1 | 0 | 0 | 0 | 0 | 0 | 0 | 0 | 0 | 0 | 0 | 0 | 0 | 0 | 0 | 0 | 0 |
| 0 | 1 | 0 | 1 | 1 | 0 | 0 | 0 | 0 | 0 | 0 | 0 | 0 | 0 | 0 | 0 | 0 | 0 | 0 | 0 | 0 |
| 1 | 1 | 0 | 0 | 0 | 1 | 1 | 0 | 0 | 0 | 0 | 0 | 0 | 0 | 0 | 0 | 0 | 0 | 0 | 0 | 0 |
| 0 | 0 | 0 | 0 | 0 | 0 | 1 | 0 | 0 | 0 | 0 | 1 | 0 | 0 | 0 | 0 | 1 | 0 | 0 | 0 | 0 |
| 0 | 0 | 0 | 0 | 1 | 0 | 1 | 0 | 0 | 0 | 1 | 0 | 0 | 0 | 0 | 0 | 0 | 0 | 0 | 0 | 0 |
| 0 | 0 | 0 | 1 | 0 | 0 | 0 | 0 | 0 | 0 | 0 | 0 | 0 | 1 | 1 | 0 | 0 | 0 | 0 | 0 | 0 |
| 0 | 1 | 1 | 1 | 1 | 0 | 0 | 0 | 0 | 0 | 0 | 0 | 0 | 0 | 0 | 0 | 0 | 0 | 0 | 0 | 1 |
| 0 | 0 | 0 | 0 | 0 | 0 | 1 | 0 | 1 | 0 | 0 | 0 | 0 | 0 | 0 | 0 | 1 | 0 | 0 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 0 |
| 1 | 0 | 1 | 0 | 0 | 0 | 0 | 0 | 0 | 1 | 0 | 0 | 0 | 0 | 0 | 0 | 0 | 0 | 0 | 0 | 0 |

Extract ends

2.1 Derive Pseudo-Item Profiles

The pseudo-item profiles were derived using a factor analysis call in S-PLUS specifying 2 factors. Only the data on attractions, and not on average child age, was used in the factor analysis.

The following gives the resulting standardised factor loadings.

Extract starts

| > factanal(Dom.x[1:500,], factors = 2) $load | | |
|---|---|---|
| Loadings: | | |
| | Factor1 | Factor2 |
| bright | | |
| chess | | 0.354 |
| natgal | 0.385 | |
| hampt | 0.241 | |
| science | 0.332 | |
| whip | 0.229 | |
| lego | | 0.165 |
| east | 0.121 | |
| lonaqu | 0.216 | |
| westab | 0.259 | |
| kew | 0.377 | |
| lonzoo | 0.237 | 0.140 |
| madamt | 0.256 | |
| britm | 0.476 | |
| oxford | 0.369 | |
| thorpe | | 0.997 |
| nathist | 0.345 | |
| tower | 0.425 | |
| wind | 0.338 | |
| woburn | 0.191 | 0.129 |

Extract ends

These factor loadings are taken as the item profiles. Because the loadings are standardised, there is no b₀. For example the item profile for Woburn is (b₁, b₂)=(0.191, 0.129).

2.2 Generate Estimates of the User Profiles

For each user these factor loadings were used to generate an estimated user profile for each group separately. Component q in the profile is equal to the sum of each observation multiplied by component q in the relevant item profile: i,e.

$${α}_{iq} = {\sum }_{j}^{} {h}_{i}^{j} {b}_{q}^{j}$$

These are available automatically from S-PLUS using the score parameter. The following shows S-PLUS call and the resulting scores for the first 5 users in the database for the outdoor attractions.

Extract begins

| > factanal(Dom.x[1:500,], scores = ‘reg’, | | |
|---|---|---|
| factors = 2)$scores[1:5,] | | |
| | Factor1 | Factor2 |
| 1 | −0.1661745 | −0.6675610 |
| 2 | −0.6143931 | −0.6655715 |
| 3 | −0.7493019 | −0.6639595 |
| 4 | −0.5263396 | −0.6660611 |
| 5 | −0.3366707 | −0.6651219 |

Extract ends

2.3 Generate Item Profiles

Using these estimated user profiles the item profiles were generated. A logit regression function in S-PLUS, glim, was called specifying the user profiles as two of the independent variables. Average child age was also specified as a third independent variable. This means that the logit regressions yield 4 parameter estimates each. One is the constant terms b₀. Two relate the user profile derived via the pseudo-item profiles of the attractions, and one relates to the average child age variable. The full results are:

Extract begins

| | | | | |
|---|---|---|---|---|
| [1,] | 0.2461899 | 0.08957790 | 0.025417992 | −0.66819314 |
| [2,] | −0.3047198 | 0.72615861 | 1.150155164 | −0.51824073 |
| [3,] | 1.5229507 | −0.45950123 | 0.446952740 | −1.89215801 |
| [4,] | 0.8353290 | 0.02789901 | −0.467996396 | −0.92878458 |
| [5,] | 1.5013147 | 0.19678912 | −0.042031655 | 0.07848287 |
| [6,] | 0.7973976 | 0.23770797 | −0.238861189 | −1.59388460 |
| [7,] | 0.2470988 | 0.38253475 | −0.592481225 | 0.08158206 |
| [8,] | 0.5837931 | 0.12096454 | −0.769423312 | −2.24451270 |
| [9,] | 0.7443689 | 0.01839470 | −0.494524151 | −0.78180470 |
| [10,] | 1.0643638 | −0.32004482 | −0.010331299 | −2.69010465 |
| [11,] | 1.4131604 | 0.12360087 | −0.185885413 | −1.56747270 |
| [12,] | 0.9490218 | 0.38215384 | −0.782284912 | 0.16017343 |
| [13,] | 0.8383658 | 0.16192526 | 0.852735719 | −1.87539562 |
| [14,] | 2.0868181 | −0.12670931 | 0.403985870 | −2.46859509 |
| [15,] | 1.4829560 | 0.18784714 | −0.563594639 | −2.49006514 |
| [16,] | −0.0946940 | 10.69750731 | −0.004585096 | −4.48642779 |
| [17,] | 1.4456744 | 0.12339996 | 0.002653749 | −0.25213316 |
| [18,] | 1.7506924 | −0.12216716 | 0.843728615 | −1.72089561 |
| [19,] | 1.2426287 | 0.09639704 | −0.113571691 | −2.04350959 |
| [20,] | 0.7927236 | 0.44133683 | −0.391512108 | −2.53944885 |

Extract ends

Appendix D

User Histories

>h1.20

| | [,1] | [,2] | [,3] | [,4] | [,5] |
|---|---|---|---|---|---|
| [1,] | 1 | 0 | 1 | 0 | 0 |
| [2,] | 1 | 0 | 0 | 0 | 0 |
| [3,] | 1 | 0 | 1 | 0 | 0 |
| [4,] | 1 | 1 | 1 | 0 | 0 |
| [5,] | 1 | 0 | 1 | 0 | 0 |
| [6,] | 1 | 0 | 1 | 0 | 1 |
| [7,] | 0 | 0 | 1 | 0 | 1 |
| [8,] | 0 | 1 | 1 | 0 | 1 |
| [9,] | 0 | 1 | 1 | 1 | 1 |
| [10,] | 0 | 1 | 1 | 0 | 1 |
| [11,] | 1 | 1 | 1 | 0 | 0 |
| [12,] | 1 | 0 | 0 | 0 | 0 |
| [13,] | 1 | 1 | 1 | 0 | 0 |
| [14,] | 1 | 1 | 1 | 0 | 0 |
| [15,] | 1 | 0 | 1 | 0 | 0 |
| [16,] | 1 | 0 | 0 | 1 | 1 |
| [17,] | 1 | 0 | 0 | 1 | 1 |
| [18,] | 1 | 0 | 0 | 0 | 1 |
| [19,] | 1 | 0 | 0 | 1 | 1 |
| [20,] | 1 | 0 | 1 | 1 | 1 |

Further examples are described below:

### Example 1

>ex.1_ab(h1.20, to1=0.01, lambda=0.5, mu=0.75)

Predicted User Histories

>H(ex.1$a.prime, ex.1$b.prime)

| | [,1] | [,2] | [,3] | [,4] | [,5] |
|---|---|---|---|---|---|
| [1,] | 1 | 0 | 1 | 0 | 0 |
| [2,] | 0 | 0 | 0 | 0 | 0 |
| [3,] | 1 | 0 | 1 | 0 | 0 |
| [4,] | 1 | 1 | 1 | 0 | 0 |
| [5,] | 1 | 0 | 1 | 0 | 0 |
| [6,] | 1 | 1 | 1 | 0 | 1 |
| [7,] | 1 | 0 | 0 | 0 | 0 |
| [8,] | 1 | 0 | 1 | 0 | 0 |
| [9,] | 1 | 0 | 1 | 1 | 1 |
| [10,] | 1 | 0 | 1 | 0 | 0 |
| [11,] | 1 | 1 | 1 | 0 | 0 |
| [12,] | 0 | 0 | 0 | 0 | 0 |
| [13,] | 1 | 1 | 1 | 0 | 0 |
| [14,] | 1 | 1 | 1 | 0 | 0 |
| [15,] | 1 | 0 | 1 | 0 | 0 |
| [16,] | 1 | 0 | 0 | 1 | 1 |
| [17,] | 1 | 0 | 0 | 1 | 1 |
| [18,] | 1 | 0 | 0 | 0 | 1 |
| [19,] | 1 | 0 | 0 | 1 | 1 |
| [20,] | 1 | 0 | 1 | 1 | 1 |

Prediction Errors

>sum(H(ex.1$a.prime, ex.1$b.prime)==1 & h1.20==0)

[1]5

>sum(H(ex.1$a.prime, ex.1$b.prime)==0 & h1.20==1)

[1]9

Normalised Log-Likelihood

>ex.1$norm.log.lik

[1]—0.3921817

Likelihood of the User Histories

>Phi(h1.20, ex.1$a.prime, ex.1$b.prime)

| | [,1] | [,2] | [,3] | [,4] | [,5] |
|---|---|---|---|---|---|
| [1,] | 0.8250856 | 0.5240304 | 0.8350231 | 0.8807971 | 0.7421196 |
| [2,] | 0.4134032 | 0.7579803 | 0.5907615 | 0.8716424 | 0.8161381 |
| [3,] | 0.8250856 | 0.5240304 | 0.8350231 | 0.8807971 | 0.7421196 |
| [4,] | 0.8737172 | 0.5256501 | 0.8807972 | 0.8785969 | 0.7186375 |
| [5,] | 0.8250856 | 0.5240304 | 0.8350231 | 0.8807971 | 0.7421196 |
| [6,] | 0.9347387 | 0.4743499 | 0.8808021 | 0.6736149 | 0.5785726 |
| [7,] | 0.3938034 | 0.7258131 | 0.4882028 | 0.7519964 | 0.3541521 |
| [8,] | 0.2115889 | 0.4070667 | 0.7482299 | 0.8185183 | 0.3313691 |
| [9,] | 0.1343897 | 0.2969896 | 0.5412996 | 0.7308824 | 0.8267741 |
| [10,] | 0.2115888 | 0.4070667 | 0.7482300 | 0.8185183 | 0.3313691 |
| [11,] | 0.8737172 | 0.5256501 | 0.8807972 | 0.8785969 | 0.7186374 |
| [12,] | 0.4134032 | 0.7579803 | 0.5907615 | 0.8716424 | 0.8161381 |
| [13,] | 0.8737172 | 0.5256501 | 0.8807972 | 0.8785969 | 0.7186375 |
| [14,] | 0.8737172 | 0.5256501 | 0.8807972 | 0.8785969 | 0.7186374 |
| [15,] | 0.8250857 | 0.5240304 | 0.8350231 | 0.8807971 | 0.7421196 |
| [16,] | 0.7457234 | 0.8312700 | 0.7736004 | 0.8807971 | 0.9003190 |
| [17,] | 0.7457234 | 0.8312700 | 0.7736004 | 0.8807971 | 0.9003190 |
| [18,] | 0.6643145 | 0.7610495 | 0.5984503 | 0.5202947 | 0.5831247 |
| [19,] | 0.7457234 | 0.8312700 | 0.7736004 | 0.8807971 | 0.9003190 |
| [20,] | 0.9758719 | 0.5418934 | 0.8153668 | 0.8738971 | 0.9449713 |

Parameter Values—User Profiles

>ex.1$a.prime

| | [,1] | [,2] |
|---|---|---|
| [1,] | 0.9054134 | 0.000000000 |
| [2,] | 0.4082206 | 0.021110260 |
| [3,] | 0.9054134 | 0.000000000 |
| [4,] | 1.0000000 | 0.005197485 |
| [5,] | 0.9054134 | 0.000000000 |
| [6,] | 1.0000000 | 0.318854833 |
| [7,] | 0.4881923 | 0.222677935 |
| [8,] | 0.7722939 | 0.123414736 |
| [9,] | 0.5413661 | 0.749776003 |
| [10,] | 0.7722940 | 0.123414730 |
| [11,] | 1.0000000 | 0.005197531 |
| [12,] | 0.4082206 | 0.021110260 |
| [13,] | 1.0000000 | 0.005197486 |
| [14,] | 1.0000000 | 0.005197531 |
| [15,] | 0.9054135 | 0.000000000 |
| [16,] | 0.1927744 | 1.000000000 |
| [17,] | 0.1927744 | 1.000000000 |
| [18,] | 0.4002291 | 0.479694159 |
| [19,] | 0.1927745 | 1.000000000 |
| [20,] | 0.8712802 | 0.983966045 |

Parameter Values—Object Profiles

>ex.1$b.prime

| | [,1] | [,2] |
|---|---|---|
| [1,] | 0.9805440 | 0.5799592265 |
| [2,] | 0.5256726 | 0.0000000000 |
| [3,] | 1.0000000 | 0.0000371357 |
| [4,] | 0.0000000 | 1.0000000000 |
| [5,] | 0.2603743 | 1.0000000000 |

Recommendation for User with Current History c(0,1,1,0,0)

Calculate user profile

>a.only(c(0,1,1,0,0), ex.1$h.prime)$a.prime

[1]0.6601747 0.0000000

Make Recommendation

>R(c(0,1,1,0,0), a.only(c(0,1,1,0,0), ex.1$b.prime)$a.prime, ex. 1$b.prime) $recommend

[1]1

### Example 2

>ex.2_ab(h1.20, to1=0.01, lambda=0.5, mu=0.75)

Predicted User Histories

>H(ex.2$a.prime, ex.2$h.prime)

| | [,1] | [,2] | [,3] | [,4] | [,5] |
|---|---|---|---|---|---|
| [1,] | 1 | 0 | 1 | 0 | 0 |
| [2,] | 0 | 0 | 0 | 0 | 0 |
| [3,] | 1 | 0 | 1 | 0 | 0 |
| [4,] | 1 | 1 | 1 | 0 | 0 |
| [5,] | 1 | 0 | 1 | 0 | 0 |
| [6,] | 1 | 1 | 1 | 0 | 1 |
| [7,] | 1 | 0 | 0 | 0 | 0 |
| [8,] | 1 | 0 | 1 | 0 | 0 |
| [9,] | 1 | 0 | 1 | 1 | 1 |
| [10,] | 1 | 0 | 1 | 0 | 0 |
| [11,] | 1 | 1 | 1 | 0 | 0 |
| [12,] | 0 | 0 | 0 | 0 | 0 |
| [13,] | 1 | 1 | 1 | 0 | 0 |
| [14,] | 1 | 1 | 1 | 0 | 0 |
| [15,] | 1 | 0 | 1 | 0 | 0 |
| [16,] | 1 | 0 | 0 | 1 | 1 |
| [17,] | 1 | 0 | 0 | 1 | 1 |
| [18,] | 1 | 0 | 0 | 0 | 1 |
| [19,] | 1 | 0 | 0 | 1 | 1 |
| [20,] | 1 | 0 | 1 | 1 | 1 |

Prediction Errors

>sum(H(ex.2$a.prime, ex.2$b.prime)==1 & h1.20==0)

[1]6

>sum(H(ex.2$a.prime, ex.2$b.prime)==0 & h1.20==1)

[1]6

Normalised Log-Likelihood

>ex.2$norm.log.lik

[1]—0.4064687

Likelihood of the User Histories

>Phi(h1.20, ex.2$a.prime, ex.2$b.prime)

| | [,1] | [,2] | [,3] | [,4] | [,5] |
|---|---|---|---|---|---|
| [1,] | 0.6340171 | 0.6228777 | 0.5417132 | 0.7324477 | 0.5088954 |
| [2,] | 0.4419658 | 0.8807971 | 0.7884062 | 0.7221042 | 0.5996140 |
| [3,] | 0.6340171 | 0.6228777 | 0.5417132 | 0.7324477 | 0.5088954 |
| [4,] | 0.6268344 | 0.8751649 | 0.8892529 | 0.8661554 | 0.6496016 |
| [5,] | 0.6340171 | 0.6228777 | 0.5417132 | 0.7324477 | 0.5088954 |
| [6,] | 0.9338098 | 0.6756966 | 0.6893552 | 0.4223050 | 0.8711992 |
| [7,] | 0.4327887 | 0.6330654 | 0.5061991 | 0.7608085 | 0.4309982 |
| [8,] | 0.4259915 | 0.8754822 | 0.8807971 | 0.8806682 | 0.3063822 |
| [9,] | 0.2070898 | 0.8175949 | 0.8859810 | 0.2268360 | 0.5567961 |
| [10,] | 0.4259915 | 0.8754822 | 0.8807971 | 0.8806682 | 0.3063822 |
| [11,] | 0.6268344 | 0.8751649 | 0.8892529 | 0.8661554 | 0.6496016 |
| [12,] | 0.4419658 | 0.8807971 | 0.7884062 | 0.7221042 | 0.5996140 |
| [13,] | 0.6268344 | 0.8751649 | 0.8892529 | 0.8661554 | 0.6496016 |
| [14,] | 0.6268344 | 0.8751649 | 0.8892529 | 0.8661554 | 0.6496016 |
| [15,] | 0.6340171 | 0.6228777 | 0.5417132 | 0.7324477 | 0.5088954 |
| [16,] | 0.8807971 | 0.8807971 | 0.6106311 | 0.5904962 | 0.8339121 |
| [17,] | 0.8807971 | 0.8807971 | 0.6106311 | 0.5904962 | 0.8339121 |
| [18,] | 0.8213265 | 0.8807971 | 0.6533716 | 0.4786965 | 0.7658134 |
| [19,] | 0.8807971 | 0.8807971 | 0.6106311 | 0.5904962 | 0.8339121 |
| [20,] | 0.9414221 | 0.6602454 | 0.7114509 | 0.5905965 | 0.8822130 |

Parameter Values—User Profiles

>ex.2$a.prime

| | [,1] | [,2] |
|---|---|---|
| [1,] | 0.41946343 | 0.3792647 |
| [2,] | 0.44170302 | 0.0000000 |
| [3,] | 0.41946343 | 0.3792647 |
| [4,] | 0.05553167 | 0.9992640 |
| [5,] | 0.41946344 | 0.3792647 |
| [6,] | 0.97756065 | 0.3204635 |
| [7,] | 0.35605448 | 0.3682253 |
| [8,] | 0.00000000 | 1.0000000 |
| [9,] | 0.32656108 | 0.8860375 |
| [10,] | 0.00000000 | 1.0000000 |
| [11,] | 0.05553167 | 0.9992641 |
| [12,] | 0.44170302 | 0.0000000 |
| [13,] | 0.05553167 | 0.9992640 |
| [14,] | 0.05553167 | 0.9992641 |
| [15,] | 0.41946344 | 0.3792647 |
| [16,] | 1.00000000 | 0.0000000 |
| [17,] | 1.00000000 | 0.0000000 |
| [18,] | 0.88134012 | 0.0000000 |
| [19,] | 1.00000000 | 0.0000000 |
| [20,] | 1.00000000 | 0.3381018 |

Parameter Values—Object Profiles

>ex.2$b.prime

| | [,1] | [,2] |
|---|---|---|
| [1,] | 1.0000000 | 0.5745561760 |
| [2,] | 0.0000000 | 0.9875815278 |
| [3,] | 0.3875086 | 1.0000000000 |
| [4,] | 0.5915042 | 0.0003067603 |
| [5,] | 0.9034027 | 0.2957280299 |

Recommendation for User with Current History c(0,1,1,0,0)

Calculate User Profile

>a.only(c(0,1,1,0,0), ex.2$b.prime)$a.prime

[1]0.0000000 0.8741234

Make Recommendation

>R(c(0,1,1,0,0), a.only(c(0,1,1,0,0),

ex.2$b.prime)$a.prime,ex.2$b.prime)$recommend

[1]1

### Example 3

>ex.3_ab(h1.20, to1=0.01, lambda=0.5, mu=0.75)

Predicted User Histories

>H(ex.3$a.prime, ex.3$h.prime)

| | [,1] | [,2] | [,3] | [,4] | [,5] |
|---|---|---|---|---|---|
| [1,] | 1 | 0 | 1 | 0 | 0 |
| [2,] | 0 | 0 | 0 | 0 | 0 |
| [3,] | 1 | 0 | 1 | 0 | 0 |
| [4,] | 1 | 0 | 1 | 0 | 0 |
| [5,] | 1 | 0 | 1 | 0 | 0 |
| [6,] | 1 | 0 | 1 | 0 | 1 |
| [7,] | 1 | 0 | 0 | 0 | 1 |
| [8,] | 1 | 0 | 1 | 0 | 1 |
| [9,] | 1 | 0 | 1 | 1 | 1 |
| [10,] | 1 | 0 | 1 | 0 | 1 |
| [11,] | 1 | 0 | 1 | 0 | 0 |
| [12,] | 0 | 0 | 0 | 0 | 0 |
| [13,] | 1 | 0 | 1 | 0 | 0 |
| [14,] | 1 | 0 | 1 | 0 | 0 |
| [15,] | 1 | 0 | 1 | 0 | 0 |
| [16,] | 1 | 0 | 0 | 1 | 1 |
| [17,] | 1 | 0 | 0 | 1 | 1 |
| [18,] | 1 | 0 | 0 | 0 | 1 |
| [19,] | 1 | 0 | 0 | 1 | 1 |
| [20,] | 1 | 0 | 1 | 1 | 1 |

Prediction Errors

>sum(H(ex.3$a.prime, ex.3$b.prime)==1 & hl.20==0)

[1]4

>sum(H(ex.3$a.prime, ex.3$b.prime)==0 & hl.20==1)

[1]10

Normalised Log-Likelihood

>ex.3$norm.log.lik

[1]—0.3932814

Likelihood of the User Histories

>Phi(h1.20, ex.3$a.prime, ex.3$b.prime)

| | [,1] | [,2] | [,3] | [,4] | [,5] |
|---|---|---|---|---|---|
| [1,] | 0.8807971 | 0.5512987 | 0.8806447 | 0.8807971 | 0.8134237 |
| [2,] | 0.4578040 | 0.7647398 | 0.5423608 | 0.8807971 | 0.8530244 |
| [3,] | 0.8807971 | 0.5512987 | 0.8806447 | 0.8807971 | 0.8134237 |
| [4,] | 0.8809262 | 0.4487512 | 0.8806558 | 0.8801523 | 0.8123465 |
| [5,] | 0.8807971 | 0.5512987 | 0.8806447 | 0.8807971 | 0.8134237 |
| [6,] | 0.9078677 | 0.5395961 | 0.8832197 | 0.6380087 | 0.5459605 |
| [7,] | 0.4803071 | 0.7609348 | 0.4472996 | 0.6039016 | 0.5141825 |
| [8,] | 0.3198346 | 0.2954913 | 0.6031322 | 0.5435446 | 0.6046766 |
| [9,] | 0.3116478 | 0.2798293 | 0.5390089 | 0.8115911 | 0.9069239 |
| [10,] | 0.3198346 | 0.2954913 | 0.6031322 | 0.5435446 | 0.6046766 |
| [11,] | 0.8809262 | 0.4487512 | 0.8806558 | 0.8801523 | 0.8123465 |
| [12,] | 0.4578040 | 0.7647398 | 0.5423608 | 0.8807971 | 0.8530244 |
| [13,] | 0.8809262 | 0.4487512 | 0.8806558 | 0.8801523 | 0.8123465 |
| [14,] | 0.8809262 | 0.4487512 | 0.8806S58 | 0.8801523 | 0.8123465 |
| [15,] | 0.8807971 | 0.5512987 | 0.8806447 | 0.8807971 | 0.8134237 |
| [16,] | 0.5377219 | 0.7733681 | 0.6146786 | 0.7964475 | 0.8892863 |
| [17,] | 0.5377219 | 0.7733681 | 0.6146786 | 0.7964475 | 0.8892863 |
| [18,] | 0.5385306 | 0.7554185 | 0.5370044 | 0.5877765 | 0.5355289 |
| [19,] | 0.5377219 | 0.7733681 | 0.6146786 | 0.7964475 | 0.8892863 |
| [20,] | 0.9275260 | 0.5379658 | 0.8731563 | 0.7973894 | 0.9173102 |

Parameter Values—User Profiles

>ex.3$a.prime

| | [,1] | [,2] |
|---|---|---|
| [1,] | 1.0000000 | 0.000000000 |
| [2,] | 0.4577034 | 0.000000000 |
| [3,] | 1.0000000 | 0.000000000 |
| [4,] | 1.0000000 | 0.001770631 |
| [5,] | 1.0000000 | 0.000000000 |
| [6,] | 1.0000000 | 0.414193699 |
| [7,] | 0.4404549 | 0.456091660 |
| [8,] | 0.5969758 | 0.527508093 |
| [9,] | 0.5243517 | 1.000000000 |
| [10,] | 0.5969757 | 0.527508094 |
| [11,] | 1.0000000 | 0.001770621 |
| [12,] | 0.4577034 | 0.000000000 |
| [13,] | 1.0000000 | 0.001770642 |
| [14,] | 1.0000000 | 0.001770642 |
| [15,] | 1.0000000 | 0.000000000 |
| [16,] | 0.3688663 | 0.972215602 |
| [17,] | 0.3688663 | 0.972215605 |
| [18,] | 0.4559963 | 0.475444315 |
| [19,] | 0.3688663 | 0.972215599 |
| [20,] | 0.9681038 | 0.973897501 |

Parameter Values—Object Profiles

>ex.3$b.prime

| | [,1] | [,2] |
|---|---|---|
| [1,] | 1.0000000 | 0.17375507 |
| [2,] | 0.448S201 | 0.02849059 |
| [3,] | 0.9996374 | 0.01492679 |
| [4,] | 0.0000000 | 0.86509546 |
| [5,] | 0.1318970 | 1.00000000 |

Recommendation for Uuser with Current History c(0,1,1,0,0)

Calculate User Profile

>a.only(c(0,1,1,0,0), ex.3$b.prime)$a.prime [1]0.6501714 0.0000000

Make Recommendation

>R(c(0,1,1,0,0), a.only(c(0,1,1,0,0), ex.3$b.prime)$a.prime,ex.3$b.prime)$recommend [1]

1

Appendix E

S-PLUS Functions

Iterative procedure to find a and b, user and object profiles to maximise user histories h. Take repeated steps of updating first the user profiles then the object profiles until the improvement in the normalised log-likelihood is less than specified tolerance (argument tol) (User and object profiles are vectors of length r.)

>ab

function(h, to1=0.1, lambda=1, mu=1, r=2, a=NULL, b=NULL)

{

n <− nrow(h)
p <— ncol(h)
a — rprof(n, 2)
b <— rprof(p, 2)
zz <— ab.min.log.Phi(h, a, b)
rho <— zz$norm.log.lik[2]/zz$norm.log.lik[a]
its <— 1
while(rho < 1 — tol && its < 10)

zz <— ab.min.log.Phi(h, zz$a.prime, zz$b.prime, lambda, mu)
rho <— zz$norm.log.lik[2J/zz$norm.log.lik[1]
its <— its + 1

obj <— list (a a, b = b, a.prime = zz$a.prime, b.prime = zz$b.prime,

norm.log.lik = zz$norm.log.lik[2

], iterations = its)

attr(obj, “call) <— match.call( )
obj

}

Two-step process to maximise log-likelihood of user histories h, first by holding b fixed and maximising over user profiles a, then maximising over object profiles b with updated user profiles a.prime. The second step generates updated object profiles b.prime. For both user and object profiles, the updated profile is a linear combination of the initial profile and the profile generated by the optimisation procedure. (Arguments lambda and mu control the linear combinations.) Each optimisation step is carried out by the S-PLUS built-in function nlminb.

> ab.min.log.Phi
function(h, a, b, lambda = 1, mu = 1)
{

n <− nrow(a)
a.prime <− matrix(NA, nrow = nrow(a), ncol = ncol(a))
a.mess <— character(n)
for(i in 1:n) (

zz <— nlminb(start = a[i, ], function(u, hi., b)

—sum(log.Phi.i. (hi., u, b)), lower = 0, upper = 1, hi. = h[i, ], b = b)

a.prime[i, ] <— lambda * zz$parameters + (1 — lambda) * a[i,

]

a.mess[i] <— zz$mess

}
m <− nrow(b)
b.prime <− matrix(NA, nrow = nrow(b), ncol = ncol(b))
b.mess <— character (n)
for(j in 1:m)

zz <— nlminb(start = b[j, ], function(u, h.j, a)

— sum(log.Phi..j(h.j, a, u)), lower = 0, upper = 1, h.j = h[, j], a = a.
prime)

b.prime [j, ] <— mu * zz$parameters + (1 — mu) * b[j,
b.mess[j] <— zz$mess

}
log.lik <— log.Phi(h, a, b)
log.lik.prime <— log.Phi(h, a.prime, b.prime)
list(a = cbind(a, a.prime), b = cbind(b, b.prime), norm.log.lik =

c(sum(log.lik), sum(log.lik.primel)/(

m * n), log.lik = cbind(log.lik, log.lik.prime), messages =

c(a.mess, b.mess), a.prime =

a.prime, b.prime = b.prime)

}
>

Log-likelihood of user profile ai given user history ai and object profiles b.

> log.Phi.i.
function(hi, ai, b)
{

p <− nrow(b)
log.lik <— numeric(p)
for(j in l:p)

log.lik[j] <— log.Phi.ij(hi[j], ai, b[j, ])

}
log. lik

}

Log-likelihood of object profile bj given user histories h.j for object j and user profiles a.

> log.Phi. . j
function(h.j, a, bj)
{

p <− nrow(a)
log.lik <— numeric(p)
for(i in l:pI {

log.lik[i] <— log.Phi.ij(h.j[i], a[i, ], bj)

}
log. lik

}

Log-likelihood of hij given user profile ai and object profile bj.

> log.Phi.ij
function(hij, ai, bj)
{

log(Phi.ij(hij, ai, bj)I

}

Likelihood of hij given user profile ai and object profile bj.

> Phi.ij
function(hij, ai, bj)
{

ifelse(hij = = 0, 1 — phi(sum(ai * bjl), phi(sum(ai * bj)))

}

Score function

> phi
function(t, lambda = 4)
{

1/(1 + exp( — lambda * (t — 0.5)))

}

Generate random profiles

> rprof
function(n, p)
{
# uniformly distributed in positive quadrant of unit disk ??
matrix(runif(n * p1,

nrow = n)

}

Generate predicted user histories

> H
function(a, b)
{

n <— nrow(a)
p <− nrow(b)
zz <— matrix(NA, nrow = n, ncol = p1
for(i in l:n)

for(j in l:p)

zz[i, j] <˜ phi(sum(a[i, ] * b[j, 2))

}

}
ifelse(zz < 0.5, 0, 1)

}

Calculate user profile for a new user with history h given object profiles b

> a.only
function (h, b)
{

p <− nrow(bI
r <− ncol(b)
a <— rprof(1, r)
zz <— nlminb(start = a, function(u, hO, b)

— sum(log.Phi.i. (hO, u, bIl, lower = 0, upper = 1, hO = h, b = hI a.prime

<— zz$parameters
log.lik <— log.Phi(h, a.prime, b)
obj <— list(a = a, a.prime = a.prime, norm.log.lik = sum(log.lik)/p,

messages = zz$message)

attr(obj, “call”) <− match.call ( )
obj

}

Make a recommendation for a user with history h given user profile a and object profiles b by choosing object not yet sampled with largest score

> R
function (h, a, b)
{

if (all (h = = 1))

stop(”’e’s been everywhere already! !)

p <− nrow(b)
if (length (h) != p1

stop(”h and p out of whack!’)

score <− numeric (p)
for (i in 1:p) {

score[i] <− phi (sum(a * b[i, ]))

}
rho <— rev(order(scorel)
i <— 1
while(h[rho[i]] = = 1) {

i<—i + 1

}
list (score = score, order = rho, recommend = rho[i])

Appendix F

S-PLUS Session Log

Complete session log of calculations for example 1 in file examples2.doc. Initial values for the user and object profiles are chosen at random, several two-stage optimisation steps are made and results are printed out.

>ex.1_ab(h1.20, to1=0.01, lambda=0.5, mu=0.75)

>H(ex.1$a.prime, ex.1$b.prime)

| | [,1] | [,2] | [,3] | [,4] | [,5] |
|---|---|---|---|---|---|
| [1,] | 1 | 0 | 1 | 0 | 0 |
| [2,] | 0 | 0 | 0 | 0 | 0 |
| [3,] | 1 | 0 | 1 | 0 | 0 |
| [4,] | 1 | 1 | 1 | 0 | 0 |
| [5,] | 1 | 0 | 1 | 0 | 0 |
| [6,] | 1 | 1 | 1 | 0 | 1 |
| [7,] | 1 | 0 | 0 | 0 | 0 |
| [8,] | 1 | 0 | 1 | 0 | 0 |
| [9,] | 1 | 0 | 1 | 1 | 1 |
| [10,] | 1 | 0 | 1 | 0 | 0 |
| [11,] | 1 | 1 | 1 | 0 | 0 |
| [12,] | 0 | 0 | 0 | 0 | 0 |
| [13,] | 1 | 1 | 1 | 0 | 0 |
| [14,] | 1 | 1 | 1 | 0 | 0 |
| [15,] | 1 | 0 | 1 | 0 | 0 |
| [16,] | 1 | 0 | 0 | 1 | 1 |
| [17,] | 1 | 0 | 0 | 1 | 1 |
| [18,] | 1 | 0 | 0 | 0 | 1 |
| [19,] | 1 | 0 | 0 | 1 | 1 |
| [20,] | 1 | 0 | 1 | 1 | 1 |

>sum(H(ex.1$a.prime, ex.1$b.prime)==1 & hl.20==0) [1]5

>sum(H(ex.1$a.prime, ex.1$b.prime)==0 & h1.20==1) [1]9

>ex.1$norm.log.lik

[1]—0.3921817

>Phi.ij

function(hij, ai, bj)

{

ifelse(hij = = 0, 1 − phi(sum(ai * bj)), phi(sum(ai * bj)))

}
> Phi
function (h, a, b)
{

n <− nrow (h)
p <− ncol (h)
likelihood < − matrix (NA, nrow = n, ncol = p)
for (I in 1:n) {

for(j in 1:p) {

likelihood[i, j] <− Phi.ij (h[i, j], a[i, ], b[j, ])

}

}
likelihood

}

>Phi(h1.20, ex.1$a.prime, ex.1$b.prime)

| | [,1] | [,2] | [,3] | [,4] | [,5] |
|---|---|---|---|---|---|
| [1,] | 0.8350231 | 0.8250856 | 0.8807971 | 0.5240304 | 0.7421196 |
| [2,] | 0.4134032 | 0.7579803 | 0.5907615 | 0.8716424 | 0.8161381 |
| [3,] | 0.8250856 | 0.5240304 | 0.8350231 | 0.8807971 | 0.7421196 |
| [4,] | 0.8737172 | 0.5256501 | 0.8807972 | 0.8785969 | 0.7186375 |
| [5,] | 0.8250856 | 0.5240304 | 0.8350231 | 0.8807971 | 0.7421196 |
| [6,] | 0.9347387 | 0.4743499 | 0.8808021 | 0.6736149 | 0.5785726 |
| [7,] | 0.3938034 | 0.7258131 | 0.4882028 | 0.7519964 | 0.3541521 |
| [8,] | 0.2115889 | 0.4070667 | 0.7482299 | 0.8185183 | 0.3313691 |
| [9,] | 0.1343897 | 0.2969896 | 0.5412996 | 0.7308824 | 0.8267741 |
| [10,] | 0.2115888 | 0.4070667 | 0.7482300 | 0.8185183 | 0.3313691 |
| [11,] | 0.8737172 | 0.5256501 | 0.8807972 | 0.8785969 | 0.7186374 |
| [12,] | 0.4134032 | 0.7579803 | 0.5907615 | 0.8716424 | 0.8161381 |
| [13,] | 0.8737172 | 0.5256501 | 0.8807972 | 0.8785969 | 0.7186375 |
| [14,] | 0.8737172 | 0.5256501 | 0.8807972 | 0.8785969 | 0.7186374 |
| [15,] | 0.8250857 | 0.5240304 | 0.8350231 | 0.8807971 | 0.7421196 |
| [16,] | 0.7457234 | 0.8312700 | 0.7736004 | 0.8807971 | 0.9003190 |
| [17,] | 0.7457234 | 0.8312700 | 0.7736004 | 0.8807971 | 0.9003190 |
| [18,] | 0.6643145 | 0.7610495 | 0.5984503 | 0.5202947 | 0.5831247 |
| [19,] | 0.7457234 | 0.8312700 | 0.7736004 | 0.8807971 | 0.9003190 |
| [20,] | 0.9758719 | 0.5418934 | 0.8153668 | 0.8738971 | 0.9449713 |

>

>ex.1$a.prime

| | [,1] | [,2] |
|---|---|---|
| [1,] | 0.9054134 | 0.000000000 |
| [2,] | 0.4082206 | 0.021110260 |
| [3,] | 0.9054134 | 0.000000000 |
| [4,] | 1.0000000 | 0.005197485 |
| [5,] | 0.9054134 | 0.000000000 |
| [6,] | 1.0000000 | 0.318854833 |
| [7,] | 0.4881923 | 0.222677935 |
| [8,] | 0.7722939 | 0.123414736 |
| [9,] | 0.5413661 | 0.749776003 |
| [10,] | 0.7722940 | 0.123414730 |
| [11,] | 1.0000000 | 0.005197531 |
| [12,] | 0.4082206 | 0.021110260 |
| [13,] | 1.0000000 | 0.005197486 |
| [14,] | 1.0000000 | 0.005197531 |
| [15,] | 0.9054135 | 0.000000000 |
| [16,] | 0.1927744 | 1.000000000 |
| [17,] | 0.1927744 | 1.000000000 |
| [18,] | 0.4002291 | 0.479694159 |
| [19,] | 0.1927745 | 1.000000000 |

[20,]0.8712802 0.983966045

>ex.1$b.prime

NULL

>ex.1$b.prime

| | [,1] | [,2] |
|---|---|---|
| [1,] | 0.9805440 | 0.5799592265 |
| [2,] | 0.5256726 | 0.0000000000 |
| [3,] | 1.0000000 | 0.0000371357 |
| [4,] | 0.0000000 | 1.0000000000 |
| [5,] | 0.2603743 | 1.0000000000 |

>

>a.only(c(0,1,1,0,0), ex.1$b.prime1$a:

[,1][,2]

[1,]0.7904475

0.1942631

$a. prime:

[1]0.6601747

0.0000000

Snorm. log. lik:

[1]—0.5728617

$messages:

[1] “RELATIVE FUNCTION CONVERGENCE”

attr(, “call”):

a.only(h=c(0, 1, 1, 0, 0), b=ex.1$b.prime)

>R(c(0,1,1,0,0), a.only(c(0,1,1,0,0), ex.1$b.prime)$a.prime, ex.1$b.prime)

$ score:

[1]0.6432096 0.3516359 0.6549116 0.1192029 0.2120806

$order:

[1]3 1 25 4

$recommend:

[1]1

Appendix G

This is an example of a numerical implementation of a preferred method of the invention using user information, implemented using the alternative preferred method based on tetrachoric correlations.

1. Specify the Data

1.1 The Set of Items

The data in the example describe visits to a number of London Attractions. There are 20 attractions. The data also includes an additional binary variable which records whether or not the user's children have an average age of 10 and above, or not (all users are assumed to have school age children). These attractions and the child-age variable are labelled in various ways in what follows. The labels, and the attraction identities, are:

| | | |
|---|---|---|
| BRIGHTON | Brighton | 1 |
| CHESS | Chessington | 2 |
| NATGAL | National Gallery | 3 |
| HAMPTON | Hampton Court Gardens | 4 |
| SCIENCE | Science Museum | 5 |
| WHIPSNDE | Whipsnade | 6 |
| LEGO | Legoland | 7 |
| EASTBORN | Eastbourne | 8 |
| LONAQUA | London Aquarium | 9 |
| WESTABBY | Westminster Abbey | 10 |
| KEW | Kew Gardens | 11 |
| LONZOO | London Zoo | 12 |
| MADTUS | Madam Tussauds | 13 |
| BRITMUS | British Museum | 14 |
| OXFORD | Oxford | 15 |
| THORPE | Thorpe Park | 16 |
| NATHIST | Natural History Museum | 17 |
| TOWER | Tower of London | 18 |
| WINDSOR | Windsor Castle | 19 |
| WOBORN | Woburn Wildlife Park | 20 |
| CH.10 | Average age of child- | 21 |
| | ren is 10 or more | |

1.2 The Data Set

The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in an appendix). The final column records whether or not the average child age in the family is above 10.

2. Generate the Tetrachoric Correlations

The tetrachoric correlations were calculated using the PRELIS, which is distributed with LISREL, a widely available statistical package. Following is a printout of the output file. The figures should be read from left to right and give only the lower left triangle of the correlation matrix. For example the first number is the tetrachoric correlation between items (1,1), ie between Brighton and Brighton, and so is 1 by definition. The second figure is the tetrachoric correlation between the second items (2,1), ie between Chessington and Brighton. The third figure is for items (2,2), and so on. The pattern is built up as:

| | | | |
|---|---|---|---|
| 1^{st} | (1,1) | | |
| 2^{nd} and 3^{rd} | (2,1) | (2,2) | |
| 4^{th}, 5^{th} and 6^{th} | (3,1) | (3,2) | (3,3) . . . |

Printout starts

| | | | | | |
|---|---|---|---|---|---|
| 0.10000D+01 | 0.25921D−01 | 0.10000D+01 | 0.15903D+00 | −0.95292D−02 | 0.10000D+01 |
| 0.24066D+00 | 0.84937D−01 | 0.28213D+00 | 0.10000D+01 | 0.39210D−01 | 0.90012D−01 |
| 0.38216D+00 | 0.23000D+00 | 0.10000D+01 | 0.21047D−02 | 0.31598D−01 | 0.14340D+00 |
| 0.44819D−01 | 0.90452D−01 | 0.10000D+01 | −0.10435D+00 | 0.32529D−01 | 0.11937D+00 |
| 0.34243D−01 | 0.91822D−01 | 0.12105D+00 | 0.10000D+01 | 0.16561D+00 | 0.76582D−01 |
| 0.85915D−01 | 0.44421D−02 | −0.23282D−01 | 0.16856D+00 | −0.23900D+00 | 0.10000D+01 |
| 0.93920D−02 | −0.10186D+00 | 0.64973D−01 | −0.16571D−01 | 0.20816D+00 | 0.47231D−01 |
| 0.17422D+00 | −0.92999D−01 | 0.10000D+01 | 0.77810D−01 | −0.31840D−01 | 0.36910D+00 |
| 0.14890D+00 | −0.12013D−01 | −0.23573D−01 | −0.83981D−01 | 0.24296D+00 | 0.10375D+00 |
| 0.10000D+01 | −0.95084D−02 | 0.11492D−01 | 0.33575D+00 | 0.37297D+00 | 0.25732D+00 |
| 0.48493D−01 | 0.10178D+00 | −0.39985D−01 | 0.19402D+00 | 0.18485D+00 | 0.10000D+01 |
| 0.16800D−01 | −0.76457D−01 | 0.27590D−01 | 0.51685D−01 | 0.23255D+00 | 0.11987D+00 |
| 0.19297D+00 | −0.13336D−01 | 0.27748D+00 | 0.11772D+00 | 0.22651D+00 | 0.10000D+01 |
| −0.92362D−02 | 0.20553D+00 | 0.16060D+00 | 0.18503D−02 | 0.81839D−01 | 0.85546D−01 |
| −0.78074D−02 | 0.89379D−01 | 0.37150D−01 | 0.24369D+00 | 0.10690D+00 | 0.15442D+00 |
| 0.10000D+01 | 0.98167D−01 | −0.19484D−01 | 0.51206D+00 | 0.22435D+00 | 0.34991D+00 |
| 0.76726D−01 | −0.11389D+00 | 0.89222D−01 | 0.22704D+00 | 0.31159D+00 | 0.25272D+00 |
| 0.16967D+00 | 0.27032D+00 | 0.10000D+01 | 0.54877D−01 | −0.10843D+00 | 0.30814D+00 |
| 0.22729D+00 | 0.12249D+00 | 0.14978D+00 | −0.80009D−02 | 0.26167D−01 | 0.15371D+00 |
| 0.34307D+00 | 0.43455D+00 | 0.10852D+00 | 0.23818D+00 | 0.35848D+00 | 0.10000D+01 |
| 0.53346D−01 | 0.51364D+00 | −0.13616D+00 | −0.11254D−01 | 0.38080D−01 | 0.13179D+00 |
| 0.23852D+00 | 0.68837D−01 | −0.53993D−01 | −0.11013D+00 | 0.38208D−01 | 0.22842D+00 |
| 0.15026D+00 | 0.21440D−02 | 0.34106D−01 | 0.10000D+01 | −0.12307D+00 | 0.20600D−01 |
| 0.24943D+00 | 0.99045D−01 | 0.48249D+00 | 0.22156D+00 | 0.15389D+00 | 0.71481D−01 |
| 0.25974D+00 | 0.82698D−01 | 0.16346D+00 | 0.25823D+00 | 0.22793D+00 | 0.39315D+00 |
| 0.87080D−01 | 0.38362D−01 | 0.10000D+01 | −0.14982D−01 | −0.96054D−01 | 0.18464D+00 |
| 0.16839D+00 | 0.16761D+00 | 0.24899D+00 | 0.68591D−03 | 0.25407D+00 | 0.15389D+00 |
| 0.40308D+00 | 0.22768D+00 | 0.13627D+00 | 0.33529D+00 | 0.41978D+00 | 0.31096D+00 |
| 0.52853D−02 | 0.22597D+00 | 0.10000D+01 | −0.46788D−01 | 0.90354D−02 | 0.19470D+00 |
| 0.29679D+00 | 0.18597D−01 | 0.17544D+00 | 0.32902D+00 | 0.39910D−01 | 0.12491D+00 |
| 0.33632D+00 | 0.24589D+00 | 0.14153D+00 | 0.24115D+00 | 0.23277D+00 | 0.43132D+00 |
| 0.95171D−01 | 0.47527D−01 | 0.42469D+00 | 0.10000D+01 | 0.11851D−01 | 0.51613D−02 |
| 0.78049D−01 | −0.23695D−01 | 0.23072D−01 | 0.65032D+00 | 0.75497D−01 | 0.20446D+00 |
| 0.19850D+00 | 0.36760D−02 | 0.11967D+00 | 0.36115D−01 | 0.11599D+00 | 0.14537D+00 |
| −0.35519D−01 | 0.19980D+00 | 0.11769D+00 | 0.19467D+00 | 0.93191D−01 | 0.10000D+01 |
| 0.37122D−01 | 0.39142D+00 | 0.17466D+00 | −0.35882D−01 | 0.47115D−01 | 0.18783D−01 |
| −0.15785D+00 | −0.10612D+00 | −0.12030D+00 | 0.73570D−01 | 0.68675D−01 | 0.17744D+00 |
| 0.36428D+00 | 0.21544D+00 | −0.14526D−01 | 0.19024D+00 | 0.42626D−01 | 0.29033D+00 |
| 0.10485D+00 | 0.18533D−01 | 0.10000D+01 | | | |

Printout ends

3. Generate the Item Profiles

The following steps were implemented using routines written in S-Plus.

3.1 Generate Item Profiles from a Linear Factor Model

The next step involves estimating a linear factor model using the tetrachoric correlations as though they were product-moment correlations. The function “factanal” in S-Plus was used to do this, using “mle” as the estimation method, and specifying that the model should use the matrix of tetrachoric correlations.

To choose the number of components a model with 1, 2 and 3 components was estimated, and at a later stage the model which gave the lowest value for the AIC was selected.

3.2 Transform the Item Profiles

Before using the item profiles in the item functions it is necessary to transform them, and to estimate the constant terms, according to the method described. The result for the 3 factor model is as follows.

| | b1 | b2 | b3 | b0 |
|---|---|---|---|---|
| bright | 0.164443933 | 0.02387331 | 0.06656386 | −0.67148568 |
| chess | −0.212229035 | 0.02942951 | 1.80109987 | −0.21662415 |
| natgal | 1.303975399 | 0.18451642 | 0.12909057 | −1.44990555 |
| hampt | 0.746484240 | −0.03754730 | 0.25781809 | −1.02481696 |
| science | 0.839550959 | 0.04849160 | −0.08324939 | −0.06765865 |
| whip | 0.260917932 | 1.57653529 | 0.08194963 | −1.51394915 |
| lego | 0.021755207 | 0.13893512 | 0.05992105 | −0.06765865 |
| east | 0.190738004 | 0.38722325 | 0.16047012 | −2.23537634 |
| lonaqu | 0.466563695 | 0.37955614 | −0.14782961 | −0.81908402 |
| westab | 1.070257914 | 0.01426026 | 0.05832279 | −2.25396441 |
| kew | 0.998836592 | 0.25822544 | 0.13767828 | −1.36827586 |
| lonzoo | 0.508300363 | 0.06881175 | −0.08651507 | −0.02898754 |
| madamt | 0.753812169 | 0.25212748 | 0.50785315 | −1.46040233 |
| britm | 1.669208468 | 0.37442186 | 0.14157002 | −1.66254774 |
| oxford | 1.341022995 | −0.07555820 | −0.08738219 | −2.11247207 |
| thorpe | −0.115980165 | 0.45865697 | 1.10414456 | −0.74431547 |
| nathist | 0.802764028 | 0.24037708 | 0.04920244 | −0.26891980 |
| tower | 1.317430770 | 0.45037219 | −0.07341733 | −1.13545286 |
| wind | 1.001775688 | 0.20237116 | 0.13371818 | −1.73649679 |
| woburn | −0.008890338 | 1.81306031 | −0.04009937 | −2.39263672 |
| ch.10 | 0.372239988 | 0.05825895 | 0.84561467 | −0.95952841 |

3.3 Choose the Number of Components

The number of components was chosen by selecting the model, from the three which were estimated, which has the lowest AIC. The AlC's are:

| Number of | |
|---|---|
| components | AIC |
| 1 | 13577.48 |
| 2 | 13609.53 |
| 3 | 13532.50 |

The lowest value of the AIC is achieved with 3 components. The selection rule therefore specifies 3 components.

4. Make Recommendations

Once the item profiles have been generated they are used to make recommendations. The following gives an example for a single user. The routines to implement the steps were written in S-Plus, a widely available statistical package. All the routines are straightforward and their functionality could be replicated by one skilled in the art.

4.1 User History

The information set on which recommendations are based gives the visiting history of the user, as well as information on the average age of her children. In this case average child age is less than 10, and the user's history is:

| bright | chess | natgal | hampt | science | whip | lego | east | lonaqu | westab | kew |
|---|---|---|---|---|---|---|---|---|---|---|
| 0 | 0 | 1 | 1 | 1 | 0 | 0 | 0 | 0 | 0 | 0 |
| lonzoo | madamt | britm | oxford | thorpe | nathist | tower | wind | woburn | ch.10 | |
| 0 | 0 | 0 | 0 | 0 | 0 | 0 | 0 | 0 | 0 | |

4.2 Prior Distribution Over Possible User Profiles

This history is used to update a prior distribution over possible user profiles. The first task is to specify the possible profiles. Each possible profile requires three numbers. In this example there are 125 possible profiles. The following gives the first 10. It will be apparent what the remainder would be.

| | [,1] | [,2] | [,3] |
|---|---|---|---|
| [1,] | −2 | −2 | −2 |
| [2,] | −2 | −2 | −1 |
| [3,] | −2 | −2 | 0 |
| [4,] | −2 | −2 | 1 |
| [5,] | −2 | −2 | 2 |
| [6,] | −2 | −1 | −2 |
| [7,] | −2 | −1 | −1 |
| [8,] | −2 | −1 | 0 |
| [9,] | −2 | −1 | 1 |
| [10,] | −2 | −1 | 2 |

The probability of each possible profile that is assumed in the prior distribution is then specified. Here the binomial approximation described in the method is used (the following should be read as: the probability of the first profile is 0.00024, the probability of the second is 0.00098, the probability of the third is 0.00145 and so on).

| | | | | | |
|---|---|---|---|---|---|
| [1] | 0.0002441406 | 0.0009765625 | 0.0014648438 | 0.0009765625 | 0.0002441406 |
| [6] | 0.0009765625 | 0.0039062500 | 0.0058593750 | 0.0039062500 | 0.0009765625 |
| [11] | 0.0014648438 | 0.0058593750 | 0.0087890625 | 0.0058593750 | 0.0014648438 |
| [16] | 0.0009765625 | 0.0039062500 | 0.0058593750 | 0.0039062500 | 0.0009765625 |
| [21] | 0.0002441406 | 0.0009765625 | 0.0014648438 | 0.0009765625 | 0.0002441406 |
| [26] | 0.0009765625 | 0.0039062500 | 0.0058593750 | 0.0039062500 | 0.0009765625 |
| [31] | 0.0039062500 | 0.0156250000 | 0.0234375000 | 0.0156250000 | 0.0039062500 |
| [36] | 0.0058593750 | 0.0234375000 | 0.0351562500 | 0.0234375000 | 0.0058593750 |
| [41] | 0.0039062500 | 0.0156250000 | 0.0234375000 | 0.0156250000 | 0.0039062500 |
| [46] | 0.0009765625 | 0.0039062500 | 0.0058593750 | 0.0039062500 | 0.0009765625 |
| [51] | 0.0014648438 | 0.0058593750 | 0.0087890625 | 0.0058593750 | 0.0014648438 |
| [56] | 0.0058593750 | 0.0234375000 | 0.0351562500 | 0.0234375000 | 0.0058593750 |
| [61] | 0.0087890625 | 0.0351562500 | 0.0527343750 | 0.0351562500 | 0.0087890625 |
| [66] | 0.0058593750 | 0.0234375000 | 0.0351562500 | 0.0234375000 | 0.0058593750 |
| [71] | 0.0014648438 | 0.0058593750 | 0.0087890625 | 0.0058593750 | 0.0014648438 |
| [76] | 0.0009765625 | 0.0039062500 | 0.0058593750 | 0.0039062500 | 0.0009765625 |
| [81] | 0.0039062500 | 0.0156250000 | 0.0234375000 | 0.0156250000 | 0.0039062500 |
| [86] | 0.0058593750 | 0.0234375000 | 0.0351562500 | 0.0234375000 | 0.0058593750 |
| [91] | 0.0039062500 | 0.0156250000 | 0.0234375000 | 0.0156250000 | 0.0039062500 |
| [96] | 0.0009765625 | 0.0039062500 | 0.0058593750 | 0.0039062500 | 0.0009765625 |
| [101] | 0.0002441406 | 0.0009765625 | 0.0014648438 | 0.0009765625 | 0.0002441406 |
| [106] | 0.0009765625 | 0.0039062500 | 0.0058593750 | 0.0039062500 | 0.0009765625 |
| [111] | 0.0014648438 | 0.0058593750 | 0.0087890625 | 0.0058593750 | 0.0014648438 |
| [116] | 0.0009765625 | 0.0039062500 | 0.0058593750 | 0.0039062500 | 0.0009765625 |
| [121] | 0.0002441406 | 0.0009765625 | 0.0014648438 | 0.0009765625 | 0.0002441406 |

4.3 Posterior Distribution Over Possible User Profiles

Having specified the prior distribution it is possible to update how likely each profile is using Bayesian updating in the light of the user's visiting history and the average age of her children. In doing so non-visits are treated as missing data.

| | | | | |
|---|---|---|---|---|
| [1] | 6.699979e−005 | 2.806902e−004 | 2.419982e−004 | 3.358869e−005 |
| [5] | 7.632225e−007 | 2.590095e−004 | 1.048043e−003 | 8.304365e−004 |
| [9] | 1.004806e−004 | 1.977892e−006 | 3.137828e−004 | 1.207297e−003 |
| [13] | 8.576925e−004 | 8.910190e−005 | 1.532839e−006 | 9.168272e−005 |
| [17] | 3.277910e−004 | 2.031615e−004 | 1.798016e−005 | 2.730554e−007 |
| [21] | 2.713426e−006 | 8.786706e−006 | 4.663137e−006 | 3.543658e−007 |
| [25] | 4.833893e−009 | 2.192618e−003 | 9.233442e−003 | 8.258069e−003 |
| [29] | 1.155176e−003 | 2.430482e−005 | 7.648856e−003 | 3.110310e−002 |
| [33] | 2.556259e−002 | 3.101062e−003 | 5.578774e−005 | 8.012018e−003 |
| [37] | 3.093900e−002 | 2.274881e−002 | 2.345240e−003 | 3.622275e−005 |
| [41] | 1.874434e−003 | 6.707115e−003 | 4.279089e−003 | 3.699688e−004 |
| [45] | 4.941894e−006 | 4.171720e−005 | 1.352035e−004 | 7.347969e−005 |
| [49] | 5.370655e−006 | 6.336093e−008 | 1.250701e−002 | 5.091771e−002 |
| [53] | 4.476230e−002 | 5.986783e−003 | 1.105110e−004 | 3.542372e−002 |
| [57] | 1.383032e−001 | 1.108921e−001 | 1.270664e−002 | 1.967364e−004 |
| [61] | 2.803246e−002 | 1.029439e−001 | 7.306196e−002 | 6.990032e−003 |
| [65] | 9.072425e−005 | 4.458134e−003 | 1.498357e−002 | 9.095821e−003 |
| [69] | 7.134330e−004 | 7.807930e−006 | 6.285411e−005 | 1.892204e−004 |
| [73] | 9.641495e−005 | 6.249456e−006 | 5.918083e−008 | 6.401432e−003 |
| [77] | 2.328295e−002 | 1.831228e−002 | 2.146807e−003 | 3.223165e−005 |
| [81] | 1.204728e−002 | 4.128927e−002 | 2.912702e−002 | 2.875144e−003 |
| [85] | 3.551597e−005 | 5.800173e−003 | 1.831337e−002 | 1.122342e−002 |
| [89] | 9.069408e−004 | 9.205726e−006 | 5.087200e−004 | 1.438586e−003 |
| [93] | 7.401864e−004 | 4.808128e−005 | 4.049637e−007 | 3.859974e−006 |
| [97] | 9.616884e−006 | 4.095597e−006 | 2.166825e−007 | 1.568099e−009 |
| [101] | 7.607398e−005 | 2.231007e−004 | 1.420848e−004 | 1.364434e−005 |
| [105] | 1.618849e−007 | 8.156078e−005 | 2.226466e−004 | 1.264308e−004 |
| [109] | 1.023321e−005 | 1.003628e−007 | 2.188857e−005 | 5.445354e−005 |
| [113] | 2.677570e−005 | 1.778263e−006 | 1.439724e−008 | 1.051691e−006 |
| [117] | 2.329810e−006 | 9.638923e−007 | 5.174587e−008 | 3.504214e−010 |
| [121] | 4.653072e−009 | 9.110448e−009 | 3.149613e−009 | 1.391284e−010 |
| [125] | 8.202664e−013 | | | |

4.4 Probability of a Visit

This posterior distribution over possible user profiles is then used to work out the likelihood of a visit to each of the 20 attractions. The probability of a visit to Brighton, say, is calculated by working out, for each possible profile, what the probability of visiting Brighton is, and then weighting each of these using the probability that the user's profile is the relevant one. The result is:

| | | | | | | |
|---|---|---|---|---|---|---|
| [1] | 0.3801371 | 0.3874973 | 0.5104397 | 0.4524723 | 0.6982596 | 0.3164832 |
| [7] | 0.4895891 | 0.1248395 | 0.4433899 | 0.2850701 | 0.4509532 | 0.6339611 |
| [13] | 0.3587119 | 0.5523940 | 0.3858625 | 0.3125870 | 0.6476852 | 0.5853585 |
| [19] | 0.3711684 | 0.1843304 | | | | |

Make a Recommendation

The recommended attraction is that one with the highest probability of a visit, but which has not yet been visited. The attraction with the highest probability of a visit is number 5, the science museum. The user has already visited this, however and it is not recommended. The recommendation is item 17, the Natural History museum. The expected probability is 0.648.

Appendix A

This is a numerical example of the implementation of a preferred method according to the invention.

1. Specify the Data

1.1 The Set of Items

The data in the example describe visits to a number of London Attractions. There are 20 attractions. These attractions are labelled in various ways in what follows. The labels, and the attraction identities, are:

| | | |
|---|---|---|
| BRIGHTON | Brighton | 1 |
| CHESS | Chessington | 2 |
| NATGAL | National Gallery | 3 |
| HAMPTON | Hampton Court Gardens | 4 |
| SCIENCE | Science Museum | 5 |
| WHIPSNDE | Whipsnade | 6 |
| LEGO | Legoland | 7 |
| EASTBORN | Eastbourne | 8 |
| LONAQUA | London Aquarium | 9 |
| WESTABBY | Westminster Abbey | 10 |
| KEW | Kew Gardens | 11 |
| LONZOO | London Zoo | 12 |
| MADTUS | Madam Tussauds | 13 |
| BRITMUS | British Museum | 14 |
| OXFORD | Oxford | 15 |
| THORPE | Thorpe Park | 16 |
| NATHIST | Natural History Museum | 17 |
| TOWER | Tower of London | 18 |
| WINDSOR | Windsor Castle | 19 |
| WOBORN | Woburn Wildlife Park | 20 |

1.2 The Data Set

The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in an appendix). As an example, this data records that the first user has visited Brighton and the National Gallery, but not Chessington.

Extract begins

| | | | | | | | | | | | | | | | | | | | |
|---|---|---|---|---|---|---|---|---|---|---|---|---|---|---|---|---|---|---|---|
| 1 | 0 | 1 | 1 | 1 | 0 | 0 | 0 | 1 | 1 | 1 | 1 | 1 | 1 | 1 | 0 | 1 | 1 | 1 | 0 |
| 1 | 1 | 1 | 1 | 1 | 0 | 1 | 1 | 1 | 1 | 1 | 1 | 1 | 1 | 0 | 1 | 1 | 1 | 1 | 0 |
| 0 | 1 | 1 | 1 | 1 | 0 | 1 | 0 | 0 | 1 | 1 | 1 | 1 | 1 | 1 | 1 | 1 | 1 | 1 | 0 |
| 0 | 0 | 1 | 1 | 1 | 0 | 1 | 0 | 1 | 1 | 1 | 1 | 1 | 1 | 1 | 0 | 1 | 1 | 1 | 0 |
| 0 | 0 | 1 | 0 | 1 | 0 | 0 | 0 | 1 | 1 | 1 | 0 | 0 | 1 | 0 | 0 | 1 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 |
| 0 | 1 | 1 | 1 | 1 | 1 | 0 | 1 | 1 | 1 | 0 | 1 | 0 | 1 | 0 | 0 | 1 | 1 | 1 | 0 |
| 1 | 1 | 0 | 1 | 1 | 1 | 1 | 0 | 0 | 1 | 1 | 1 | 0 | 1 | 0 | 1 | 1 | 0 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 |
| 0 | 1 | 1 | 1 | 1 | 0 | 0 | 0 | 0 | 0 | 1 | 0 | 0 | 1 | 0 | 0 | 1 | 1 | 1 | 0 |

Extract ends

2. Generate the Item Profiles

To derive the item profiles from the data the program TWOMISS was used. 2 components were specified. This specification is convenient when the administrator wants to visualise the results.

2.1 Inputs

Generating item profiles from TWVOMISS required setting up a command file that contained the commands and the data. The command file, including the first 10 lines of data, was as follows.

Extract begins

attractions data
624 20 16
1 1 0 0 1 1000 1 0.00000001

| | | | | | | | | | | | | | | | | | | | |
|---|---|---|---|---|---|---|---|---|---|---|---|---|---|---|---|---|---|---|---|
| 1 | 0 | 1 | 1 | 1 | 0 | 0 | 0 | 1 | 1 | 1 | 1 | 1 | 1 | 1 | 0 | 1 | 1 | 1 | 0 |
| 1 | 1 | 1 | 1 | 1 | 0 | 1 | 1 | 1 | 1 | 1 | 1 | 1 | 1 | 0 | 1 | 1 | 1 | 1 | 0 |
| 0 | 1 | 1 | 1 | 1 | 0 | 1 | 0 | 0 | 1 | 1 | 1 | 1 | 1 | 1 | 1 | 1 | 1 | 1 | 0 |
| 0 | 0 | 1 | 1 | 1 | 0 | 1 | 0 | 1 | 1 | 1 | 1 | 1 | 1 | 1 | 0 | 1 | 1 | 1 | 0 |
| 0 | 0 | 1 | 0 | 1 | 0 | 0 | 0 | 1 | 1 | 1 | 0 | 0 | 1 | 0 | 0 | 1 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 |
| 0 | 1 | 1 | 1 | 1 | 1 | 0 | 1 | 1 | 1 | 0 | 1 | 0 | 1 | 0 | 0 | 1 | 1 | 1 | 0 |
| 1 | 1 | 0 | 1 | 1 | 1 | 1 | 0 | 0 | 1 | 1 | 1 | 0 | 1 | 0 | 1 | 1 | 0 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 |
| 0 | 1 | 1 | 1 | 1 | 0 | 0 | 0 | 0 | 0 | 1 | 0 | 0 | 1 | 0 | 0 | 1 | 1 | 1 | 0 |

Extract ends

2.2 Outputs

TWOMISS generated the following output file. Only an extract is shown—a lot of the diagnostics results are omitted.

### ***PROGRAM TWOMISS***

### MAXIMUM LIKELIHOOD ESTIMATION OF A 2 FACTOR LOGIT/PROBIT

### MODEL 1 for NON-RESPONSES for BINARY DATA

attractions data

| | |
|---|---|
| NUMBER OF OBSERVED VARIABLES = | 20 |
| NUMBER OF CASES SAMPLED = | 624 |
| NUMBER OF DIFFERENT RESPONSE | 543 |
| PATTERNS = | |
| NUMBER OF ITERATIONS IS | 408 |
| % OF G-SQUARE EXPLAINED | 9.7217 |
| LOGLIKELIHOOD VALUE | −6301.4533 |
| LIKELIHOOD RATIO STAT. | 3075.62681 |
| DEGREES OF FREEDOM | −48 |

### MAXIMUM LIKELIHOOD ESTIMATES OF ITEM PARAMETERS AND STANDARD DEVIATIONS

| ITEM I | ALPHA(0, I) | S.D | ALPHA(1, I) | S.D | ALPHA(2, I) | S.D | P(X = 1/Z = 0) |
|---|---|---|---|---|---|---|---|
| 1 | −0.6802 | 0.0926 | 0.0704 | 0.1211 | 0.0539 | 0.1331 | 0.336 |
| 2 | −0.2718 | 0.1073 | 0.5666 | 0.7178 | −0.7902 | 0.5099 | 0.432 |
| 3 | −1.8687 | 0.1779 | 0.4720 | 1.0221 | 1.1784 | 0.4671 | 0.134 |
| 4 | −1.1091 | 0.1094 | 0.3798 | 0.4086 | 0.4534 | 0.3757 | 0.248 |
| 5 | −0.0792 | 0.1108 | 0.7731 | 0.6404 | 0.7170 | 0.7036 | 0.480 |
| 6 | −1.6246 | 0.1273 | 0.5688 | 0.1822 | 0.1073 | 0.5121 | 0.165 |
| 7 | −0.0812 | 0.0936 | 0.4707 | 0.2271 | −0.1895 | 0.4279 | 0.480 |
| 8 | −2.2609 | 0.1484 | 0.1971 | 0.1746 | 0.0936 | 0.2577 | 0.094 |
| 9 | −0.8844 | 0.1028 | 0.3768 | 0.3787 | 0.4252 | 0.3589 | 0.292 |
| 10 | −2.6064 | 0.2221 | 0.2910 | 0.8004 | 0.9070 | 0.3510 | 0.069 |
| 11 | −1.5944 | 0.1369 | 0.6185 | 0.6250 | 0.6698 | 0.5662 | 0.169 |
| 12 | −0.0344 | 0.1014 | 0.7496 | 0.2182 | 0.1763 | 0.6720 | 0.491 |
| 13 | −1.5998 | 0.1284 | 0.6243 | 0.2503 | 0.2417 | 0.5751 | 0.168 |
| 14 | −2.2586 | 0.2023 | 0.8328 | 1.0463 | 1.2082 | 0.7884 | 0.095 |
| 15 | −2.4845 | 0.1922 | 0.5724 | 0.7306 | 0.8150 | 0.5343 | 0.077 |
| 16 | −2.5609 | 2.2307 | 3.6515 | 4.8844 | −3.4526 | 4.6125 | 0.072 |
| 17 | −0.3246 | 0.1147 | 0.8504 | 0.6313 | 0.6654 | 0.7504 | 0.420 |
| 18 | −1.3700 | 0.1336 | 0.6666 | 0.6878 | 0.7828 | 0.6334 | 0.203 |
| 19 | −1.9593 | 0.1485 | 0.6560 | 0.4665 | 0.4697 | 0.5873 | 0.124 |
| 20 | −2.5633 | 0.1844 | 0.6230 | 0.2112 | 0.0168 | 0.5718 | 0.072 |

Extract ends

Looking at the table, the attraction is identified in the first column. The item profiles are given in the columns marked ALPHA (0, I)” “ALPHA (1, I)” and “ALPHA (2, I)”. The first of these is the constant term b₀. The other columns give measures of the statistical fit of the model.

As an example consider the British Museum. This is item number 14. The results above give the item profile for the British Museum as:

(b₀, b₁, b₂)=(−2.2586,0.8328,1.2082)

3. Make Recommendations

Once the item profiles have been generated they are used to make recommendations. The following gives an example for a single user. The routines to implement the steps were written in S-Plus, a widely available statistical package. All the routines are straightforward and their functionality could be replicated by one skilled in the art.

3.1 User History

The information set on which recommendations are based gives the visiting history of the user. This is:

| bright | chess | natgal | hampt | science | whip | lego | east | lonaqu | westab | kew |
|---|---|---|---|---|---|---|---|---|---|---|
| 0 | 0 | 1 | 1 | 1 | 0 | 0 | 0 | 0 | 0 | 0 |
| lonzoo | madamt | britm | oxford | thorpe | nathist | tower | wind | woburn | | |
| 0 | 0 | 0 | 0 | 0 | 0 | 0 | 0 | 0 | | |

3.2 Prior Distribution Over Possible User Profiles

This history is used to update a prior distribution over possible user profiles. The first task is to specify the possible profiles. Each possible profile requires two numbers. In this example the possible profiles are:

| | [,1] | [,2] |
|---|---|---|
| [1,] | −2 | −2 |
| [2,] | −2 | −1 |
| [3,] | −2 | 0 |
| [4,] | −2 | 1 |
| [5,] | −2 | 2 |
| [6,] | −1 | −2 |
| [7,] | −1 | −1 |
| [8,] | −1 | 0 |
| [9,] | −1 | 1 |
| [10,] | −1 | 2 |
| [11,] | 0 | −2 |
| [12,] | 0 | −1 |
| [13,] | 0 | 0 |
| [14,] | 0 | 1 |
| [15,] | 0 | 2 |
| [16,] | 1 | −2 |
| [17,] | 1 | −1 |
| [18,] | 1 | 0 |
| [19,] | 1 | 1 |
| [20,] | 1 | 2 |
| [21,] | 2 | −2 |
| [22,] | 2 | −1 |
| [23,] | 2 | 0 |
| [24,] | 2 | 1 |
| [25,] | 2 | 2 |

The probability of each possible profile that is assumed in the prior distribution is then specified. Here the binomial approximation described in the method is used (the following should be read as: the probability of the first profile is 0.0039, the probability of the second is 0.0156, the probability of the third is 0.234 and so on).

| | | | | | |
|---|---|---|---|---|---|
| [1] | 0.00390625 | 0.01562500 | 0.02343750 | 0.01562500 | 0.00390625 |
| [6] | 0.01562500 | 0.06250000 | 0.09375000 | 0.06250000 | 0.01562500 |
| [11] | 0.02343750 | 0.09375000 | 0.14062500 | 0.09375000 | 0.02343750 |
| [16] | 0.01562500 | 0.06250000 | 0.09375000 | 0.06250000 | 0.01562500 |
| [21] | 0.00390625 | 0.01562500 | 0.02343750 | 0.01562500 | 0.00390625 |

3.3 Posterior Distribution Over Possible User Profiles

Having specified the prior distribution it is possible to update how likely each profile is using Bayesian updating in the light of the user's visiting history. In doing so non-visits are treated as missing data.

| | | | | |
|---|---|---|---|---|
| [1] | 4.216343e−005 | 2.112094e−003 | 2.653238e−002 | 8.865934e−002 |
| [5] | 4.837746e−002 | 1.109330e−004 | 1.388096e−002 | 1.472363e−001 |
| [9] | 3.019428e−001 | 7.143967e−002 | 7.536219e−006 | 6.086883e−003 |
| [13] | 1.288960e−001 | 1.397300e−001 | 1.195930e−002 | 8.154766e−008 |
| [17] | 5.951040e−005 | 5.049851e−003 | 7.615486e−003 | 2.471819e−004 |
| [21] | 1.408664e−010 | 5.562026e−008 | 2.743733e−006 | 1.069964e−005 |
| [25] | 5.195977e−007 | | | |

3.4 Probability of a Visit

This posterior distribution over possible user profiles is then used to work out the likelihood of a visit to each attraction. The probability of a visit to Brighton, say, is calculated by working out, for each possible profile, what the probability of visiting Brighton is, and then weighting each of these using the probability that the user's profile is the relevant one. The result is:

| | | | | | | |
|---|---|---|---|---|---|---|
| [1] | 0.3602410 | 0.3465327 | 0.4420367 | 0.4132967 | 0.7439769 | 0.2564223 |
| [7] | 0.5088269 | 0.1176002 | 0.4583606 | 0.2129104 | 0.3982676 | 0.6469330 |
| [13] | 0.2979243 | 0.4219590 | 0.2499722 | 0.2270095 | 0.6982817 | 0.4828844 |
| [19] | 0.2829756 | 0.1180267 | | | | |

3.5 Make a Recommendation

The recommended attraction is that one with the highest probability of a visit, but which has not yet been visited. The attraction with the highest probability of a visit is number 5, the science museum. The user has already visited this, however and it is not recommended. The recommendation is item 17, the Natural History museum. The expected probability is 0.698

Appendix I

The following is an example of the alternative preferred method, using tetrachoric correlations of observations to estimate the correlations between continuous variables.

1. Specify the Data

1.1 The Set of Items

The data in the example describe visits to a number of London Attractions. There are 20 attractions. These attractions are labelled in various ways in what follows. The labels, and the attraction identities, are:

| | | |
|---|---|---|
| BRIGHTON | Brighton | 1 |
| CHESS | Chessington | 2 |
| NATGAL | National Gallery | 3 |
| HAMPTON | Hampton Court Gardens | 4 |
| SCIENCE | Science Museum | 5 |
| WHIPSNDE | Whipsnade | 6 |
| LEGO | Legoland | 7 |
| EASTBORN | Eastbourne | 8 |
| LONAQUA | London Aquarium | 9 |
| WESTABBY | Westminster Abbey | 10 |
| KEW | Kew Gardens | 11 |
| LONZOO | London Zoo | 12 |
| MADTUS | Madam Tussauds | 13 |
| BRITMUS | British Museum | 14 |
| OXFORD | Oxford | 15 |
| THORPE | Thorpe Park | 16 |
| NATHIST | Natural History Museum | 17 |
| TOWER | Tower of London | 18 |
| WINDSOR | Windsor Castle | 19 |
| WOBORN | Woburn Wildlife Park | 20 |

1.2 The Data Set

The data records attendance at each attraction for 624 users. Each user is represented by a row in the data set. The first column in the row is the first attraction (Brighton), the second column is the second attraction (Chessington) and so on. The data records “1” if the user has visited the attraction in the past 4 years, and 0 otherwise. The following gives the first 10 records from the dataset (the full set is in appendix B1). As an example, this data records that the first user has visited Brighton and the National Gallery, but not Chessington.

Extract begins

| | | | | | | | | | | | | | | | | | | | |
|---|---|---|---|---|---|---|---|---|---|---|---|---|---|---|---|---|---|---|---|
| 1 | 0 | 1 | 1 | 1 | 0 | 0 | 0 | 1 | 1 | 1 | 1 | 1 | 1 | 1 | 0 | 1 | 1 | 1 | 0 |
| 1 | 1 | 1 | 1 | 1 | 0 | 1 | 1 | 1 | 1 | 1 | 1 | 1 | 1 | 0 | 1 | 1 | 1 | 1 | 0 |
| 0 | 1 | 1 | 1 | 1 | 0 | 1 | 0 | 0 | 1 | 1 | 1 | 1 | 1 | 1 | 1 | 1 | 1 | 1 | 0 |
| 0 | 0 | 1 | 1 | 1 | 0 | 1 | 0 | 1 | 1 | 1 | 1 | 1 | 1 | 1 | 0 | 1 | 1 | 1 | 0 |
| 0 | 0 | 1 | 0 | 1 | 0 | 0 | 0 | 1 | 1 | 1 | 0 | 0 | 1 | 0 | 0 | 1 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 |
| 0 | 1 | 1 | 1 | 1 | 1 | 0 | 1 | 1 | 1 | 0 | 1 | 0 | 1 | 0 | 0 | 1 | 1 | 1 | 0 |
| 1 | 1 | 0 | 1 | 1 | 1 | 1 | 0 | 0 | 1 | 1 | 1 | 0 | 1 | 0 | 1 | 1 | 0 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 |
| 0 | 1 | 1 | 1 | 1 | 0 | 0 | 0 | 0 | 0 | 1 | 0 | 0 | 1 | 0 | 0 | 1 | 1 | 1 | 0 |

Extract ends

2. Generate the Tetrachoric Correlations

The tetrachoric correlations were calculated using the PRELIS, which is distributed with LISREL, a widely available statistical package. Following is a printout of the output file. The figures should be read from left to right and give only the lower left triangle of the correlation matrix. For example the first number is the tetrachoric correlation between items (1,1), ie between Brighton and Brighton, and so is 1 by definition. The second figure is the tetrachoric correlation between the second items (2,1), ie between Chessington and Brighton. The third figure is for items (2,2), and so on. The pattern is built up as:

| | | | |
|---|---|---|---|
| 1^{st} | (1,1) | | |
| 2^{nd} and 3^{rd} | (2,1) | (2,2) | |
| 4^{th}, 5^{th} and 6^{th} | (3,1) | (3,2) | (3,3) . . . |

Printout starts

| | | | | | |
|---|---|---|---|---|---|
| 0.10000D+01 | 0.30859D−01 | 0.10000D+01 | 0.16190D+00 | −0.57209D−02 | 0.10000D+01 |
| 0.24375D+00 | 0.89119D−01 | 0.28443D+00 | 0.10000D+01 | 0.44469D−01 | −0.83145D−01 |
| 0.38516D+00 | 0.23402D+00 | 0.10000D+01 | 0.51530D−02 | 0.35267D−01 | 0.14557D+00 |
| 0.47440D−01 | 0.94268D−01 | 0.10000D+01 | −0.98718D−01 | 0.38950D−01 | −0.11513D+00 |
| 0.38859D−01 | 0.98427D−01 | 0.12480D+00 | 0.10000D+01 | 0.16793D+00 | 0.79544D−01 |
| 0.87762D−01 | 0.66322D−02 | −0.19969D−01 | 0.17030D+00 | −0.23559D+00 | 0.10000D+01 |
| 0.13250D−01 | −0.9693.8D−01 | 0.67831D−01 | −0.13165D−01 | 0.21256D+00 | 0.50056D−01 |
| 0.17875D+00 | −0.90583D−01 | 0.10000D+01 | 0.80235D−01 | −0.28762D−01 | 0.37060D+00 |
| 0.15095D+00 | −0.87271D−02 | −0.21707D−01 | −0.80627D−01 | 0.24432D+00 | 0.10601D+00 |
| 0.10000D+01 | −0.63046D−02 | 0.15365D−01 | 0.33770D+00 | 0.37511D+00 | 0.26084D+00 |
| 0.50825D−01 | 0.10574D+00 | −0.38016D−01 | 0.19673D+00 | 0.18665D+00 | 0.10000D+01 |
| 0.22228D−01 | −0.69500D−01 | 0.31688D−01 | 0.56343D−01 | 0.23850D+00 | 0.12369D+00 |
| 0.19915D+00 | −0.99709D−02 | 0.28168D+00 | 0.12087D+00 | 0.23019D+00 | 0.10000D+01 |
| −0.61246D−02 | 0.20887D+00 | 0.16278D+00 | 0.45582D−02 | 0.85736D−01 | 0.87777D−01 |
| −0.37335D−02 | 0.91217D−01 | 0.40034D−01 | 0.24536D+00 | 0.10920D+00 | 0.15821D+00 |
| 0.10000D+01 | 0.10096D+00 | −0.15898D−01 | 0.51349D+00 | 0.22662D+00 | 0.35285D+00 |
| 0.78836D−01 | −0.10993D+00 | 0.90954D−01 | 0.22947D+00 | 0.31309D+00 | 0.25470D+00 |
| 0.17321D+00 | 0.27222D+00 | 0.10000D+01 | 0.57412D−01 | −0.10519D+00 | 0.30978D+00 |
| 0.22930D+00 | 0.12568D+00 | 0.15159D+00 | −0.46045D−02 | 0.27738D−01 | 0.15598D+00 |
| 0.34436D+00 | 0.43601D+00 | 0.11179D+00 | 0.23991D+00 | 0.35995D+00 | 0.10000D+01 |
| 0.57234D−01 | 0.51653D+00 | −0.13304D+00 | −0.77538D−02 | 0.43194D−01 | 0.13457D+00 |
| 0.24292D+00 | 0.71213D−01 | −0.50154D−01 | −0.10765D+00 | 0.41262D−01 | 0.23294D+00 |
| 0.15306D+00 | 0.49770D−02 | 0.36588D−01 | 0.10000D+01 | −0.11794D+00 | −0.14578D−01 |
| 0.25259D+00 | 0.10309D+00 | 0.48637D+00 | 0.22474D+00 | 0.15963D+00 | 0.74381D−01 |
| 0.26358D+00 | 0.85570D−01 | 0.16692D+00 | 0.26353D+00 | 0.23114D+00 | 0.39571D+00 |
| 0.90043D−01 | 0.43015D−01 | 0.10000D+01 | −0.11512D−01 | −0.91696D−01 | 0.18703D+00 |
| 0.17115D+00 | 0.17169D+00 | 0.25122D+00 | 0.52008D−02 | 0.25591D+00 | 0.15690D+00 |
| 0.40467D+00 | 0.23005D+00 | 0.14052D+00 | 0.33738D+00 | 0.42158D+00 | 0.31277D+00 |
| 0.86295D−02 | 0.22952D+00 | 0.10000D+01 | −0.43889D−01 | 0.12507D−01 | 0.19668D+00 |
| 0.29888D+00 | 0.22309D−01 | 0.17741D+00 | 0.33198D+00 | 0.41637D−01 | 0.12746D+00 |
| 0.33775D+00 | 0.24784D+00 | 0.14507D+00 | 0.24306D+00 | 0.23457D+00 | 0.43265D+00 |
| 0.97836D−01 | 0.50860D−01 | 0.42644D+00 | 0.10000D+01 | 0.14261D−01 | −0.22059D−02 |
| 0.79836D−01 | −0.21568D−01 | 0.26212D−01 | 0.65122D+00 | 0.78564D−01 | 0.20582D+00 |
| 0.20058D+00 | 0.51469D−02 | 0.12147D+00 | 0.39297D−01 | 0.11774D+00 | 0.14699D+00 |
| −0.33985D−01 | 0.20193D+00 | 0.12043D+00 | 0.19653D+00 | 0.94825D−01 | 0.10000D+01 |

Printout ends

3. Generate the Item Profiles

The following steps were implemented using routines written in S-Plus.

3.1 Generate Item Profiles from a Linear Factor Model

The next step involves estimating a linear factor model using the tetrachoric correlations as though they were product-moment correlations. The function “factanal” in S-Plus was used to do this, using “mle” as the estimation method, and specifying that the model should use the matrix of tetrachoric correlations.

To choose the number of components a model with 1, 2 and 3 components was estimated, and the model which gave the lowest value for the AIC was selected. Here just the output for the 3 factor model is given. In this list Brighton, for example, is identified as “x1”.

| | b1 | b2 | b3 |
|---|---|---|---|
| X1 | 0.09812377 | 0.01172569 | 0.058754708 |
| X2 | −0.04223647 | −0.04764051 | 0.524952031 |
| X3 | 0.58772477 | 0.10554566 | −0.131620998 |
| X4 | 0.40369691 | −0.01218747 | 0.003927246 |
| X5 | 0.42576703 | 0.03238520 | 0.050496584 |
| X6 | 0.10662699 | 0.65120393 | 0.060790719 |
| X7 | 0.03506458 | 0.05954881 | 0.238530868 |
| X8 | 0.11046878 | 0.20506293 | 0.050144673 |
| X9 | 0.25271908 | 0.21336301 | −0.069474679 |
| X10 | 0.51048182 | 0.02588921 | −0.098528948 |
| X11 | 0.49170279 | 0.13060467 | 0.038550361 |
| X12 | 0.28804377 | 0.02624733 | 0.238872437 |
| X13 | 0.36181297 | 0.11430611 | 0.149815576 |
| X14 | 0.65958452 | 0.16336789 | 0.002362186 |
| X15 | 0.59758813 | −0.02425055 | 0.054954849 |
| X16 | −0.02527818 | 0.11813677 | 0.992629902 |
| X17 | 0.40883780 | 0.12757439 | 0.038566893 |
| X18 | 0.54724404 | 0.21079612 | −0.002458373 |
| X19 | 0.48305439 | 0.09853702 | 0.099141707 |
| X20 | −0.02418029 | 0.99611314 | 0.084262195 |

3.2 Transform the Item Profiles

Before using the item profiles in the item functions it is necessary to transform them, and to estimate the constant terms, according to the method described. The result for the 3 factor model is as follows.

| | b1 | b2 | b3 | b0 |
|---|---|---|---|---|
| bright | 0.17916486 | 0.02141001 | 0.107280622 | −0.67148568 |
| chess | −0.09026066 | −0.10180926 | 1.121838928 | −0.21662415 |
| natgal | 1.34721208 | 0.24193703 | −0.301708229 | −1.44990555 |
| hampt | 0.80041830 | −0.02416434 | 0.007786632 | −1.02481696 |
| science | 0.85536112 | 0.06506150 | 0.101447062 | −0.06765865 |
| whip | 0.25824137 | 1.57715976 | 0.147229879 | −1.51394915 |
| lego | 0.06565695 | 0.11150264 | 0.446638983 | −0.06765865 |
| east | 0.20630971 | 0.38297223 | 0.093649385 | −2.23537634 |
| lonaqu | 0.48703898 | 0.41119215 | −0.133891260 | −0.81908402 |
| westab | 1.08441820 | 0.05499653 | −0.209305366 | −2.25396441 |
| kew | 1.03697579 | 0.27543851 | 0.081300719 | −1.36827586 |
| lonzoo | 0.56361160 | 0.05135782 | 0.467398672 | −0.02898754 |
| madamt | 0.71878587 | 0.22708312 | 0.297627027 | −1.46040233 |
| britm | 1.63067053 | 0.40388941 | 0.005839960 | −1.66254774 |
| oxford | 1.35564366 | −0.05501297 | 0.124666452 | −2.11247207 |
| thorpe | −0.04584748 | 0.21426669 | 1.800349935 | −0.74431547 |
| nathist | 0.82136797 | 0.25630094 | 0.077482099 | −0.26891980 |
| tower | 1.22543682 | 0.47203314 | −0.005505005 | −1.13545286 |
| wind | 1.01365495 | 0.20677286 | 0.208041754 | −1.73649679 |
| woburn | −0.04385657 | 1.80668272 | 0.152829077 | −2.39263672 |

3.3 Choose the Number of Components

The number of components is chosen by selecting the model, from the three which have been estimated, which has the lowest AIC. The AIC's are:

| Number of | |
|---|---|
| components | AIC |
| 1 | 12844.76 |
| 2 | 12875.14 |
| 3 | 12833.84 |

The lowest value of the AIC is achieved with 3 components. The selection rule therefore specifies 3 components.

4. Make Recommendations

Once the item profiles have been generated they are used to make recommendations. The following gives an example for a single user. The routines to implement the steps were written in S-Plus, a widely available statistical package. All the routines are straightforward and their functionality could be replicated by one skilled in the art.

4.1 User History

The information set on which recommendations are based gives the visiting history of the user. This is:

| bright | chess | natgal | hampt | science | whip | lego | east | lonaqu | westab | kew |
|---|---|---|---|---|---|---|---|---|---|---|
| 0 | 0 | 1 | 1 | 1 | 0 | 0 | 0 | 0 | 0 | 0 |
| lonzoo | madamt | britm | oxford | thorpe | nathist | tower | wind | woburn | | |
| 0 | 0 | 0 | 0 | 0 | 0 | 0 | 0 | 0 | | |

4.2 Prior Distribution Over Possible User Profiles

This history is used to update a prior distribution over possible user profiles. The first task is to specify the possible profiles. Each possible profile requires three numbers. In this example there are 125 possible profiles. The following gives the first 10. It will be apparent what the remainder would be.

| | [,1] | [,2] | [,3] |
|---|---|---|---|
| [1,] | −2 | −2 | −2 |
| [2,] | −2 | −2 | −1 |
| [3,] | −2 | −2 | 0 |
| [4,] | −2 | −2 | 1 |
| [5,] | −2 | −2 | 2 |
| [6,] | −2 | −1 | −2 |
| [7,] | −2 | −1 | −1 |
| [8,] | −2 | −1 | 0 |
| [9,] | −2 | −1 | 1 |
| [10,] | −2 | −1 | 2 |

The probability of each possible profile that is assumed in the prior distribution is then specified. The binomial approximation described in the method is used (the following should be read as: the probability of the first profile is 0.00024, the probability of the second is 0.00098, the probability of the third is 0.00145 and so on).

| | | | | | |
|---|---|---|---|---|---|
| [1] | 0.0002441406 | 0.0009765625 | 0.0014648438 | 0.0009765625 | 0.0002441406 |
| [6] | 0.0009765625 | 0.0039062500 | 0.0058593750 | 0.0039062500 | 0.0009765625 |
| [11] | 0.0014648438 | 0.0058593750 | 0.0087890625 | 0.0058593750 | 0.0014648438 |
| [16] | 0.0009765625 | 0.0039062500 | 0.0058593750 | 0.0039062500 | 0.0009765625 |
| [21] | 0.0002441406 | 0.0009765625 | 0.0014648438 | 0.0009765625 | 0.0002441406 |
| [26] | 0.0009765625 | 0.0039062500 | 0.0058593750 | 0.0039062500 | 0.0009765625 |
| [31] | 0.0039062500 | 0.0156250000 | 0.0234375000 | 0.0156250000 | 0.0039062500 |
| [36] | 0.0058593750 | 0.0234375000 | 0.0351562500 | 0.0234375000 | 0.0058593750 |
| [41] | 0.0039062500 | 0.0156250000 | 0.0234375000 | 0.0156250000 | 0.0039062500 |
| [46] | 0.0009765625 | 0.0039062500 | 0.0058593750 | 0.0039062500 | 0.0009765625 |
| [51] | 0.0014648438 | 0.0058593750 | 0.0087890625 | 0.0058593750 | 0.0014648438 |
| [56] | 0.0058593750 | 0.0234375000 | 0.0351562500 | 0.0234375000 | 0.0058593750 |
| [61] | 0.0087890625 | 0.0351562500 | 0.0527343750 | 0.0351562500 | 0.0087890625 |
| [66] | 0.0058593750 | 0.0234375000 | 0.0351562500 | 0.0234375000 | 0.0058593750 |
| [71] | 0.0014648438 | 0.0058593750 | 0.0087890625 | 0.0058593750 | 0.0014648438 |
| [76] | 0.0009765625 | 0.0039062500 | 0.0058593750 | 0.0039062500 | 0.0009765625 |
| [81] | 0.0039062500 | 0.0156250000 | 0.0234375000 | 0.0156250000 | 0.0039062500 |
| [86] | 0.0058593750 | 0.0234375000 | 0.0351562500 | 0.0234375000 | 0.0058593750 |
| [91] | 0.0039062500 | 0.0156250000 | 0.0234375000 | 0.0156250000 | 0.0039062500 |
| [96] | 0.0009765625 | 0.0039062500 | 0.0058593750 | 0.0039062500 | 0.0009765625 |
| [101] | 0.0002441406 | 0.0009765625 | 0.0014648438 | 0.0009765625 | 0.0002441406 |
| [106] | 0.0009765625 | 0.0039062500 | 0.0058593750 | 0.0039062500 | 0.0009765625 |
| [111] | 0.0014648438 | 0.0058593750 | 0.0087890625 | 0.0058593750 | 0.0014648438 |
| [116] | 0.0009765625 | 0.0039062500 | 0.0058593750 | 0.0039062500 | 0.0009765625 |
| [121] | 0.0002441406 | 0.0009765625 | 0.0014648438 | 0.0009765625 | 0.0002441406 |

4.3 Posterior Distribution Over Possible User Profiles

Having specified the prior distribution it is then possible to update how likely each profile is using Bayesian updating in the light of the user's visiting history. In doing so non-visits are treated as missing data.

| | | | | |
|---|---|---|---|---|
| [1] | 8.749907e−005 | 1.820013e−004 | 8.450827e−005 | 6.548309e−006 |
| [5] | 7.164878e−008 | 3.961831e−004 | 8.156683e−004 | 3.634953e−004 |
| [9] | 2.570837e−005 | 2.632381e−007 | 5.792464e−004 | 1.157804e−003 |
| [13] | 4.825574e−004 | 3.053029e−005 | 2.878185e−007 | 2.242654e−004 |
| [17] | 4.107871e−004 | 1.499652e−004 | 8.003480e−006 | 6.562691e−008 |
| [21] | 9.523444e−006 | 1.521454e−005 | 4.651408e−006 | 2.044132e−007 |
| [25] | 1.441148e−009 | 3.548322e−003 | 7.103657e−003 | 3.155501e−003 |
| [29] | 2.311364e−004 | 2.311808e−006 | 1.432083e−002 | 2.831893e−002 |
| [33] | 1.204498e−002 | 8.023704e−004 | 7.466107e−006 | 1.782866e−002 |
| [37] | 3.410567e−002 | 1.350949e−002 | 8.000372e−004 | 6.798161e−006 |
| [41] | 5.443664e−003 | 9.491454e−003 | 3.273783e−003 | 1.622767e−004 |
| [45] | 1.189165e−006 | 1.696725e−004 | 2.579233e−004 | 7.446106e−005 |
| [49] | 3.032338e−006 | 1.906306e−008 | 2.416957e−002 | 4.609570e−002 |
| [53] | 1.921800e−002 | 1.300825e−003 | 1.161696e−005 | 7.619505e−002 |
| [57] | 1.435425e−001 | 5.727368e−002 | 3.518754e−003 | 2.910110e−005 |
| [61] | 6.842617e−002 | 1.244226e−001 | 4.611078e−002 | 2.507375e−003 |
| [65] | 1.881609e−005 | 1.348691e−002 | 2.226247e−002 | 7.160354e−003 |
| [69] | 3.245205e−004 | 2.091073e−006 | 2.495306e−004 | 3.594790e−004 |
| [73] | 9.701760e−005 | 3.619574e−006 | 2.006631e−008 | 1.302715e−002 |
| [77] | 2.367770e−002 | 9.259014e−003 | 5.789887e−004 | 4.610520e−006 |
| [81] | 2.541782e−002 | 4.550767e−002 | 1.703579e−002 | 9.686878e−004 |
| [85] | 7.152861e−006 | 1.286919e−002 | 2.206853e−002 | 7.645826e−003 |
| [89] | 3.843336e−004 | 2.575478e−006 | 1.297935e−003 | 1.999784e−003 |
| [93] | 5.987266e−004 | 2.508436e−005 | 1.449616e−007 | 1.201406e−005 |
| [97] | 1.605980e−005 | 4.036751e−006 | 1.399459e−007 | 7.033403e−010 |
| [101] | 1.451943e−004 | 2.442635e−004 | 8.941886e−005 | 5.290626e−006 |
| [105] | 3.924750e−008 | 1.519482e−004 | 2.483600e−004 | 8.636743e−005 |
| [109] | 4.638888e−006 | 3.200580e−008 | 4.069437e−005 | 6.263256e−005 |
| [113] | 1.993554e−005 | 9.415378e−007 | 5.897003e−009 | 2.164317e−006 |
| [117] | 2.948934e−006 | 8.044585e−007 | 3.159448e−008 | 1.714367e−010 |
| [121] | 1.139329e−008 | 1.338166e−008 | 3.060821e−009 | 9.973320e−011 |
| [125] | 4.745181e−013 | | | |

4.4 Probability of a Visit

This posterior distribution over possible user profiles is then used to work out the likelihood of a visit to each attraction. The probability of a visit to Brighton, say, is calculated by working out, for each possible profile, what the probability of visiting Brighton is, and then weighting each of these using the probability that the users profile is the relevant one. The result is:

| | | | | | | |
|---|---|---|---|---|---|---|
| [1] | 0.3870819 | 0.4108272 | 0.5532911 | 0.4876843 | 0.7103175 | 0.3310440 |
| [7] | 0.4949912 | 0.1313193 | 0.4609472 | 0.3095996 | 0.4826755 | 0.6374526 |
| [13] | 0.3675939 | 0.5743559 | 0.4031034 | 0.3512299 | 0.6664543 | 0.5865752 |
| [19] | 0.3916554 | 0.1871927 | | | | |

Make a Recommendation

The recommended attraction is that one with the highest probability of a visit, but which has not yet been visited. The attraction with the highest probability of a visit is number 5, the science museum. The user has already visited this, however and it is not recommended. The recommendation is item 17, the Natural History museum. The expected probability is 0.666.

### Example 7

002

A PCA topping based on scores.

B Step—Estimate the Item Profiles.

First do PCA analysis on the covariance matrix. The following is output from S-PLUS

>cbind(Dom.pca$b[,1:3], hbar=Dom.pca$hbar)

| | PC1 | PC2 | PC3 | hbar |
|---|---|---|---|---|
| bright | 0.01702424 | −0.03265263 | −0.412040936 | 0.33816425 |
| chess | −0.02872608 | 0.62200723 | −0.376592717 | 0.44605475 |
| natgal | 0.20941066 | −0.14936054 | −0.268636236 | 0.19001610 |
| hampt | 0.19091245 | −0.03316651 | −0.347284798 | 0.26409018 |
| science | 0.45500923 | −0.13794577 | −0.038133444 | 0.48309179 |
| whip | 0.12634410 | 0.06386758 | −0.012276090 | 0.18035427 |
| lego | 0.19121826 | 0.36480031 | 0.478449889 | 0.48309179 |
| east | 0.01404058 | −0.00654658 | −0.102627621 | 0.09661836 |
| lonaqu | 0.26664885 | −0.06199254 | 0.233395599 | 0.30595813 |
| westab | 0.07639228 | −0.05113437 | −0.096709504 | 0.09500805 |
| kew | 0.23023112 | −0.02068946 | −0.120386433 | 0.20289855 |
| lonzoo | 0.36141969 | 0.15191398 | 0.265047262 | 0.49275362 |
| madamt | 0.14627349 | 0.09109878 | −0.134194851 | 0.18840580 |
| britm | 0.23483611 | −0.09731590 | −0.183014065 | 0.15942029 |
| oxford | 0.11686354 | −0.04211381 | −0.095154883 | 0.10789050 |
| thorpe | 0.09239023 | 0.60867948 | −0.096328325 | 0.32206119 |
| nathist | 0.46022234 | −0.04100992 | 0.111261162 | 0.43317230 |
| tower | 0.25260849 | −0.08283769 | −0.147741804 | 0.24315620 |
| wind | 0.14447895 | 0.05180584 | −0.044192512 | 0.14975845 |
| woburn | 0.05506417 | 0.03430597 | −0.003405975 | 0.08373591 |

The item profile for bright, for example, is:

b₀=0.338

b₁, b₂, b₃=0.017, −0.032, −0.412

A Step—Learn About a Case Profile

The user has visited the following attractions.

| > h | | | | | | | | | | | |
|---|---|---|---|---|---|---|---|---|---|---|---|
| bright | chess | natgal | hampt | science | whip | lego | east | lonaqu | westab | kew | lonzoo |
| 0 | 0 | 1 | 1 | 1 | 0 | 0 | 0 | 0 | 0 | 0 | 0 |
| madamt | britm | oxford | thorpe | nathist | tower | wind | woburn | | | | |
| 0 | 0 | 0 | 0 | 0 | 0 | 0 | 0 | 0 | | | |

This implies a case profile of:

| > (h - Dom.pca$hbar) %*% Dom.pca$b[,1:3] | | |
|---|---|---|
| PC1 | PC2 | PC3 |
| −0.2721838 | −0.882913 | −0.482576 |

Y Step—Make Predictions

Predicted likelihood for item 1 (i.e. function of user and item profiles)

>((h-Dom.pca$hbar) %*% Dom.pca$b[,1:31) %*% t(Dom.pca$b[1, 1:3, drop=F])+Dom.pca$hbar[1]

bright

0.561201

Predicted likelihood for each of the items

>((h-Dom.pca$hbar) %*% Dom.pca$b[,1:3]) %* t(Dom.pca$b[,1:3]) +Dom.pca$hbar

| bright | chess | natgal | hampt | science | whip | lego |
|---|---|---|---|---|---|---|
| 0.561201 | 0.08642984 | 0.3945277 | 0.4090014 | 0.4994421 | 0.09550008 | −0.1219301 |
| east | lonaqu | westab | kew | lonzoo | madamt | britm |
| 0.1481024 | 0.1754836 | 0.1660322 | 0.2165960 | 0.1323488 | 0.1329194 | 0.2697414 |
| oxford | thorpe | nathist | tower | wind | woburn | |
| 0.1591844 | −0.1940112 | 0.2904235 | 0.3188354 | 0.08601982 | 0.04010279 | |

And a recommendation

>recomm(((h-Dom.pca$hbar) %*% Dom.pca$b[,1:3]) %*% t(Dom.pca$bf,1:3])+Dom.pca$hbar, h)

$item

[1]1

$p

[1]0.561201

### Example 8

019

Example of using the restricted user history for the topping. First get some item profiles.

>lep.b

$b

| | b1 | b2 | b3 | b0 |
|---|---|---|---|---|
| bright | 0.17916486 | 0.02141001 | 0.107280622 | −0.67148568 |
| chess | −0.09026066 | −0.10180926 | 1.121838928 | −0.21662415 |
| natgal | 1.34721208 | 0.24193703 | −0.301708229 | −1.44990555 |
| hampt | 0.80041830 | −0.02416434 | 0.007786632 | −1.02481696 |
| science | 0.85536112 | 0.06506150 | 0.101447062 | −0.06765865 |
| whip | 0.25824137 | 1.57715976 | 0.147229879 | −1.51394915 |
| lego | 0.06565695 | 0.11150264 | 0.446638983 | −0.06765865 |
| east | 0.20630971 | 0.38297223 | 0.093649385 | −2.23537634 |
| lonagu | 0.48703898 | 0.41119215 | −0.133891260 | −0.81908402 |
| westab | 1.08441820 | 0.05499653 | −0.209305366 | −2.25396441 |
| kew | 1.03697579 | 0.27543851 | 0.081300719 | −1.36827586 |
| lonzoo | 0.56361160 | 0.05135782 | 0.467398672 | −0.02898754 |
| madamt | 0.71878587 | 0.22708312 | 0.297627027 | −1.46040233 |
| britm | 1.63067053 | 0.40388941 | 0.005839960 | −1.66254774 |
| oxford | 1.35564366 | −0.05501297 | 0.124666452 | −2.11247207 |
| thorpe | −0.04584748 | 0.21426669 | 1.800349935 | −0.74431547 |
| nathist | 0.82136797 | 0.25630094 | 0.077482099 | −0.26891980 |
| tower | 1.22543682 | 0.47203314 | −0.005505005 | −1.13545286 |
| wind | 1.01365495 | 0.20677286 | 0.208041754 | −1.73649679 |
| woburn | −0.04385657 | 1.80668272 | 0.152829077 | −2.39263672 |

Next get the set of observations about the case in question

| > h | | | | | | | | |
|---|---|---|---|---|---|---|---|---|
| bright | chess | natgal | hampt | science | whip | lego | east | lonaqu |
| 0 | 0 | 1 | 1 | 1 | 0 | 0 | 0 | 0 |
| westab | kew | lonzoo | madamt | britm | oxford | thorpe | nathist | tower |
| 0 | 0 | 0 | 0 | 0 | 0 | 0 | 0 | 0 |
| wind | woburn | | | | | | | |
| 0 | 0 | | | | | | | |

We want to know whether this person is likely to go to Brighton next. So before updating knowledge of her profile we replace the first observation with a missing.

| > h.1 | | | | | | | | |
|---|---|---|---|---|---|---|---|---|
| bright | chess | natgal | hampt | science | whip | lego | east | lonaqu |
| NA | 0 | 1 | 1 | 1 | 0 | 0 | 0 | 0 |
| westab | kew | lonzoo | madamt | britm | oxford | thorpe | nathist | tower |
| 0 | 0 | 0 | 0 | 0 | 0 | 0 | 0 | 0 |
| wind | woburn | | | | | | | |
| 0 | 0 | | | | | | | |

Now start with the prior distribution over possible user profiles.

>prior

$x

| | [,1] | [,2] | [,3] |
|---|---|---|---|
| [1,] | −2 | −2 | −2 |
| [2,] | −2 | −2 | −1 |
| [3,] | −2 | −2 | 0 |
| [4,] | −2 | −2 | 1 |
| [5,] | −2 | −2 | 2 |
| [6,] | −2 | −1 | −2 |
| [7,] | −2 | −1 | −1 |
| [8,] | −2 | −1 | 0 |
| [9,] | −2 | −1 | 1 |
| [10,] | −2 | −1 | 2 |
| [11,] | −2 | 0 | −2 |
| [12,] | −2 | 0 | −1 |
| [13,] | −2 | 0 | 0 |
| [14,] | −2 | 0 | 1 |
| [15,] | −2 | 0 | 2 |
| [16,] | −2 | 1 | −2 |
| [17,] | −2 | 1 | −1 |
| [18,] | −2 | 1 | 0 |
| [19,] | −2 | 1 | 1 |
| [20,] | −2 | 1 | 2 |
| [21,] | −2 | 2 | −2 |
| [22,] | −2 | 2 | −1 |
| [23,] | −2 | 2 | 0 |
| [24,] | −2 | 2 | 1 |
| [25,] | −2 | 2 | 2 |
| [26,] | −1 | −2 | −2 |
| [27,] | −1 | −2 | −1 |
| [28,] | −1 | −2 | 0 |
| [29,] | −1 | −2 | 1 |
| [30,] | −1 | −2 | 2 |
| [31,] | −1 | −1 | −2 |
| [32,] | −1 | −1 | −1 |
| [33,] | −1 | −1 | 0 |
| [34,] | −1 | −1 | 1 |
| [35,] | −1 | −1 | 2 |
| [36,] | −1 | 0 | −2 |
| [37,] | −1 | 0 | −1 |
| [38,] | −1 | 0 | 0 |
| [39,] | −1 | 0 | 1 |
| [40,] | −1 | 0 | 2 |
| [41,] | −1 | 1 | −2 |
| [42,] | −1 | 1 | −1 |
| [43,] | −1 | 1 | 0 |
| [44,] | −1 | 1 | 1 |
| [45,] | −1 | 1 | 2 |
| [46,] | −1 | 2 | −2 |
| [47,] | −1 | 2 | −1 |
| [48,] | −1 | 2 | 0 |
| [49,] | −1 | 2 | 1 |
| [50,] | −1 | 2 | 2 |
| [51,] | 0 | −2 | −2 |
| [52,] | 0 | −2 | −1 |
| [53,] | 0 | −2 | 0 |
| [54,] | 0 | −2 | 1 |
| [55,] | 0 | −2 | 2 |
| [56,] | 0 | −1 | −2 |
| [57,] | 0 | −1 | −1 |
| [58,] | 0 | −1 | 0 |
| [59,] | 0 | −1 | 1 |
| [60,] | 0 | −1 | 2 |
| [61,] | 0 | 0 | −2 |
| [62,] | 0 | 0 | −1 |
| [63,] | 0 | 0 | 0 |
| [64,] | 0 | 0 | 1 |
| [65,] | 0 | 0 | 2 |
| [66,] | 0 | 1 | −2 |
| [67,] | 0 | 1 | −1 |
| [68,] | 0 | 1 | 0 |
| [69,] | 0 | 1 | 1 |
| [70,] | 0 | 1 | 2 |
| [71,] | 0 | 2 | −2 |
| [72,] | 0 | 2 | −1 |
| [78,] | 1 | −2 | 0 |
| [79,] | 1 | −2 | 1 |
| [80,] | 1 | −2 | 2 |
| [81,] | 1 | −1 | −2 |
| [82,] | 1 | −1 | −1 |
| [83,] | 1 | −1 | 0 |
| [84,] | 1 | −1 | 1 |
| [85,] | 1 | −1 | 2 |
| [86,] | 1 | 0 | −2 |
| [87,] | 1 | 0 | −1 |
| [88,] | 1 | 0 | 0 |
| [89,] | 1 | 0 | 1 |
| [90,] | 1 | 0 | 2 |
| [91,] | 1 | 1 | −2 |
| [92,] | 1 | 1 | −1 |
| [93,] | 1 | 1 | 0 |
| [94,] | 1 | 1 | 1 |
| [95,] | 1 | 1 | 2 |
| [96,] | 1 | 2 | −2 |
| [97,] | 1 | 2 | −1 |
| [98,] | 1 | 2 | 0 |
| [99,] | 1 | 2 | 1 |
| [100,] | 1 | 2 | 2 |
| [101,] | 2 | −2 | −2 |
| [102,] | 2 | −2 | −1 |
| [103,] | 2 | −2 | 0 |
| [104,] | 2 | −2 | 1 |
| [105,] | 2 | −2 | 2 |
| [106,] | 2 | −1 | −2 |
| [107,] | 2 | −1 | −1 |
| [108,] | 2 | −1 | 0 |
| [109,] | 2 | −1 | 1 |
| [110,] | 2 | −1 | 2 |
| [111,] | 2 | 0 | −2 |
| [112,] | 2 | 0 | −1 |
| [113,] | 2 | 0 | 0 |
| [114,] | 2 | 0 | 1 |
| [115,] | 2 | 0 | 2 |
| [116,] | 2 | 1 | −2 |
| [117,] | 2 | 1 | −1 |
| [118,] | 2 | 1 | 0 |
| [119,] | 2 | 1 | 1 |
| [120,] | 2 | 1 | 2 |
| [121,] | 2 | 2 | −2 |
| [122,] | 2 | 2 | −1 |
| [123,] | 2 | 2 | 0 |
| [124,] | 2 | 2 | 1 |
| [125,] | 2 | 2 | 2 |

$density

| | | | | | |
|---|---|---|---|---|---|
| [1] | 0.0002441406 | 0.0009765625 | 0.0014648438 | 0.0009765625 | 0.0002441406 |
| [6] | 0.0009765625 | 0.0039062500 | 0.0058593750 | 0.0039062500 | 0.0009765625 |
| [11] | 0.0014648438 | 0.0058593750 | 0.0087890625 | 0.0058593750 | 0.0014648438 |
| [16] | 0.0009765625 | 0.0039062500 | 0.0058593750 | 0.0039062500 | 0.0009765625 |
| [21] | 0.0002441406 | 0.0009765625 | 0.0014648438 | 0.0009765625 | 0.0002441406 |
| [26] | 0.0009765625 | 0.0039062500 | 0.0058593750 | 0.0039062500 | 0.0009765625 |
| [31] | 0.0039062500 | 0.0156250000 | 0.0234375000 | 0.0156250000 | 0.0039062500 |
| [36] | 0.0058593750 | 0.0234375000 | 0.0351562500 | 0.0234375000 | 0.0058593750 |
| [41] | 0.0039062500 | 0.0156250000 | 0.0234375000 | 0.0156250000 | 0.0039062500 |
| [46] | 0.0009765625 | 0.0039062500 | 0.0058593750 | 0.0039062500 | 0.0009765625 |
| [51] | 0.0014648438 | 0.0058593750 | 0.0087890625 | 0.0058593750 | 0.0014648438 |
| [56] | 0.0058593750 | 0.0234375000 | 0.0351562500 | 0.0234375000 | 0.0058593750 |
| [61] | 0.0087890625 | 0.0351562500 | 0.0527343750 | 0.0351562500 | 0.0087890625 |
| [66] | 0.0058593750 | 0.0234375000 | 0.0351562500 | 0.0234375000 | 0.0058593750 |
| [71] | 0.0014648438 | 0.0058593750 | 0.0087890625 | 0.0058593750 | 0.0014648438 |
| [76] | 0.0009765625 | 0.0039062500 | 0.0058593750 | 0.0039062500 | 0.0009765625 |
| [81] | 0.0039062500 | 0.0156250000 | 0.0234375000 | 0.0156250000 | 0.0039062500 |
| [86] | 0.0058593750 | 0.0234375000 | 0.0351562500 | 0.0234375000 | 0.0058593750 |
| [91] | 0.0039062500 | 0.0156250000 | 0.0234375000 | 0.0156250000 | 0.0039062500 |
| [96] | 0.0009765625 | 0.0039062500 | 0.0058593750 | 0.0039062500 | 0.0009765625 |
| [101] | 0.0002441406 | 0.0009765625 | 0.0014648438 | 0.0009765625 | 0.0002441406 |
| [106] | 0.0009765625 | 0.0039062500 | 0.0058593750 | 0.0039062500 | 0.0009765625 |
| [111] | 0.0014648438 | 0.0058593750 | 0.0087890625 | 0.0058593750 | 0.0014648438 |
| [116] | 0.0009765625 | 0.0039062500 | 0.0058593750 | 0.0039062500 | 0.0009765625 |
| [121] | 0.0002441406 | 0.0009765625 | 0.0014648438 | 0.0009765625 | 0.0002441406 |

Update this in the light of the modified set of observations

>do.user.dist(h.1, prior, lep.b$b)

$x

$ density

| | | | | | |
|---|---|---|---|---|---|
| [1] | 7.672890e−05 | 1.635089e−04 | 7.794280e−05 | 6.213913e−06 | 7.011357e−08 |
| [6] | 3.490438e−04 | 7.365193e−04 | 3.371046e−04 | 2.454116e−05 | 2.592575e−07 |
| [11] | 5.127550e−04 | 1.050861e−03 | 4.500308e−04 | 2.932081e−05 | 2.853203e−07 |
| [16] | 1.994830e−04 | 3.748035e−04 | 1.406532e−04 | 7.733731e−06 | 6.548919e−08 |
| [21] | 8.512749e−06 | 1.395594e−05 | 4.387817e−06 | 1.987583e−07 | 1.447813e−09 |
| [26] | 3.243640e−03 | 6.676244e−03 | 3.055914e−03 | 2.312031e−04 | 2.394440e−06 |
| [31] | 1.316148e−02 | 2.676985e−02 | 1.173815e−02 | 8.080382e−04 | 7.789287e−06 |
| [36] | 1.647478e−02 | 3.243054e−02 | 1.324935e−02 | 8.112264e−04 | 7.144813e−06 |
| [41] | 5.058183e−03 | 9.079432e−03 | 3.231540e−03 | 1.656939e−04 | 1.259165e−06 |
| [46] | 1.585460e−04 | 2.482305e−04 | 7.398349e−05 | 3.118099e−06 | 2.033852e−08 |
| [51] | 2.317040e−02 | 4.560712e−02 | 1.967198e−02 | 1.381112e−03 | 1.282665e−05 |
| [56] | 7.349274e−02 | 1.429598e−01 | 5.904360e−02 | 3.764450e−03 | 3.239402e−05 |
| [61] | 6.641006e−02 | 1.247488e−01 | 4.787870e−02 | 2.703213e−03 | 2.111866e−05 |
| [66] | 1.317223e−02 | 2.247279e−02 | 7.489297e−03 | 3.526124e−04 | 2.366655e−06 |
| [71] | 2.452715e−04 | 3.653819e−04 | 1.022277e−04 | 3.964182e−06 | 2.290390e−08 |
| [76] | 1.318247e−02 | 2.483070e−02 | 1.008892e−02 | 6.572711e−04 | 5.467797e−06 |
| [81] | 2.589950e−02 | 4.807970e−02 | 1.871111e−02 | 1.109051e−03 | 8.560060e−06 |
| [86] | 1.320545e−02 | 2.349219e−02 | 8.465754e−03 | 4.438305e−04 | 3.110557e−06 |
| [91] | 1.341369e−03 | 2.145120e−03 | 6.683755e−04 | 2.922139e−05 | 1.767116e−07 |
| [96] | 1.250612e−05 | 1.736093e−05 | 4.543827e−06 | 1.644732e−07 | 8.654834e−10 |
| [101] | 1.561765e−04 | 2.734836e−04 | 1.044944e−04 | 6.471019e−06 | 5.038589e−08 |
| [106] | 1.647185e−04 | 2.803943e−04 | 1.018283e−04 | 5.727670e−06 | 4.150223e−08 |
| [111] | 4.446394e−05 | 7.130991e−05 | 2.371643e−05 | 1.173679e−06 | 7.724482e−09 |
| [116] | 2.383790e−06 | 3.386293e−06 | 9.657758e−07 | 3.976672e−08 | 2.268751e−10 |
| [121] | 1.265075e−08 | 1.549984e−08 | 3.708606e−09 | 1.267636e−10 | 6.344982e−13 |

Get the predicted likelihood of visiting the first attraction

>do.pred(lep.b, h.1, 1, prior)

[1]0.312789

Repeat this for each attraction, recalculating the posterior each time. This gives:

>mh(lep.b, h, 1:20, prior)

| | | | | | | |
|---|---|---|---|---|---|---|
| [1] | 0.31278903 | 0.27180617 | 0.16427276 | 0.24566550 | 0.41710747 | 0.12806525 |
| [7] | 0.36447443 | 0.07352558 | 0.29817359 | 0.13808571 | 0.19315128 | 0.39286417 |
| [13] | 0.14204873 | 0.18939037 | 0.13652884 | 0.13132923 | 0.40522199 | 0.24230986 |
| [19] | 0.13127001 | 0.06436074 | | | | |

And a recommendation

>recomm(mh(lep.b, h, 1:20, prior), h)

$item

[1]17

$P

[1]0.405222

### Example 9

### DATE: Jun. 26, 2001

### TIME: 15:06

### L I S R E L 8.30

### BY

### Karl G. J″reskog & Dag S″rbom

### This program is published exclusively by Scientific Software International, Inc. 7383 N. Lincoln Avenue, Suite 100 Lincolnwood, Ill. 60712, U.S.A. Phone: (800)247-6113, (847)675-0720, Fax: (847)675-2140 Copyright by Scientific Software International, Inc., 1981-2000 Use of this program is subject to the terms specified in the Universal Copyright Convention. Website: www.ssicentral.com

The following lines were read from file C:\WINDOWS\DESKTOP\LISREL\1006LA3.LPJ:

This example uses prior knowledge about the attractions in order to build a model which may be more readily interpreted. We have defined 5 characteristics that people may value when choosing an attraction

SW fringes

Beach

Museum

Animals

Adventure park

We then assumed a latent trait for each characteristic, and fixed the loading to be 0 for those attractions we considered did not indicate that trait.

We added 2 further latent traits, one each for oxford and madame Tussauds. We did not consider that either indicated any of the other characteristics. For these two, only one loading is free—on oxford for oxford, and on Madame Tussauds for Madame Tussauds. To prevent estimation problems we fixed the value of the unique variance to be 0.3 for both attractions.

DA NI=21 NO=624 MA=PM

Labels;

BRIGHT CHESS NATGAL HAMPTON SCIENCE WHIP LEGO EAST LAQUA WABBEY KEW LZOO

MTUSS BRITM OXFORD THORPE NATHIST TOWER WINDSOR WOBURN OLDKID

PM Fl=LAkids.cma

AC Fl=LAkids.acc

SE

BRIGHT CHESS NATGAL HAMPTON SCIENCE WHIP LEGO EAST LAQUA WABBEY KEW LZOO

MTUSS BRITM OXFORD THORPE

NATHIST TOWER WINDSOR WOBURN/

MO NX=20 NK=7 TD=DI

PA LX

| * | | | | | | |
|---|---|---|---|---|---|---|
| 0 | 1 | 0 | 0 | 0 | 0 | 0! Brighton |
| 1 | 0 | 0 | 0 | 1 | 0 | 0! Chessington |
| 0 | 0 | 1 | 0 | 0 | 0 | 0! National Gallery |
| 1 | 0 | 0 | 0 | 0 | 0 | 0! Hampton Court Gardens |
| 0 | 0 | 1 | 0 | 0 | 0 | 0! Science Museum |
| 0 | 0 | 0 | 1 | 0 | 0 | 0! Whipsnade |
| 1 | 0 | 0 | 0 | 0 | 0 | 0! Lego Land |
| 0 | 1 | 0 | 0 | 0 | 0 | 0! Eastbourne |
| 0 | 0 | 0 | 1 | 0 | 0 | 0! London Aquarium |
| 0 | 0 | 1 | 0 | 0 | 0 | 0! Westminster Abbey |
| 1 | 0 | 0 | 0 | 0 | 0 | 0! Kew |
| 0 | 0 | 0 | 1 | 0 | 0 | 0! London Zoo |
| 0 | 0 | 0 | 0 | 0 | 0 | 1! Madam Tussauds |
| 0 | 0 | 1 | 0 | 0 | 0 | 0! British Museum |
| 0 | 0 | 0 | 0 | 0 | 1 | 0! Oxford |
| 1 | 0 | 0 | 0 | 1 | 0 | 0! Thorpe Park |
| 0 | 0 | 1 | 1 | 0 | 0 | 0! Natural History Museum |
| 0 | 0 | 1 | 0 | 0 | 0 | 0! Tower of London |
| 1 | 0 | 0 | 0 | 0 | 0 | 0! Windsor Castle |
| 0 | 0 | 0 | 1 | 0 | 0 | 0! Woburn |

PA PH

| | | | | | | | | | |
|---|---|---|---|---|---|---|---|---|---|
| * | | | | | | | | | |
| 1 | | | | | | | | | |
| 1 | 1 | | | | | | | | |
| 1 | 1 | 1 | | | | | | | |
| 1 | 1 | 1 | 1 | | | | | | |
| 1 | 1 | 1 | 0 | 1 | | | | | |
| 1 | 1 | 1 | 1 | 1 | 1 | | | | |
| 1 | 1 | 1 | 1 | 1 | 1 | 1 | | | |
| ! | 0 | 0 | 0 | 0 | 0 | 0 | 0 | 1 | |
| ! | 0 | 0 | 0 | 0 | 0 | 0 | 0 | 0 | 1 |

PA TD
*
1
1
1
1
1
1
1
1
1
1
1
0
1
0
1
1
1
1
1

VA 0.3 TD(15,15) TD(13,13)

!Path diagram

OU AD =200 SE MI

This example uses prior knowledge about the attractions in order to build a mod

Number of Input Variables 21

Number of Y-Variables 0

Number of X-Variables 20

Number of ETA-Variables 0

Number of KSI-Variables 7

Number of Observations 624

This example uses prior knowledge about the attractions in order to build a mod Correlation Matrix to be Analyzed

| | BRIGHT | CHESS | NATGAL | HAMPTON | SCIENCE | WHIP |
|---|---|---|---|---|---|---|
| BRIGHT | 1.00 | | | | | |
| CHESS | 0.03 | 1.00 | | | | |
| NATGAL | 0.16 | −0.01 | 1.00 | | | |
| HAMPTON | 0.24 | 0.08 | 0.28 | 1.00 | | |
| SCIENCE | 0.04 | −0.09 | 0.38 | 0.23 | 1.00 | |
| WHIP | 0.00 | 0.03 | 0.14 | 0.04 | 0.09 | 1.00 |
| LEGO | −0.10 | 0.03 | −0.12 | 0.03 | 0.09 | 0.12 |
| EAST | 0.17 | 0.08 | 0.09 | 0.00 | −0.02 | 0.17 |
| LAQUA | 0.01 | −0.10 | 0.06 | −0.02 | 0.21 | 0.05 |
| WABBEY | 0.08 | −0.03 | 0.37 | 0.15 | −0.01 | −0.02 |
| KEW | −0.01 | 0.01 | 0.34 | 0.37 | 0.26 | 0.05 |
| LZOO | 0.02 | −0.08 | 0.03 | 0.05 | 0.23 | 0.12 |
| MTUSS | −0.01 | 0.21 | 0.16 | 0.00 | 0.08 | 0.09 |
| BRITM | 0.10 | −0.02 | 0.51 | 0.22 | 0.35 | 0.08 |
| OXFORD | 0.05 | −0.11 | 0.31 | 0.23 | 0.12 | 0.15 |
| THORPE | 0.05 | 0.51 | −0.14 | −0.01 | 0.04 | 0.13 |
| NATHIST | −0.12 | −0.02 | 0.25 | 0.10 | 0.48 | 0.22 |
| TOWER | −0.01 | −0.10 | 0.18 | 0.17 | 0.17 | 0.25 |
| WINDSOR | −0.05 | 0.01 | 0.19 | 0.30 | 0.02 | 0.18 |
| WOBURN | 0.01 | −0.01 | 0.08 | −0.02 | 0.02 | 0.65 |

Correlation Matrix to be Analyzed

| | | | | | | |
|---|---|---|---|---|---|---|
| LEGO | 1.00 | | | | | |
| EAST | −0.24 | 1.00 | | | | |
| LAQUA | 0.17 | −0.09 | 1.00 | | | |
| WABBEY | −0.08 | 0.24 | 0.10 | 1.00 | | |
| KEW | 0.10 | −0.04 | 0.19 | 0.18 | 1.00 | |
| LZOO | 0.19 | −0.01 | 0.28 | 0.12 | 0.23 | 1.00 |
| MTUSS | −0.01 | 0.09 | 0.04 | 0.24 | 0.11 | 0.15 |
| BRITM | −0.11 | 0.09 | 0.23 | 0.31 | 0.25 | 0.17 |
| OXFORD | −0.01 | 0.03 | 0.15 | 0.34 | 0.43 | 0.11 |
| THORPE | 0.24 | 0.07 | −0.05 | −0.11 | 0.04 | 0.23 |
| NATHIST | 0.15 | 0.07 | 0.26 | 0.08 | 0.16 | 0.26 |
| TOWER | 0.00 | 0.25 | 0.15 | 0.40 | 0.23 | 0.14 |
| WINDSOR | 0.33 | 0.04 | 0.12 | 0.34 | 0.25 | 0.14 |
| WOBURN | 0.08 | 0.20 | 0.20 | 0.00 | 0.12 | 0.04 |

Correlation Matrix to be Analyzed

| | MTUSS | BRITM | OXFORD | THORPE | NATHIST | TOWER |
|---|---|---|---|---|---|---|
| MTUSS | 1.00 | | | | | |
| BRITM | 0.27 | 1.00 | | | | |
| OXFORD | 0.24 | 0.36 | 1.00 | | | |
| THORPE | 0.15 | 0.00 | 0.03 | 1.00 | | |
| NATHIST | 0.23 | 0.39 | 0.09 | 0.04 | 1.00 | |
| TOWER | 0.34 | 0.42 | 0.31 | 0.01 | 0.23 | 1.00 |
| WINDSOR | 0.24 | 0.23 | 0.43 | 0.10 | 0.05 | 0.42 |
| WOBURN | 0.12 | 0.15 | −0.04 | 0.20 | 0.12 | 0.19 |

Correlation Matrix to be Analyzed

| | WINDSOR | WOBURN |
|---|---|---|
| WINDSOR | 1.00 | |
| WOBURN | 0.09 | 1.00 |

This example uses prior knowledge about the attractions in order to build a mod

Parameter Specifications

LAMBDA-X

| | KSI 1 | KSI 2 | KSI 3 | KSI 4 | KSI 5 | KSI 6 | KSI 7 |
|---|---|---|---|---|---|---|---|
| BRIGHT | 0 | 1 | 0 | 0 | 0 | 0 | 0 |
| CHESS | 2 | 0 | 0 | 0 | 3 | 0 | 0 |
| NATGAL | 0 | 0 | 4 | 0 | 0 | 0 | 0 |
| HAMPTON | 5 | 0 | 0 | 0 | 0 | 0 | 0 |
| SCIENCE | 0 | 0 | 6 | 0 | 0 | 0 | 0 |
| WHIP | 0 | 0 | 0 | 7 | 0 | 0 | 0 |
| LEGO | 8 | 0 | 0 | 0 | 0 | 0 | 0 |
| EAST | 0 | 9 | 0 | 0 | 0 | 0 | 0 |
| LAQUA | 0 | 0 | 0 | 10 | 0 | 0 | 0 |
| WABBEY | 0 | 0 | 11 | 0 | 0 | 0 | 0 |
| KEW | 12 | 0 | 0 | 0 | 0 | 0 | 0 |
| LZOO | 0 | 0 | 0 | 13 | 0 | 0 | 0 |
| MTUSS | 0 | 0 | 0 | 0 | 0 | 0 | 14 |
| BRITM | 0 | 0 | 15 | 0 | 0 | 0 | 0 |
| OXFORD | 0 | 0 | 0 | 0 | 0 | 16 | 0 |
| THORPE | 17 | 0 | 0 | 0 | 18 | 0 | 0 |
| NATHIST | 0 | 0 | 19 | 20 | 0 | 0 | 0 |
| TOWER | 0 | 0 | 21 | 0 | 0 | 0 | 0 |
| WINDSOR | 22 | 0 | 0 | 0 | 0 | 0 | 0 |
| WOBURN | 0 | 0 | 0 | 23 | 0 | 0 | 0 |

| | PHI | | | | | | |
|---|---|---|---|---|---|---|---|
| | KSI 1 | KSI 2 | KSI 3 | KSI 4 | KSI 5 | KSI 6 | KSI 7 |
| KSI 1 | 0 | | | | | | |
| KSI 2 | 24 | 0 | | | | | |
| KSI 3 | 25 | 26 | 0 | | | | |
| KSI 4 | 27 | 28 | 29 | 0 | | | |
| KSI 5 | 30 | 31 | 32 | 0 | 0 | | |
| KSI 6 | 33 | 34 | 35 | 36 | 37 | 0 | |
| KSI 7 | 38 | 39 | 40 | 41 | 42 | 43 | 0 |

THETA-DELTA

| | | | | |
|---|---|---|---|---|
| BRIGHT | CHESS | NATGAL | HAMPTON | SCIENCE |
| 44 | 45 | 46 | 47 | 48 |
| WHIP | LEGO | EAST | LAQUA | WABBEY |
| 49 | 50 | 51 | 52 | 53 |
| KEW | LZOO | MTUSS | BRITM | OXFORD |
| 54 | 55 | 0 | 56 | 0 |
| THORPE | NATHIST | TOWER | WINDSOR | WOBURN |
| 57 | 58 | 59 | 60 | 62 |

This example uses prior knowledge about the attractions in order to build a mod

Number of Iterations=35

LISREL Estimates (Weighted Least Squares)

| | LAMBDA-X | | | | | | |
|---|---|---|---|---|---|---|---|
| | KSI 1 | KSI 2 | KSI 3 | KSI 4 | KSI 5 | KSI 6 | KSI 7 |
| BRIGHT | — | 0.41 | — | — | — | — | — |
| | | (0.06) | | | | | |
| | | 6.55 | | | | | |
| CHESS | 0.14 | — | — | — | 0.96 | — | — |
| | (0.11) | | | | (0.17) | | |
| | 1.31 | | | | 5.78 | | |
| NATGAL | — | — | 0.79 | — | — | — | — |
| | | | (0.04) | | | | |
| | | | 21.01 | | | | |
| HAMPTON | 0.66 | — | — | — | — | — | — |
| | (0.05) | | | | | | |
| | 14.63 | | | | | | |
| SCIENCE | — | — | 0.60 | — | — | — | — |
| | | | (0.03) | | | | |
| | | | 19.43 | | | | |
| WHIP | — | — | — | 0.74 | — | — | — |
| | | | | (0.04) | | | |
| | | | | 18.64 | | | |
| LEGO | 0.36 | — | — | — | — | — | — |
| | (0.04) | | | | | | |
| | 9.01 | | | | | | |
| EAST | — | 0.75 | — | — | — | — | — |
| | | (0.11) | | | | | |
| | | 7.04 | | | | | |
| LAQUA | — | — | — | 0.53 | | | — |
| | | | | (0.05) | | | |
| | | | | 10.99 | | | |
| WABBEY | — | — | 0.52 | — | — | — | — |
| | | | (0.05) | | | | |
| | | | 9.78 | | | | |
| KEW | 0.75 | — | — | — | — | — | — |
| | (0.05) | | | | | | |
| | 15.33 | | | | | | |
| LZOO | — | — | — | 0.40 | | | — |
| | | | | (0.04) | | | |
| | | | | 9.80 | | | |
| MTUSS | — | — | — | — | — | — | 0.84 |
| | | | | | | | (0.02) |
| | | | | | | | 34.94 |
| BRITM | — | — | 0.82 | — | — | — | — |
| | | | (0.04) | | | | |
| | | | 18.84 | | | | |
| OXFORD | — | — | — | — | — | 0.84 | — |
| | | | | | | (0.02) | |
| | | | | | | 34.94 | |
| THORPE | 0.19 | — | — | — | 0.62 | — | — |
| | (0.08) | | | | (0.11) | | |
| | 2.28 | | | | 5.58 | | |
| NATHIST | — | — | 0.63 | −0.03 | — | — | — |
| | | | (0.08) | (0.09) | | | |
| | | | 7.99 | −0.37 | | | |
| TOWER | — | — | 0.68 | — | — | — | — |
| | | | (0.04) | | | | |
| | | | 18.51 | | | | |
| WINDSOR | 0.74 | — | — | — | — | — | — |
| | (0.05) | | | | | | |
| | 13.75 | | | | | | |
| WOBURN | — | — | — | 0.96 | — | — | — |
| | | | | (0.06) | | | |
| | | | | 16.12 | | | |

| | PHI | | | | | | |
|---|---|---|---|---|---|---|---|
| | KSI 1 | KSI 2 | KSI 3 | KSI 4 | KSI 5 | KSI 6 | KSI 7 |
| KSI 1 | 1.00 | | | | | | |
| KSI 2 | 0.43 | 1.00 | | | | | |
| | (0.10) | | | | | | |
| | 4.46 | | | | | | |
| KSI 3 | 0.65 | 0.56 | 1.00 | | | | |
| | (0.05) | (0.10) | | | | | |
| | 14.34 | 5.73 | | | | | |
| KSI 4 | 0.49 | 0.63 | 0.65 | 1.00 | | | |
| | (0.06) | (0.10) | (0.05) | | | | |
| | 8.20 | 6.14 | 13.30 | | | | |
| KSI 5 | 0.15 | 0.15 | −0.04 | — | 1.00 | | |
| | (0.12) | (0.09) | (0.08) | | | | |
| | 1.27 | 1.60 | −0.55 | | | | |
| KSI 6 | 0.62 | 0.20 | 0.42 | 0.19 | 0.00 | 1.00 | |
| | (0.07) | (0.12) | (0.07) | (0.09) | (0.10) | | |
| | 8.85 | 1.71 | 6.13 | 2.17 | 0.03 | | |
| KSI 7 | 0.43 | 0.50 | 0.67 | 0.50 | 0.23 | 0.30 | 1.00 |
| | (0.07) | (0.12) | (0.06) | (0.07) | (0.08) | (0.09) | |
| | 5.76 | 4.10 | 10.89 | 7.04 | 2.84 | 3.18 | |

THETA-DELTA

| | | | | | |
|---|---|---|---|---|---|
| BRIGHT | CHESS | NATGAL | HAMPTON | SCIENCE | WHIP |
| 0.84 | 0.03 | 0.37 | 0.56 | 0.64 | 0.45 |
| (0.06) | (0.31) | (0.07) | (0.07) | (0.05) | (0.07) |
| 13.01 | 0.10 | 5.21 | 7.85 | 11.69 | 6.27 |
| LEGO | EAST | LAQUA | WABBEY | KEW | LZOO |
| 0.87 | 0.44 | 0.72 | 0.73 | 0.43 | 0.84 |
| (0.05) | (0.16) | (0.06) | (0.07) | (0.08) | (0.05) |
| 17.59 | 2.66 | 11.16 | 10.79 | 5.12 | 16.35 |
| MTUSS | BRITM | OXFORD | THORPE | NATHIST | TOWER |
| 0.30 | 0.33 | 0.30 | 0.54 | 0.62 | 0.53 |
| | (0.08) | | (0.14) | (0.06) | (0.06) |
| | 4.10 | | 3.78 | 10.50 | 8.30 |
| WINDSOR | WOBURN | | | | |
| 0.45 | 0.08 | | | | |
| (0.09) | (0.12) | | | | |
| 4.97 | 0.65 | | | | |

Squared Multiple Correlations for X - Variables

| | | | | | |
|---|---|---|---|---|---|
| BRIGHT | CHESS | NATGAL | HAMPTON | SCIENCE | WHIP |
| 0.16 | 0.97 | 0.63 | 0.44 | 0.36 | 0.55 |
| LEGO | EAST | LAQUA | WABBEY | KEW | LZOO |
| 0.13 | 0.56 | 0.28 | 0.27 | 0.57 | 0.16 |
| MTUSS | BRITM | OXFORD | THORPE | MATHIST | TOWER |
| 0.70 | 0.67 | 0.70 | 0.46 | 0.38 | 0.47 |
| WINDSOR | WOBURN | | | | |
| 0.55 | 0.92 | | | | |

### Goodness of Fit Statistics

Degrees of Freedom 149

Minimum Fit Function Chi-Square 381.65 (P=0.0)

Estimated Non-centrality Parameter (NCP)=232.65

90 Percent Confidence Interval for NCP=(178.79 ; 294.19)

Minimum Fit Function Value=0.61

Population Discrepancy Function Value (F0)=0.37

90 Percent Confidence Interval for F0=(0.29 ; 0.47)

Root Mean Square Error of Approximation (RMSEA)=0.050

90 Percent Confidence Interval for RMSEA=(0.044 ; 0.056)

P-Value for Test of Close Fit (RMSEA<0.05)=0.48

Expected Cross-Validation Index (ECVI)=0.81

90 Percent Confidence Interval for ECVI=(0.72 ; 0.91)

ECVI for Saturated Model=0.67

ECVI for Indepence Model=3.01

Chi-Square for Independence Model with 190 Degrees of Freedom=1837.13

Independence AIC=1877.13

Model AIC—503.65

Saturated AIC=420.00

Independence CAIC=1985.85

Model CAIC—835.25

Saturated CAIC=1561.59

Normed Fit Index (NFI)=0.79

Non-Normed Fit Index (NNFI)=0.82

Parsimony Formed Fit Index (PNFI)=0.62

Comparative Fit Index (CFI)=0.86

Incremental Fit Index (IFI)=0.86

Relative Fit Index (RFI)=0.74

Critical N (CN)=314.54

Root Mean Square Residual (RMR)=0.16

Standardized RMR=0.16

Goodness of Fit Index (GFI)=0.97

Adjusted Goodness of Fit Index (AGFI)=0.96

Parsimony Goodness of Fit Index (PGFI) 0.69

This example uses prior knowledge about the attractions in order to build a mod Modification Indices and Expected Change

Modification Indices for LAMBDA-X

| | KSI 1 | KSI 2 | KSI 3 | KSI 4 | KSI 5 | KSI 6 |
|---|---|---|---|---|---|---|
| BRIGHT | 0.33 | — | 0.04 | 1.00 | 1.80 | 0.02 |
| CHESS | — | 0.40 | 0.85 | 0.10 | — | 1.94 |
| NATGAL | 0.43 | 0.16 | — | 0.06 | 0.04 | 0.09 |
| HAMPTON | — | 2.36 | 3.71 | 12.89 | 1.22 | 0.00 |
| SCIENCE | 0.30 | 3.93 | — | 1.28 | 2.97 | 0.28 |
| WHIP | 0.03 | 1.08 | 0.01 | — | 0.14 | 1.38 |
| LEGO | — | 6.53 | 8.82 | 0.02 | 0.28 | 2.44 |
| EAST | 0.33 | — | 0.04 | 1.00 | 1.80 | 0.02 |
| LAQUA | 1.25 | 0.60 | 15.01 | — | 1.43 | 1.12 |
| WABBEY | 1.96 | 0.53 | — | 0.49 | 1.87 | 4.32 |
| KEW | — | 0.32 | 0.06 | 4.12 | 0.47 | 6.73 |
| LZOO | 18.75 | 4.40 | 19.25 | — | 0.96 | 15.38 |
| MTUSS | — | — | — | — | — | — |
| BRITM | 1.74 | 0.18 | — | 0.20 | 0.00 | 0.00 |
| OXFORD | — | — | — | — | — | — |
| THORPE | — | 0.40 | 0.85 | 0.10 | — | 1.94 |
| NATHIST | 4.21 | 0.15 | — | — | 0.49 | 2.02 |
| TOWER | 6.47 | 0.63 | — | 2.08 | 0.07 | 1.68 |
| WINDSOR | — | 5.20 | 11.17 | 2.72 | 0.43 | 2.77 |
| WOBURN | 9.80 | 0.03 | 29.98 | — | 0.38 | 17.27 |

Modification Indices for LAMBDA-X

KSI 7

| | |
|---|---|
| BRIGHT | 0.27 |
| CHESS | 1.07 |
| NATGAL | 0.51 |
| HAMPTON | 6.20 |
| SCIENCE | 9.54 |
| WHIP | 2.24 |
| LEGO | 7.32 |
| EAST | 0.27 |
| LAQUA | 0.33 |
| WABBEY | 0.58 |
| KEW | 0.08 |
| LZOO | 13.18 |
| MTUSS | — |
| BRITM | 0.01 |
| OXFORD | — |
| THORPE | 1.07 |
| NATHIST | 9.13 |
| TOWER | 0.23 |
| WINDSOR | 14.42 |
| WOBURN | 0.94 |

Expected Change for LAMBDA-X

| | KSI 1 | KSI 2 | KSI 3 | KSI 4 | KSI 5 | KSI 6 |
|---|---|---|---|---|---|---|
| BRIGHT | 0.06 | — | −0.03 | 0.18 | −0.08 | 0.01 |
| CHESS | — | −0.08 | 0.12 | 0.03 | — | −0.23 |
| NATGAL | 0.06 | 0.04 | — | −0.02 | −0.01 | −0.02 |
| HAMPTON | — | −0.14 | −0.16 | −0.24 | 0.07 | −0.01 |
| SCIENCE | −0.04 | −0.18 | — | −0.10 | −0.09 | −0.03 |
| WHIP | −0.01 | −0.17 | 0.01 | — | −0.02 | 0.10 |
| LEGO | — | −0.20 | −0.23 | 0.01 | 0.03 | −0.15 |
| EAST | −0.11 | — | 0.05 | −0.34 | 0.16 | −0.02 |
| LAQUA | 0.09 | −0.11 | 0.42 | — | −0.07 | 0.09 |
| WABBEY | 0.15 | 0.09 | — | 0.08 | 0.09 | 0.21 |
| KEW | — | 0.05 | 0.02 | 0.15 | −0.05 | 0.33 |
| LZOO | 0.31 | 0.26 | 0.40 | — | 0.05 | 0.29 |
| MTUSS | — | — | — | — | — | — |
| BRITM | −0.13 | 0.04 | — | −0.04 | 0.00 | 0.00 |
| OXFORD | — | — | — | — | — | — |
| THORPE | — | 0.05 | −0.08 | −0.02 | — | 0.15 |
| NATHIST | −0.16 | −0.04 | — | — | 0.04 | −0.09 |
| TOWER | 0.22 | 0.08 | — | 0.13 | 0.01 | 0.11 |
| WINDSOR | — | 0.21 | 0.29 | 0.14 | −0.04 | −0.20 |
| WOBURN | −0.31 | 0.03 | −0.75 | — | 0.04 | −0.42 |

Expected Change for LAMBDA-X

KSI 7

| | |
|---|---|
| BRIGHT | 0.07 |
| CHESS | 0.13 |
| NATGAL | −0.08 |
| HAMPTON | −0.20 |
| SCIENCE | −0.32 |
| WHIP | −0.16 |
| LEGO | −0.21 |
| EAST | −0.14 |
| LAQUA | 0.06 |
| WABBEY | 0.10 |
| KEW | 0.03 |
| LZOO | 0.33 |
| MTUSS | — |
| BRITM | −0.01 |
| OXFORD | — |
| THORPE | −0.08 |
| NATHIST | 0.33 |
| TOWER | 0.06 |
| WINDSOR | 0.34 |
| WOBURN | −0.12 |

No Non-Zero Modification Indices for PHI

Modification Indices for THETA-DELTA

| | BRIGHT | CHESS | NATGAL | HAMPTON | SCIENCE | WHIP |
|---|---|---|---|---|---|---|
| BRIGHT | — | | | | | |
| CHESS | 9.82 | — | | | | |
| NATGAL | 0.57 | 2.74 | — | | | |
| HAMPTON | 14.26 | 2.59 | 2.90 | — | | |
| SCIENCE | 0.00 | 1.50 | 4.58 | 2.18 | — | |
| WHIP | 1.73 | 0.27 | 1.39 | 7.22 | 3.20 | — |
| LEGO | 0.12 | 2.59 | 2.33 | 0.03 | 0.02 | 0.93 |
| EAST | — | 0.31 | 0.35 | 0.12 | 1.81 | 3.08 |
| LAQUA | 1.46 | 2.42 | 0.13 | 8.36 | 0.83 | 22.40 |
| WABBEY | 4.15 | 1.43 | 0.02 | 0.48 | 7.71 | 1.50 |
| KEW | 0.46 | 0.00 | 3.81 | 1.98 | 0.03 | 1.40 |
| LZOO | 0.64 | 4.54 | 0.34 | 0.03 | 2.43 | 0.07 |
| MTUSS | 3.37 | 2.50 | 0.36 | 3.81 | 6.08 | 4.11 |
| BRITM | 0.50 | 0.08 | 1.79 | 0.04 | 0.31 | 2.29 |
| OXFORD | 0.29 | 3.03 | 0.97 | 0.52 | 0.49 | 5.91 |
| THORPE | 3.08 | — | 8.07 | 0.66 | 0.09 | 0.05 |
| NATHIST | 6.82 | 1.92 | 0.58 | 0.13 | 20.84 | 4.41 |
| TOWER | 8.19 | 2.97 | 5.42 | 5.23 | 0.22 | 7.79 |
| WINDSOR | 0.14 | 0.08 | 5.44 | 1.46 | 0.38 | 2.35 |
| WOBURN | 1.45 | 0.08 | 2.16 | 0.37 | 0.08 | 51.51 |

Modification Indices for THETA-DELTA

| | LEGO | EAST | LAQUA | WABBEY | KEW | LZOO |
|---|---|---|---|---|---|---|
| LEGO | — | | | | | |
| EAST | 15.03 | — | | | | |
| LAQUA | 7.04 | 6.23 | — | | | |
| WABBEY | 0.79 | 1.17 | 0.19 | — | | |
| KEW | 0.00 | 0.27 | 1.65 | 0.17 | — | |
| LZOO | 1.60 | 0.35 | 2.66 | 4.19 | 11.82 | — |
| MTUSS | 1.44 | 3.37 | 2.70 | 0.03 | 0.03 | 1.70 |
| BRITM | 5.99 | 0.46 | 4.77 | 0.02 | 1.28 | 0.01 |
| OXFORD | 0.81 | 0.29 | 0.05 | 5.09 | 13.04 | 1.32 |
| THORPE | 10.71 | 1.33 | 8.33 | 0.00 | 0.17 | 15.28 |
| NATHIST | 0.35 | 0.30 | 1.88 | 0.14 | 4.16 | 1.49 |
| TOWER | 1.18 | 3.35 | 5.63 | 0.54 | 0.22 | 0.11 |
| WINDSOR | 12.13 | 1.07 | 0.02 | 0.05 | 12.81 | 2.17 |
| WOBURN | 1.12 | 7.28 | 3.09 | 2.17 | 5.16 | 21.60 |

Modification Indices for THETA-DELTA

| | MTUSS | BRITM | OXFORD | THORPE | NATHIST | TOWER |
|---|---|---|---|---|---|---|
| MTUSS | — | | | | | |
| BRITM | 0.22 | — | | | | |
| OXFORD | — | 0.83 | — | | | |
| THORPE | 2.50 | 0.83 | 3.03 | — | | |
| NATHIST | 10.07 | 0.10 | 0.34 | 1.47 | — | |
| TOWER | 0.46 | 0.76 | 0.00 | 4.05 | 6.03 | — |
| WINDSOR | 7.99 | 0.00 | 5.73 | 1.04 | 2.00 | 4.72 |
| WOBURN | 5.30 | 0.19 | 9.32 | 0.00 | 9.72 | 6.85 |

Modification Indices for THETA-DELTA

| | WINDSOR | WOBURN |
|---|---|---|
| WINDSOR | — | — |
| WOBURN | 6.98 | — |

Expected Change for THETA-DELTA

| | BRIGHT | CHESS | NATGAL | HAMPTON | SCIENCE | WHIP |
|---|---|---|---|---|---|---|
| BRIGHT | — | | | | | |
| CHESS | −0.18 | — | | | | |
| NATGAL | 0.04 | 0.09 | — | | | |
| HAMPTON | 0.22 | 0.10 | −0.09 | — | | |
| SCIENCE | 0.00 | −0.06 | 0.12 | 0.08 | — | |
| WHIP | 0.08 | 0.03 | 0.06 | −0.14 | −0.09 | — |
| LEGO | −0.02 | −0.08 | −0.08 | −0.01 | −0.01 | 0.06 |
| EAST | — | 0.05 | 0.04 | −0.03 | −0.08 | −0.14 |
| LAQUA | 0.07 | 0.08 | −0.02 | −0.14 | 0.05 | −0.27 |
| WABBEY | 0.14 | 0.06 | −0.01 | −0.04 | −0.15 | −0.07 |
| KEW | −0.04 | 0.00 | 0.11 | 0.08 | −0.01 | −0.06 |
| LZOO | −0.04 | −0.11 | −0.03 | −0.01 | 0.08 | −0.01 |
| MTUSS | 0.12 | 0.19 | −0.04 | −0.11 | −0.13 | −0.11 |
| BRITM | 0.04 | −0.02 | 0.08 | −0.01 | −0.03 | −0.07 |
| OXFORD | −0.04 | −0.16 | −0.06 | −0.04 | −0.03 | 0.17 |
| THORPE | 0.10 | — | −0.14 | −0.04 | 0.01 | −0.01 |
| NATHIST | −0.13 | 0.07 | −0.04 | 0.02 | 0.23 | 0.12 |
| TOWER | −0.15 | −0.09 | −0.12 | 0.11 | −0.02 | 0.14 |
| WINDSOR | −0.02 | −0.02 | 0.12 | 0.07 | −0.03 | 0.09 |
| WOBURN | −0.08 | −0.02 | −0.09 | −0.04 | −0.02 | 0.84 |

Expected Change for THETA-DELTA

| | LEGO | EAST | LAQUA | WABBEY | KEW | LZOO |
|---|---|---|---|---|---|---|
| LEGO | — | | | | | |
| EAST | −0.26 | — | | | | |
| LAQUA | 0.14 | −0.16 | — | | | |
| WABBEY | 0.05 | −0.07 | −0.03 | — | | |
| KEW | 0.00 | −0.04 | 0.07 | −0.02 | — | |
| LZOO | 0.06 | 0.04 | 0.09 | 0.11 | 0.18 | — |
| MTUSS | −0.07 | −0.22 | −0.10 | −0.01 | −0.01 | 0.08 |
| BRITM | −0.12 | 0.04 | 0.11 | 0.01 | −0.06 | −0.01 |
| OXFORD | −0.05 | 0.07 | −0.01 | 0.16 | 0.25 | 0.07 |
| THORPE | 0.17 | 0.08 | −0.14 | 0.00 | −0.02 | 0.20 |
| NATHIST | 0.03 | 0.03 | 0.07 | 0.02 | −0.11 | 0.06 |
| TOWER | −0.05 | 0.13 | 0.12 | 0.05 | 0.02 | −0.02 |
| WINDSOR | 0.22 | 0.07 | 0.01 | 0.01 | −0.20 | −0.08 |
| WOBURN | 0.07 | 0.24 | 0.13 | 0.11 | 0.14 | −0.29 |

Expected Change for THETA-DELTA

| | MTUSS | BRITM | OXFORD | THORPE | NATHIST | TOWER |
|---|---|---|---|---|---|---|
| MTUSS | — | | | | | |
| BRITM | −0.03 | — | | | | |
| OXFORD | — | 0.05 | — | | | |
| THORPE | −0.12 | 0.05 | 0.10 | — | | |
| NATHIST | 0.18 | −0.02 | −0.03 | −0.06 | — | |
| TOWER | 0.04 | 0.04 | 0.00 | 0.10 | −0.12 | — |
| WINDSOR | 0.17 | 0.00 | −0.15 | −0.06 | −0.07 | 0.11 |
| WOBURN | 0.14 | −0.02 | −0.29 | 0.00 | −0.20 | −0.15 |

Expected Change for THETA-DELTA

| | WINDSOR | WOBURN |
|---|---|---|
| WINDSOR | — | |
| WOBURN | −0.22 | — |

Maximum Modification Index is 51.51 for Element (20, 6) of THETA-DELTA

The Problem used 297584 Bytes (=0.4% of Available Workspace)

Time used: 12.910 Seconds

| | | | | | | | | | | | | | | | | | | | | |
|---|---|---|---|---|---|---|---|---|---|---|---|---|---|---|---|---|---|---|---|---|
| 0 | 0 | 1 | 1 | 1 | 0 | 0 | 0 | 0 | 0 | 0 | 0 | 0 | 0 | 0 | 0 | 0 | 0 | 0 | 0 | 0 |
| 0 | 1 | 0 | 1 | 1 | 0 | 0 | 0 | 0 | 0 | 0 | 0 | 0 | 0 | 0 | 0 | 0 | 0 | 0 | 0 | 0 |
| 1 | 1 | 0 | 0 | 0 | 1 | 1 | 0 | 0 | 0 | 0 | 0 | 0 | 0 | 0 | 0 | 0 | 0 | 0 | 0 | 0 |
| 0 | 0 | 0 | 0 | 0 | 0 | 1 | 0 | 0 | 0 | 0 | 1 | 0 | 0 | 0 | 0 | 1 | 0 | 0 | 0 | 0 |
| 0 | 0 | 0 | 0 | 1 | 0 | 1 | 0 | 0 | 0 | 1 | 0 | 0 | 0 | 0 | 0 | 0 | 0 | 0 | 0 | 0 |
| 0 | 0 | 0 | 1 | 0 | 0 | 0 | 0 | 0 | 0 | 0 | 0 | 0 | 1 | 1 | 0 | 0 | 0 | 0 | 0 | 0 |
| 0 | 1 | 1 | 1 | 1 | 0 | 0 | 0 | 0 | 0 | 0 | 0 | 0 | 0 | 0 | 0 | 0 | 0 | 0 | 0 | 1 |
| 0 | 0 | 0 | 0 | 0 | 0 | 1 | 0 | 1 | 0 | 0 | 0 | 0 | 0 | 0 | 0 | 1 | 0 | 0 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 0 |
| 1 | 0 | 1 | 0 | 0 | 0 | 0 | 0 | 0 | 1 | 0 | 0 | 0 | 0 | 0 | 0 | 0 | 0 | 0 | 0 | 0 |
| 1 | 1 | 0 | 0 | 1 | 0 | 0 | 0 | 0 | 0 | 0 | 0 | 0 | 0 | 0 | 0 | 0 | 0 | 0 | 0 | 0 |
| 1 | 1 | 0 | 0 | 1 | 0 | 0 | 0 | 0 | 0 | 0 | 0 | 0 | 0 | 0 | 0 | 0 | 0 | 0 | 0 | 1 |
| 0 | 0 | 0 | 0 | 0 | 0 | 1 | 0 | 0 | 0 | 0 | 1 | 0 | 0 | 0 | 0 | 1 | 0 | 0 | 0 | 1 |
| 1 | 0 | 1 | 0 | 0 | 0 | 0 | 0 | 0 | 0 | 1 | 0 | 0 | 0 | 0 | 0 | 0 | 0 | 0 | 0 | 1 |
| 0 | 0 | 0 | 0 | 1 | 0 | 0 | 0 | 0 | 0 | 0 | 0 | 0 | 0 | 0 | 0 | 1 | 0 | 0 | 0 | 0 |
| 1 | 0 | 0 | 0 | 0 | 1 | 0 | 0 | 0 | 0 | 0 | 1 | 0 | 0 | 0 | 0 | 0 | 0 | 0 | 0 | 0 |
| 0 | 0 | 0 | 0 | 1 | 0 | 0 | 0 | 0 | 0 | 0 | 0 | 1 | 0 | 0 | 0 | 1 | 0 | 0 | 0 | 1 |
| 0 | 0 | 1 | 1 | 1 | 0 | 1 | 0 | 0 | 0 | 1 | 0 | 0 | 0 | 0 | 0 | 0 | 0 | 0 | 0 | 0 |
| 0 | 1 | 0 | 0 | 1 | 0 | 0 | 0 | 0 | 0 | 0 | 0 | 0 | 0 | 0 | 1 | 1 | 0 | 0 | 0 | 0 |
| 0 | 1 | 0 | 0 | 1 | 0 | 1 | 0 | 0 | 1 | 0 | 1 | 0 | 0 | 0 | 1 | 1 | 1 | 1 | 0 | 0 |
| 0 | 1 | 0 | 0 | 1 | 0 | 1 | 0 | 1 | 0 | 0 | 0 | 1 | 0 | 0 | 0 | 0 | 0 | 0 | 0 | 0 |
| 0 | 0 | 0 | 0 | 1 | 0 | 0 | 0 | 0 | 0 | 0 | 0 | 0 | 1 | 0 | 0 | 1 | 0 | 0 | 0 | 1 |
| 1 | 0 | 0 | 0 | 1 | 1 | 0 | 0 | 1 | 0 | 0 | 0 | 0 | 0 | 0 | 0 | 1 | 0 | 0 | 0 | 0 |
| 1 | 0 | 1 | 0 | 1 | 0 | 0 | 1 | 1 | 1 | 0 | 0 | 0 | 1 | 1 | 0 | 1 | 1 | 0 | 0 | 1 |
| 1 | 1 | 0 | 0 | 0 | 1 | 0 | 0 | 0 | 0 | 0 | 1 | 1 | 0 | 0 | 0 | 0 | 1 | 1 | 0 | 1 |
| 0 | 1 | 0 | 1 | 1 | 1 | 0 | 1 | 0 | 0 | 0 | 0 | 0 | 0 | 0 | 1 | 1 | 0 | 0 | 0 | 1 |
| 0 | 0 | 0 | 0 | 1 | 0 | 1 | 0 | 0 | 0 | 1 | 0 | 1 | 0 | 1 | 0 | 1 | 0 | 0 | 0 | 0 |
| 0 | 1 | 0 | 0 | 0 | 0 | 1 | 0 | 0 | 0 | 0 | 0 | 1 | 0 | 0 | 0 | 0 | 0 | 0 | 0 | 1 |
| 0 | 0 | 1 | 0 | 1 | 1 | 1 | 0 | 1 | 0 | 0 | 1 | 0 | 0 | 0 | 0 | 1 | 0 | 0 | 0 | 0 |
| 1 | 0 | 1 | 1 | 0 | 0 | 0 | 0 | 0 | 0 | 1 | 0 | 0 | 0 | 0 | 0 | 0 | 0 | 0 | 0 | 0 |
| 0 | 0 | 0 | 0 | 0 | 0 | 0 | 0 | 1 | 0 | 0 | 1 | 0 | 0 | 0 | 0 | 0 | 0 | 0 | 0 | 0 |
| 0 | 1 | 0 | 1 | 0 | 0 | 1 | 0 | 0 | 1 | 0 | 0 | 0 | 0 | 0 | 0 | 0 | 0 | 0 | 0 | 0 |
| 0 | 1 | 0 | 1 | 0 | 0 | 1 | 1 | 0 | 0 | 0 | 0 | 0 | 0 | 0 | 0 | 0 | 0 | 0 | 0 | 0 |
| 0 | 1 | 0 | 0 | 1 | 1 | 0 | 0 | 0 | 0 | 0 | 1 | 1 | 0 | 0 | 0 | 1 | 0 | 0 | 0 | 0 |
| 1 | 1 | 0 | 0 | 1 | 0 | 0 | 0 | 0 | 0 | 0 | 1 | 0 | 0 | 0 | 1 | 1 | 0 | 0 | 0 | 0 |
| 0 | 1 | 1 | 1 | 1 | 0 | 1 | 1 | 0 | 0 | 1 | 1 | 0 | 0 | 0 | 1 | 1 | 0 | 0 | 0 | 0 |
| 0 | 1 | 0 | 0 | 0 | 1 | 0 | 0 | 1 | 0 | 0 | 0 | 0 | 0 | 1 | 0 | 0 | 0 | 0 | 0 | 1 |
| 0 | 1 | 0 | 1 | 0 | 1 | 0 | 0 | 0 | 0 | 0 | 0 | 0 | 0 | 0 | 0 | 1 | 0 | 1 | 0 | 1 |
| 1 | 1 | 0 | 0 | 0 | 0 | 1 | 1 | 1 | 0 | 0 | 1 | 0 | 0 | 0 | 1 | 0 | 1 | 0 | 0 | 0 |
| 1 | 1 | 1 | 1 | 0 | 0 | 0 | 0 | 0 | 0 | 0 | 0 | 0 | 0 | 0 | 0 | 0 | 0 | 0 | 0 | 0 |
| 0 | 1 | 0 | 0 | 1 | 0 | 0 | 0 | 1 | 0 | 1 | 0 | 0 | 0 | 1 | 1 | 0 | 0 | 0 | 0 | 1 |
| 0 | 1 | 1 | 1 | 1 | 1 | 1 | 0 | 1 | 0 | 0 | 1 | 1 | 1 | 0 | 1 | 1 | 1 | 1 | 0 | 1 |
| 0 | 0 | 1 | 0 | 0 | 0 | 1 | 1 | 0 | 1 | 0 | 1 | 0 | 0 | 1 | 0 | 0 | 1 | 1 | 0 | 0 |
| 1 | 1 | 0 | 0 | 0 | 0 | 1 | 1 | 1 | 1 | 0 | 1 | 0 | 1 | 1 | 0 | 0 | 0 | 0 | 0 | 0 |
| 0 | 0 | 0 | 0 | 0 | 0 | 1 | 1 | 0 | 0 | 0 | 0 | 0 | 0 | 0 | 0 | 1 | 1 | 0 | 0 | 1 |
| 1 | 0 | 0 | 0 | 0 | 0 | 0 | 0 | 0 | 1 | 0 | 0 | 0 | 0 | 0 | 0 | 1 | 0 | 0 | 0 | 0 |
| 1 | 0 | 0 | 0 | 0 | 0 | 0 | 1 | 0 | 0 | 0 | 0 | 0 | 0 | 0 | 0 | 0 | 1 | 1 | 0 | 0 |
| 0 | 1 | 1 | 0 | 1 | 0 | 0 | 0 | 0 | 0 | 0 | 0 | 0 | 1 | 0 | 0 | 1 | 0 | 0 | 1 | 0 |
| 0 | 0 | 0 | 0 | 0 | 0 | 0 | 0 | 0 | 0 | 0 | 1 | 0 | 0 | 0 | 0 | 1 | 1 | 0 | 0 | 0 |
| 0 | 0 | 0 | 0 | 0 | 0 | 0 | 0 | 0 | 0 | 0 | 0 | 1 | 0 | 0 | 0 | 1 | 1 | 0 | 0 | 0 |
| 0 | 1 | 0 | 0 | 0 | 0 | 0 | 0 | 0 | 0 | 0 | 1 | 0 | 0 | 0 | 1 | 0 | 0 | 0 | 0 | 1 |
| 0 | 0 | 0 | 0 | 0 | 0 | 0 | 0 | 1 | 0 | 0 | 0 | 1 | 0 | 0 | 0 | 1 | 0 | 0 | 0 | 0 |
| 0 | 1 | 0 | 0 | 0 | 0 | 1 | 0 | 0 | 0 | 1 | 1 | 0 | 0 | 0 | 0 | 0 | 0 | 0 | 0 | 0 |
| 1 | 1 | 1 | 0 | 0 | 0 | 0 | 0 | 0 | 0 | 0 | 0 | 0 | 0 | 0 | 0 | 0 | 0 | 0 | 0 | 1 |
| 0 | 1 | 0 | 0 | 0 | 0 | 1 | 0 | 0 | 0 | 0 | 0 | 0 | 0 | 0 | 0 | 1 | 0 | 0 | 0 | 0 |
| 0 | 0 | 0 | 0 | 0 | 0 | 0 | 0 | 0 | 0 | 0 | 1 | 1 | 0 | 0 | 0 | 1 | 0 | 0 | 0 | 0 |
| 0 | 0 | 0 | 0 | 1 | 0 | 0 | 1 | 0 | 0 | 0 | 0 | 0 | 0 | 0 | 0 | 1 | 1 | 0 | 0 | 0 |
| 0 | 0 | 0 | 0 | 0 | 0 | 1 | 0 | 1 | 0 | 0 | 0 | 0 | 0 | 0 | 0 | 1 | 0 | 0 | 0 | 0 |
| 0 | 0 | 0 | 0 | 1 | 0 | 1 | 0 | 0 | 0 | 0 | 0 | 0 | 0 | 0 | 0 | 1 | 0 | 0 | 0 | 0 |
| 0 | 0 | 0 | 0 | 1 | 0 | 0 | 0 | 0 | 1 | 0 | 0 | 0 | 0 | 0 | 0 | 0 | 1 | 0 | 0 | 1 |
| 0 | 0 | 0 | 0 | 0 | 0 | 0 | 0 | 1 | 0 | 1 | 1 | 0 | 0 | 0 | 0 | 0 | 0 | 0 | 0 | 0 |
| 1 | 0 | 0 | 0 | 1 | 0 | 1 | 0 | 0 | 0 | 0 | 0 | 0 | 0 | 0 | 0 | 0 | 1 | 0 | 0 | 0 |
| 0 | 1 | 0 | 1 | 0 | 0 | 0 | 0 | 1 | 0 | 0 | 0 | 0 | 0 | 0 | 1 | 0 | 0 | 0 | 0 | 0 |
| 0 | 0 | 0 | 1 | 0 | 0 | 0 | 0 | 0 | 0 | 0 | 1 | 0 | 0 | 0 | 1 | 0 | 0 | 0 | 0 | 0 |
| 0 | 1 | 0 | 0 | 0 | 0 | 1 | 0 | 0 | 0 | 0 | 0 | 1 | 0 | 0 | 0 | 0 | 0 | 0 | 0 | 1 |
| 0 | 1 | 0 | 0 | 0 | 1 | 0 | 0 | 0 | 0 | 0 | 0 | 0 | 0 | 0 | 1 | 0 | 0 | 0 | 0 | 1 |
| 0 | 0 | 0 | 0 | 1 | 0 | 0 | 0 | 0 | 0 | 1 | 0 | 0 | 0 | 0 | 0 | 0 | 1 | 0 | 0 | 1 |
| 1 | 0 | 0 | 0 | 0 | 0 | 1 | 0 | 0 | 0 | 0 | 1 | 0 | 0 | 0 | 0 | 0 | 0 | 0 | 0 | 0 |
| 0 | 0 | 0 | 0 | 0 | 1 | 0 | 0 | 1 | 0 | 0 | 1 | 0 | 0 | 0 | 0 | 0 | 0 | 0 | 0 | 0 |
| 0 | 1 | 0 | 0 | 1 | 0 | 1 | 0 | 1 | 0 | 0 | 0 | 0 | 0 | 0 | 1 | 0 | 0 | 0 | 0 | 1 |
| 1 | 1 | 1 | 0 | 0 | 0 | 0 | 0 | 0 | 0 | 0 | 0 | 0 | 0 | 0 | 0 | 0 | 0 | 0 | 0 | 0 |
| 1 | 0 | 0 | 1 | 0 | 0 | 0 | 1 | 0 | 0 | 0 | 0 | 0 | 0 | 0 | 0 | 0 | 0 | 0 | 0 | 0 |
| 0 | 1 | 0 | 0 | 1 | 1 | 1 | 0 | 0 | 0 | 0 | 0 | 0 | 0 | 0 | 0 | 0 | 1 | 0 | 0 | 0 |
| 1 | 1 | 0 | 0 | 0 | 0 | 0 | 0 | 0 | 0 | 0 | 0 | 0 | 0 | 0 | 0 | 1 | 0 | 0 | 0 | 0 |
| 0 | 0 | 0 | 1 | 0 | 0 | 1 | 0 | 1 | 0 | 0 | 0 | 0 | 0 | 0 | 0 | 0 | 0 | 0 | 0 | 1 |
| 0 | 1 | 0 | 0 | 0 | 0 | 0 | 0 | 0 | 0 | 0 | 0 | 1 | 0 | 0 | 0 | 0 | 1 | 0 | 0 | 1 |
| 1 | 0 | 1 | 0 | 0 | 0 | 0 | 0 | 0 | 0 | 0 | 0 | 0 | 1 | 0 | 0 | 0 | 0 | 0 | 0 | 0 |
| 0 | 0 | 0 | 0 | 0 | 0 | 0 | 0 | 1 | 0 | 1 | 1 | 0 | 0 | 0 | 0 | 0 | 0 | 0 | 0 | 0 |
| 1 | 0 | 0 | 1 | 0 | 0 | 0 | 0 | 0 | 1 | 0 | 0 | 0 | 0 | 0 | 0 | 0 | 0 | 0 | 0 | 0 |
| 1 | 1 | 0 | 0 | 0 | 0 | 0 | 0 | 0 | 0 | 0 | 0 | 0 | 0 | 0 | 1 | 0 | 0 | 0 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 1 |
| 1 | 0 | 0 | 0 | 0 | 1 | 0 | 0 | 0 | 0 | 0 | 0 | 0 | 0 | 0 | 0 | 1 | 0 | 0 | 0 | 0 |
| 0 | 1 | 0 | 0 | 0 | 0 | 0 | 0 | 0 | 0 | 0 | 1 | 0 | 0 | 0 | 0 | 1 | 0 | 0 | 0 | 1 |
| 0 | 1 | 0 | 0 | 1 | 0 | 0 | 0 | 0 | 0 | 0 | 0 | 0 | 0 | 0 | 1 | 0 | 0 | 0 | 0 | 0 |
| 0 | 1 | 0 | 0 | 0 | 0 | 0 | 0 | 0 | 0 | 0 | 1 | 0 | 0 | 0 | 1 | 0 | 0 | 0 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 1 | 0 | 1 | 0 | 0 | 1 | 0 | 0 | 0 | 0 | 0 | 0 | 0 | 0 | 0 |
| 0 | 0 | 1 | 0 | 1 | 0 | 1 | 0 | 0 | 0 | 0 | 0 | 0 | 0 | 0 | 0 | 0 | 0 | 0 | 0 | 0 |
| 0 | 1 | 0 | 0 | 0 | 0 | 1 | 0 | 0 | 0 | 0 | 0 | 0 | 0 | 0 | 1 | 0 | 0 | 0 | 0 | 1 |
| 0 | 1 | 1 | 0 | 0 | 0 | 0 | 0 | 0 | 0 | 0 | 0 | 0 | 1 | 0 | 0 | 0 | 0 | 0 | 0 | 0 |
| 0 | 0 | 0 | 0 | 1 | 0 | 1 | 0 | 1 | 0 | 0 | 0 | 0 | 0 | 0 | 0 | 0 | 0 | 0 | 0 | 0 |
| 0 | 0 | 0 | 0 | 1 | 1 | 1 | 0 | 0 | 0 | 0 | 0 | 0 | 0 | 0 | 0 | 0 | 0 | 0 | 0 | 0 |
| 1 | 0 | 0 | 0 | 0 | 0 | 1 | 0 | 0 | 0 | 0 | 0 | 0 | 0 | 0 | 0 | 0 | 0 | 0 | 1 | 0 |
| 0 | 1 | 0 | 0 | 0 | 0 | 0 | 0 | 0 | 0 | 0 | 0 | 0 | 0 | 0 | 0 | 1 | 0 | 1 | 0 | 1 |
| 1 | 1 | 0 | 0 | 0 | 0 | 1 | 0 | 0 | 0 | 0 | 0 | 0 | 0 | 0 | 0 | 0 | 0 | 0 | 0 | 1 |
| 1 | 0 | 0 | 0 | 1 | 0 | 1 | 0 | 0 | 0 | 0 | 0 | 0 | 0 | 0 | 0 | 0 | 0 | 0 | 0 | 0 |
| 0 | 0 | 0 | 0 | 1 | 0 | 1 | 0 | 1 | 0 | 0 | 0 | 0 | 0 | 0 | 0 | 0 | 0 | 0 | 0 | 0 |
| 1 | 0 | 0 | 0 | 1 | 0 | 0 | 0 | 0 | 0 | 0 | 0 | 0 | 0 | 0 | 0 | 1 | 0 | 0 | 0 | 1 |
| 0 | 0 | 0 | 1 | 0 | 0 | 1 | 0 | 0 | 0 | 0 | 1 | 0 | 0 | 0 | 0 | 0 | 0 | 0 | 0 | 0 |
| 0 | 0 | 0 | 1 | 1 | 0 | 0 | 0 | 0 | 0 | 0 | 0 | 0 | 1 | 0 | 0 | 0 | 0 | 0 | 0 | 0 |
| 0 | 1 | 0 | 0 | 1 | 0 | 1 | 0 | 0 | 0 | 0 | 0 | 0 | 0 | 0 | 0 | 0 | 0 | 0 | 0 | 0 |
| 1 | 1 | 1 | 0 | 0 | 0 | 0 | 0 | 0 | 0 | 0 | 0 | 0 | 0 | 0 | 0 | 0 | 0 | 0 | 0 | 0 |
| 1 | 0 | 0 | 0 | 0 | 0 | 1 | 1 | 0 | 0 | 0 | 0 | 0 | 0 | 0 | 0 | 0 | 0 | 0 | 0 | 0 |
| 1 | 0 | 0 | 0 | 0 | 0 | 0 | 0 | 0 | 0 | 0 | 0 | 0 | 1 | 0 | 0 | 0 | 1 | 0 | 0 | 0 |
| 1 | 1 | 0 | 0 | 0 | 0 | 0 | 0 | 1 | 0 | 0 | 0 | 0 | 0 | 0 | 0 | 0 | 0 | 0 | 0 | 0 |
| 1 | 0 | 0 | 0 | 0 | 0 | 1 | 0 | 0 | 0 | 0 | 0 | 0 | 0 | 0 | 0 | 0 | 0 | 0 | 0 | 0 |
| 0 | 0 | 0 | 0 | 0 | 0 | 1 | 0 | 1 | 1 | 0 | 0 | 0 | 0 | 0 | 0 | 1 | 0 | 0 | 0 | 0 |
| 0 | 0 | 0 | 0 | 1 | 0 | 1 | 0 | 1 | 0 | 0 | 0 | 0 | 0 | 0 | 0 | 0 | 0 | 0 | 0 | 0 |
| 0 | 0 | 0 | 0 | 1 | 0 | 1 | 0 | 0 | 0 | 0 | 1 | 0 | 0 | 0 | 0 | 0 | 0 | 0 | 0 | 0 |
| 1 | 0 | 0 | 1 | 0 | 0 | 0 | 0 | 0 | 0 | 0 | 0 | 0 | 0 | 0 | 0 | 0 | 1 | 0 | 0 | 0 |
| 0 | 0 | 1 | 0 | 0 | 0 | 0 | 0 | 0 | 0 | 1 | 0 | 0 | 0 | 1 | 0 | 0 | 0 | 0 | 0 | 0 |
| 0 | 0 | 0 | 0 | 1 | 0 | 0 | 0 | 0 | 0 | 1 | 1 | 0 | 0 | 0 | 0 | 0 | 0 | 0 | 0 | 0 |
| 0 | 0 | 0 | 1 | 1 | 1 | 0 | 0 | 1 | 0 | 1 | 1 | 0 | 0 | 0 | 0 | 0 | 0 | 0 | 1 | 1 |
| 1 | 1 | 0 | 0 | 0 | 0 | 0 | 1 | 0 | 0 | 0 | 0 | 0 | 0 | 0 | 0 | 0 | 0 | 0 | 0 | 0 |
| 1 | 0 | 0 | 1 | 1 | 0 | 0 | 0 | 0 | 0 | 0 | 0 | 0 | 0 | 0 | 0 | 0 | 0 | 0 | 0 | 0 |
| 0 | 0 | 1 | 0 | 0 | 0 | 1 | 0 | 0 | 0 | 1 | 0 | 0 | 0 | 0 | 0 | 0 | 0 | 0 | 0 | 0 |
| 0 | 0 | 0 | 0 | 0 | 0 | 1 | 0 | 0 | 0 | 1 | 0 | 0 | 0 | 0 | 1 | 0 | 0 | 0 | 0 | 0 |
| 0 | 1 | 0 | 0 | 1 | 0 | 0 | 0 | 0 | 0 | 0 | 0 | 1 | 0 | 0 | 0 | 0 | 0 | 0 | 0 | 1 |
| 1 | 0 | 0 | 1 | 1 | 0 | 0 | 0 | 0 | 0 | 0 | 0 | 0 | 0 | 0 | 0 | 0 | 0 | 0 | 0 | 0 |
| 0 | 0 | 0 | 1 | 0 | 1 | 1 | 0 | 0 | 0 | 0 | 0 | 0 | 0 | 0 | 0 | 0 | 0 | 0 | 0 | 0 |
| 0 | 1 | 0 | 0 | 0 | 0 | 0 | 1 | 0 | 0 | 0 | 0 | 1 | 0 | 0 | 0 | 0 | 0 | 0 | 0 | 0 |
| 0 | 0 | 0 | 0 | 0 | 0 | 0 | 0 | 1 | 0 | 0 | 0 | 0 | 1 | 0 | 0 | 0 | 0 | 1 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 0 |
| 1 | 1 | 0 | 0 | 1 | 1 | 1 | 0 | 0 | 1 | 1 | 1 | 1 | 0 | 0 | 1 | 1 | 1 | 1 | 0 | 1 |
| 1 | 0 | 0 | 1 | 0 | 0 | 0 | 0 | 0 | 0 | 0 | 1 | 0 | 0 | 0 | 0 | 0 | 0 | 0 | 0 | 0 |
| 0 | 0 | 0 | 0 | 1 | 0 | 1 | 0 | 0 | 0 | 1 | 1 | 0 | 0 | 0 | 0 | 0 | 0 | 0 | 0 | 0 |
| 0 | 0 | 0 | 0 | 1 | 0 | 0 | 0 | 0 | 0 | 0 | 1 | 0 | 0 | 0 | 0 | 1 | 0 | 0 | 0 | 0 |
| 1 | 0 | 1 | 0 | 1 | 1 | 1 | 0 | 1 | 0 | 0 | 0 | 1 | 1 | 0 | 0 | 1 | 1 | 0 | 1 | 0 |
| 0 | 1 | 0 | 0 | 0 | 0 | 0 | 0 | 1 | 0 | 1 | 1 | 0 | 0 | 0 | 0 | 1 | 0 | 1 | 0 | 1 |
| 0 | 0 | 0 | 0 | 0 | 0 | 1 | 0 | 0 | 0 | 0 | 1 | 1 | 0 | 0 | 1 | 0 | 1 | 0 | 0 | 1 |
| 1 | 1 | 1 | 1 | 1 | 0 | 1 | 1 | 1 | 1 | 1 | 1 | 1 | 1 | 0 | 1 | 1 | 1 | 1 | 0 | 1 |
| 1 | 1 | 0 | 1 | 1 | 0 | 1 | 0 | 1 | 0 | 1 | 1 | 1 | 0 | 1 | 1 | 1 | 1 | 0 | 0 | 0 |
| 1 | 0 | 0 | 0 | 0 | 0 | 0 | 0 | 0 | 0 | 0 | 0 | 1 | 0 | 1 | 1 | 0 | 0 | 0 | 0 | 0 |
| 1 | 0 | 0 | 0 | 1 | 1 | 1 | 0 | 1 | 0 | 0 | 1 | 0 | 0 | 0 | 0 | 0 | 0 | 1 | 1 | 0 |
| 0 | 0 | 0 | 0 | 1 | 0 | 1 | 0 | 0 | 0 | 0 | 1 | 1 | 1 | 1 | 1 | 0 | 1 | 1 | 0 | 1 |
| 1 | 1 | 0 | 1 | 1 | 0 | 0 | 1 | 0 | 0 | 1 | 1 | 1 | 0 | 1 | 0 | 1 | 1 | 0 | 0 | 0 |
| 0 | 1 | 0 | 0 | 0 | 1 | 0 | 0 | 1 | 0 | 0 | 0 | 0 | 0 | 0 | 1 | 0 | 0 | 0 | 1 | 1 |
| 1 | 1 | 0 | 0 | 0 | 0 | 1 | 0 | 0 | 0 | 0 | 0 | 0 | 0 | 0 | 0 | 0 | 0 | 0 | 0 | 1 |
| 1 | 1 | 0 | 0 | 1 | 0 | 0 | 0 | 0 | 0 | 0 | 1 | 0 | 1 | 0 | 0 | 1 | 0 | 0 | 0 | 0 |
| 0 | 0 | 0 | 0 | 0 | 1 | 0 | 0 | 0 | 0 | 0 | 0 | 1 | 0 | 0 | 1 | 0 | 1 | 0 | 0 | 1 |
| 1 | 1 | 1 | 1 | 1 | 1 | 1 | 0 | 1 | 1 | 1 | 1 | 1 | 1 | 0 | 1 | 1 | 1 | 1 | 0 | 1 |
| 0 | 1 | 0 | 1 | 0 | 1 | 0 | 0 | 0 | 0 | 0 | 0 | 0 | 0 | 1 | 1 | 0 | 0 | 0 | 0 | 0 |
| 0 | 1 | 0 | 0 | 0 | 0 | 1 | 0 | 0 | 0 | 0 | 0 | 0 | 0 | 0 | 1 | 0 | 0 | 0 | 0 | 1 |
| 1 | 0 | 0 | 1 | 0 | 0 | 0 | 0 | 0 | 0 | 0 | 1 | 0 | 0 | 0 | 0 | 0 | 0 | 0 | 0 | 0 |
| 1 | 1 | 0 | 0 | 0 | 0 | 0 | 1 | 0 | 0 | 0 | 0 | 0 | 0 | 0 | 0 | 0 | 0 | 0 | 0 | 1 |
| 0 | 0 | 0 | 0 | 0 | 0 | 1 | 0 | 0 | 1 | 0 | 0 | 0 | 0 | 0 | 0 | 0 | 1 | 0 | 0 | 0 |
| 0 | 1 | 0 | 0 | 0 | 0 | 0 | 0 | 0 | 0 | 0 | 1 | 1 | 0 | 0 | 0 | 0 | 0 | 0 | 0 | 0 |
| 1 | 1 | 0 | 0 | 0 | 0 | 1 | 0 | 0 | 0 | 0 | 0 | 0 | 0 | 0 | 1 | 0 | 0 | 0 | 0 | 1 |
| 0 | 1 | 0 | 0 | 1 | 0 | 1 | 0 | 0 | 0 | 0 | 0 | 0 | 0 | 0 | 0 | 0 | 0 | 0 | 0 | 1 |
| 1 | 0 | 0 | 0 | 0 | 0 | 1 | 0 | 0 | 0 | 0 | 1 | 0 | 0 | 0 | 0 | 0 | 0 | 0 | 0 | 1 |
| 0 | 1 | 0 | 0 | 1 | 0 | 1 | 0 | 0 | 0 | 1 | 1 | 0 | 0 | 0 | 0 | 0 | 0 | 0 | 0 | 0 |
| 0 | 0 | 0 | 1 | 0 | 0 | 0 | 0 | 0 | 0 | 0 | 0 | 0 | 0 | 0 | 0 | 1 | 0 | 1 | 0 | 1 |
| 0 | 0 | 0 | 0 | 0 | 0 | 0 | 0 | 0 | 0 | 0 | 1 | 0 | 0 | 0 | 1 | 0 | 0 | 0 | 1 | 0 |
| 0 | 0 | 0 | 0 | 1 | 0 | 0 | 0 | 1 | 0 | 0 | 0 | 0 | 0 | 0 | 0 | 1 | 0 | 0 | 0 | 0 |
| 0 | 0 | 0 | 0 | 1 | 0 | 1 | 0 | 0 | 0 | 0 | 1 | 0 | 0 | 0 | 0 | 0 | 0 | 0 | 0 | 0 |
| 0 | 0 | 1 | 0 | 1 | 0 | 0 | 0 | 1 | 1 | 1 | 0 | 0 | 1 | 0 | 0 | 1 | 0 | 0 | 0 | 0 |
| 0 | 0 | 0 | 0 | 0 | 0 | 0 | 0 | 0 | 0 | 0 | 0 | 1 | 1 | 0 | 0 | 1 | 0 | 0 | 0 | 0 |
| 1 | 1 | 0 | 0 | 1 | 0 | 0 | 0 | 0 | 0 | 0 | 0 | 0 | 0 | 0 | 0 | 0 | 0 | 0 | 0 | 0 |
| 1 | 0 | 1 | 1 | 1 | 1 | 0 | 0 | 0 | 0 | 0 | 0 | 0 | 0 | 0 | 0 | 0 | 0 | 0 | 0 | 0 |
| 1 | 0 | 0 | 0 | 1 | 0 | 0 | 0 | 0 | 0 | 0 | 1 | 0 | 0 | 0 | 0 | 0 | 0 | 0 | 0 | 0 |
| 0 | 1 | 0 | 0 | 0 | 0 | 0 | 0 | 0 | 1 | 0 | 0 | 1 | 0 | 0 | 0 | 0 | 0 | 0 | 0 | 1 |
| 0 | 0 | 0 | 1 | 1 | 0 | 0 | 0 | 0 | 0 | 0 | 0 | 0 | 0 | 0 | 1 | 0 | 0 | 0 | 0 | 0 |
| 1 | 0 | 1 | 1 | 1 | 0 | 0 | 0 | 0 | 0 | 0 | 0 | 0 | 0 | 0 | 0 | 0 | 0 | 0 | 0 | 0 |
| 0 | 0 | 0 | 0 | 1 | 0 | 1 | 0 | 0 | 0 | 0 | 1 | 0 | 0 | 0 | 0 | 0 | 0 | 0 | 0 | 1 |
| 0 | 1 | 0 | 0 | 0 | 0 | 1 | 0 | 0 | 0 | 0 | 0 | 0 | 0 | 0 | 1 | 0 | 0 | 0 | 0 | 0 |
| 1 | 1 | 1 | 0 | 1 | 0 | 0 | 0 | 0 | 0 | 0 | 0 | 0 | 0 | 0 | 0 | 0 | 0 | 0 | 0 | 0 |
| 1 | 0 | 0 | 0 | 1 | 0 | 1 | 0 | 0 | 0 | 0 | 0 | 0 | 0 | 0 | 0 | 0 | 0 | 0 | 0 | 1 |
| 1 | 1 | 0 | 1 | 0 | 0 | 0 | 0 | 0 | 0 | 0 | 0 | 0 | 0 | 0 | 0 | 0 | 0 | 0 | 0 | 1 |
| 0 | 1 | 0 | 0 | 0 | 1 | 0 | 1 | 0 | 0 | 0 | 0 | 0 | 0 | 0 | 0 | 0 | 0 | 0 | 0 | 0 |
| 0 | 0 | 0 | 1 | 1 | 0 | 1 | 0 | 0 | 0 | 1 | 1 | 0 | 0 | 0 | 0 | 1 | 1 | 0 | 0 | 0 |
| 0 | 0 | 0 | 0 | 0 | 0 | 0 | 0 | 0 | 0 | 0 | 1 | 0 | 0 | 1 | 0 | 0 | 0 | 0 | 0 | 0 |
| 0 | 0 | 0 | 1 | 1 | 0 | 1 | 0 | 0 | 0 | 1 | 0 | 0 | 0 | 0 | 0 | 0 | 0 | 1 | 0 | 0 |
| 0 | 0 | 1 | 0 | 1 | 1 | 1 | 0 | 0 | 0 | 0 | 0 | 0 | 0 | 0 | 1 | 1 | 0 | 0 | 1 | 0 |
| 1 | 1 | 0 | 0 | 1 | 0 | 1 | 0 | 1 | 0 | 0 | 1 | 0 | 1 | 0 | 1 | 0 | 0 | 0 | 0 | 1 |
| 1 | 0 | 0 | 0 | 0 | 1 | 0 | 0 | 1 | 0 | 0 | 1 | 0 | 0 | 0 | 0 | 1 | 1 | 0 | 0 | 0 |
| 0 | 1 | 0 | 0 | 1 | 0 | 0 | 0 | 0 | 0 | 0 | 0 | 0 | 0 | 0 | 0 | 1 | 1 | 0 | 0 | 1 |
| 0 | 0 | 1 | 0 | 0 | 0 | 0 | 0 | 1 | 0 | 1 | 0 | 0 | 0 | 1 | 0 | 0 | 0 | 0 | 1 | 0 |
| 1 | 1 | 0 | 0 | 1 | 0 | 1 | 0 | 0 | 0 | 0 | 0 | 0 | 0 | 0 | 0 | 1 | 0 | 1 | 0 | 0 |
| 0 | 0 | 0 | 0 | 1 | 1 | 1 | 0 | 1 | 1 | 1 | 1 | 0 | 0 | 0 | 0 | 1 | 1 | 0 | 0 | 0 |
| 0 | 0 | 0 | 0 | 0 | 0 | 0 | 0 | 0 | 0 | 0 | 1 | 1 | 1 | 0 | 0 | 0 | 1 | 0 | 0 | 0 |
| 1 | 0 | 1 | 0 | 1 | 1 | 0 | 0 | 1 | 0 | 0 | 1 | 0 | 0 | 0 | 0 | 1 | 0 | 0 | 1 | 1 |
| 0 | 0 | 1 | 0 | 0 | 1 | 1 | 0 | 0 | 1 | 0 | 0 | 1 | 0 | 0 | 0 | 1 | 0 | 0 | 0 | 1 |
| 0 | 1 | 1 | 1 | 1 | 0 | 1 | 0 | 0 | 1 | 1 | 1 | 1 | 1 | 1 | 1 | 1 | 1 | 1 | 0 | 1 |
| 0 | 0 | 0 | 0 | 1 | 0 | 1 | 0 | 1 | 0 | 1 | 1 | 0 | 0 | 0 | 0 | 1 | 0 | 0 | 0 | 0 |
| 0 | 1 | 0 | 1 | 1 | 0 | 1 | 0 | 0 | 0 | 1 | 0 | 0 | 0 | 0 | 0 | 0 | 0 | 0 | 0 | 1 |
| 1 | 1 | 1 | 1 | 1 | 1 | 1 | 0 | 1 | 0 | 1 | 1 | 0 | 1 | 0 | 1 | 1 | 1 | 0 | 0 | 1 |
| 0 | 0 | 1 | 0 | 1 | 1 | 0 | 1 | 0 | 0 | 0 | 1 | 1 | 0 | 1 | 1 | 1 | 0 | 0 | 0 | 0 |
| 0 | 1 | 0 | 1 | 0 | 1 | 0 | 0 | 1 | 1 | 1 | 1 | 0 | 0 | 0 | 1 | 0 | 1 | 0 | 1 | 1 |
| 0 | 1 | 0 | 0 | 0 | 0 | 1 | 0 | 0 | 0 | 0 | 1 | 1 | 0 | 0 | 1 | 0 | 0 | 0 | 0 | 0 |
| 0 | 1 | 0 | 0 | 1 | 0 | 0 | 0 | 0 | 0 | 0 | 0 | 0 | 0 | 0 | 0 | 1 | 1 | 0 | 0 | 1 |
| 0 | 0 | 0 | 0 | 1 | 0 | 0 | 0 | 0 | 0 | 0 | 1 | 0 | 0 | 0 | 0 | 0 | 1 | 0 | 0 | 0 |
| 0 | 0 | 1 | 0 | 0 | 0 | 0 | 0 | 0 | 0 | 0 | 1 | 0 | 0 | 0 | 0 | 0 | 0 | 1 | 0 | 0 |
| 0 | 0 | 1 | 0 | 1 | 0 | 0 | 0 | 0 | 0 | 0 | 1 | 0 | 1 | 0 | 0 | 1 | 0 | 0 | 0 | 0 |
| 0 | 0 | 0 | 0 | 0 | 0 | 1 | 0 | 1 | 0 | 0 | 1 | 0 | 0 | 0 | 1 | 0 | 0 | 0 | 0 | 0 |
| 0 | 0 | 0 | 0 | 1 | 0 | 0 | 0 | 1 | 0 | 0 | 1 | 0 | 0 | 0 | 0 | 1 | 0 | 1 | 0 | 0 |
| 1 | 0 | 0 | 1 | 0 | 0 | 1 | 0 | 0 | 0 | 0 | 1 | 0 | 0 | 0 | 1 | 1 | 0 | 0 | 0 | 0 |
| 1 | 1 | 0 | 1 | 1 | 0 | 0 | 0 | 0 | 0 | 0 | 0 | 1 | 0 | 0 | 1 | 0 | 0 | 0 | 0 | 1 |
| 0 | 1 | 0 | 0 | 1 | 0 | 1 | 0 | 0 | 0 | 0 | 0 | 0 | 0 | 0 | 1 | 0 | 0 | 0 | 0 | 0 |
| 1 | 1 | 0 | 1 | 1 | 0 | 1 | 0 | 0 | 0 | 0 | 0 | 0 | 0 | 1 | 1 | 1 | 0 | 0 | 0 | 0 |
| 0 | 0 | 1 | 0 | 1 | 0 | 0 | 0 | 0 | 0 | 0 | 1 | 0 | 0 | 0 | 0 | 1 | 0 | 0 | 0 | 0 |
| 0 | 0 | 1 | 1 | 1 | 0 | 1 | 0 | 1 | 0 | 0 | 1 | 0 | 0 | 0 | 0 | 1 | 1 | 0 | 0 | 0 |
| 0 | 1 | 0 | 1 | 1 | 0 | 1 | 0 | 0 | 0 | 0 | 1 | 0 | 0 | 0 | 1 | 0 | 0 | 0 | 0 | 0 |
| 1 | 0 | 0 | 0 | 1 | 0 | 1 | 0 | 0 | 0 | 1 | 1 | 0 | 0 | 0 | 1 | 0 | 1 | 0 | 0 | 0 |
| 0 | 0 | 0 | 0 | 0 | 0 | 1 | 0 | 1 | 0 | 0 | 0 | 0 | 0 | 0 | 0 | 1 | 0 | 0 | 0 | 0 |
| 1 | 1 | 0 | 1 | 1 | 0 | 0 | 1 | 0 | 0 | 0 | 1 | 0 | 1 | 0 | 0 | 1 | 1 | 0 | 0 | 0 |
| 0 | 0 | 0 | 0 | 0 | 0 | 0 | 0 | 1 | 0 | 1 | 1 | 0 | 0 | 0 | 0 | 0 | 0 | 0 | 0 | 0 |
| 0 | 1 | 1 | 1 | 1 | 0 | 1 | 0 | 0 | 0 | 0 | 0 | 0 | 0 | 0 | 0 | 1 | 0 | 0 | 0 | 0 |
| 0 | 0 | 1 | 0 | 1 | 0 | 0 | 0 | 0 | 0 | 1 | 0 | 0 | 0 | 0 | 0 | 1 | 0 | 0 | 0 | 1 |
| 0 | 0 | 0 | 0 | 1 | 1 | 1 | 0 | 1 | 0 | 0 | 1 | 0 | 1 | 0 | 0 | 1 | 1 | 0 | 0 | 0 |
| 0 | 0 | 0 | 0 | 0 | 0 | 1 | 0 | 0 | 0 | 0 | 1 | 0 | 0 | 0 | 1 | 0 | 0 | 1 | 0 | 0 |
| 0 | 0 | 0 | 0 | 0 | 1 | 0 | 0 | 0 | 0 | 0 | 0 | 0 | 0 | 1 | 0 | 0 | 1 | 1 | 1 | 0 |
| 0 | 0 | 0 | 0 | 0 | 1 | 1 | 0 | 0 | 0 | 0 | 1 | 0 | 0 | 0 | 0 | 1 | 1 | 0 | 0 | 0 |
| 0 | 0 | 0 | 0 | 1 | 1 | 1 | 0 | 0 | 0 | 0 | 0 | 0 | 0 | 1 | 1 | 1 | 0 | 1 | 0 | 0 |
| 0 | 1 | 0 | 0 | 1 | 1 | 1 | 0 | 0 | 0 | 0 | 1 | 1 | 0 | 0 | 1 | 1 | 0 | 0 | 0 | 1 |
| 0 | 1 | 1 | 1 | 1 | 1 | 1 | 1 | 1 | 0 | 1 | 1 | 1 | 1 | 0 | 0 | 1 | 1 | 1 | 1 | 0 |
| 1 | 0 | 0 | 0 | 1 | 1 | 1 | 0 | 1 | 0 | 0 | 0 | 1 | 0 | 0 | 1 | 1 | 1 | 0 | 1 | 0 |
| 0 | 1 | 0 | 0 | 0 | 0 | 1 | 0 | 0 | 0 | 1 | 0 | 0 | 0 | 0 | 1 | 0 | 0 | 0 | 0 | 0 |
| 1 | 0 | 0 | 1 | 1 | 0 | 1 | 0 | 1 | 0 | 1 | 1 | 0 | 1 | 1 | 0 | 1 | 1 | 1 | 0 | 0 |
| 1 | 1 | 0 | 0 | 0 | 0 | 0 | 0 | 1 | 0 | 0 | 0 | 0 | 0 | 0 | 0 | 0 | 0 | 0 | 0 | 0 |
| 0 | 1 | 0 | 1 | 0 | 0 | 1 | 0 | 0 | 0 | 0 | 1 | 0 | 0 | 0 | 1 | 1 | 0 | 0 | 0 | 0 |
| 1 | 1 | 1 | 1 | 1 | 0 | 1 | 0 | 0 | 0 | 1 | 1 | 1 | 0 | 0 | 1 | 1 | 0 | 0 | 0 | 0 |
| 1 | 1 | 1 | 0 | 1 | 0 | 0 | 0 | 0 | 0 | 0 | 0 | 0 | 1 | 0 | 0 | 1 | 0 | 0 | 0 | 1 |
| 0 | 0 | 0 | 0 | 0 | 0 | 1 | 0 | 0 | 0 | 0 | 0 | 1 | 0 | 0 | 0 | 0 | 1 | 1 | 0 | 0 |
| 0 | 1 | 1 | 1 | 1 | 0 | 1 | 0 | 0 | 0 | 1 | 1 | 0 | 1 | 0 | 0 | 1 | 0 | 1 | 0 | 0 |
| 0 | 0 | 1 | 0 | 0 | 0 | 0 | 0 | 1 | 1 | 0 | 1 | 1 | 1 | 1 | 0 | 0 | 1 | 1 | 0 | 0 |
| 0 | 1 | 0 | 0 | 1 | 0 | 1 | 0 | 0 | 0 | 0 | 1 | 1 | 0 | 0 | 1 | 1 | 0 | 1 | 0 | 0 |
| 0 | 0 | 0 | 0 | 0 | 0 | 1 | 0 | 1 | 0 | 0 | 1 | 0 | 1 | 0 | 0 | 0 | 0 | 1 | 0 | 0 |
| 0 | 0 | 0 | 0 | 1 | 0 | 1 | 0 | 1 | 0 | 0 | 1 | 0 | 0 | 0 | 1 | 0 | 0 | 0 | 0 | 0 |
| 0 | 0 | 0 | 0 | 1 | 0 | 0 | 0 | 1 | 0 | 0 | 1 | 0 | 0 | 0 | 0 | 1 | 0 | 0 | 0 | 0 |
| 0 | 1 | 0 | 1 | 0 | 0 | 1 | 0 | 0 | 0 | 0 | 1 | 1 | 0 | 0 | 1 | 1 | 1 | 1 | 0 | 0 |
| 0 | 0 | 1 | 0 | 1 | 0 | 0 | 0 | 1 | 0 | 1 | 0 | 0 | 1 | 1 | 0 | 1 | 0 | 0 | 0 | 0 |
| 1 | 1 | 1 | 1 | 1 | 1 | 1 | 1 | 1 | 1 | 1 | 1 | 1 | 1 | 1 | 1 | 1 | 1 | 1 | 1 | 1 |
| 0 | 0 | 0 | 1 | 1 | 0 | 1 | 0 | 1 | 0 | 0 | 1 | 1 | 0 | 0 | 0 | 1 | 0 | 0 | 0 | 0 |
| 0 | 1 | 0 | 0 | 0 | 0 | 0 | 0 | 0 | 0 | 1 | 1 | 0 | 0 | 0 | 0 | 0 | 0 | 0 | 0 | 0 |
| 1 | 1 | 1 | 1 | 1 | 0 | 1 | 0 | 0 | 0 | 1 | 1 | 0 | 0 | 1 | 0 | 1 | 1 | 0 | 0 | 1 |
| 0 | 0 | 1 | 1 | 0 | 0 | 0 | 0 | 0 | 0 | 0 | 0 | 1 | 0 | 0 | 0 | 0 | 0 | 0 | 0 | 0 |
| 0 | 1 | 0 | 1 | 1 | 0 | 0 | 0 | 1 | 0 | 1 | 1 | 1 | 1 | 0 | 1 | 1 | 1 | 0 | 1 | 0 |
| 1 | 1 | 1 | 0 | 0 | 0 | 0 | 0 | 0 | 1 | 0 | 1 | 0 | 1 | 0 | 1 | 1 | 0 | 0 | 0 | 1 |
| 0 | 1 | 0 | 0 | 1 | 0 | 0 | 0 | 1 | 0 | 0 | 1 | 0 | 0 | 0 | 1 | 1 | 0 | 0 | 0 | 0 |
| 0 | 1 | 0 | 0 | 0 | 0 | 0 | 0 | 0 | 0 | 1 | 1 | 1 | 0 | 0 | 0 | 0 | 0 | 0 | 0 | 1 |
| 1 | 0 | 0 | 0 | 0 | 0 | 0 | 0 | 1 | 0 | 0 | 1 | 0 | 0 | 0 | 0 | 0 | 0 | 0 | 0 | 0 |
| 0 | 1 | 0 | 0 | 0 | 0 | 1 | 0 | 1 | 0 | 0 | 0 | 0 | 0 | 0 | 0 | 0 | 0 | 1 | 1 | 1 |
| 1 | 1 | 0 | 1 | 0 | 0 | 0 | 0 | 1 | 0 | 0 | 0 | 0 | 0 | 0 | 0 | 1 | 0 | 0 | 0 | 0 |
| 0 | 0 | 0 | 0 | 0 | 0 | 0 | 0 | 1 | 0 | 0 | 1 | 0 | 0 | 0 | 0 | 0 | 1 | 0 | 0 | 1 |
| 0 | 1 | 1 | 1 | 1 | 0 | 0 | 0 | 0 | 0 | 1 | 0 | 0 | 1 | 0 | 0 | 1 | 0 | 0 | 0 | 0 |
| 0 | 0 | 0 | 0 | 1 | 0 | 1 | 0 | 0 | 0 | 0 | 0 | 0 | 0 | 0 | 0 | 1 | 0 | 0 | 0 | 0 |
| 0 | 1 | 0 | 0 | 0 | 0 | 1 | 0 | 1 | 0 | 0 | 1 | 1 | 0 | 0 | 0 | 0 | 0 | 0 | 0 | 0 |
| 0 | 0 | 0 | 1 | 0 | 0 | 1 | 0 | 1 | 0 | 1 | 0 | 0 | 0 | 0 | 0 | 0 | 0 | 0 | 0 | 0 |
| 1 | 1 | 0 | 0 | 1 | 0 | 1 | 0 | 1 | 0 | 0 | 1 | 1 | 0 | 0 | 0 | 1 | 0 | 0 | 0 | 1 |
| 1 | 0 | 0 | 0 | 0 | 0 | 1 | 0 | 1 | 0 | 0 | 0 | 0 | 0 | 0 | 0 | 0 | 0 | 1 | 0 | 0 |
| 1 | 1 | 0 | 0 | 1 | 0 | 1 | 0 | 1 | 0 | 0 | 1 | 1 | 0 | 0 | 1 | 1 | 0 | 0 | 0 | 1 |
| 0 | 0 | 0 | 0 | 1 | 1 | 0 | 0 | 0 | 0 | 1 | 1 | 0 | 0 | 0 | 0 | 0 | 0 | 0 | 0 | 0 |
| 0 | 0 | 0 | 0 | 0 | 1 | 1 | 0 | 0 | 0 | 0 | 0 | 0 | 0 | 0 | 1 | 0 | 0 | 0 | 0 | 0 |
| 0 | 1 | 0 | 0 | 0 | 0 | 0 | 0 | 0 | 1 | 0 | 0 | 0 | 0 | 0 | 0 | 0 | 1 | 0 | 0 | 0 |
| 1 | 0 | 0 | 0 | 1 | 0 | 0 | 0 | 0 | 0 | 1 | 1 | 1 | 1 | 0 | 0 | 0 | 0 | 0 | 0 | 0 |
| 1 | 1 | 0 | 0 | 0 | 0 | 0 | 0 | 0 | 0 | 0 | 0 | 0 | 1 | 0 | 0 | 1 | 0 | 0 | 0 | 1 |
| 0 | 1 | 0 | 0 | 0 | 0 | 0 | 0 | 0 | 0 | 0 | 0 | 0 | 0 | 1 | 0 | 0 | 0 | 1 | 0 | 0 |
| 0 | 0 | 0 | 0 | 0 | 0 | 1 | 0 | 1 | 0 | 0 | 1 | 0 | 0 | 0 | 0 | 0 | 1 | 1 | 0 | 0 |
| 0 | 1 | 1 | 0 | 1 | 0 | 1 | 0 | 0 | 0 | 1 | 1 | 1 | 0 | 0 | 0 | 0 | 0 | 0 | 0 | 1 |
| 0 | 1 | 0 | 0 | 0 | 0 | 1 | 0 | 0 | 0 | 1 | 0 | 0 | 1 | 0 | 1 | 0 | 0 | 0 | 0 | 1 |
| 0 | 1 | 0 | 0 | 1 | 0 | 0 | 0 | 0 | 0 | 0 | 1 | 1 | 0 | 0 | 1 | 1 | 0 | 0 | 0 | 1 |
| 1 | 0 | 0 | 1 | 0 | 0 | 1 | 0 | 0 | 0 | 0 | 1 | 0 | 0 | 0 | 0 | 0 | 1 | 0 | 0 | 0 |
| 1 | 1 | 1 | 0 | 0 | 1 | 1 | 0 | 0 | 0 | 0 | 1 | 0 | 0 | 0 | 1 | 0 | 1 | 0 | 0 | 1 |
| 1 | 0 | 0 | 0 | 0 | 1 | 1 | 0 | 0 | 0 | 0 | 1 | 0 | 0 | 0 | 1 | 0 | 0 | 0 | 0 | 0 |
| 0 | 0 | 0 | 0 | 0 | 0 | 1 | 0 | 0 | 0 | 0 | 0 | 1 | 0 | 0 | 0 | 1 | 0 | 0 | 0 | 0 |
| 0 | 0 | 0 | 0 | 0 | 0 | 1 | 0 | 0 | 0 | 0 | 0 | 0 | 0 | 1 | 1 | 0 | 1 | 1 | 0 | 0 |
| 1 | 1 | 0 | 1 | 1 | 0 | 1 | 0 | 0 | 0 | 0 | 1 | 0 | 0 | 0 | 0 | 0 | 0 | 0 | 0 | 0 |
| 0 | 1 | 0 | 0 | 0 | 0 | 1 | 0 | 0 | 0 | 0 | 1 | 0 | 0 | 0 | 1 | 0 | 0 | 1 | 0 | 0 |
| 0 | 1 | 0 | 0 | 0 | 0 | 0 | 0 | 0 | 0 | 0 | 1 | 1 | 0 | 0 | 0 | 0 | 0 | 0 | 0 | 1 |
| 1 | 0 | 0 | 0 | 1 | 0 | 0 | 0 | 1 | 0 | 0 | 0 | 0 | 0 | 0 | 1 | 0 | 0 | 0 | 1 | 0 |
| 0 | 0 | 0 | 0 | 1 | 0 | 1 | 0 | 1 | 0 | 0 | 1 | 0 | 0 | 0 | 1 | 1 | 0 | 0 | 0 | 0 |
| 1 | 1 | 0 | 0 | 1 | 0 | 1 | 0 | 0 | 0 | 1 | 1 | 0 | 0 | 1 | 1 | 1 | 0 | 0 | 0 | 0 |
| 0 | 1 | 0 | 0 | 0 | 0 | 1 | 0 | 0 | 0 | 0 | 0 | 0 | 0 | 0 | 0 | 1 | 0 | 0 | 0 | 0 |
| 0 | 0 | 0 | 0 | 0 | 0 | 1 | 0 | 0 | 0 | 0 | 1 | 1 | 0 | 0 | 0 | 1 | 1 | 0 | 0 | 1 |
| 0 | 1 | 0 | 0 | 0 | 0 | 1 | 0 | 1 | 0 | 0 | 1 | 0 | 0 | 0 | 0 | 1 | 0 | 0 | 0 | 0 |
| 0 | 0 | 0 | 1 | 1 | 1 | 0 | 1 | 0 | 0 | 0 | 1 | 0 | 0 | 0 | 0 | 1 | 0 | 0 | 0 | 0 |
| 0 | 1 | 0 | 0 | 1 | 0 | 0 | 1 | 1 | 0 | 1 | 1 | 0 | 0 | 0 | 1 | 0 | 0 | 0 | 0 | 0 |
| 0 | 1 | 0 | 0 | 0 | 0 | 1 | 0 | 0 | 0 | 0 | 1 | 1 | 0 | 0 | 1 | 0 | 1 | 1 | 0 | 0 |
| 0 | 1 | 0 | 0 | 1 | 0 | 1 | 0 | 1 | 0 | 0 | 1 | 0 | 0 | 0 | 1 | 1 | 0 | 0 | 0 | 0 |
| 0 | 1 | 0 | 0 | 0 | 0 | 1 | 0 | 1 | 0 | 0 | 0 | 0 | 0 | 0 | 0 | 1 | 0 | 0 | 0 | 0 |
| 1 | 0 | 0 | 1 | 1 | 0 | 1 | 0 | 1 | 1 | 0 | 1 | 0 | 0 | 0 | 0 | 0 | 0 | 1 | 0 | 0 |
| 0 | 1 | 0 | 0 | 1 | 0 | 0 | 0 | 1 | 0 | 0 | 0 | 0 | 0 | 0 | 0 | 0 | 0 | 0 | 0 | 1 |
| 1 | 0 | 0 | 1 | 0 | 0 | 1 | 0 | 0 | 0 | 0 | 1 | 0 | 0 | 0 | 0 | 0 | 0 | 1 | 0 | 1 |
| 0 | 0 | 0 | 1 | 1 | 0 | 1 | 0 | 0 | 0 | 0 | 1 | 0 | 0 | 0 | 0 | 1 | 0 | 0 | 0 | 0 |
| 0 | 0 | 0 | 0 | 1 | 1 | 0 | 0 | 0 | 0 | 0 | 1 | 0 | 1 | 0 | 0 | 1 | 1 | 0 | 0 | 0 |
| 0 | 0 | 0 | 0 | 0 | 0 | 0 | 0 | 0 | 0 | 1 | 1 | 1 | 0 | 0 | 1 | 1 | 0 | 0 | 0 | 1 |
| 1 | 0 | 1 | 0 | 1 | 0 | 1 | 0 | 1 | 1 | 0 | 1 | 1 | 0 | 0 | 0 | 1 | 1 | 0 | 0 | 1 |
| 1 | 1 | 0 | 1 | 1 | 1 | 1 | 0 | 0 | 1 | 1 | 1 | 0 | 1 | 0 | 1 | 1 | 0 | 0 | 1 | 0 |
| 0 | 0 | 0 | 1 | 0 | 0 | 0 | 0 | 0 | 0 | 0 | 0 | 0 | 1 | 0 | 0 | 0 | 1 | 0 | 1 | 1 |
| 1 | 0 | 0 | 0 | 1 | 1 | 1 | 1 | 0 | 0 | 0 | 1 | 0 | 0 | 0 | 0 | 0 | 0 | 0 | 1 | 0 |
| 1 | 0 | 1 | 1 | 1 | 0 | 0 | 0 | 1 | 1 | 1 | 1 | 1 | 1 | 1 | 0 | 1 | 1 | 1 | 0 | 1 |
| 1 | 0 | 1 | 0 | 1 | 1 | 0 | 0 | 0 | 0 | 1 | 0 | 0 | 1 | 1 | 0 | 1 | 1 | 0 | 0 | 1 |
| 0 | 1 | 0 | 0 | 0 | 0 | 1 | 0 | 0 | 0 | 0 | 0 | 0 | 0 | 0 | 1 | 0 | 0 | 0 | 0 | 0 |
| 0 | 1 | 1 | 0 | 0 | 0 | 1 | 0 | 1 | 0 | 0 | 0 | 0 | 1 | 0 | 0 | 0 | 0 | 0 | 0 | 1 |
| 0 | 1 | 0 | 0 | 0 | 0 | 1 | 0 | 1 | 0 | 0 | 1 | 0 | 0 | 0 | 0 | 1 | 0 | 0 | 0 | 0 |
| 0 | 1 | 1 | 0 | 1 | 0 | 0 | 0 | 0 | 0 | 0 | 1 | 1 | 0 | 0 | 1 | 1 | 1 | 0 | 0 | 1 |
| 0 | 0 | 0 | 0 | 0 | 0 | 1 | 0 | 0 | 0 | 0 | 1 | 0 | 0 | 0 | 0 | 0 | 0 | 1 | 0 | 0 |
| 0 | 1 | 0 | 0 | 0 | 1 | 1 | 0 | 1 | 0 | 0 | 1 | 1 | 0 | 0 | 1 | 1 | 0 | 0 | 1 | 0 |
| 0 | 1 | 0 | 0 | 0 | 0 | 0 | 0 | 0 | 0 | 0 | 0 | 0 | 0 | 0 | 1 | 1 | 0 | 1 | 0 | 1 |
| 1 | 1 | 0 | 0 | 0 | 0 | 0 | 1 | 0 | 0 | 0 | 1 | 0 | 0 | 0 | 0 | 0 | 0 | 0 | 0 | 0 |
| 1 | 0 | 0 | 0 | 0 | 0 | 1 | 0 | 0 | 0 | 0 | 1 | 0 | 0 | 0 | 1 | 0 | 0 | 0 | 0 | 1 |
| 0 | 1 | 0 | 1 | 0 | 0 | 1 | 0 | 0 | 0 | 0 | 1 | 0 | 0 | 0 | 1 | 0 | 0 | 0 | 0 | 0 |
| 0 | 0 | 0 | 0 | 1 | 0 | 0 | 0 | 1 | 0 | 0 | 0 | 1 | 0 | 0 | 0 | 1 | 0 | 0 | 0 | 0 |
| 0 | 0 | 0 | 1 | 1 | 0 | 1 | 0 | 0 | 0 | 0 | 0 | 0 | 0 | 0 | 0 | 0 | 1 | 0 | 1 | 0 |
| 0 | 1 | 0 | 0 | 1 | 0 | 1 | 0 | 1 | 0 | 0 | 1 | 1 | 0 | 0 | 0 | 0 | 1 | 1 | 0 | 0 |
| 0 | 0 | 0 | 0 | 1 | 1 | 1 | 0 | 0 | 0 | 0 | 0 | 0 | 0 | 1 | 0 | 1 | 0 | 1 | 0 | 0 |
| 0 | 0 | 0 | 0 | 1 | 0 | 0 | 0 | 0 | 1 | 0 | 1 | 1 | 0 | 1 | 0 | 0 | 0 | 0 | 0 | 0 |
| 0 | 1 | 1 | 0 | 1 | 0 | 0 | 0 | 1 | 0 | 1 | 1 | 1 | 0 | 1 | 0 | 1 | 1 | 1 | 0 | 1 |
| 1 | 0 | 0 | 1 | 1 | 0 | 1 | 0 | 1 | 0 | 0 | 1 | 0 | 0 | 0 | 0 | 1 | 0 | 0 | 0 | 0 |
| 0 | 0 | 1 | 0 | 1 | 0 | 0 | 0 | 0 | 1 | 0 | 0 | 0 | 1 | 0 | 0 | 0 | 0 | 0 | 0 | 0 |
| 0 | 1 | 0 | 0 | 0 | 0 | 1 | 0 | 0 | 0 | 0 | 0 | 0 | 0 | 1 | 1 | 0 | 1 | 0 | 0 | 1 |
| 0 | 0 | 0 | 1 | 1 | 1 | 1 | 0 | 0 | 0 | 0 | 0 | 0 | 0 | 0 | 0 | 1 | 1 | 0 | 0 | 0 |
| 0 | 0 | 0 | 1 | 1 | 0 | 1 | 0 | 0 | 0 | 1 | 0 | 0 | 0 | 0 | 0 | 1 | 1 | 0 | 0 | 1 |
| 0 | 0 | 0 | 1 | 0 | 0 | 0 | 0 | 0 | 1 | 0 | 1 | 0 | 0 | 0 | 0 | 0 | 0 | 0 | 0 | 0 |
| 1 | 1 | 0 | 0 | 1 | 1 | 0 | 1 | 0 | 0 | 0 | 1 | 0 | 1 | 0 | 1 | 1 | 1 | 0 | 0 | 1 |
| 0 | 0 | 1 | 0 | 0 | 0 | 0 | 0 | 0 | 0 | 0 | 1 | 1 | 0 | 0 | 0 | 0 | 0 | 0 | 0 | 0 |
| 1 | 1 | 0 | 0 | 0 | 1 | 0 | 0 | 0 | 0 | 0 | 0 | 0 | 0 | 0 | 1 | 0 | 0 | 0 | 1 | 1 |
| 0 | 0 | 0 | 0 | 0 | 1 | 0 | 0 | 0 | 0 | 0 | 0 | 0 | 0 | 0 | 0 | 1 | 1 | 0 | 1 | 0 |
| 1 | 1 | 1 | 0 | 1 | 0 | 1 | 0 | 0 | 0 | 0 | 1 | 1 | 0 | 0 | 1 | 1 | 0 | 0 | 0 | 1 |
| 1 | 0 | 0 | 0 | 0 | 0 | 0 | 0 | 0 | 1 | 0 | 0 | 1 | 0 | 0 | 0 | 0 | 0 | 0 | 0 | 0 |
| 1 | 0 | 0 | 1 | 0 | 0 | 0 | 0 | 0 | 0 | 0 | 0 | 1 | 0 | 0 | 0 | 0 | 0 | 0 | 0 | 0 |
| 0 | 0 | 1 | 0 | 1 | 0 | 0 | 0 | 0 | 0 | 0 | 1 | 0 | 0 | 0 | 0 | 0 | 0 | 0 | 0 | 0 |
| 0 | 0 | 0 | 0 | 1 | 0 | 0 | 0 | 0 | 0 | 0 | 1 | 1 | 1 | 0 | 0 | 1 | 0 | 0 | 0 | 0 |
| 0 | 0 | 0 | 0 | 0 | 1 | 1 | 0 | 0 | 0 | 0 | 1 | 0 | 0 | 0 | 0 | 1 | 0 | 0 | 0 | 0 |
| 0 | 1 | 0 | 0 | 0 | 0 | 0 | 0 | 1 | 0 | 0 | 0 | 1 | 0 | 1 | 0 | 0 | 0 | 0 | 0 | 1 |
| 1 | 1 | 0 | 1 | 1 | 0 | 0 | 1 | 1 | 0 | 0 | 1 | 0 | 0 | 0 | 1 | 0 | 0 | 0 | 0 | 0 |
| 0 | 1 | 0 | 0 | 0 | 0 | 1 | 0 | 0 | 1 | 0 | 1 | 0 | 0 | 0 | 0 | 0 | 1 | 0 | 1 | 0 |
| 1 | 1 | 0 | 0 | 1 | 0 | 0 | 0 | 0 | 1 | 0 | 1 | 0 | 0 | 1 | 1 | 0 | 1 | 0 | 0 | 0 |
| 0 | 1 | 0 | 1 | 1 | 0 | 1 | 0 | 0 | 0 | 0 | 0 | 0 | 0 | 0 | 0 | 0 | 0 | 0 | 0 | 1 |
| 1 | 0 | 1 | 0 | 0 | 0 | 1 | 0 | 0 | 0 | 0 | 0 | 0 | 0 | 0 | 0 | 1 | 0 | 0 | 0 | 0 |
| 0 | 0 | 0 | 0 | 0 | 0 | 1 | 0 | 1 | 0 | 0 | 1 | 0 | 0 | 0 | 0 | 0 | 0 | 0 | 0 | 0 |
| 1 | 0 | 0 | 0 | 1 | 0 | 0 | 0 | 0 | 0 | 0 | 1 | 0 | 0 | 0 | 1 | 0 | 1 | 0 | 0 | 0 |
| 1 | 1 | 0 | 0 | 0 | 1 | 0 | 0 | 0 | 0 | 0 | 1 | 0 | 0 | 0 | 0 | 1 | 0 | 0 | 0 | 0 |
| 0 | 0 | 1 | 0 | 1 | 0 | 1 | 0 | 1 | 0 | 0 | 0 | 0 | 0 | 0 | 1 | 1 | 0 | 1 | 0 | 1 |
| 0 | 0 | 0 | 0 | 1 | 0 | 0 | 0 | 0 | 0 | 0 | 0 | 0 | 0 | 0 | 1 | 1 | 0 | 0 | 0 | 1 |
| 0 | 1 | 0 | 0 | 0 | 0 | 1 | 0 | 0 | 0 | 0 | 1 | 0 | 0 | 0 | 0 | 0 | 0 | 0 | 0 | 0 |
| 0 | 1 | 0 | 0 | 1 | 1 | 0 | 0 | 0 | 0 | 0 | 0 | 1 | 0 | 0 | 0 | 0 | 1 | 0 | 1 | 1 |
| 0 | 1 | 1 | 0 | 1 | 1 | 1 | 0 | 1 | 0 | 0 | 0 | 0 | 0 | 0 | 0 | 1 | 0 | 0 | 0 | 0 |
| 1 | 0 | 0 | 0 | 1 | 0 | 1 | 0 | 1 | 0 | 0 | 1 | 0 | 1 | 0 | 0 | 1 | 1 | 0 | 0 | 0 |
| 1 | 0 | 0 | 0 | 1 | 0 | 0 | 0 | 0 | 1 | 0 | 1 | 0 | 0 | 0 | 0 | 0 | 0 | 1 | 0 | 0 |
| 0 | 0 | 0 | 0 | 0 | 0 | 1 | 0 | 0 | 0 | 0 | 1 | 0 | 0 | 1 | 0 | 0 | 0 | 0 | 0 | 0 |
| 0 | 1 | 0 | 0 | 1 | 0 | 1 | 0 | 0 | 0 | 0 | 0 | 0 | 0 | 0 | 1 | 0 | 1 | 0 | 0 | 1 |
| 0 | 1 | 0 | 0 | 0 | 0 | 0 | 0 | 0 | 0 | 0 | 0 | 0 | 1 | 0 | 0 | 0 | 1 | 1 | 0 | 1 |
| 0 | 1 | 0 | 1 | 0 | 0 | 0 | 0 | 0 | 0 | 0 | 1 | 0 | 0 | 0 | 0 | 0 | 0 | 0 | 0 | 0 |
| 0 | 0 | 1 | 1 | 0 | 0 | 0 | 0 | 0 | 1 | 1 | 0 | 0 | 1 | 0 | 0 | 0 | 1 | 1 | 0 | 0 |
| 0 | 1 | 0 | 0 | 1 | 0 | 1 | 0 | 0 | 0 | 0 | 0 | 0 | 0 | 0 | 1 | 1 | 0 | 0 | 0 | 0 |
| 1 | 0 | 1 | 0 | 0 | 0 | 0 | 1 | 1 | 0 | 1 | 1 | 0 | 0 | 0 | 0 | 1 | 0 | 0 | 1 | 0 |
| 0 | 1 | 0 | 0 | 0 | 0 | 1 | 0 | 1 | 0 | 0 | 0 | 1 | 0 | 0 | 1 | 1 | 0 | 0 | 0 | 1 |
| 1 | 1 | 0 | 0 | 1 | 0 | 1 | 0 | 1 | 0 | 0 | 1 | 0 | 0 | 0 | 1 | 1 | 0 | 0 | 0 | 0 |
| 1 | 0 | 0 | 0 | 1 | 0 | 0 | 0 | 1 | 0 | 0 | 1 | 0 | 0 | 0 | 0 | 1 | 0 | 0 | 0 | 0 |
| 0 | 0 | 1 | 1 | 1 | 0 | 1 | 0 | 0 | 0 | 1 | 0 | 0 | 1 | 1 | 0 | 1 | 1 | 1 | 0 | 0 |
| 0 | 0 | 0 | 0 | 0 | 1 | 1 | 0 | 1 | 0 | 0 | 1 | 0 | 0 | 0 | 0 | 0 | 0 | 1 | 0 | 0 |
| 0 | 0 | 0 | 0 | 0 | 0 | 0 | 0 | 1 | 1 | 0 | 1 | 0 | 0 | 0 | 0 | 0 | 0 | 0 | 0 | 0 |
| 0 | 0 | 0 | 0 | 1 | 0 | 1 | 0 | 0 | 0 | 0 | 0 | 1 | 0 | 0 | 0 | 0 | 0 | 1 | 0 | 0 |
| 0 | 1 | 0 | 0 | 0 | 0 | 0 | 0 | 0 | 0 | 0 | 0 | 1 | 0 | 0 | 0 | 0 | 1 | 0 | 0 | 1 |
| 0 | 0 | 0 | 0 | 0 | 0 | 1 | 0 | 1 | 0 | 1 | 1 | 0 | 0 | 0 | 0 | 1 | 0 | 0 | 0 | 0 |
| 1 | 1 | 0 | 0 | 0 | 0 | 0 | 0 | 0 | 0 | 0 | 0 | 0 | 1 | 0 | 0 | 0 | 0 | 0 | 0 | 0 |
| 0 | 1 | 0 | 0 | 0 | 0 | 0 | 0 | 0 | 0 | 0 | 0 | 0 | 0 | 0 | 1 | 0 | 1 | 0 | 0 | 1 |
| 1 | 1 | 0 | 1 | 1 | 0 | 1 | 1 | 0 | 0 | 1 | 0 | 1 | 0 | 0 | 1 | 1 | 1 | 1 | 0 | 0 |
| 1 | 1 | 0 | 0 | 0 | 0 | 0 | 0 | 0 | 0 | 0 | 0 | 0 | 0 | 0 | 1 | 0 | 0 | 0 | 0 | 0 |
| 1 | 0 | 0 | 1 | 1 | 0 | 0 | 0 | 0 | 0 | 0 | 1 | 0 | 0 | 0 | 1 | 0 | 0 | 0 | 0 | 0 |
| 1 | 0 | 1 | 0 | 0 | 0 | 0 | 0 | 0 | 0 | 0 | 0 | 1 | 1 | 0 | 0 | 0 | 1 | 0 | 0 | 1 |
| 1 | 1 | 0 | 0 | 0 | 0 | 0 | 0 | 1 | 0 | 1 | 1 | 0 | 0 | 0 | 1 | 0 | 0 | 0 | 0 | 0 |
| 0 | 0 | 0 | 1 | 1 | 0 | 0 | 0 | 0 | 0 | 0 | 1 | 0 | 1 | 0 | 1 | 1 | 0 | 0 | 0 | 1 |
| 0 | 1 | 0 | 0 | 1 | 1 | 1 | 0 | 0 | 0 | 1 | 0 | 0 | 0 | 0 | 1 | 1 | 1 | 0 | 1 | 0 |
| 1 | 1 | 1 | 1 | 0 | 1 | 1 | 0 | 0 | 0 | 0 | 0 | 0 | 0 | 0 | 0 | 0 | 0 | 0 | 0 | 0 |
| 0 | 1 | 1 | 0 | 1 | 0 | 0 | 0 | 0 | 0 | 0 | 1 | 0 | 0 | 0 | 1 | 1 | 0 | 0 | 0 | 0 |
| 0 | 1 | 0 | 0 | 0 | 0 | 0 | 0 | 0 | 0 | 0 | 1 | 0 | 0 | 0 | 1 | 1 | 0 | 0 | 0 | 0 |
| 1 | 0 | 0 | 0 | 1 | 0 | 0 | 0 | 1 | 0 | 0 | 1 | 0 | 0 | 0 | 0 | 1 | 0 | 0 | 0 | 0 |
| 0 | 0 | 0 | 0 | 1 | 0 | 0 | 0 | 1 | 0 | 1 | 1 | 0 | 0 | 0 | 0 | 0 | 0 | 0 | 0 | 0 |
| 0 | 0 | 0 | 1 | 0 | 1 | 1 | 0 | 0 | 0 | 0 | 0 | 0 | 0 | 0 | 0 | 0 | 0 | 1 | 0 | 0 |
| 1 | 1 | 0 | 0 | 0 | 0 | 1 | 0 | 1 | 0 | 0 | 1 | 0 | 0 | 0 | 1 | 0 | 0 | 0 | 0 | 0 |
| 0 | 0 | 0 | 1 | 0 | 0 | 0 | 1 | 0 | 0 | 1 | 0 | 0 | 0 | 0 | 0 | 0 | 1 | 0 | 0 | 0 |
| 0 | 1 | 0 | 0 | 1 | 0 | 0 | 0 | 0 | 0 | 0 | 0 | 0 | 0 | 0 | 1 | 0 | 0 | 1 | 0 | 1 |
| 0 | 0 | 0 | 0 | 1 | 0 | 1 | 0 | 1 | 0 | 0 | 0 | 0 | 1 | 0 | 1 | 1 | 0 | 0 | 0 | 0 |
| 1 | 0 | 0 | 0 | 1 | 0 | 1 | 0 | 1 | 0 | 0 | 1 | 0 | 0 | 0 | 0 | 1 | 1 | 0 | 0 | 0 |
| 0 | 0 | 0 | 0 | 0 | 0 | 1 | 0 | 0 | 1 | 0 | 0 | 0 | 0 | 0 | 0 | 0 | 1 | 0 | 0 | 0 |
| 0 | 1 | 0 | 0 | 0 | 0 | 0 | 0 | 1 | 0 | 0 | 0 | 1 | 0 | 0 | 0 | 0 | 0 | 0 | 0 | 0 |
| 0 | 0 | 0 | 1 | 0 | 0 | 1 | 0 | 0 | 0 | 0 | 0 | 0 | 0 | 0 | 0 | 1 | 0 | 0 | 0 | 0 |
| 0 | 1 | 0 | 0 | 0 | 0 | 1 | 0 | 0 | 0 | 1 | 1 | 0 | 0 | 0 | 1 | 0 | 0 | 0 | 0 | 0 |
| 1 | 0 | 1 | 1 | 1 | 0 | 0 | 0 | 0 | 0 | 0 | 0 | 0 | 1 | 1 | 0 | 0 | 0 | 0 | 0 | 1 |
| 1 | 1 | 1 | 1 | 1 | 1 | 0 | 0 | 0 | 0 | 0 | 1 | 1 | 1 | 1 | 0 | 1 | 0 | 0 | 0 | 1 |
| 0 | 0 | 0 | 0 | 1 | 0 | 0 | 0 | 0 | 0 | 0 | 1 | 0 | 1 | 0 | 0 | 1 | 0 | 0 | 0 | 1 |
| 1 | 0 | 0 | 0 | 1 | 1 | 0 | 0 | 0 | 0 | 0 | 1 | 0 | 0 | 0 | 0 | 0 | 0 | 0 | 0 | 0 |
| 0 | 1 | 1 | 1 | 1 | 1 | 1 | 0 | 0 | 0 | 1 | 1 | 0 | 0 | 1 | 0 | 1 | 1 | 1 | 0 | 0 |
| 1 | 1 | 1 | 1 | 1 | 0 | 1 | 0 | 0 | 0 | 0 | 1 | 0 | 1 | 0 | 1 | 1 | 0 | 1 | 0 | 1 |
| 0 | 1 | 1 | 1 | 1 | 0 | 0 | 0 | 0 | 0 | 1 | 0 | 0 | 1 | 0 | 0 | 1 | 1 | 1 | 0 | 0 |
| 0 | 0 | 0 | 0 | 1 | 0 | 1 | 0 | 0 | 0 | 0 | 1 | 0 | 0 | 0 | 0 | 1 | 0 | 0 | 0 | 0 |
| 1 | 0 | 1 | 0 | 1 | 0 | 0 | 0 | 0 | 0 | 0 | 1 | 0 | 0 | 0 | 0 | 0 | 0 | 0 | 0 | 1 |
| 1 | 0 | 1 | 1 | 1 | 0 | 0 | 0 | 1 | 0 | 0 | 1 | 0 | 1 | 1 | 0 | 1 | 0 | 0 | 0 | 0 |
| 0 | 0 | 1 | 1 | 1 | 1 | 1 | 0 | 0 | 0 | 0 | 0 | 0 | 0 | 0 | 0 | 1 | 0 | 0 | 0 | 0 |
| 0 | 1 | 0 | p | 0 | 0 | 0 | 0 | 1 | 0 | 0 | 0 | 0 | 0 | 0 | 1 | 0 | 0 | 0 | 0 | 0 |
| 0 | 1 | 0 | 1 | 0 | 0 | 0 | 0 | 0 | 0 | 1 | 1 | 0 | 0 | 0 | 0 | 0 | 0 | 0 | 0 | 0 |
| 0 | 0 | 0 | 0 | 0 | 0 | 1 | 0 | 0 | 0 | 1 | 1 | 0 | 0 | 0 | 0 | 1 | 0 | 0 | 0 | 1 |
| 0 | 0 | 0 | 1 | 1 | 1 | 1 | 0 | 1 | 0 | 0 | 1 | 0 | 0 | 1 | 0 | 1 | 1 | 1 | 0 | 0 |
| 0 | 0 | 1 | 0 | 1 | 0 | 0 | 0 | 1 | 0 | 0 | 1 | 0 | 0 | 0 | 0 | 1 | 0 | 0 | 0 | 0 |
| 0 | 0 | 0 | 1 | 1 | 0 | 0 | 0 | 1 | 0 | 0 | 1 | 0 | 0 | 0 | 0 | 1 | 0 | 0 | 0 | 0 |
| 0 | 0 | 0 | 0 | 1 | 0 | 0 | 0 | 1 | 0 | 1 | 1 | 0 | 0 | 0 | 0 | 0 | 0 | 0 | 0 | 0 |
| 1 | 0 | 1 | 0 | 1 | 0 | 0 | 0 | 1 | 0 | 0 | 1 | 0 | 1 | 0 | 1 | 1 | 1 | 0 | 0 | 1 |
| 0 | 0 | 0 | 0 | 1 | 0 | 0 | 0 | 1 | 0 | 0 | 1 | 0 | 0 | 0 | 0 | 0 | 0 | 0 | 0 | 0 |
| 0 | 0 | 0 | 0 | 1 | 0 | 0 | 0 | 1 | 0 | 0 | 1 | 0 | 0 | 0 | 0 | 1 | 1 | 0 | 0 | 0 |
| 1 | 0 | 0 | 0 | 0 | 0 | 1 | 0 | 0 | 0 | 1 | 1 | 0 | 0 | 1 | 1 | 0 | 0 | 1 | 0 | 0 |
| 0 | 0 | 1 | 1 | 1 | 0 | 0 | 0 | 1 | 0 | 1 | 1 | 0 | 0 | 0 | 0 | 1 | 0 | 0 | 0 | 0 |
| 1 | 0 | 1 | 1 | 1 | 1 | 0 | 0 | 0 | 0 | 1 | 1 | 0 | 0 | 0 | 0 | 0 | 1 | 0 | 0 | 1 |
| 1 | 0 | 0 | 1 | 0 | 0 | 1 | 0 | 1 | 0 | 1 | 1 | 1 | 1 | 1 | 1 | 0 | 0 | 1 | 0 | 0 |
| 0 | 0 | 0 | 0 | 0 | 0 | 1 | 0 | 1 | 0 | 0 | 0 | 0 | 1 | 0 | 0 | 0 | 0 | 0 | 0 | 0 |
| 0 | 1 | 0 | 0 | 1 | 1 | 0 | 1 | 0 | 0 | 0 | 1 | 1 | 1 | 0 | 1 | 1 | 1 | 0 | 1 | 0 |
| 0 | 1 | 0 | 0 | 1 | 0 | 0 | 0 | 0 | 0 | 0 | 1 | 0 | 0 | 0 | 0 | 0 | 0 | 0 | 0 | 0 |
| 0 | 1 | 0 | 0 | 0 | 0 | 0 | 0 | 0 | 0 | 0 | 0 | 1 | 0 | 0 | 0 | 1 | 0 | 0 | 0 | 1 |
| 0 | 1 | 0 | 1 | 0 | 0 | 0 | 0 | 0 | 0 | 0 | 0 | 0 | 0 | 0 | 1 | 0 | 0 | 0 | 0 | 0 |
| 0 | 0 | 0 | 0 | 0 | 0 | 1 | 0 | 1 | 0 | 0 | 0 | 0 | 0 | 0 | 0 | 1 | 0 | 0 | 0 | 0 |
| 0 | 0 | 0 | 1 | 0 | 0 | 0 | 0 | 0 | 0 | 0 | 1 | 0 | 0 | 0 | 0 | 1 | 0 | 0 | 0 | 0 |
| 1 | 0 | 0 | 0 | 0 | 0 | 0 | 0 | 0 | 0 | 0 | 1 | 0 | 0 | 0 | 1 | 0 | 0 | 0 | 0 | 0 |
| 0 | 1 | 0 | 0 | 1 | 0 | 0 | 0 | 0 | 0 | 0 | 0 | 0 | 0 | 0 | 1 | 0 | 0 | 0 | 0 | 1 |
| 0 | 1 | 0 | 0 | 0 | 0 | 0 | 0 | 0 | 0 | 0 | 0 | 0 | 1 | 0 | 1 | 0 | 0 | 0 | 0 | 0 |
| 0 | 1 | 0 | 0 | 0 | 1 | 1 | 0 | 0 | 0 | 0 | 0 | 0 | 0 | 0 | 0 | 0 | 0 | 0 | 0 | 0 |
| 0 | 0 | 0 | 0 | 0 | 1 | 1 | 0 | 0 | 0 | 0 | 1 | 0 | 0 | 0 | 0 | 0 | 0 | 0 | 0 | 0 |
| 1 | 1 | 0 | 0 | 0 | 0 | 0 | 0 | 0 | 0 | 0 | 0 | 0 | 0 | 0 | 0 | 1 | 0 | 0 | 0 | 1 |
| 1 | 1 | 0 | 0 | 0 | 0 | 0 | 0 | 0 | 0 | 0 | 0 | 0 | 0 | 0 | 1 | 0 | 0 | 0 | 0 | 1 |
| 0 | 0 | 0 | 0 | 0 | 0 | 0 | 0 | 1 | 0 | 0 | 0 | 0 | 0 | 1 | 0 | 0 | 1 | 0 | 0 | 0 |
| 1 | 0 | 1 | 0 | 1 | 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 1 | 0 | 0 | 0 | 0 | 0 | 0 | 0 | 0 | 1 | 0 | 0 | 0 | 1 | 1 |
| 0 | 1 | 0 | 0 | 0 | 0 | 0 | 0 | 0 | 0 | 0 | 1 | 0 | 0 | 0 | 1 | 0 | 0 | 0 | 0 | 1 |
| 0 | 1 | 0 | 0 | 0 | 0 | 1 | 0 | 0 | 0 | 0 | 0 | 1 | 0 | 0 | 0 | 1 | 0 | 0 | 0 | 1 |
| 0 | 0 | 0 | 0 | 0 | 0 | 0 | 1 | 0 | 0 | 0 | 1 | 0 | 0 | 0 | 0 | 1 | 1 | 0 | 0 | 0 |
| 0 | 0 | 0 | 0 | 0 | 0 | 0 | 1 | 0 | 0 | 0 | 0 | 1 | 0 | 0 | 0 | 0 | 1 | 0 | 0 | 0 |
| 0 | 1 | 0 | 1 | 0 | 0 | 1 | 0 | 0 | 0 | 0 | 1 | 0 | 0 | 0 | 1 | 0 | 0 | 0 | 0 | 0 |
| 1 | 1 | 0 | 1 | 1 | 1 | 1 | 0 | 1 | 0 | 1 | 0 | 1 | 0 | 0 | 1 | 1 | 1 | 1 | 1 | 1 |
| 0 | 0 | 0 | 0 | 1 | 0 | 0 | 0 | 0 | 0 | 0 | 0 | 0 | 0 | 0 | 0 | 1 | 1 | 0 | 0 | 1 |
| 1 | 0 | 0 | 0 | 0 | 0 | 1 | 0 | 0 | 0 | 0 | 0 | 0 | 0 | 0 | 1 | 0 | 0 | 0 | 0 | 0 |
| 0 | 1 | 1 | 1 | 1 | 0 | 0 | 0 | 0 | 1 | 1 | 1 | 0 | 1 | 0 | 0 | 1 | 0 | 0 | 0 | 0 |
| 0 | 1 | 1 | 0 | 0 | 0 | 1 | 0 | 1 | 0 | 1 | 0 | 0 | 0 | 1 | 1 | 0 | 0 | 1 | 0 | 1 |
| 0 | 1 | 0 | 0 | 1 | 1 | 1 | 0 | 1 | 0 | 0 | 1 | 0 | 0 | 1 | 1 | 1 | 0 | 0 | 1 | 0 |
| 0 | 1 | 0 | 0 | 1 | 0 | 1 | 0 | 0 | 0 | 0 | 0 | 0 | 0 | 0 | 1 | 0 | 0 | 0 | 0 | 0 |
| 0 | 1 | 0 | 0 | 1 | 0 | 0 | 0 | 0 | 0 | 0 | 0 | 0 | 1 | 0 | 0 | 1 | 0 | 0 | 0 | 1 |
| 1 | 0 | 0 | 0 | 1 | 0 | 1 | 0 | 0 | 0 | 1 | 1 | 0 | 0 | 0 | 1 | 0 | 0 | 0 | 0 | 0 |
| 1 | 0 | 0 | 0 | 0 | 0 | 1 | 1 | 1 | 0 | 0 | 0 | 0 | 0 | 0 | 0 | 0 | 1 | 1 | 0 | 0 |
| 0 | 0 | 0 | 0 | 1 | 0 | 0 | 0 | 0 | 0 | 0 | 1 | 0 | 0 | 0 | 1 | 1 | 0 | 0 | 0 | 1 |
| 1 | 1 | 0 | 1 | 0 | 1 | 0 | 0 | 0 | 0 | 0 | 0 | 1 | 0 | 0 | 1 | 0 | 0 | 1 | 0 | 0 |
| 0 | 0 | 1 | 1 | 1 | 0 | 1 | 0 | 0 | 0 | 0 | 1 | 0 | 0 | 0 | 0 | 0 | 0 | 1 | 0 | 0 |
| 0 | 1 | 0 | 0 | 0 | 0 | 1 | 0 | 0 | 0 | 0 | 0 | 0 | 0 | 0 | 0 | 1 | 0 | 0 | 0 | 0 |
| 1 | 0 | 0 | 0 | 0 | 0 | 0 | 0 | 1 | 0 | 0 | 0 | 1 | 0 | 1 | 0 | 0 | 1 | 0 | 0 | 1 |
| 0 | 1 | 0 | 0 | 1 | 0 | 0 | 0 | 1 | 0 | 0 | 0 | 1 | 0 | 0 | 0 | 0 | 0 | 0 | 0 | 0 |
| 0 | 0 | 0 | 1 | 0 | 1 | 0 | 0 | 0 | 0 | 0 | 0 | 0 | 0 | 0 | 0 | 0 | 0 | 0 | 1 | 0 |
| 0 | 0 | 0 | 0 | 1 | 0 | 1 | 0 | 0 | 0 | 0 | 1 | 0 | 0 | 0 | 0 | 0 | 1 | 0 | 0 | 0 |
| 0 | 0 | 0 | 1 | 1 | 0 | 0 | 0 | 0 | 0 | 1 | 1 | 1 | 1 | 1 | 0 | 0 | 0 | 0 | 0 | 0 |
| 0 | 1 | 0 | 0 | 0 | 0 | 0 | 0 | 0 | 0 | 0 | 0 | 0 | 0 | 0 | 1 | 1 | 0 | 0 | 0 | 1 |
| 0 | 0 | 0 | 0 | 0 | 0 | 1 | 0 | 1 | 0 | 1 | 1 | 0 | 0 | 0 | 0 | 1 | 0 | 0 | 0 | 0 |
| 0 | 0 | 0 | 0 | 0 | 1 | 1 | 0 | 0 | 0 | 0 | 0 | 0 | 0 | 0 | 0 | 1 | 1 | 1 | 0 | 0 |
| 0 | 1 | 0 | 0 | 0 | 0 | 0 | 0 | 0 | 0 | 1 | 0 | 1 | 0 | 0 | 0 | 1 | 0 | 0 | 0 | 0 |
| 0 | 0 | 0 | 0 | 0 | 0 | 1 | 0 | 0 | 0 | 0 | 1 | 0 | 0 | 0 | 0 | 1 | 0 | 0 | 0 | 0 |
| 0 | 0 | 0 | 0 | 0 | 1 | 1 | 0 | 1 | 1 | 0 | 1 | 0 | 0 | 0 | 0 | 1 | 1 | 0 | 0 | 0 |
| 0 | 0 | 1 | 0 | 0 | 0 | 0 | 1 | 0 | 0 | 0 | 0 | 0 | 0 | 0 | 0 | 0 | 0 | 0 | 0 | 1 |
| 0 | 1 | 0 | 0 | 0 | 0 | 0 | 0 | 1 | 0 | 1 | 1 | 0 | 0 | 0 | 1 | 0 | 0 | 0 | 1 | 1 |
| 1 | 1 | 1 | 0 | 1 | 0 | 1 | 0 | 0 | 0 | 1 | 1 | 1 | 0 | 0 | 1 | 0 | 0 | 0 | 0 | 1 |
| 1 | 1 | 0 | 0 | 0 | 1 | 1 | 0 | 1 | 0 | 1 | 1 | 1 | 1 | 1 | 1 | 1 | 0 | 0 | 1 | 0 |
| 1 | 1 | 0 | 1 | 1 | 0 | 1 | 1 | 1 | 0 | 0 | 1 | 1 | 0 | 0 | 1 | 1 | 0 | 0 | 0 | 0 |
| 1 | 0 | 0 | 0 | 0 | 1 | 1 | 1 | 0 | 0 | 0 | 0 | 0 | 0 | 0 | 0 | 0 | 0 | 0 | 0 | 0 |
| 0 | 1 | 0 | 0 | 1 | 0 | 1 | 0 | 1 | 0 | 0 | 1 | 0 | 1 | 0 | 1 | 1 | 0 | 0 | 0 | 0 |
| 1 | 0 | 0 | 1 | 1 | 0 | 0 | 0 | 0 | 0 | 1 | 0 | 0 | 0 | 0 | 0 | 0 | 0 | 1 | 1 | 0 |
| 0 | 0 | 0 | 1 | 1 | 0 | 1 | 0 | 1 | 0 | 1 | 1 | 1 | 1 | 0 | 1 | 1 | 1 | 0 | 0 | 1 |
| 0 | 0 | 0 | 1 | 0 | 0 | 0 | 0 | 0 | 1 | 1 | 0 | 0 | 0 | 0 | 0 | 1 | 0 | 0 | 0 | 1 |
| 1 | 0 | 1 | 0 | 1 | 0 | 1 | 0 | 0 | 0 | 1 | 0 | 0 | 1 | 0 | 0 | 0 | 0 | 0 | 0 | 0 |
| 1 | 0 | 0 | 0 | 0 | 0 | 0 | 1 | 0 | 1 | 0 | 0 | 0 | 0 | 0 | 0 | 0 | 0 | 0 | 0 | 0 |
| 0 | 1 | 0 | 1 | 1 | 0 | 1 | 0 | 1 | 0 | 0 | 1 | 0 | 0 | 0 | 0 | 0 | 0 | 0 | 0 | 0 |
| 1 | 1 | 0 | 0 | 0 | 0 | 1 | 0 | 0 | 1 | 1 | 0 | 0 | 0 | 0 | 0 | 0 | 0 | 0 | 0 | 1 |
| 1 | 0 | 1 | 0 | 0 | 0 | 1 | 0 | 1 | 0 | 0 | 0 | 0 | 0 | 0 | 0 | 1 | 0 | 0 | 0 | 0 |
| 0 | 0 | 1 | 1 | 0 | 0 | 0 | 0 | 0 | 0 | 0 | 0 | 0 | 0 | 0 | 0 | 1 | 0 | 0 | 0 | 0 |
| 0 | 0 | 0 | 0 | 1 | 0 | 0 | 0 | 1 | 0 | 0 | 1 | 0 | 0 | 0 | 0 | 1 | 0 | 0 | 0 | 0 |
| 1 | 0 | 0 | 1 | 1 | 0 | 0 | 0 | 1 | 0 | 1 | 0 | 0 | 0 | 0 | 0 | 1 | 0 | 0 | 0 | 0 |
| 1 | 0 | 1 | 0 | 1 | 0 | 0 | 0 | 1 | 0 | 0 | 0 | 0 | 0 | 0 | 0 | 0 | 0 | 0 | 0 | 0 |
| 0 | 1 | 1 | 1 | 1 | 0 | 0 | 0 | 1 | 0 | 0 | 0 | 0 | 0 | 0 | 1 | 0 | 1 | 0 | 0 | 1 |
| 0 | 0 | 0 | 0 | 0 | 0 | 1 | 0 | 0 | 0 | 1 | 1 | 0 | 0 | 0 | 0 | 0 | 0 | 0 | 0 | 0 |
| 0 | 1 | 0 | 0 | 0 | 1 | 1 | 0 | 0 | 0 | 0 | 0 | 0 | 0 | 0 | 1 | 0 | 0 | 0 | 0 | 0 |
| 0 | 1 | 0 | 0 | 1 | 0 | 0 | 1 | 0 | 0 | 0 | 0 | 0 | 0 | 0 | 1 | 1 | 0 | 0 | 0 | 0 |
| 1 | 1 | 0 | 1 | 1 | 1 | 1 | 0 | 1 | 0 | 0 | 1 | 1 | 0 | 0 | 1 | 1 | 0 | 0 | 1 | 0 |
| 1 | 1 | 0 | 1 | 1 | 0 | 1 | 0 | 0 | 0 | 0 | 0 | 0 | 0 | 0 | 1 | 0 | 0 | 1 | 0 | 1 |
| 1 | 1 | 0 | 1 | 1 | 1 | 1 | 0 | 1 | 0 | 1 | 1 | 0 | 1 | 1 | 1 | 1 | 1 | 0 | 0 | 1 |
| 0 | 1 | 0 | 0 | 0 | 0 | 1 | 1 | 0 | 0 | 1 | 0 | 0 | 0 | 1 | 1 | 1 | 0 | 0 | 0 | 0 |
| 0 | 1 | 0 | 0 | 1 | 0 | 0 | 0 | 1 | 0 | 0 | 1 | 0 | 1 | 0 | 0 | 1 | 1 | 0 | 0 | 1 |
| 0 | 0 | 0 | 0 | 1 | 0 | 0 | 1 | 0 | 0 | 0 | 0 | 0 | 0 | 0 | 0 | 1 | 0 | 0 | 0 | 0 |
| 1 | 0 | 0 | 1 | 0 | 0 | 0 | 0 | 0 | 1 | 1 | 1 | 0 | 0 | 1 | 0 | 0 | 1 | 1 | 0 | 0 |
| 0 | 0 | 0 | 0 | 0 | 0 | 1 | 0 | 0 | 0 | 0 | 0 | 0 | 0 | 0 | 0 | 1 | 0 | 0 | 1 | 0 |
| 0 | 1 | 0 | 0 | 1 | 1 | 1 | 0 | 0 | 0 | 0 | 1 | 0 | 0 | 0 | 1 | 1 | 0 | 0 | 0 | 0 |
| 0 | 0 | 1 | 0 | 1 | 0 | 0 | 0 | 1 | 0 | 0 | 0 | 0 | 0 | 0 | 0 | 0 | 0 | 0 | 0 | 0 |
| 0 | 0 | 0 | 0 | 1 | 0 | 0 | 0 | 0 | 0 | 0 | 1 | 0 | 0 | 0 | 0 | 1 | 1 | 0 | 0 | 1 |
| 1 | 1 | 1 | 1 | 0 | 1 | 0 | 0 | 0 | 0 | 1 | 0 | 0 | 0 | 0 | 1 | 1 | 0 | 0 | 1 | 0 |
| 0 | 0 | 1 | 0 | 1 | 1 | 1 | 1 | 0 | 0 | 0 | 1 | 1 | 1 | 0 | 0 | 1 | 1 | 1 | 1 | 1 |
| 0 | 0 | 0 | 1 | 1 | 0 | 1 | 0 | 1 | 0 | 0 | 1 | 0 | 0 | 0 | 0 | 1 | 0 | 0 | 0 | 0 |
| 0 | 0 | 0 | 0 | 1 | 1 | 1 | 0 | 0 | 0 | 0 | 1 | 0 | 0 | 0 | 1 | 1 | 0 | 0 | 1 | 0 |
| 0 | 1 | 0 | 1 | 0 | 0 | 0 | 0 | 0 | 0 | 0 | 1 | 0 | 0 | 0 | 1 | 1 | 0 | 0 | 0 | 0 |
| 0 | 1 | 0 | 1 | 0 | 0 | 0 | 0 | 0 | 0 | 0 | 0 | 0 | 0 | 0 | 0 | 0 | 1 | 0 | 0 | 1 |
| 1 | 0 | 0 | 0 | 0 | 0 | 1 | 1 | 0 | 0 | 0 | 1 | 0 | 0 | 0 | 1 | 0 | 0 | 0 | 0 | 0 |
| 0 | 1 | 0 | 0 | 1 | 0 | 0 | 0 | 0 | 0 | 0 | 0 | 0 | 0 | 0 | 0 | 1 | 1 | 0 | 0 | 1 |
| 0 | 0 | 0 | 0 | 1 | 0 | 1 | 0 | 0 | 0 | 0 | 1 | 0 | 0 | 0 | 0 | 1 | 0 | 0 | 0 | 0 |
| 1 | 0 | 0 | 1 | 1 | 0 | 1 | 0 | 0 | 0 | 0 | 1 | 0 | 0 | 0 | 0 | 1 | 0 | 0 | 0 | 0 |
| 0 | 0 | 0 | 0 | 1 | 0 | 1 | 0 | 0 | 0 | 0 | 0 | 0 | 0 | 0 | 1 | 0 | 0 | 0 | 0 | 0 |
| 1 | 1 | 0 | 1 | 0 | 0 | 0 | 0 | 0 | 0 | 0 | 0 | 0 | 0 | 0 | 0 | 0 | 0 | 0 | 0 | 0 |
| 0 | 1 | 0 | 0 | 0 | 0 | 0 | 0 | 0 | 0 | 0 | 0 | 0 | 1 | 0 | 1 | 1 | 0 | 0 | 0 | 0 |
| 1 | 0 | 0 | 0 | 1 | 0 | 1 | 0 | 0 | 0 | 0 | 1 | 0 | 0 | 0 | 1 | 0 | 0 | 0 | 0 | 0 |
| 1 | 0 | 1 | 0 | 1 | 0 | 0 | 0 | 0 | 0 | 0 | 1 | 0 | 0 | 0 | 1 | 0 | 0 | 0 | 0 | 1 |
| 0 | 1 | 0 | 0 | 1 | 0 | 1 | 0 | 0 | 0 | 0 | 0 | 0 | 0 | 0 | 0 | 1 | 0 | 0 | 0 | 0 |
| 0 | 0 | 1 | 1 | 1 | 1 | 1 | 0 | 1 | 0 | 1 | 1 | 0 | 1 | 1 | 0 | 1 | 1 | 0 | 0 | 0 |
| 0 | 1 | 1 | 1 | 1 | 0 | 1 | 0 | 1 | 0 | 1 | 1 | 0 | 0 | 0 | 1 | 1 | 1 | 0 | 0 | 0 |
| 1 | 0 | 0 | 0 | 1 | 0 | 1 | 0 | 1 | 0 | 0 | 0 | 0 | 0 | 0 | 0 | 1 | 0 | 0 | 0 | 0 |
| 0 | 1 | 1 | 0 | 0 | 1 | 1 | 0 | 0 | 0 | 1 | 1 | 0 | 0 | 0 | 1 | 1 | 1 | 1 | 0 | 0 |
| 0 | 0 | 0 | 0 | 1 | 0 | 0 | 0 | 0 | 0 | 0 | 1 | 0 | 0 | 1 | 0 | 0 | 0 | 0 | 0 | 0 |
| 0 | 0 | 0 | 0 | 0 | 1 | 0 | 1 | 0 | 0 | 1 | 1 | 0 | 0 | 0 | 0 | 0 | 0 | 0 | 0 | 0 |
| 0 | 1 | 1 | 0 | 1 | 1 | 0 | 1 | 1 | 0 | 0 | 1 | 1 | 1 | 0 | 0 | 0 | 1 | 0 | 1 | 0 |
| 0 | 0 | 0 | 1 | 0 | 0 | 1 | 0 | 0 | 0 | 0 | 0 | 0 | 1 | 1 | 1 | 0 | 0 | 1 | 0 | 0 |
| 0 | 0 | 0 | 1 | 1 | 0 | 0 | 0 | 1 | 0 | 1 | 0 | 0 | 1 | 0 | 0 | 1 | 1 | 0 | 0 | 1 |
| 0 | 1 | 0 | 0 | 0 | 1 | 0 | 1 | 0 | 0 | 0 | 0 | 0 | 0 | 0 | 1 | 0 | 0 | 0 | 0 | 0 |
| 0 | 0 | 0 | 0 | 0 | 0 | 0 | 0 | 0 | 0 | 0 | 1 | 0 | 1 | 0 | 1 | 0 | 0 | 0 | 0 | 0 |
| 0 | 1 | 0 | 0 | 0 | 0 | 1 | 0 | 0 | 0 | 0 | 1 | 0 | 0 | 0 | 0 | 0 | 0 | 0 | 0 | 0 |
| 0 | 0 | 0 | 0 | 0 | 0 | 0 | 1 | 0 | 0 | 0 | 0 | 0 | 0 | 0 | 0 | 1 | 0 | 0 | 1 | 0 |
| 1 | 0 | 0 | 1 | 0 | 0 | 0 | 0 | 1 | 0 | 0 | 0 | 1 | 0 | 0 | 0 | 0 | 1 | 0 | 0 | 1 |
| 0 | 0 | 0 | 0 | 0 | 0 | 0 | 0 | 0 | 1 | 0 | 0 | 1 | 0 | 0 | 0 | 0 | 0 | 1 | 0 | 0 |
| 0 | 1 | 0 | 0 | 1 | 0 | 0 | 1 | 1 | 1 | 0 | 1 | 0 | 0 | 0 | 1 | 1 | 1 | 0 | 0 | 0 |
| 0 | 0 | 0 | 0 | 0 | 1 | 0 | 0 | 0 | 0 | 1 | 0 | 0 | 0 | 0 | 0 | 1 | 0 | 0 | 0 | 1 |
| 0 | 1 | 0 | 1 | 1 | 0 | 0 | 0 | 0 | 0 | 0 | 0 | 0 | 0 | 0 | 0 | 0 | 0 | 0 | 0 | 1 |
| 0 | 1 | 0 | 0 | 0 | 0 | 0 | 1 | 0 | 0 | 0 | 0 | 0 | 0 | 0 | 1 | 0 | 0 | 0 | 0 | 1 |
| 0 | 0 | 0 | 0 | 1 | 0 | 0 | 0 | 0 | 0 | 0 | 1 | 0 | 1 | 0 | 0 | 1 | 0 | 0 | 0 | 0 |
| 1 | 1 | 1 | 1 | 0 | 0 | 0 | 1 | 0 | 1 | 0 | 1 | 1 | 0 | 0 | 1 | 1 | 0 | 0 | 0 | 0 |
| 0 | 1 | 1 | 1 | 1 | 1 | 0 | 1 | 1 | 1 | 0 | 1 | 0 | 1 | 0 | 0 | 1 | 1 | 1 | 0 | 1 |
| 1 | 1 | 0 | 0 | 0 | 0 | 0 | 0 | 1 | 0 | 0 | 0 | 0 | 0 | 0 | 0 | 0 | 0 | 0 | 0 | 1 |
| 1 | 0 | 0 | 0 | 0 | 0 | 0 | 0 | 0 | 0 | 0 | 0 | 0 | 0 | 0 | 1 | 0 | 1 | 0 | 0 | 1 |
| 0 | 0 | 0 | 0 | 1 | 1 | 0 | 0 | 1 | 0 | 1 | 1 | 0 | 0 | 1 | 0 | 1 | 0 | 0 | 0 | 0 |
| 0 | 0 | 0 | 0 | 1 | 0 | 0 | 1 | 0 | 0 | 0 | 0 | 0 | 0 | 0 | 1 | 0 | 0 | 0 | 0 | 0 |
| 0 | 0 | 0 | 0 | 1 | 0 | 0 | 1 | 0 | 0 | 0 | 0 | 0 | 0 | 0 | 0 | 0 | 1 | 0 | 0 | 0 |
| 0 | 0 | 0 | 0 | 0 | 0 | 0 | 0 | 0 | 1 | 1 | 0 | 0 | 0 | 1 | 0 | 0 | 1 | 0 | 0 | 0 |
| 0 | 0 | 0 | 0 | 0 | 0 | 0 | 1 | 0 | 1 | 0 | 0 | 0 | 0 | 0 | 0 | 0 | 1 | 1 | 0 | 0 |
| 1 | 0 | 0 | 0 | 0 | 0 | 0 | 0 | 0 | 0 | 0 | 1 | 0 | 0 | 1 | 0 | 0 | 0 | 0 | 0 | 0 |
| 0 | 1 | 0 | 1 | 1 | 0 | 1 | 0 | 1 | 1 | 1 | 1 | 1 | 0 | 1 | 1 | 1 | 0 | 1 | 0 | 0 |
| 0 | 0 | 0 | 0 | 1 | 0 | 0 | 0 | 0 | 0 | 1 | 1 | 0 | 0 | 0 | 0 | 0 | 0 | 0 | 0 | 1 |
| 1 | 0 | 0 | 0 | 0 | 1 | 0 | 1 | 0 | 0 | 0 | 1 | 0 | 0 | 0 | 0 | 1 | 0 | 0 | 1 | 0 |
| 0 | 0 | 0 | 0 | 1 | 0 | 1 | 0 | 1 | 0 | 0 | 1 | 0 | 0 | 0 | 1 | 1 | 1 | 1 | 0 | 0 |
| 0 | 1 | 0 | 0 | 0 | 1 | 1 | 0 | 0 | 0 | 0 | 1 | 1 | 0 | 0 | 0 | 0 | 0 | 0 | 0 | 0 |
| 1 | 0 | 0 | 1 | 1 | 0 | 1 | 0 | 0 | 0 | 0 | 1 | 0 | 0 | 0 | 1 | 1 | 0 | 0 | 0 | 0 |
| 0 | 0 | 0 | 0 | 1 | 0 | 1 | 0 | 0 | 0 | 0 | 1 | 0 | 1 | 0 | 0 | 1 | 0 | 0 | 0 | 1 |
| 1 | 1 | 0 | 1 | 0 | 0 | 1 | 0 | 0 | 0 | 0 | 1 | 0 | 0 | 0 | 0 | 0 | 0 | 0 | 0 | 1 |
| 0 | 0 | 0 | 0 | 0 | 1 | 0 | 0 | 0 | 0 | 0 | 0 | 0 | 0 | 0 | 1 | 1 | 0 | 0 | 0 | 0 |
| 1 | 0 | 0 | 0 | 0 | 0 | 0 | 0 | 1 | 0 | 0 | 0 | 0 | 0 | 0 | 0 | 1 | 0 | 0 | 0 | 0 |
| 0 | 0 | 0 | 1 | 0 | 0 | 1 | 0 | 0 | 0 | 0 | 1 | 0 | 0 | 0 | 0 | 0 | 0 | 0 | 0 | 0 |
| 1 | 1 | 0 | 1 | 1 | 1 | 1 | 0 | 0 | 0 | 1 | 1 | 0 | 0 | 0 | 1 | 0 | 0 | 1 | 0 | 0 |
| 0 | 0 | 0 | 0 | 1 | 0 | 1 | 0 | 0 | 0 | 0 | 1 | 0 | 0 | 0 | 0 | 1 | 0 | 0 | 0 | 0 |
| 0 | 0 | 0 | 0 | 0 | 0 | 0 | 0 | 0 | 0 | 0 | 0 | 0 | 0 | 0 | 0 | 0 | 1 | 1 | 1 | 1 |
| 1 | 0 | 1 | 0 | 1 | 0 | 0 | 1 | 1 | 1 | 0 | 0 | 1 | 1 | 0 | 0 | 1 | 0 | 0 | 0 | 0 |
| 1 | 0 | 0 | 0 | 0 | 0 | 0 | 0 | 1 | 0 | 0 | 1 | 0 | 0 | 0 | 0 | 0 | 0 | 0 | 0 | 0 |
| 0 | 0 | 1 | 1 | 1 | 0 | 1 | 0 | 1 | 1 | 1 | 1 | 1 | 1 | 1 | 0 | 1 | 1 | 1 | 0 | 1 |
| 0 | 1 | 0 | 0 | 0 | 0 | 0 | 0 | 0 | 0 | 0 | 1 | 0 | 0 | 0 | 1 | 1 | 1 | 0 | 0 | 0 |
| 0 | 1 | 1 | 0 | 1 | 1 | 1 | 0 | 1 | 1 | 0 | 1 | 0 | 1 | 0 | 0 | 1 | 1 | 0 | 1 | 0 |
| 1 | 1 | 1 | 1 | 1 | 0 | 1 | 0 | 0 | 0 | 1 | 0 | 0 | 0 | 0 | 1 | 0 | 0 | 0 | 0 | 0 |
| 0 | 1 | 0 | 0 | 0 | 1 | 1 | 0 | 0 | 0 | 0 | 1 | 0 | 0 | 0 | 1 | 0 | 0 | 0 | 1 | 1 |
| 1 | 1 | 0 | 1 | 1 | 0 | 1 | 0 | 1 | 0 | 1 | 1 | 0 | 0 | 0 | 1 | 1 | 0 | 1 | 0 | 0 |
| 1 | 0 | 0 | 0 | 0 | 0 | 0 | 0 | 1 | 0 | 0 | 1 | 0 | 1 | 0 | 0 | 1 | 1 | 0 | 0 | 0 |
| 0 | 1 | 0 | 0 | 0 | 0 | 1 | 0 | 1 | 0 | 0 | 1 | 0 | 1 | 0 | 1 | 0 | 0 | 0 | 0 | 0 |
| 0 | 1 | 0 | 0 | 0 | 0 | 0 | 0 | 0 | 0 | 1 | 0 | 0 | 0 | 0 | 0 | 1 | 0 | 0 | 0 | 0 |
| 0 | 1 | 1 | 1 | 1 | 0 | 1 | 0 | 1 | 1 | 0 | 1 | 1 | 0 | 0 | 1 | 1 | 1 | 1 | 0 | 1 |
| 1 | 1 | 0 | 0 | 0 | 0 | 1 | 0 | 0 | 0 | 0 | 1 | 0 | 0 | 0 | 1 | 0 | 0 | 0 | 0 | 0 |
| 0 | 1 | 1 | 0 | 1 | 0 | 0 | 0 | 0 | 0 | 0 | 1 | 0 | 0 | 0 | 1 | 1 | 0 | 0 | 0 | 0 |
| 1 | 0 | 0 | 0 | 1 | 0 | 1 | 0 | 0 | 0 | 0 | 0 | 1 | 1 | 0 | 1 | 1 | 1 | 0 | 0 | 1 |
| 1 | 1 | 0 | 0 | 0 | 0 | 0 | 0 | 0 | 1 | 0 | 1 | 0 | 0 | 0 | 0 | 0 | 0 | 0 | 0 | 0 |
| 0 | 0 | 0 | 0 | 0 | 0 | 1 | 0 | 1 | 0 | 0 | 1 | 0 | 0 | 0 | 0 | 1 | 0 | 0 | 1 | 0 |
| 1 | 1 | 0 | 0 | 1 | 0 | 1 | 0 | 0 | 0 | 0 | 1 | 1 | 0 | 0 | 1 | 1 | 0 | 0 | 0 | 0 |
| 1 | 0 | 0 | 1 | 0 | 0 | 0 | 0 | 0 | 0 | 0 | 1 | 1 | 0 | 1 | 0 | 1 | 1 | 1 | 0 | 0 |
| 1 | 0 | 0 | 1 | 0 | 1 | 0 | 0 | 1 | 0 | 1 | 0 | 0 | 0 | 0 | 0 | 0 | 1 | 1 | 0 | 0 |
| 0 | 0 | 0 | 1 | 1 | 0 | 1 | 0 | 0 | 1 | 0 | 0 | 0 | 0 | 1 | 0 | 1 | 0 | 0 | 0 | 0 |
| 0 | 0 | 0 | 0 | 1 | 1 | 0 | 0 | 0 | 0 | 0 | 1 | 1 | 0 | 0 | 0 | 0 | 0 | 0 | 0 | 0 |
| 0 | 1 | 0 | 0 | 0 | 0 | 0 | 0 | 1 | 0 | 0 | 0 | 0 | 0 | 0 | 1 | 0 | 0 | 0 | 0 | 0 |
| 0 | 0 | 0 | 0 | 0 | 0 | 1 | 0 | 0 | 0 | 0 | 0 | 0 | 0 | 0 | 1 | 0 | 0 | 0 | 0 | 0 |
| 0 | 0 | 1 | 0 | 0 | 0 | 0 | 0 | 0 | 1 | 0 | 0 | 0 | 0 | 1 | 0 | 0 | 0 | 0 | 0 | 0 |
| 0 | 0 | 0 | 0 | 0 | 0 | 0 | 1 | 0 | 0 | 0 | 1 | 1 | 0 | 0 | 1 | 0 | 0 | 0 | 0 | 1 |
| 0 | 1 | 0 | 0 | 0 | 0 | 0 | 0 | 0 | 0 | 0 | 1 | 0 | 0 | 0 | 1 | 0 | 0 | 0 | 0 | 0 |
| 1 | 1 | 0 | 0 | 0 | 0 | 1 | 0 | 0 | 0 | 0 | 1 | 0 | 0 | 0 | 1 | 0 | 0 | 1 | 0 | 0 |
| 0 | 1 | 0 | 0 | 0 | 0 | 0 | 0 | 0 | 0 | 0 | 1 | 0 | 0 | 0 | 0 | 1 | 0 | 0 | 0 | 0 |
| 0 | 1 | 0 | 0 | 0 | 0 | 1 | 0 | 1 | 0 | 0 | 1 | 0 | 0 | 0 | 1 | 0 | 1 | 0 | 0 | 0 |
| 0 | 0 | 1 | 1 | 1 | 0 | 1 | 0 | 1 | 0 | 1 | 1 | 0 | 1 | 1 | 0 | 1 | 1 | 1 | 0 | 0 |
| 1 | 0 | 0 | 0 | 1 | 0 | 1 | 1 | 0 | 0 | 0 | 0 | 0 | 0 | 0 | 0 | 1 | 0 | 0 | 0 | 0 |
| 0 | 0 | 0 | 0 | 0 | 0 | 0 | 0 | 0 | 0 | 0 | 1 | 1 | 0 | 0 | 1 | 0 | 0 | 0 | 0 | 0 |
| 1 | 0 | 0 | 1 | 1 | 0 | 0 | 0 | 1 | 0 | 0 | 1 | 0 | 1 | 0 | 1 | 1 | 1 | 0 | 0 | 0 |
| 0 | 0 | 0 | 0 | 0 | 0 | 1 | 0 | 1 | 0 | 0 | 0 | 0 | 0 | 0 | 1 | 1 | 0 | 0 | 0 | 0 |
| 0 | 1 | 0 | 0 | 1 | 0 | 0 | 0 | 0 | 0 | 0 | 0 | 0 | 0 | 0 | 1 | 0 | 0 | 0 | 0 | 0 |
| 0 | 0 | 0 | 0 | 1 | 1 | 0 | 0 | 1 | 0 | 0 | 0 | 0 | 0 | 0 | 0 | 1 | 0 | 0 | 0 | 0 |
| 0 | 1 | 0 | 0 | 0 | 0 | 1 | 0 | 0 | 0 | 0 | 0 | 0 | 0 | 0 | 1 | 0 | 1 | 0 | 0 | 1 |
| 0 | 0 | 0 | 0 | 1 | 0 | 1 | 0 | 1 | 0 | 1 | 1 | 0 | 0 | 0 | 0 | 1 | 0 | 0 | 0 | 0 |
| 0 | 0 | 0 | 0 | 0 | 1 | 1 | 0 | 0 | 0 | 0 | 0 | 0 | 0 | 0 | 1 | 0 | 0 | 0 | 0 | 0 |
| 1 | 1 | 0 | 1 | 0 | 0 | 1 | 0 | 0 | 0 | 0 | 0 | 1 | 1 | 0 | 0 | 1 | 0 | 0 | 0 | 1 |
| 0 | 0 | 0 | 0 | 1 | 0 | 1 | 0 | 0 | 0 | 0 | 0 | 1 | 0 | 0 | 0 | 1 | 0 | 0 | 0 | 0 |
| 0 | 0 | 0 | 0 | 0 | 1 | 1 | 0 | 0 | 0 | 0 | 1 | 0 | 0 | 0 | 1 | 0 | 0 | 1 | 1 | 0 |
| 0 | 1 | 0 | 0 | 0 | 0 | 0 | 1 | 0 | 0 | 0 | 0 | 0 | 0 | 0 | 1 | 0 | 0 | 0 | 0 | 1 |
| 0 | 1 | 0 | 0 | 0 | 0 | 1 | 0 | 0 | 0 | 1 | 0 | 0 | 0 | 0 | 1 | 1 | 0 | 0 | 0 | 0 |
| 1 | 0 | 0 | 0 | 0 | 0 | 1 | 0 | 1 | 0 | 0 | 1 | 0 | 0 | 0 | 1 | 0 | 0 | 0 | 0 | 0 |
| 0 | 0 | 0 | 0 | 0 | 1 | 1 | 0 | 0 | 0 | 0 | 1 | 0 | 0 | 0 | 1 | 1 | 0 | 0 | 1 | 0 |
| 1 | 0 | 0 | 0 | 0 | 0 | 0 | 0 | 0 | 0 | 0 | 1 | 0 | 0 | 0 | 1 | 0 | 0 | 0 | 0 | 0 |
| 1 | 0 | 0 | 0 | 1 | 0 | 1 | 0 | 1 | 0 | 1 | 1 | 0 | 1 | 0 | 0 | 1 | 1 | 0 | 0 | 0 |
| 0 | 0 | 0 | 0 | 1 | 0 | 1 | 0 | 0 | 0 | 0 | 0 | 0 | 0 | 0 | 0 | 1 | 0 | 1 | 0 | 0 |
| 0 | 1 | 1 | 0 | 1 | 0 | 0 | 0 | 0 | 1 | 0 | 1 | 1 | 1 | 0 | 1 | 1 | 1 | 0 | 0 | 1 |
| 1 | 1 | 0 | 0 | 0 | 0 | 1 | 0 | 1 | 0 | 0 | 0 | 0 | 0 | 0 | 0 | 0 | 0 | 0 | 0 | 0 |
| 0 | 1 | 0 | 0 | 0 | 0 | 1 | 0 | 1 | 0 | 0 | 0 | 0 | 0 | 0 | 0 | 0 | 0 | 1 | 0 | 1 |
| 0 | 0 | 0 | 0 | 1 | 0 | 1 | 0 | 0 | 0 | 1 | 1 | 0 | 0 | 0 | 0 | 0 | 0 | 0 | 0 | 0 |
| 0 | 0 | 0 | 0 | 1 | 0 | 1 | 0 | 1 | 0 | 0 | 0 | 0 | 0 | 0 | 0 | 1 | 0 | 0 | 0 | 0 |
| 0 | 1 | 0 | 0 | 0 | 0 | 1 | 0 | 1 | 0 | 0 | 0 | 0 | 0 | 0 | 0 | 0 | 0 | 0 | 0 | 0 |
| 0 | 1 | 0 | 1 | 0 | 0 | 1 | 0 | 0 | 0 | 0 | 1 | 0 | 0 | 0 | 0 | 1 | 1 | 0 | 0 | 0 |
| 0 | 1 | 0 | 0 | 1 | 1 | 1 | 0 | 1 | 0 | 0 | 0 | 0 | 0 | 0 | 0 | 0 | 0 | 0 | 0 | 0 |
| 0 | 1 | 0 | 0 | 0 | 0 | 1 | 0 | 1 | 0 | 0 | 0 | 1 | 0 | 0 | 0 | 0 | 0 | 0 | 0 | 0 |
| 1 | 1 | 0 | 0 | 1 | 0 | 1 | 0 | 0 | 0 | 0 | 1 | 1 | 0 | 0 | 1 | 1 | 0 | 0 | 0 | 1 |
| 1 | 0 | 0 | 1 | 1 | 0 | 1 | 0 | 1 | 0 | 0 | 1 | 0 | 0 | 0 | 0 | 0 | 0 | 0 | 0 | 0 |
| 1 | 1 | 0 | 0 | 1 | 0 | 0 | 0 | 0 | 0 | 1 | 0 | 1 | 0 | 0 | 0 | 1 | 0 | 0 | 0 | 1 |
| 0 | 1 | 0 | 1 | 0 | 0 | 1 | 0 | 0 | 0 | 0 | 0 | 0 | 0 | 0 | 0 | 0 | 0 | 0 | 0 | 0 |
| 0 | 0 | 1 | 0 | 1 | 0 | 1 | 0 | 0 | 0 | 0 | 1 | 1 | 1 | 0 | 0 | 1 | 0 | 0 | 0 | 0 |
| 0 | 0 | 0 | 0 | 0 | 1 | 0 | 0 | 0 | 0 | 0 | 0 | 1 | 1 | 0 | 1 | 0 | 1 | 0 | 0 | 0 |
| 0 | 0 | 0 | 0 | 0 | 0 | 1 | 0 | 0 | 0 | 0 | 1 | 0 | 0 | 0 | 0 | 1 | 0 | 0 | 0 | 0 |
| 1 | 0 | 0 | 1 | 1 | 0 | 0 | 0 | 1 | 0 | 1 | 0 | 0 | 0 | 0 | 0 | 0 | 1 | 0 | 0 | 0 |
| 1 | 0 | 1 | 0 | 0 | 0 | 0 | 0 | 0 | 0 | 0 | 0 | 0 | 0 | 0 | 0 | 0 | 1 | 0 | 0 | 0 |
| 1 | 0 | 0 | 0 | 1 | 0 | 1 | 0 | 0 | 0 | 0 | 0 | 0 | 0 | 0 | 0 | 0 | 0 | 0 | 1 | 0 |
| 1 | 1 | 1 | 0 | 1 | 1 | 0 | 0 | 0 | 0 | 0 | 1 | 0 | 0 | 1 | 0 | 0 | 0 | 0 | 0 | 0 |
| 0 | 1 | 0 | 0 | 0 | 0 | 1 | 0 | 0 | 0 | 0 | 1 | 0 | 0 | 0 | 0 | 0 | 0 | 1 | 0 | 1 |
| 1 | 0 | 0 | 1 | 1 | 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 0 | 0 | 0 | 0 | 1 | 0 | 1 | 0 | 0 | 0 | 0 | 1 | 0 | 0 | 1 |
| 0 | 0 | 0 | 0 | 1 | 0 | 0 | 0 | 1 | 0 | 0 | 1 | 0 | 0 | 0 | 0 | 0 | 0 | 0 | 0 | 0 |
| 0 | 0 | 0 | 0 | 0 | 0 | 1 | 0 | 1 | 0 | 0 | 1 | 0 | 0 | 0 | 0 | 0 | 0 | 0 | 0 | 0 |

1. A method of filtering data to predict an observation about an item for a particular case, in which: a set of data representing actual observations about a plurality of items for a plurality of different cases is modelled as a function of a plurality of case and item profiles, each profile being a set of parameters comprising at least one hidden metrical variable, the parameters defining characteristics of the respective case or item;
a best fit of the function to the data is approximated in order to find the values of the item profiles; and
the profiles found are used together with the function to predict an observation for a particular case about one or more items for which data is not available for that case.

2. A method as claimed in claim 1, wherein the function which models the data set comprises a plurality of models, each model representing the observations about one item for the cases in the data set.

3. A method as claimed in claim 1 or 2, wherein each model is derived by identifying a model type which approximates the closest fit to the data available for the item in question.

4. A method as claimed in claim 1, 2 or 3, wherein in the function which models the data set, the observations about items for cases are independent, conditional on the case profiles.

5. A method as claimed in any preceding claim, wherein the models which make up the function are learnt from past observations.

6. A method as claimed in any preceding claim, wherein point estimates of the parameters of the case and item profiles are found for the dataset and these are used to predict an observation.

7. A method of filtering data to predict an observation about an item for a particular case, in which a set of data is obtained representing actual observations for a plurality of cases, including the particular case, about a plurality of items, a function which models the data set is solved so that the data is decomposed into a plurality of case profiles and item profiles, and an observation for the particular case about an item is predicted using the case profiles and item profiles obtained.

8. A method as claimed in claim 6 or 7, wherein the function is maximised so as to determine the case and item profiles.

9. A method as claimed in claim 8, wherein the data set is modelled as a function of the likelihood of the data in the data set being present and the function is solved by choosing item profiles and case profiles which maximise the likelihood of the data in the data set being present.

10. A method as claimed in claim 8 or 9, wherein the function is maximised iteratively such that one of the case and item profiles is held constant during each step of an iteration.

11. A method as claimed in any of claims 1 to 5, wherein the function which models the dataset is a function of a prior distribution over possible case profiles and point estimates of the item profiles are then obtained.

12. A method of filtering data to predict an observation about an item for a particular case, in which a set of data is obtained representing actual observations for a plurality of cases about a plurality of items, a function which models the data set as a function of a plurality of item profiles and a prior distribution over a plurality of possible case profiles is set up to provide point estimates of the item profiles that fit the function to the data, and an observation about an item for a particular case is predicted using the item profile point estimates obtained together with a set of data representing observations about a plurality of items for the said particular case.

13. A method as claimed in any preceding claim, wherein the observation is predicted by updating a prior distribution over possible case profiles using Bayesian inference.

14. A method of filtering data to predict an observation about an item for a particular case, in which a set of data representing actual observations for a plurality of cases about a plurality of items is modelled by a function, and the function is solved so as to decompose the data into a plurality of case profiles and a plurality of item profiles, and an observation for the particular case about an item is predicted by Bayesian inference using the case profiles and item profiles obtained together with a set of data representing observations about a plurality of items for the said particular case.

15. A method as claimed in claim 14, wherein the case profiles obtained are used to obtain a prior probability distribution over possible case profiles for the said particular case and the prior probability distribution is then used in the Bayesian inference.

16. A method as claimed in claim 15, wherein the prior probability distribution is generated by taking an average of the case profiles in the data set.

17. A method as claimed in claim 16, wherein a posterior probability distribution over possible case profiles for the said particular case is generated from the prior probability distribution by Bayesian inference using the set of data relating to the said case and the function modelling the likelihood of the data set being present.

18. A method as claimed in claim 17, wherein the posterior probability distribution is used to generate a probability distribution over possible observations about items for the particular case.

19. A method as claimed in any of claims 13 to 18, wherein only the data relating to those items for which observations have been obtained for the case is used in updating the prior distribution over possible case profiles.

20. A method as claimed in any of claims 13 to 19, wherein the item profiles are estimated as those parameters which maximise the fit between the function which models the data set and the data.

21. A method as claimed in any of claims 13 to 20, wherein the number of components of each item profile is set to maximise the effectiveness of the function in making predictions.

22. A method as claimed in claim 21, wherein the number of components is set using standard model selection techniques such as the Akaike information criterion.

23. A method as claimed in claim 11 or 12, wherein the data set is modelled as a function of the expected likelihood of the data in the data set being present and the item profiles are chosen as the parameter values which maximise the likelihood of the data in the data set being present given the function and the assumed prior distribution of the case profiles.

24. A method as claimed in claim 23, wherein the function is maximised iteratively and preferably, an EM algorithm is used to do this.

25. A method as claimed in any of claims 13 to 24, wherein the prior distribution over each component of the plurality of possible case profiles is assumed to be a standard normal distribution and the components are assumed to be independent.

26. A method as claimed in claim 25, wherein this distribution is also used in the Bayesian inference to estimate the observation about an item for the particular case.

27. A method as claimed in any of claims 13 to 26, wherein a posterior probability distribution over possible case profiles for the said particular case is generated from the prior probability distribution by Bayesian inference using the set of data relating to the said particular case and the function modelling the likelihood of the data set being present.

28. A method as claimed in claim 27, wherein the posterior probability distribution is used to generate a probability distribution over possible observations about items for the particular case.

29. A method as claimed in any preceding claim, wherein each case is a different user of a prediction system such that observations by that user about various items are included in the dataset.

30. A method as claimed in claim 29, wherein the function is made up of a plurality of models, each model representing the suitability of an item for a user.

31. A method as claimed in claim 30, wherein each model of the suitability of an item for a user depends directly only on the case profile for that user and the profile for that item, and not directly on any of the data relating to the suitability for the user of any other item.

32. A method of filtering data to predict an observation about an item for a particular case, in which a set of data is obtained representing actual observations for a plurality of cases about a plurality of items, a function which models the data set as a function of a set of case profiles and a set of items profiles comprising sets of parameters is set up, wherein the case and item profiles each comprise at least one hidden metrical variable, the parameters defining the characteristics of each said respective case and item, the method comprising the steps of:
a) estimating the values of the case profile parameters by solving a hidden variable model of the dataset;
b) using the estimated values of the case profile metrical variables in the function to estimate the values of the item profile metrical variables; and
c) predicting an observation about an item for a particular case using the item profile values obtained together with a set of data representing observations about a plurality of items for the said particular case.

33. A method as claimed in claim 32, wherein the case profile values are estimated by solving a hidden variable model of the dataset to find approximate values of the item profile variables and the approximate item profile values are then used to estimate the case profile values.

34. A method as claimed in claim 33, wherein the hidden variable model used is a linear model such as for example a standard linear factor model or principal component analysis.

35. A method as claimed in any of claims 32 to 34, wherein the estimated case profile values are substituted into the function modelling the dataset which is then solved using maximum likelihood techniques to find the item profile values.

36. A method as claimed in any of claims 32 to 35, wherein items in the dataset are considered as belonging to a plurality of different groups, each group having a different set of case profiles associated with it so that the case profile values for each group are estimated separately.

37. A method as claimed in any of claims 32 to 36, wherein some items in the dataset are treated directly as observed components of the case profile, i.e. as values of one or more of the metrical variables.

38. A method as claimed in any of claims 32 to 37, wherein the prediction of an observation about an item for the case is made by updating a prior distribution over possible profiles for the case by Bayesian inference and then using the updated case profile obtained together with the function modelling the dataset and the estimated item profile values to make predictions.

39. A method as claimed in any of claims 32 to 37, wherein an observation about an item for the case is estimated by maximising the likelihood of the data relating to the case in question given the function modelling the dataset and the estimated item profile values to find the values of the case profile, and then using the case profile obtained together with a likelihood function and the estimated item profiles to predict observations about items for that case.

40. A method as claimed in any preceding claim, wherein the method for estimating an observation about an item for the case is implemented using a software program that manipulates Bayesian networks.

41. A method as claimed in any preceding claim, wherein the item profiles and the prior distribution over possible case profiles or the actual case profiles are calculated in an off-line non real-time filtering engine and are supplied to an on-line real-time engine for use in the calculation of predicted observations for a case when a set of data relating to the said case is supplied to the real-time engine.

42. A method of filtering data to find items which are similar to an item specified by a user, in which a set of data representing observations about a plurality of items for a plurality of cases is obtained, a function which models the data set is used to estimate a plurality of item profiles each containing a set of parameters representing characteristics of the item and at least one hidden metrical variable, and wherein items which are similar to a specified item are found by comparing the item profile of the specified item to other item profiles.

43. A method of filtering data, in which a set of data representing observations about a plurality of items for a plurality of cases is obtained, a function which models the data set is solved so that the data is used to estimate a plurality of item profiles each containing a set of parameters representing characteristics of the item, and at least one hidden metrical variable, and wherein cases and/or items are sorted into groups or clusters such that each group contains cases or items having similar case or item profiles.

44. A method as claimed in any preceding claim, wherein statistical techniques are used to correct for bias in the case data prior to predicting an observation about an item for a particular case.

45. A method as claimed in any preceding claim, further comprising the step of obtaining data relating to the assessment by a plurality of users of one or more exogenous standards so as to increase the amount and range of data available.

46. A method of obtaining a data set from which the suitability of a specific object for a user can be estimated, in which data relating to the suitability for a plurality of users of a plurality of related objects is obtained together with data relating to the preferences of those users for at least one exogenous standard which is not directly related to the plurality of related objects.

47. A method of obtaining a data set from which an observation for a case about a specific object can be predicted, in which data relating to the observations for a plurality of cases about a plurality of predefined items is obtained and in which further data relating to one or more attributes of one or more of the predefined items may also be provided for one or more of the cases.

48. A method as claimed in any preceding claim, wherein a pre-filtering processing step is provided to carry out preliminary screening using objective criteria to reduce the number of items that must be assessed in the filtering step.

49. A method as claimed in claim 48, wherein weighting factors may be applied to the data relating to the observations about items for the cases prior to the filtering step.

50. A method as claimed in claim 49, wherein the weighting factors applied to the data reflect the time that has elapsed since the time at which the observation about the item was formed such that the weight of each piece of data for predictive purposes declines with time.

51. A method of weighting data relating to observations about an item in which the weight of the data decreases with an increase in the time elapsed since the observation was made.

52. A method as claimed in any of claims 48 to 51, wherein a post filtering processing step is provided in addition to or instead of the pre-filtering processing step.

53. A method as claimed in claim 52, wherein the post-filtering processing step is a rules based processing step which excludes any items which do not fall within a defined set of criteria from the predictions output from the filtering step.

54. A method as claimed in any preceding claim, wherein a different type of output giving an estimated prediction such as for example the generic mean of the output can be substituted for filtering predictions where, for whatever reason, there-is insufficient information concerning either one or more items within the item database or concerning one or more cases.

55. A method as claimed in claim 54, wherein the estimated predictions are replaced gradually by predictions obtained from the filtering method of the invention as more data becomes available.

56. A method as claimed in claim 53, wherein a manager of the dataset generates a fixed number of phantom cases such that the profile of an item for which insufficient data is available is specified by the manager as being a weighted average of some other items and the phantom cases are specified to rate that item with ratings which depend on the manually determined profile.

57. A method as claimed in any preceding claim, wherein the method is used to provide a data filtering service in which a database of observations about a plurality of items for a plurality of users is obtained and analysed on an exclusive basis for a single client.

58. A method as claimed in any of claims 1 to 56, wherein the method is used to provide a data filtering service in which a database of observations about a plurality of items for a plurality of cases is obtained and analysed to provide a database which may be pooled with other databases, the filtering service operating from the pooled databases via linkage preferably through a dedicated extranet. Under this arrangement a single history database (i.e. a data set representing the suitability of a plurality of objects for a plurality of users) may be established, developed and maintained for the class of clients being served as a whole.

59. A method as claimed in claim 58, wherein the pooled database is configured such that, although the history database is held in common as described above, contributing websites retain either partial or complete exclusivity in relation to the inputs and outputs from the database in respect of those particular users that register through their sites.

60. A method as claimed in claim 58, wherein database information concerning individual users may be held in a common pooled database but either partial or complete exclusivity may be maintained by individual clients in relation to inputs and outputs in relation to specific classes of item.

61. A method as claimed in any preceding claim, wherein an indication of the level of personalisation of the predictions provided is given at the user interface.

62. A method of providing an indication of the level of personalisation of recommendations generated by a collaborative filtering engine to a user at the user interface.

63. A method as claimed in claim 61 or 62, wherein the indication of the level of personalisation is provided by a sliding scale representing a personalisation score.

64. A method as claimed in any of claims 61 to 63, wherein the recommendations are generated by a filtering method according to any one of claims 1 to 41 and the personalisation score is obtained by determining the q average variance of the probability distribution over each characteristic for the case in question.

65. A method as claimed in any of claims 61 to 64, wherein the recommendations provided to the user at the user interface are updated each time that the user enters a further piece of information into the database.

66. A method as claimed in any of claims 61 to 65, wherein the user interface is a web site and the inputting of information is carried out on the same page on which the personalisation level indicator and the recommendations are displayed.

67. A method as claimed in any preceding claim, wherein each item in the data set is plotted against a first component of the item profile and a second component of the item profile on the x and y axes respectively.

68. A method as claimed in claim 67, wherein if the user considers that the position of an item is incorrect, he can move that item thus imposing a different profile on it.

69. A method of filtering data in which a function is set up which models a set of data representing observations about a plurality of items for a plurality of cases, as a function of a plurality of item profiles and case profiles each containing a set of unknown parameters defining characteristics of the case or item, and a best fit of the function to the data is found in order to find the values of the unknown parameters, the unknown parameters for each item are compared to one another and, if desired, an operator alters one or more of the unknown parameters for one or more of the items before using the sets of unknown parameters to analyse the underlying trends in the data.

70. A method as claimed in claim 69, wherein the parameters found together with the altered parameters are used together with the function to predict an observation about one or more items for a particular case for which data is not available.

71. A computer program product for carrying out the method as claimed in any preceding claim when run on computer processing means.

72. A computer program product containing instructions which when run on computer processing means will create a computer program for carrying out the method as claimed in any preceding claim.

73. A method of filtering data to find items which are suitable for a user, in which a set of data representing observations about a plurality of items for a plurality of users is obtained, a function which models the data set is used to estimate a plurality of user profiles each comprising a set of parameters representing characteristics of the case, wherein items which were preferred by users with similar user profiles to the user are recommended to that user.

74. Data processing means programmed to carry out the method as claimed in any preceding claim.
